(19) United States
(12) Patent Application Publication
(10) Pub. No.: US 2025/0321708 A1
(43) Pub. Date: Oct. 16, 2025

(54) AUDITORY USER INTERFACES AND ASSOCIATED SYSTEMS, METHODS, DEVICES, AND NON-TRANSITORY COMPUTER-READABLE MEDIA

(71) Applicant: Iyo Inc., Redwood City, CA (US)

(72) Inventors: Neil David Treat, Los Gatos, CA (US); Christian Ervin, San Anselmo, CA (US); Jason Steven Rugolo, Gilbert, AZ (US)

(73) Assignee: Iyo Inc., Redwood City, CA (US)

(21) Appl. No.: 19/177,479

(22) Filed: Apr. 11, 2025

Related U.S. Application Data
(60) Provisional application No. 63/633,611, filed on Apr. 12, 2024.

(51) Int. Cl. G06F 3/16; G06F 21/62; G10L 15/22

(52) U.S. Cl. CPC G06F 3/167; G06F 21/6218; G10L 15/22

(57) ABSTRACT

An auditory operating system designed to facilitate context-aware, audio-based user interactions, particularly with artificial intelligence agents or applications. An auditory operating system shell serves as the primary interface, managing and coordinating multiple specialized agents that handle specific domains like music streaming, scheduling, or home automation. Using natural language processing, the auditory operating system shell identifies the appropriate agent or application for a user's command or query and ensures task execution and context preservation across interactions. The auditory operating system shell enforces privacy and stability by controlling agents' and applications' access to data and system privileges. The auditory operating system shell also supports dynamic context management, enabling seamless handoffs between agents when user requests span multiple domains. This auditory operating system shell may reduce the need for users to memorize specific wake words or commands, as the auditory operating system shell may determine the user's intent from speech or contextual cues.

### CROSS-REFERENCE TO RELATED APPLICATION

This application claims priority to U.S. Provisional Patent Application No. 63/633,611, filed on Apr. 12, 2024, and entitled “Auditory User Interfaces,” and is related to U.S. patent application Ser. No. 18/621,974, filed on Mar. 29, 2024, and entitled “VIRTUAL AUDITORY DISPLAY FILTERS AND ASSOCIATED SYSTEMS, METHODS, AND NON-TRANSITORY COMPUTER-READABLE MEDIA,” and to U.S. patent application Ser. No. 18/622,540, filed Mar. 29, 2024, and entitled “VIRTUAL AUDITORY DISPLAY DEVICES AND ASSOCIATED SYSTEMS, METHODS, AND DEVICES.” Each of the foregoing applications is incorporated by reference herein in its entirety.

### TECHNICAL FIELD

The present disclosure relates in general to auditory user interfaces, and in particular to auditory user interfaces that provide context-aware auditory experiences and facilitate audio interactions, such as audio interactions with artificial intelligence agents.

### BACKGROUND

As conversational devices and artificial intelligence assistants grow more complex, users may interact with multiple agents, such as an agent for music streaming, another for task scheduling, still another for home automation, and so forth. Existing voice interfaces operate as singular monolithic assistants, forcing the user to remember specific invocation phrases or skill commands. This can lead to confusion and inefficiency. Moreover, a user may only interact with a single agent at a time.

Conventional agents are typically rendered in a mono or simple stereo format, lacking positional cues that would otherwise bolster realism. This limitation diminishes user engagement and can result in cognitive burden or poor orientation, especially in mixed reality or virtual reality environments where multi-sensory immersion may be a goal. Spatial audio has been employed for music or environmental effects, but existing systems do not utilize three-dimensional positioning for agentic speech.

Many headphones and earbuds isolate the user from external sounds, creating a situation where ambient noise and environmental cues are greatly diminished. Although noise isolation can be beneficial in certain settings, it can also pose safety risks (for example, while walking in busy streets) and reduce situational awareness. In augmented reality or other immersive experiences, purely digital audio can overshadow important real-world cues, which may compromise the user's sense of presence and safety.

No admission is necessarily intended, nor should it be construed, that any of the preceding information constitutes prior art.

### SUMMARY

This disclosure describes an auditory operating system designed to facilitate context-aware, audio-based user interactions, particularly with artificial intelligence (AI) agents or other applications. An auditory operating system shell serves as the main interface, managing and coordinating multiple specialized agents that handle specific domains like music streaming, scheduling, or home automation. Using natural language processing techniques, the auditory operating system shell identifies the appropriate agent or application for a user's command or query and ensures smooth task execution and context preservation across interactions.

The auditory operating system shell enforces privacy and stability by controlling agents' access to APIs, data, and system privileges. The auditory operating system shell also supports dynamic context management, enabling seamless handoffs between agents when user requests span multiple domains. This interface may reduce or eliminate the need for users to memorize specific wake words or commands, as the auditory operating system shell determines the user's intent from speech or contextual cues. In some cases, the auditory operating system shell maintains a cohesive and standardized response style across all agents or applications.

For devices featuring spatial audio capabilities, the auditory operating system shell provides a spatial audio framework for agents, applications, or other audio stream sources. This framework assigns virtual positions to agents or applications, allowing users to perceive distinct audio sources as though emanating from specific directions or distances. By leveraging real-time user tracking, head orientation sensors, and advanced audio rendering, the auditory operating system shell adapts agent positions dynamically to create a realistic auditory scene, enhancing usability and reducing cognitive load.

Moreover, the auditory operating system shell may incorporate features like environmental noise adaptation and selective sound filtering. These capabilities may optimize or improve digital audio experiences by balancing them with real-world sounds, ensuring critical alerts remain audible while filtering out irrelevant background noise. Users can further customize these settings, adjusting levels of sound blending or prioritizing specific external sounds, thereby integrating digital audio seamlessly with their environment.

The auditory operating system shell also emphasizes personalization and convenience, offering customizable settings and quick adjustments through gestures or voice commands. This allows users to effortlessly transition between audio modes (for example, immersive or ambient audio modes) without interrupting their activities. By blending digital content with the natural soundscape, the auditory operating system shell fosters an enriched auditory experience that is both immersive and practical, enhancing user awareness and interaction.

### BRIEF DESCRIPTION OF THE DRAWINGS

The particular arrangements shown in the Figures should not be viewed as limiting. It should be understood that the illustrated elements, including the shape, size and scale, may not necessarily be drawn in actual proportion to each other.

FIG. 1A is a front bottom perspective view of a virtual auditory display device according to an embodiment.

FIG. 1B is a front elevational view of the virtual auditory display device of FIG. 1A.

FIG. 2 is a front perspective view and a rear view of an ear-worn device of the virtual auditory display device of FIG. 1A.

FIG. 3 is an exploded view of the ear-worn device of FIG. 2

FIG. 4 is an exploded view of an electronics package of the ear-worn device of FIG. 2.

FIG. 5A is a front perspective view and a rear perspective view of an acoustics package of the ear-worn device of FIG. 2.

FIG. 5B is a front perspective view and a rear perspective view of another acoustics package of another ear-worn device of the virtual auditory display device of FIG. 1A.

FIG. 5C depicts multiple views of the acoustics package of FIG. 5A.

FIG. 5D depicts multiple views of the acoustics package of FIG. 5B.

FIG. 6 is an exploded view of the acoustics package of FIG. 5A and an ear interface of the virtual auditory display device of FIG. 1A.

FIG. 7A is a rear bottom perspective view and FIG. 7B is a front top perspective view of a collar for an ear-worn device in some embodiments.

FIG. 8A is a graph depicting frequency responses of multiple audio signals for acoustic packages according to various embodiments.

FIG. 8B is another graph depicting frequency responses of multiple audio signals for acoustic packages according to various embodiments.

FIG. 9A is a rear perspective view of an ear-worn device having the collar of FIGS. 7A and 7B and a pressure-equalization vent in some embodiments.

FIG. 9B is a cross-sectional view of an ear-worn device having another pressure-equalization vent in some embodiments.

FIG. 10A is a logic block diagram of components of an electronics package of the virtual auditory display system of FIG. 1A.

FIG. 10B is another logic block diagram of components of another electronics package of the virtual auditory display system of FIG. 1A.

FIG. 11 is a front perspective view and a rear perspective view of an ear-worn device of a virtual auditory display device according to another embodiment.

FIG. 12 is an exploded view of the ear-worn device of FIG. 11.

FIG. 13 is an exploded view of the electronics package of the ear-worn device of FIG. 11.

FIG. 14 is a logic block diagram of components of the electronics package of FIG. 13.

FIGS. 15A and 15B depict multiple views of a virtual auditory display device according to another embodiment.

FIGS. 16A and 16B depict multiple views of a virtual auditory display device according to another embodiment.

FIG. 17A is a front perspective view and FIG. 17B is a rear perspective view of a virtual auditory display device according to another embodiment.

FIGS. 17C through 17G depict multiple views of an ear-worn device of the virtual auditory display device of FIGS. 17A and 17B.

FIGS. 18A and 18B depict multiple views of a controller for the virtual auditory display device of FIGS. 17A through 17G according to some embodiments.

FIG. 19 depicts a cable that may be utilized with the virtual auditory display device of FIGS. 17A through 17G and the controller of FIGS. 18A and 18B according to some embodiments.

FIG. 20 depicts a battery assembly that may be utilized with the virtual auditory display device of FIGS. 17A through 17G and the controller of FIGS. 18A and 18B according to some embodiments.

FIG. 21 depicts a wireless communications device in some embodiments.

FIGS. 22A and 22B depict multiple views of a virtual auditory display device according to another embodiment.

FIG. 23 is a diagram of an environment in which a virtual auditory display system and virtual auditory display devices may operate in some embodiments.

FIG. 24A is a block diagram depicting components of the virtual auditory display system in some embodiments.

FIG. 24B is a block diagram depicting components of an ear-worn device in some embodiments.

FIG. 24C is a block diagram depicting a process for generating acoustic environment digital filters in some embodiments.

FIG. 24D is a block diagram depicting operations of a spatialization engine of the virtual auditory display system in some embodiments.

FIG. 25A is a block diagram of a method of generating and applying digital filters in some embodiments.

FIG. 25B is a block depicting components of a filter generation system in some embodiments

FIGS. 26A through 26C are graphs of frequency responses of digital audio signals in some embodiments.

FIG. 27A depicts a distribution of center frequencies as a function of azimuth (x-axis) and elevation (y-axis) for the left ear.

FIG. 27B depicts a distribution of center frequencies as a function of azimuth (x-axis) and elevation (y-axis) for the right ear.

FIG. 28A is a graph of the center frequency of a digital filter as a function of elevation angle relative to a head orientation according to some embodiments.

FIG. 28B is a graph of user experience data of multiple trials with five different digital filters, which vary as a function of notch center frequency, in some embodiments.

FIGS. 29A through 29X depict gain modifier masks that may be applied to modify gains of digital filters in some embodiments.

FIGS. 30A and 30B depict head shadow gains produced by digital filters in some embodiments.

FIG. 30C depicts an output of the application of digital filters to a digital audio signal according to some embodiments.

FIG. 30D depicts user experience data for a transfer function based on digital filters according to some embodiments and user experience data for a prior art transfer function.

FIG. 30E depicts an example head-related transfer function (HRTF).

FIGS. 31A and 31B depict methods of generating digital filters according to some embodiments.

FIGS. 32A and 32B depict methods of applying digital filters according to some embodiments.

FIG. 32C depicts a method of generating and applying virtual auditory display filters in some embodiments.

FIGS. 33A and 33B depict an example user interface for displaying a representation of a virtual audio display in some embodiments.

FIG. 33C depicts an example user interface for adjusting settings for a virtual audio display in some embodiments.

FIG. 34 is multiple images depicting example use cases of display filter technology in some embodiments.

FIGS. 35A and 35B are diagrams of a method of personalizing digital filters in some embodiments.

FIGS. 36A and 36B depict methods of personalizing digital filters in some embodiments.

FIGS. 37A through 37C depict an example user interface for calibrating a virtual auditory display device in some embodiments.

FIGS. 37D through 37F depict an example user interface for personalizing a virtual auditory display of a virtual auditory display device in some embodiments.

FIGS. 37G through 37J depict an example user interface for providing information on calibration of a virtual auditory display device and personalization of a virtual auditory display of the virtual auditory display device in some embodiments.

FIG. 38A depicts an example configuration for implementing an auditory user interface in some embodiments.

FIG. 38B depicts another example configuration for implementing an auditory user interface according to some embodiments.

FIG. 39 is a block diagram depicting an auditory operating system according to some embodiments.

FIG. 40 depicts functionality of an auditory operating system in some embodiments.

FIG. 41 depicts interactions between a user device, a shared auditory space, and an auditory operating system according to some embodiments.

FIGS. 42-46 are flow diagrams illustrating example methods that some embodiments of aspects of the described technology may perform.

FIG. 47 depicts a developer studio application and software development kit for developing agents in some embodiments.

FIG. 48 depicts a block diagram of an example digital device in some embodiments.

Throughout the drawings, like reference numerals will be understood to refer to like parts, components, and structures.

### DETAILED DESCRIPTION

Described herein are virtual auditory display devices. A virtual auditory display device may include a first ear-worn device and a second ear-worn device that a person wears on the person's ears. The virtual auditory display device may receive audio signals from another device and generate virtual auditory display sound based on the audio signals. Virtual auditory display sound may refer to sounds that are capable of being perceived by the wearer of the virtual auditory display device as coming from any point in space surrounding the wearer. The virtual auditory display device may thus provide an immersive sound experience for the wearer.

Virtual auditory display devices may have a wide range of uses. For example, a music creator may use a virtual auditory display device to listen to music the music creator has produced. The music creator may then remix or modify the music based on their hearing the music rendered as virtual auditory display sound. For example, the music creator may move the location of certain sounds, emphasize certain sounds, deemphasize certain sounds, and the like. In this fashion, the music creator may utilize the virtual auditory display device as part of an iterative process of creating music until the music creator achieves the desired effect for the music.

Another use may be by music afficionados who may utilize a virtual auditory display device to provide a listening experience that reinvigorates the music that they love. Another use may be for users who play video games. The virtual auditory display devices may allow the users to hear sounds emanating from locations that are not shown on their displays, thereby improving the users' awareness.

Another group of example use cases relate to military, non-military (for example, first responders such as police and firefighters) and/or other organizational applications. Virtual auditory display devices may be used to provide hyper-realistic virtual audio environments that facilitate virtual training for military and/or non-military personnel. For military personnel, virtual auditory display devices and associated devices may provide enhanced hearing, communications and hyper-situational awareness in combat and training. Other uses are described herein, and still other uses will be apparent.

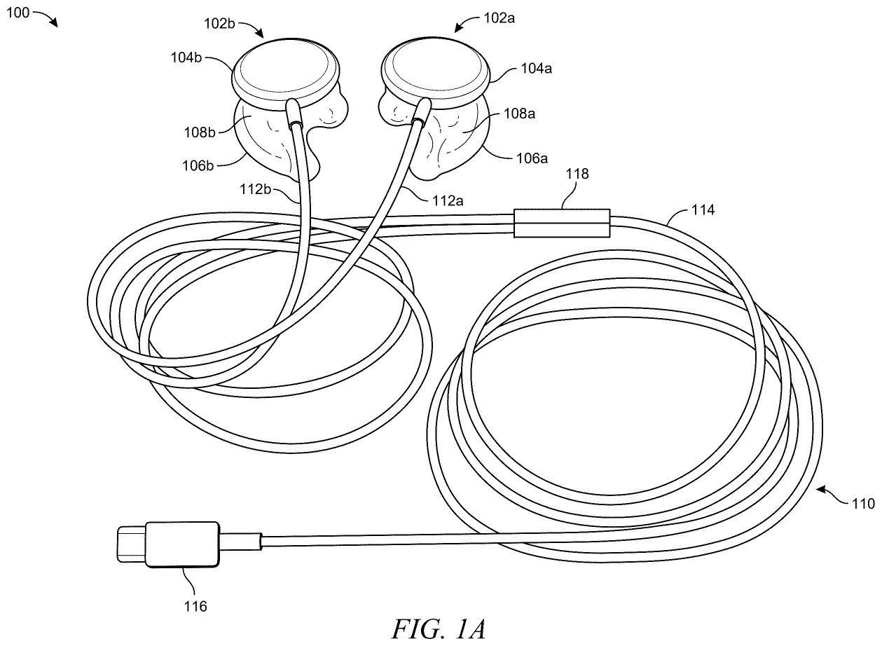

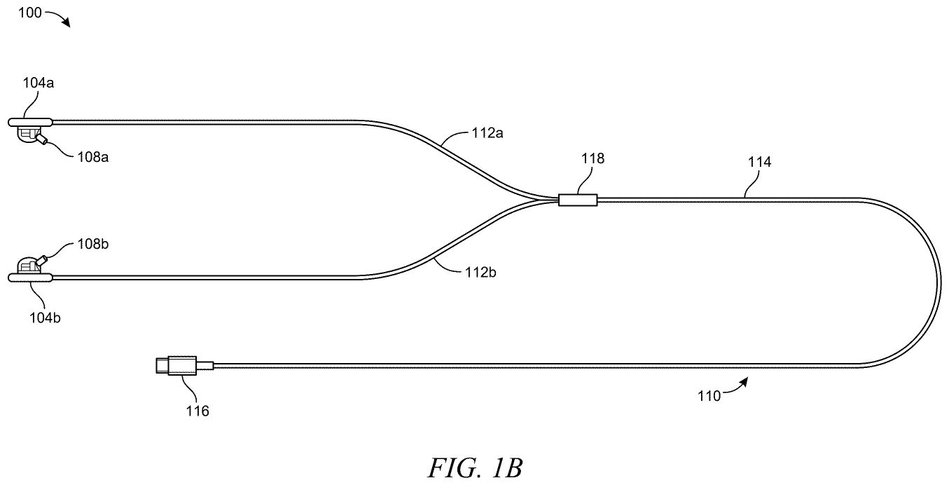

FIG. 1A is a front bottom view of a virtual auditory display device 100 according to an embodiment. The virtual auditory display device 100 includes a first ear-worn device 102a, a second ear-worn device 102b, and a cable 110. The first ear-worn device 102a includes a first electronics package 104a, a first ear interface 106a, and a first acoustic package 108a positioned within the first ear interface 106a and attached to the first electronics package 104a.

The second ear-worn device 102b includes a second electronics package 104b, a second ear interface 106b, and a second acoustic package 108b positioned within the second ear interface 106b and attached to the second electronics package 104b. The cable 110 includes a connector 116, a cable connector portion 114, a junction 118, a first cable portion 112a connected to the junction 118 and the first electronics package 104a, and a second cable portion 112b connected to the junction 118 and the second electronics package 104b.

As described in more detail herein, the first ear interface 106a is structured to be placed in a left ear of a wearer of the virtual auditory display device 100 and the second ear interface 106b is structured to be placed in a right ear of the wearer. The first ear interface 106a and the second ear interface 106b may be custom made for the wearer's ears so as to provide a generally acoustically sealed fit for the wearer's ears.

Each of the first electronics package 104a and the second electronics package 104b includes electronics components for generating audio signals based on digital audio signals received via the cable 110 from an external device, such as a phone or a computer, to which the virtual auditory display device 100 is connected. Each of the first acoustic package 108a and the second acoustic package 108b includes one or more analog components, such as one or more speakers, that are configured to emit sound based on the audio signals received from the first electronics package 104a and the second electronics package 104b respectively. The sound travels through the first ear interface 106a and the second ear interface 106b and into the ear canals of the wearers.

FIG. 1A depicts the first electronics package 104a and the second electronics package 104b as attached to the first acoustic package 108a and the second acoustic package 108b, respectively. However, as described in more detail herein, the first electronics package 104a and the second electronics package 104b may be removed from the first acoustic package 108a and the second acoustic package 108b, respectively.

The wearer may remove the first electronics package 104a and the second electronics package 104b from the first acoustic package 108a and the second acoustic package 108b and insert the first ear interface 106a into the wearer's left ear and the second ear interface 106b into the wearer's right ear. The wearer may then connect the first electronics package 104a to the first acoustic package 108a and the second electronics package 104b to the second acoustic package 108b.

Although the first ear interface 106a and the first acoustic package 108a are for the left ear of the wearer and the second ear interface 106b and the second acoustic package 108b are for the right ear of the wearer, the first electronics package 104a may be connected to either the first acoustic package 108a or the second acoustic package 108b. Similarly, the second electronics package 104b may be connected to either the first acoustic package 108a or the second acoustic package.

The user may connect the virtual auditory display device 100 to an external device such as a phone or laptop or desktop computer (not illustrated in FIG. 1A) via the connector 116 of the cable 110. The external device may stream two-channel digital audio to the first ear-worn device 102a and the second ear-worn device 102b via the cable 110. The two-channel digital audio may have been generated using virtual auditory display filters that produce audio signals that the first ear-worn device 102a and the second ear-worn device 102b use to generate virtual auditory display sound for the wearer. Virtual auditory display sound may refer to sounds that are capable of being perceived by the wearer of the virtual auditory display device 100 as coming from any point in space surrounding the wearer. The virtual auditory display device 100 may thus provide an immersive sound experience for the wearer using the sound output by the first ear-worn device 102a and the sound output by the second ear-worn device 102b. The generation of virtual auditory display filters and application of virtual auditory display filters so that the first ear-worn device 102a and the second ear-worn device 102b may output virtual auditory display sound is described in more detail herein.

FIG. 1B is a front elevational view of the virtual auditory display device 100. The first ear-worn device 102a and the second ear-worn device 102b are shown without the first acoustic package 108a and the second acoustic package 108b positioned within the first ear interface 106a and the second ear interface 106b, respectively.

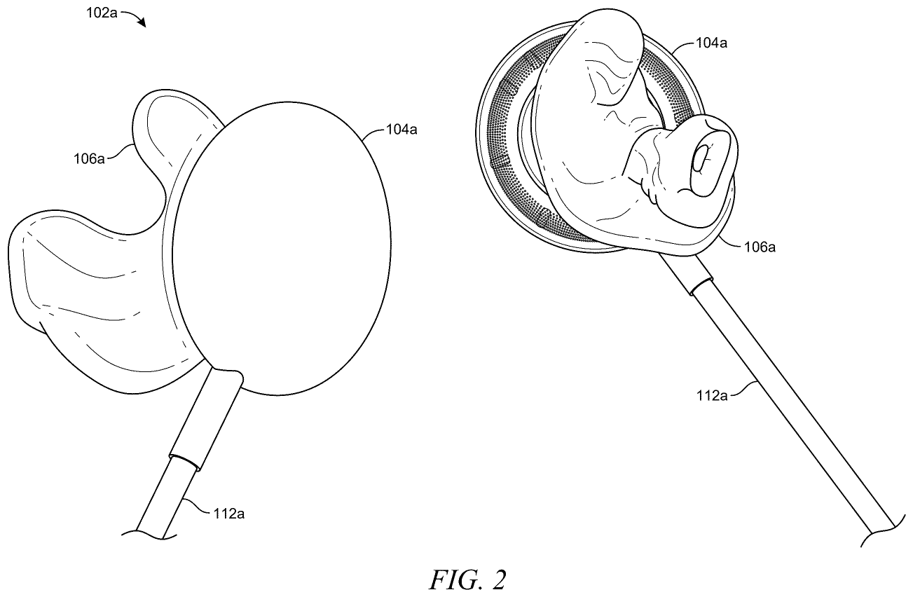

FIG. 2 depicts a front perspective view and a rear view of the first ear-worn device 102a. As described in more detail herein, the first electronics package 104a is removably magnetically coupleable to the first acoustic package 108a (not illustrated in FIG. 2), and the first acoustic package 108a is removably coupleable to the first ear interface 106a. Similarly, for the second ear-worn device 102b (not illustrated in FIG. 2), the second electronics package 104b is removably coupleable to the second acoustic package 108b and the second acoustic package 108b is removably coupleable to the second ear interface 106b.

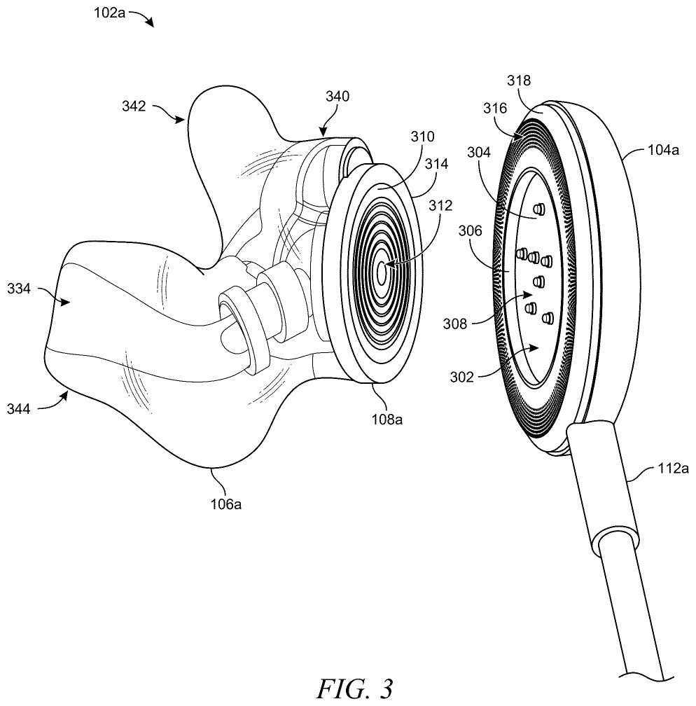

FIG. 3 is an exploded view of the first ear-worn device 102a. The first ear-worn device 102a includes the first electronics package 104a, the first acoustic package 108a, and the first ear interface 106a. The first acoustic package 108a includes a connector 310 having a generally planar surface. The connector 310 includes a first set of electrical contacts 312 on the generally planar surface. In some embodiments, the first set of electrical contacts 312 includes a set of annular electrical contacts. In some embodiments, there are seven annular electrical contacts in the set. The first acoustic package 108a also includes a magnet 314 having a generally hollow cylindrical shape.

The first electronics package 104a includes a microphone cover 318 including multiple perforations 316. The first electronics package 104a further includes a magnet 306 positioned inward relative to the microphone cover 318. The microphone cover 318 and the magnet 306 form a generally cylindrical recess 302 having a generally planar surface 304. A second set of electrical contacts 308 extend outwards from the generally planar surface 304. Each electrical contact of the second set of electrical contacts 308 is configured to connect with a separate electrical contact of the first set of electrical contacts 312 so that power and/or data may pass between the electronics package 104a and the acoustics package 108a. In some embodiments, the second set of electrical contacts 308 includes a set of pogo pins. In some embodiments, there are seven pogo pins in the set, and each pogo pin is arranged on the generally planar surface 304 such that the pogo pin contacts a separate annular electrical contact.

The generally cylindrical recess 302 has the same general shape as the magnet 314 and the connector 310 of the second acoustic package 108b. The first electronics package 104a may thus removably magnetically couple to the first acoustic package 108a. The first electronics package 104a is removably magnetically coupleable to the first acoustic package 108a due to attractive magnetic forces between the magnet 314 and the magnet 306. Similarly, the second electronics package 104b of the second ear-worn device 102b is also removably magnetically coupleable to the second acoustic package 108b due to magnetic attractive forces between corresponding magnets.

The first ear interface 106a includes a proximal portion 340, an upper portion 342, and a distal portion 344. When first ear-worn device 102a is worn by a wearer, the distal portion 344 is positioned in the left ear canal of the wearer and the upper portion 342 is positioned generally proximate to the left ear concha and generally between the left ear antihelix and helical crus of the wearer. The proximal portion 340 is positioned generally proximate to the left ear antihelix, antitragus, and tragus of the wearer.

The first ear interface 106a also includes a first opening and multiple cavities (not illustrated in FIG. 3) that allow the first acoustic package 108a to be placed into and positioned within the first ear interface 106a. The first ear interface 106a also includes a second opening (not illustrated in FIG. 3) and a passage 334 from the second opening to the first acoustic package 108a. The second ear interface 106b is structured similarly to the first ear interface 106a but for the right ear of the wearer.

The first ear interface 106a and the second ear interface 106b (not illustrated in FIG. 3) may be custom-made for a left ear and a right ear of a wearer. The first ear interface 106a and the second ear interface 106b may thus provide a generally acoustically sealed fit for the left ear and the right ear, respectively, of the wearer. The first ear interface 106a and the second ear interface 106b may be made of any suitable material, such as silicone, thermoplastic elastomers (TPE), and/or other biocompatible options, and may be transparent, translucent, or opaque.

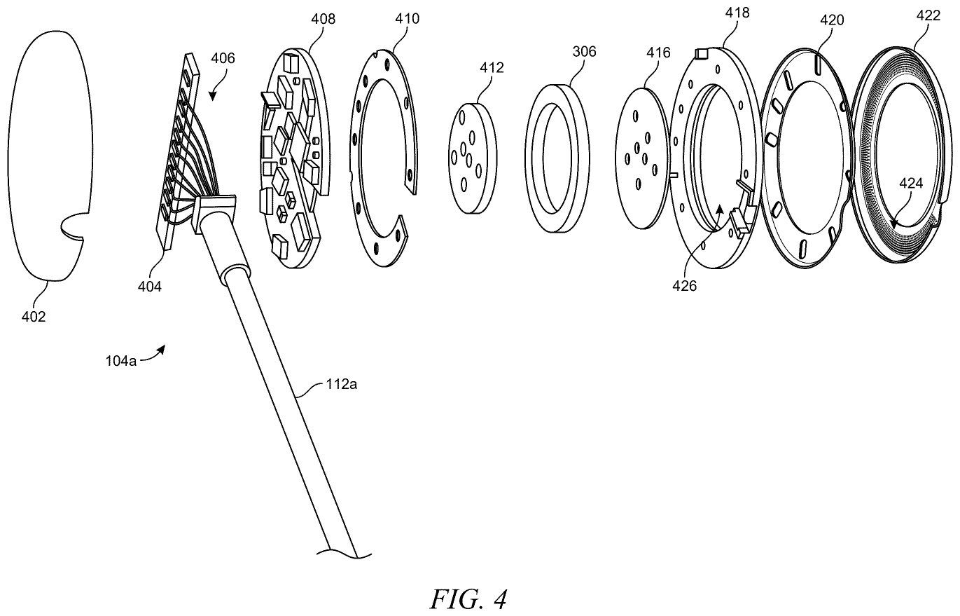

FIG. 4 is an exploded view of the first electronics package 104a. From left to right, the first electronics package 104a includes a cap 402. The cap 402 may be made from titanium or other suitable material. In some embodiments, the cap 402 is machined from a solid block of material (for example, titanium). In some embodiments, the cap 402 has a curvature continuous surface. In some embodiments, at least a portion of the cap 402 has a curvature continuous surface.

The first electronics package 104a further includes a cable printed circuit board 404. The first cable portion 112a includes multiple wires 406 that are attached to the cable printed circuit board 404. In some embodiments, the first cable portion 112a includes eleven wires. Several of the multiple wires 406 may be for carrying power and/or data from an external device to which the connector 116 is connected to, such as a phone or a desktop or laptop computer. Several of the multiple wires 406 may be for carrying data to and from the first electronics package 104a.

The first electronics package 104a further includes a printed circuit board 408. The printed circuit board 408 includes multiple electronics components such as a microcontroller, memory, an inertial measurement unit (IMU)-based sensor system (which may be referred to as an IMU), a magnetometer, codecs with audio digital signal processors (DSPs), multiple microphones, and the second set of electrical contacts 308.

In some embodiments, the printed circuit board 408 includes nine microphones. The nine microphones on the printed circuit board 408 may be utilized for different purposes. In some embodiments, eight of the nine microphones are digital and may be utilized to create a transparency mode by capturing external noises that are processed by the first electronics package 104a and output by first acoustic package 108a. In some embodiments, one microphone is a high signal-to-noise ratio analog microphone that may be utilized for feedforward active noise cancellation.

The first electronics package 104a also includes a first pressure-sensitive adhesive layer 410, an electrical connector spacer 412, the magnet 306, and a first pressure-sensitive adhesive layer 416.

The first electronics package 104a also includes a microphone manifold 418 having an opening 426 with a continuously increasing radius that may reduce or eliminate a Helmholtz resonance. The first electronics package 104a further includes a microphone cover adhesive layer 420 and a microphone cover 422. The microphone cover 422 includes numerous perforations 424 to allow sounds to pass through and be captured by the multiple microphones on the printed circuit board 408. The microphone cover 422 may be made of any suitable material, such as stainless steel, and the numerous perforations 424 may be created by chemical etching. In some embodiments a perforation has a diameter of approximately 150 microns.

The components of the first electronics package 104a may be attached or coupled using any suitable means, such as adhesives, mechanical fasteners, ultrasonic welding, and the like. Although not depicted in FIG. 4, the second electronics package 104b may include generally similar components as the first electronics package 104a.

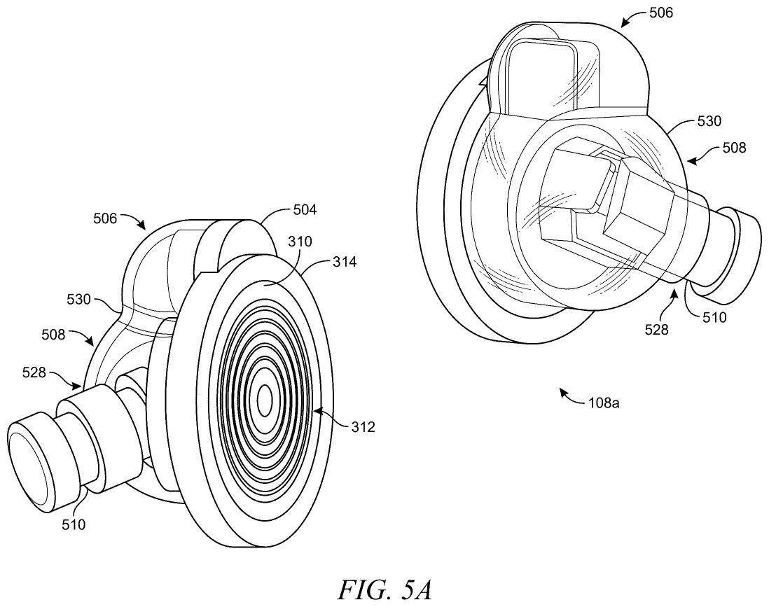

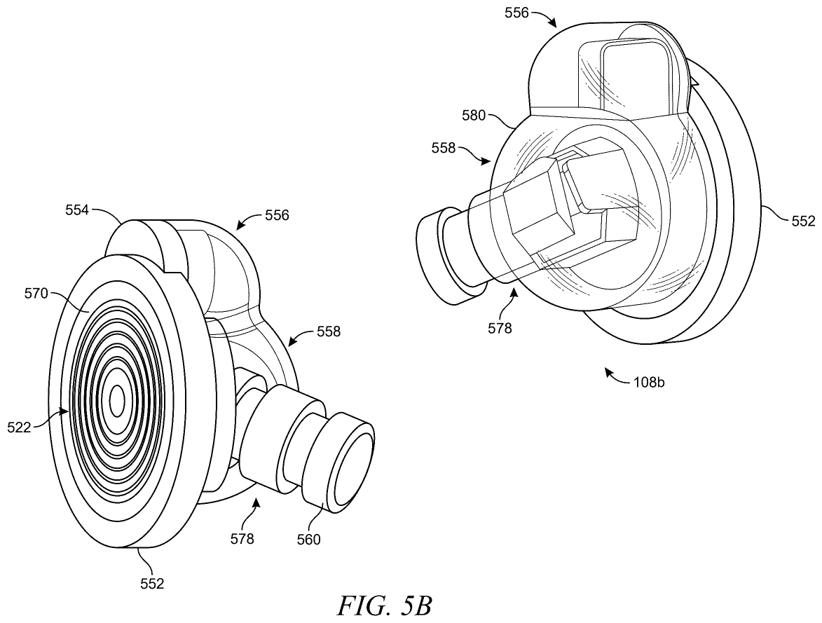

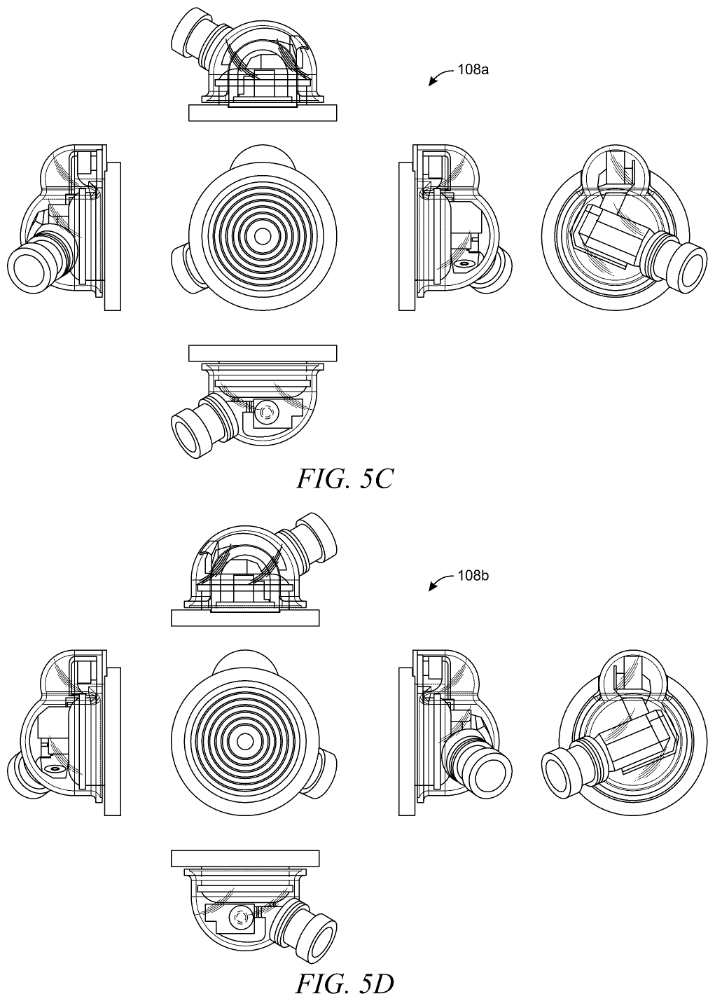

FIG. 5A depicts a front perspective view and a rear perspective view of the first acoustic package 108a. The first acoustic package 108a is for a left ear of a wearer. The first acoustic package 108a includes a housing 530 that includes a first housing portion 508 having a first partial generally capsule shape and a second housing portion 506 having a second partial generally capsule shape. The first partial generally capsule shape of the first housing portion 508 may include a first partial generally cylindrical portion and a first partial generally hemispherical portion. Similarly, the second partial generally capsule shape of the second housing portion 506 may include a second partial generally cylindrical portion and a second partial generally hemispherical portion.

The housing 530 also includes a third housing portion 528 having a generally cylindrical shape. Positioned within the housing 530 are various components including one or more speakers, such as a driver and a balanced armature. The housing 530 may be made of any suitable material, such as polycarbonate, and may be transparent, translucent, or opaque.

The first acoustic package 108a further includes the magnet 314, the connector 310, the first set of electrical contacts 312, and a cap 504. The first acoustic package 108a further includes a snout 510, a portion of which is positioned in the third housing portion 528.

FIG. 5B depicts a front perspective view and a rear perspective view of the second acoustic package 108b. The second acoustic package 108b is for a right ear of a wearer. The second acoustic package 108b includes a housing 580 that includes a first housing portion 558 having a first partial generally capsule shape and a second housing portion 556 having a second partial generally capsule shape. The first partial generally capsule shape of the first housing portion 558 may include a first partial generally cylindrical portion and a first partial generally hemispherical portion. Similarly, the second partial generally capsule shape of the second housing portion 556 may include a second partial generally cylindrical portion and a second partial generally hemispherical portion.

The housing 580 also includes a third housing portion 578 having a generally cylindrical shape. Positioned within the housing 580 are various components including one or more speakers, such as a driver and a balanced armature. The housing 580 may be made of any suitable material, such as polycarbonate, and may be transparent, translucent, or opaque.

The second acoustic package 108b further includes a magnet 552, a connector 570, a set of annular electrical contacts 522 on the connector 570, and a cap 554. The second acoustic package 108b further includes a snout 560, a portion of which is positioned in the third housing portion 578. The components of the first acoustic package 108a and the second acoustic package 108b may be attached or coupled using any suitable means, such as adhesives, mechanical fasteners, ultrasonic welding, and the like.

FIG. 5C depicts multiple views of the first acoustic package 108a, including a front elevational view, a rear elevational view, a left-side elevational view, a right-side elevational view, a top plan view, and a bottom plan view. Similarly, FIG. 5D depicts multiple views of the second acoustic package 108b, including a front elevational view, a rear elevational view, a left-side elevational view, a right-side elevational view, a top plan view, and a bottom plan view.

Example dimensions of the first acoustic package 108a are as follows. In front elevational view, the housing 530 may have a length from an extremity of the first housing portion 508 to an extremity of the second housing portion 506 of about approximately 16 mm to about approximately 18 mm, such as approximately 16.4 mm, the first housing portion 508 may have a width of about approximately 12 mm to about approximately 14 mm, such as approximately 13.1 mm, and the second housing portion 506 may have a width of about approximately 6 mm to about approximately 8 mm, such as approximately 7.3 mm. In side view, the housing 530 may have a height of about approximately 8 mm to about approximately 10 mm, such as approximately 8.8 mm. The third housing portion 578 may have an outside diameter of about approximately 4 mm to about approximately 6 mm, such as approximately 5.0 mm. The second acoustic package 108b may have similar example dimensions.

Other embodiments of the acoustic package may have a different shape. For example, in one embodiment, an acoustic package may have a housing that has an asymmetric teardrop shape in front elevational view. The housing of the acoustic package for the left ear may be larger towards the left of the housing and smaller towards the right of the housing in front elevational view. Similarly, the housing of the acoustic package for the right ear may be larger towards the right of the housing and smaller towards the left of the housing in front elevational view. Other shapes for the acoustic package that fit the anatomy of an ear are possible. Accordingly, the first acoustic package 108a may have any suitable configuration and corresponding dimensions that fits a left ear and the second acoustic package 108b may have any suitable any suitable configuration and corresponding dimensions that fits a right ear.

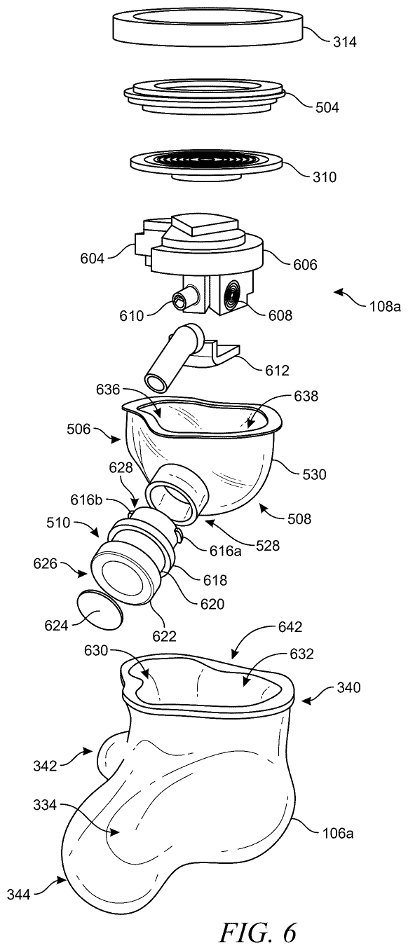

FIG. 6 is an exploded view of the first acoustic package 108a and the first ear interface 106a. The first acoustic package 108a includes the magnet 314, the cap 504, and the connector 310. The first acoustic package 108a also includes a flexible printed circuit board 604, a driver 606, a balanced armature 610, and an in-ear canal microphone 608. The first acoustic package 108a also includes a balanced armature port 612 into which a portion of the balanced armature 610 is positioned.

The in-ear canal microphone 608 may be utilized as an error reference microphone for feedback active noise cancellation. The driver 606 may serve as a woofer and may provide a suitable low-frequency response. The balanced armature 610 may serve as a tweeter and may provide a suitable high-frequency response. In some embodiments the first acoustic package 108a includes only analog components, which may allow for long usage of the first acoustic package 108a.

The first housing portion 508 and the second housing portion 506 of the housing 530 define a first housing cavity 638 and a second housing cavity 636. The flexible printed circuit board 604, the driver 606, the balanced armature 610, the in-ear canal microphone 608, and the balanced armature port 612 may be positioned at least partially in the first housing cavity 638 and the second housing cavity 636. The snout 510 is generally cylindrically shaped and includes a snout proximal portion 628 positioned at least partially within the third housing portion 528 and a snout distal portion 626. A first wing 616a and a second wing 616b positioned at the snout proximal portion 628 may function to secure the snout proximal portion 628 to the third housing portion 528.

The snout 510 further includes a first flange 618, an intermediate snout portion 620, and a second flange 622. The first flange 618 is positioned flush against the third housing portion 528. The snout 510 has a first opening at the snout proximal portion 628, a second opening at the snout distal portion 626, and a snout passage therebetween such that the sound emitted by driver 606 and the balanced armature 610 may pass through the first opening, the snout passage, and the second opening.

The snout 510 further includes one or more acoustic mesh layers 624, which may be made of any suitable material, such as stainless steel, and have oleophobic and hydrophobic properties. The one or more acoustic mesh layers 624 may provide suitable acoustic resistance so that the effect of external acoustics on the components of the first acoustic package 108a is reduced or eliminated. The one or more acoustic mesh layer 624 may also not interfere with sound generated by the first acoustic package 108a and allow air to pass through.

The first ear interface 106a includes the proximal portion 340, the upper portion 342, and the distal portion 344. The first ear interface 106a further includes a first opening 642 at the proximal portion 340 and a first cavity 632 and a second cavity 630 extending away, or inwardly, from the first opening 642. The first cavity 632 has a partial generally capsule shape generally matching the partial generally capsule shape of the first housing portion 508. The second cavity 630 has a partial generally capsule shape generally matching the second partial generally capsule shape of the second housing portion 556. The matching shapes of the first cavity 632 and the second cavity 630 allow the first acoustic package 108a to be positioned within the first ear interface 106a.

The first ear interface 106a further includes a second opening (not illustrated in FIG. 6) at the distal portion 344. Sound emitted by the driver 606 and the balanced armature 610 may pass through the passage 334 and the second opening.

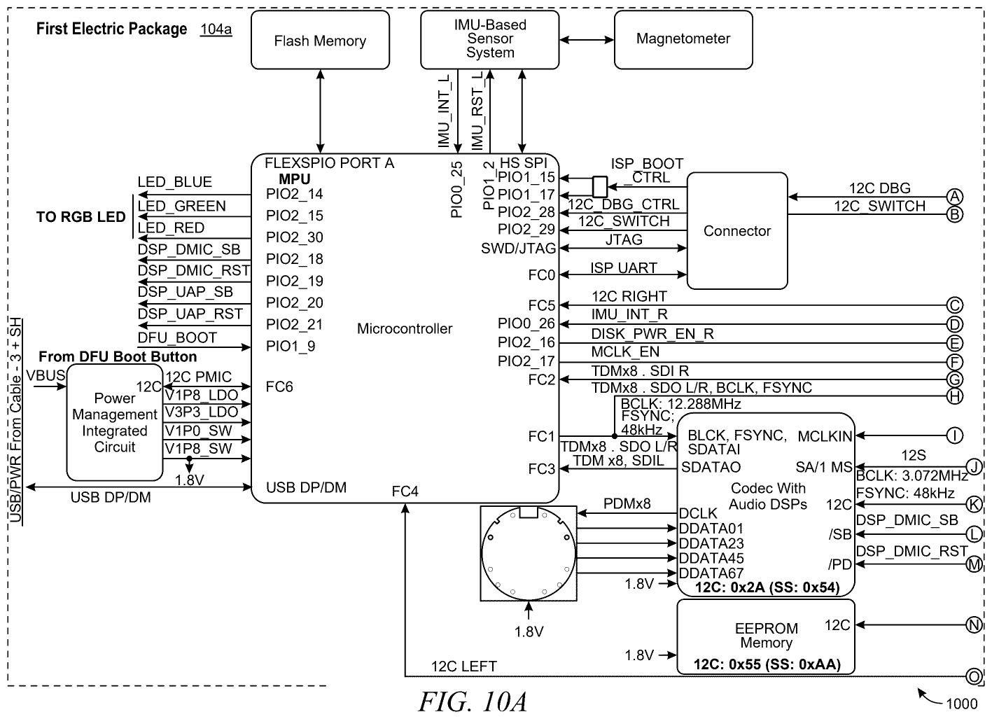

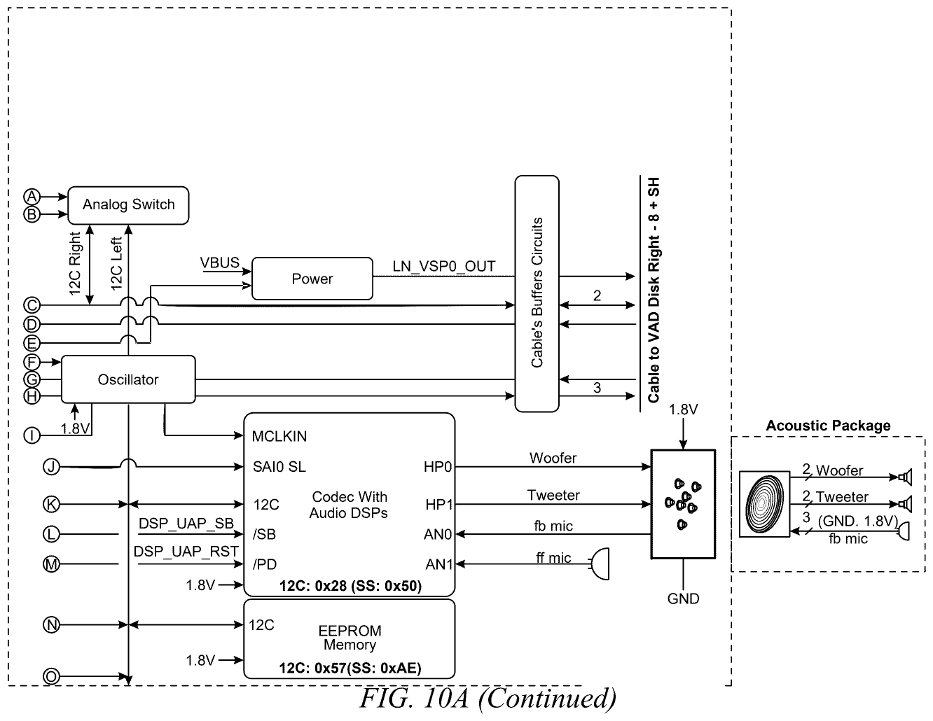

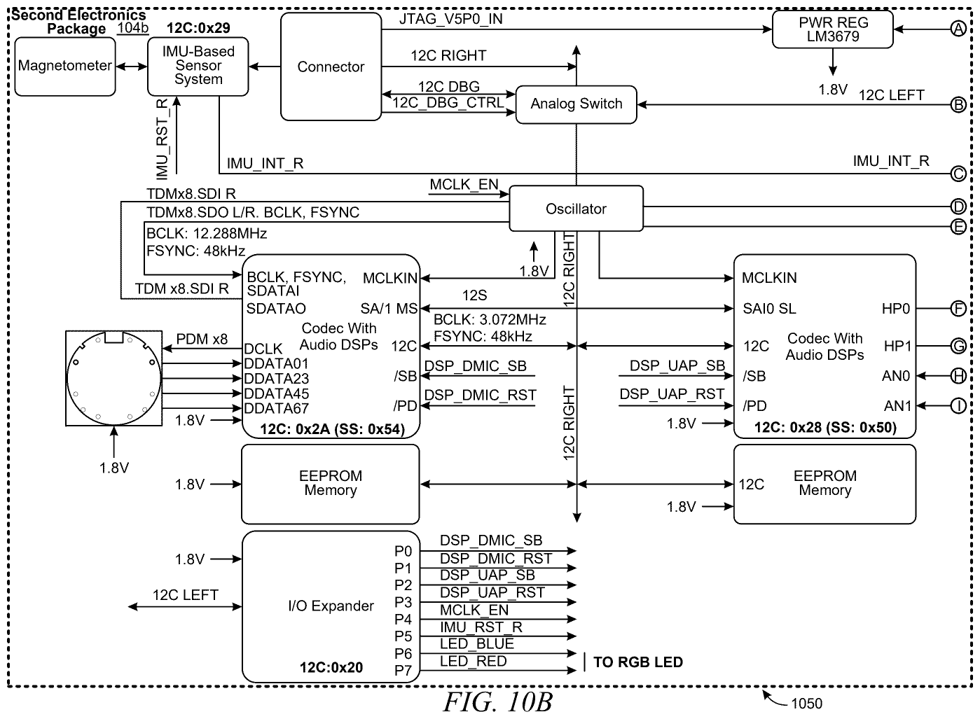

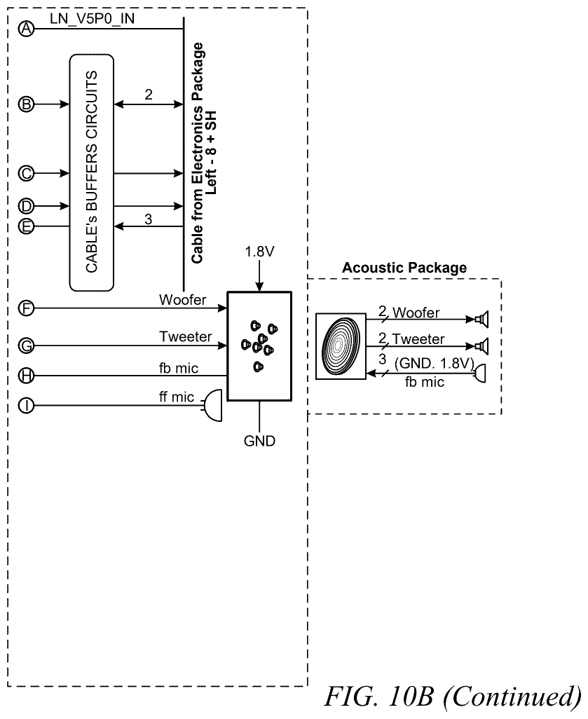

FIG. 10A is a logic block diagram 1000 of the first electronics package 104a. The logic block diagram 1000 depicts the first electronics package 104a as including multiple electronic components that perform various functions. The multiple electronic components include memory, both flash and EEPROM, an IMU-based sensor system, a magnetometer, a microcontroller which may include one or more processors, a power management integrated circuit, codecs with audio digital signal processors (DSPs), an oscillator, microphones, and switches. The various functions that the multiple electronic components may perform include receiving a digital audio signal, processing the audio signal by applying digital filters to the audio signal, generating an analog signal based on the processed digital signal, and providing the analog signal to first acoustic package 108a. The electronic components may perform functions other than those described herein.

FIG. 10B is another logic block diagram 1050 of the second electronics package 104b. The logic block diagram 1050 depicts the second electronics package 104b as including multiple electronic components that perform various functions. The multiple electronic components include EEPROM memory, an IMU-based sensor system, a magnetometer, codecs with audio DSPs, an oscillator, microphones, and a switch. The various functions that the multiple electronic components may perform include receiving a digital audio signal, processing the audio signal by applying digital filters to the audio signal, generating an analog signal based on the processed digital signal, and providing the analog signal to the second acoustic package 108b.

The memories of the first electronics package 104a and/or the second electronics package 104b may store instructions that may be executed by the microcontroller and/or the DSPs. In some embodiments, the memory may store virtual auditory display filters that the microcontroller processor and/or the DSPs may apply to audio signals that the first electronics package 104a and the second electronics package 104b receive.

One or more components of the first electronics package 104a and/or the second electronics package 104b (for example, the IMU-based sensor system, the magnetometer, an accelerometer, a gyroscope, or other suitable components) may be configured to capture head orientation data for a head orientation of a wearer of the first ear-worn device and the second ear-worn device. The memories of the first electronics package 104a and/or the second electronics package 104b may store instructions that when executed by the microcontroller and/or the DSPs may cause the microcontroller and/or the DSPs to determine the head orientation of the wearer based on the head orientation data captured by the one or more components.

The memories of the first electronics package 104a and/or the second electronics package 104b may store instructions that when executed by the microcontroller and/or the DSPs may also cause the microcontroller and/or the DSPs to perform active noise cancellation of the sounds of the wearer captured by the in-canal microphone in the first acoustic package 108a and/or the second acoustic package 108b and/or active noise cancellation of external sounds captured by the high signal-to-noise ratio analog microphone in the first electronics package 104a and/or the second electronics package 104b.

Electronic components of the first electronics package 104a, such as the microcontroller, may control electronic components of the second electronics package 104b. Accordingly, the first electronics package 104a may be considered as a primary electronics package and the second electronics package 104b may be considered as a secondary electronics package.

The virtual auditory display device 100 may interface with a virtual auditory display system as described herein to render virtual auditory display sound for a wearer. Virtual auditory display sound may be considered as immersive, panoramic sound that is capable of being perceived as emanating from any point in space surrounding the wearer. The virtual auditory display system may apply digital filters to a multi-channel audio signal to generate audio signals that are sent to the virtual auditory display device 100. The virtual auditory display device 100 generates, based on the audio signals, the virtual auditory display sound.

Virtual auditory display sound may be especially desirable for a music creator, who may create music with multiple channels (for example, 9.1.6). The music creator may use a digital audio workstation to create music. The music creator may then use the virtual auditory display system to apply digital filters to the music so that the music may be rendered as virtual auditory display sound by the virtual auditory display device 100. The virtual auditory display system may allow the music creator to apply different acoustic environment filters so that the virtual auditory display sound may be heard in different simulated acoustic environments (for example, in a car, in a night club).

The music creator may then remix or modify the music based on their hearing the music rendered as virtual auditory display sound. For example, the music creator may move the location of certain sounds, emphasize certain sounds, deemphasize certain sounds, and the like. In this fashion, the music creator may utilize the virtual auditory display device 100 as part of an iterative process of creating music until the music creator achieves the desired effect for the music.

The virtual auditory display device 100 may switch between a transparency mode and an immersion mode by detecting interactions of the wearer with the virtual auditory display device 100. For example, the wearer may tap once on either the first electronics package 104a or the second electronics package 104b to cause the virtual auditory display device 100 to enter a transparency mode. In the transparency mode one or more microphones of the first electronics package 104a and the second electronics package 104b may capture external sounds, signals based on the captured external sounds may be generated, and the one or more speakers of the first acoustic package 108a and the second acoustic package 108b may output sound based on the generated signals.

As another example, the wearer may also tap twice on either the first electronics package 104a or the second electronics package 104b to cause the virtual auditory display device 100 to enter the immersion mode. In the immersion mode the first electronics package 104a and the second electronics package 104b may perform active noise cancellation on signals corresponding to sound captured by one or more microphones of the first electronics package 104a and the second electronics package 104b.

The virtual auditory display device 100 may provide other functionality enabled by components of the virtual auditory display device 100. For example, the arrays of microphones may enable the virtual auditory display device 100 to selectively amplify certain sounds and selectively cancel certain sounds. The DSPs may enable sound detection and the arrays of microphones may enable the virtual auditory display device 100 to locate detected sounds. The virtual auditory display device 100 may then amplify the detected sounds. As another example, the microphones of the virtual auditory display device 100 may enable active noise cancellation of sounds generated by the wearer, such as the wearer's voice. The virtual auditory display device 100 may also provide functionality other than what is described herein.

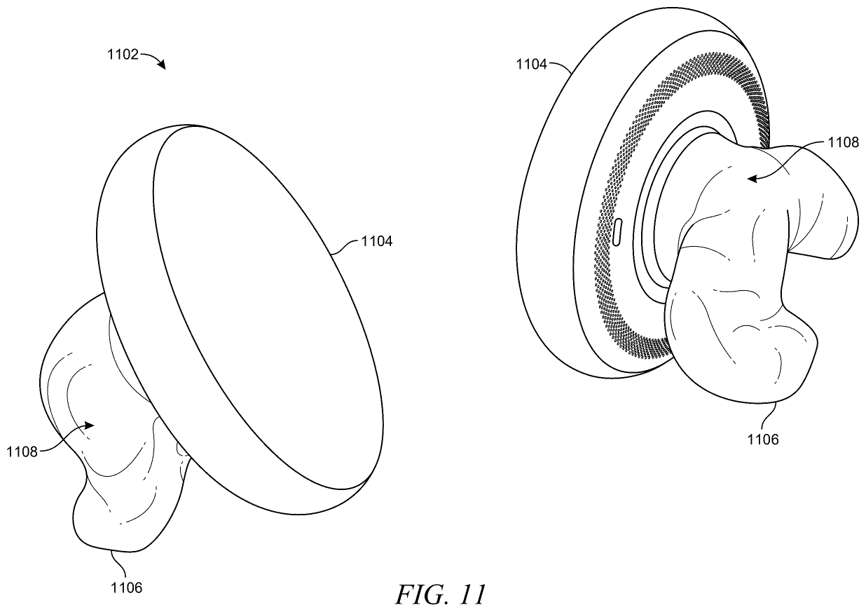

FIG. 11 depicts a front perspective view and a rear perspective view of an ear-worn device 1102 of another virtual auditory display device according to another embodiment. The ear-worn device 1102 is for a left ear of a wearer. The ear-worn device 1102 includes an electronics package 1104, an ear interface 1106, and an acoustic package 1108 (not illustrated in FIG. 11) positioned within the ear interface 1106. The virtual auditory display system may include the ear-worn device 1102 and another ear-worn device (not illustrated in FIG. 11) for the right ear of the wearer.

FIG. 12 is an exploded view of the ear-worn device 1102 showing the ear interface 1106, the acoustic package 1108, and the electronics package 1104. The acoustic package 1108 includes a connector 1210 having a generally planar surface. The connector 1210 includes a set of annular electrical contacts 1212 on the generally planar surface. In some embodiments, the set of annular electrical contacts 1212 includes seven annular electrical contacts. The acoustic package 1108 also includes a magnet 1214 having a generally hollow cylindrical shape. The ear interface 1106 and the acoustic package 1108 may be generally similar to the first ear interface 106a and the first acoustic package 108a, respectively, of the virtual auditory display device 100. Also depicted is a passage 1234 between a cavity of the ear interface 1106 and an opening at a distal portion of the ear interface 1106.

The electronics package 1104 includes a microphone cover 1218 including multiple perforations 1216, a first proximity sensor window 1220a and a second proximity sensor window 1220b. The electronics package 1104 also includes a magnet 1206 positioned inward relative to the microphone cover 1218. The microphone cover 1218 and the magnet 1206 form a generally cylindrical recess 1202 having a generally planar surface 1204. A set of electrical connectors 1208 extend outwards from the generally planar surface 1204. Each electrical connector is configured to connect with an electrical contact of the set of annular electrical contacts 1212. In some embodiments, the set of electrical connectors 1208 includes seven electrical connectors. In some embodiments, the set of electrical connectors 1208 includes a set of seven pogo pins.

The generally cylindrical recess 1202 has the same general shape as the magnet 1214 and the connector 1210. The electronics package 1104 may thus removably couple to the acoustic package 1108. The electronics package 1104 is removably magnetically coupleable to the acoustic package 1108 due to attractive magnetic forces between the magnet 1214 and the magnet 1206.

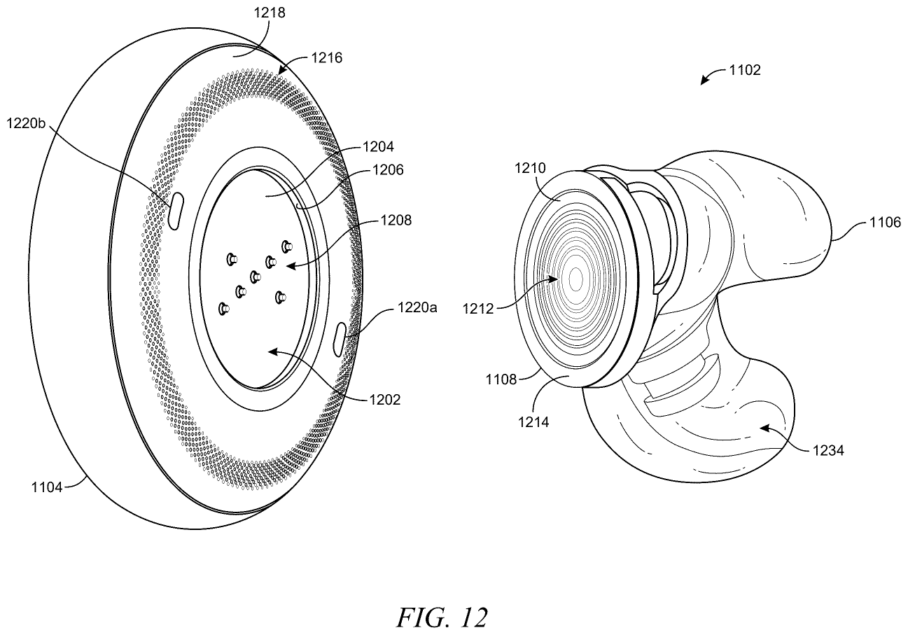

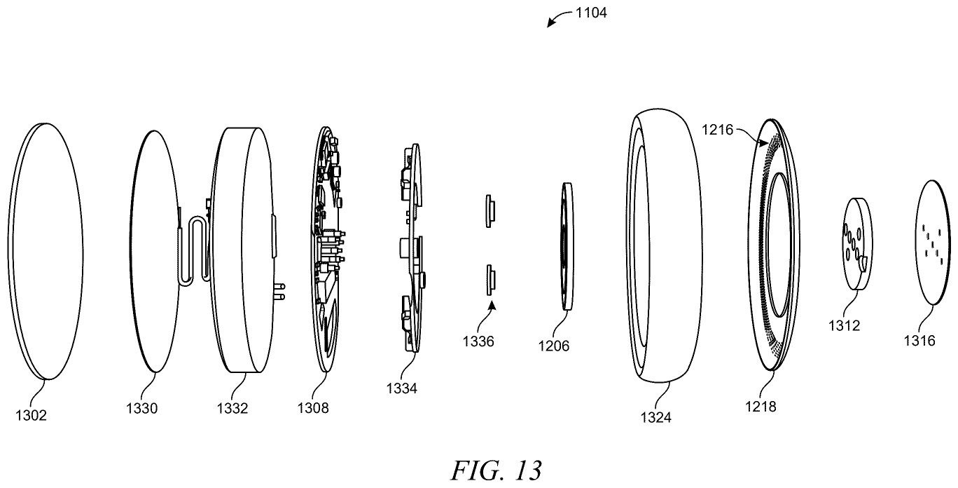

FIG. 13 is an exploded view of the electronics package 1104. From left to right, the electronics package 1104 includes a cap 1302. The cap 1302 may be made from glass or other suitable material that allows wireless signals to pass through the cap 1302. The cap 1302 may have a generally convex surface. In some embodiments, the cap 1302 may have a generally planar surface.

The electronics package 1104 also includes an antenna component 1330 and a battery 1332. The antenna component 1330 may include one or more antennas configured to receive and transmit wireless signals (for example, Wi-Fi, Bluetooth, cellular signals). The battery 1332 may be a pouch or coin cell battery and provide power to multiple electronics components of the electronics package 1104. The battery 1332 may be or include a rechargeable battery. In some embodiments, the electronics package 1104 may be removed from the ear-worn device and placed in a charging case having electrical contacts that connect with the set of electrical connectors 1208, so that the charging case may charge the electronics package 1104.

The electronics package 1104 also includes a printed circuit board 1308 which may include multiple electronics components such as a microcontroller, memory, codecs with audio digital signal processors (DSPs), multiple microphones, and the set of electrical connectors 1208. In some embodiments, the printed circuit board 1308 includes nine microphones. The electronics package 1104 further includes a circuit board 1334, which may include multiple electronics components such as an inertial measurement unit (IMU)-based sensor system (which may be referred to as an IMU), a magnetometer, and/or other sensors, such as accelerometers and/or gyroscopes to aid head orientations detections, and proximity sensors to detect proximity to a wearer. The electronics package 1104 further includes one or more sensor lenses 1336.

The electronics package 1104 also includes the magnet 1206 and a housing 1324 including a microphone manifold. The microphone manifold may have a continuously increasing radius like the microphone manifold 418 so as to reduce or eliminate a Helmholtz resonance. The electronics package 1104 further includes the microphone cover 1218, which includes the multiple perforations 1216. The multiple perforations 1216 allow sounds to pass through and be captured by the multiple microphones on the printed circuit board 1308. The microphone cover 1218 may be made of any suitable material, such as stainless steel, and the multiple perforations 1216 may be created by chemical etching. In some embodiments a perforation has a diameter of approximately 150 microns.

The electronics package 1104 further includes an electrical connector spacer 1312, which functions to space apart the electrical connectors of the set of electrical connectors 1208, and a glide film layer 1316, which functions to reduce a friction of the generally planar surface 1204.

Although not depicted in FIG. 13, the other electronics package of the other ear-worn device of the other virtual auditory display device may include generally similar components as the electronics package 1104.

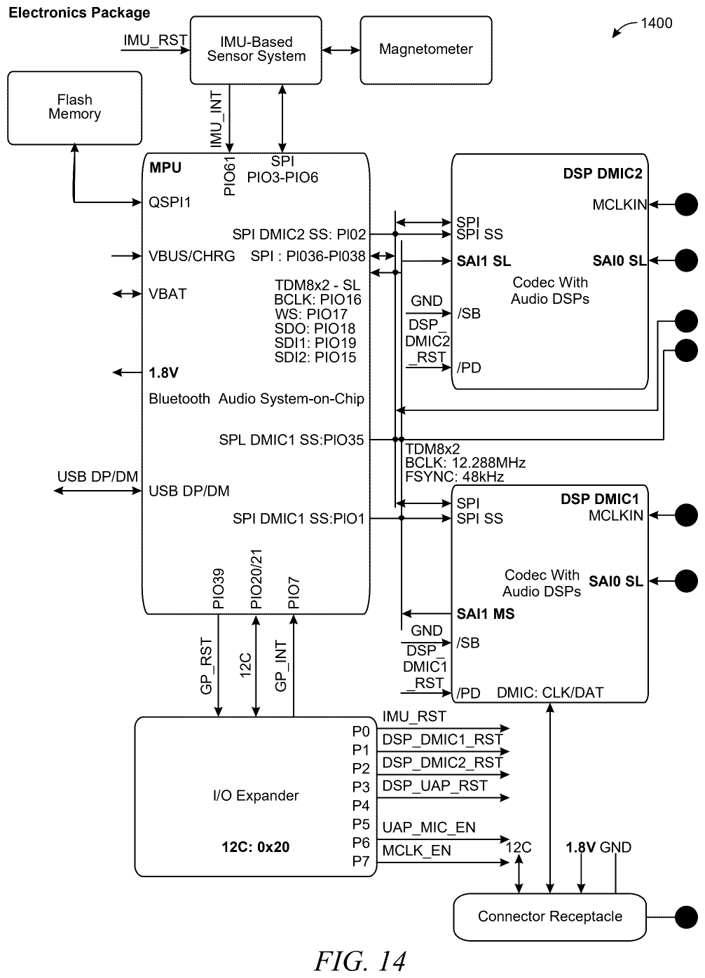

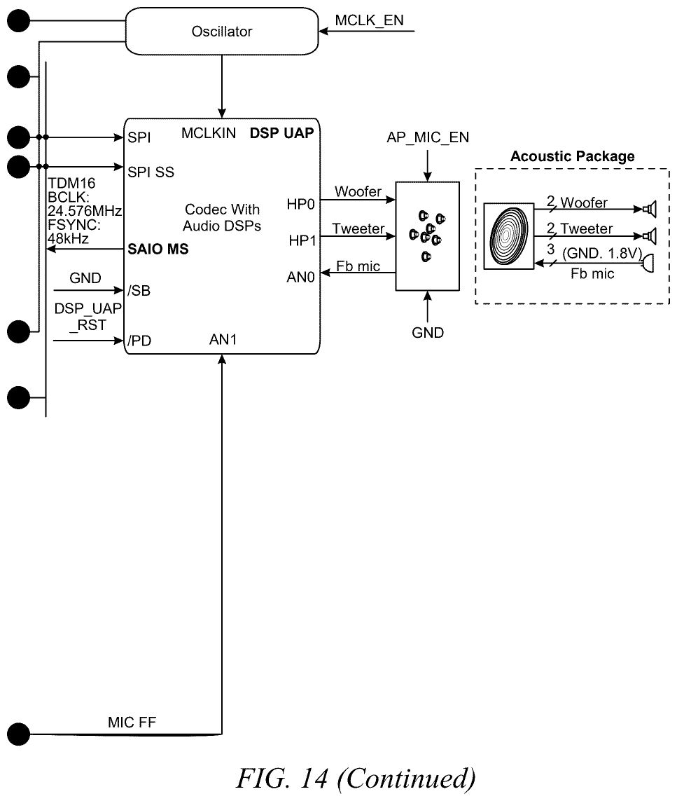

FIG. 14 is a logic block diagram 1400 of components of the electronics package 1104. The logic block diagram 1400 depicts the electronics package 1104 including multiple electronic components that perform various functions. The multiple electronic components include flash memory, an IMU-based sensor system, a magnetometer, a system-on-chip (SOC), codecs with audio digital signal processors (DSPs), an oscillator, and a switch. The various functions that the multiple electronic components may perform include receiving a digital audio signal, processing the audio signal by applying digital filters to the audio signal, generating an analog signal based on the processed digital signal, and providing the analog signal to the second acoustic package 108b. The electronic components may perform functions other than those described herein.

The other virtual auditory display device that comprises the ear-worn device 1102 and a corresponding ear-worn device for the right ear may provide the same functionality as the virtual auditory display device 100. In addition, the other virtual auditory display device may provide acoustic zoom functionality that may be static, adaptive, or directional. For example, the other virtual auditory display device may enhance sounds based on a head orientation of the wearer. As another example of additional functionality, the other virtual auditory display device may provide gradual noise cancellation when starting or playing sound received from another device. Other functionality will be apparent.

In addition, the electronics package 1104 of the ear-worn device 1102 may be rotatable relative to the acoustic package 1108. The ear-worn device 1102 may thus provide a rotatable user interface for the wearer. The wearer may thus rotate the electronics package 1104 to cause the ear-worn device to perform certain functions, such as to adjust a sound volume. Other functionality will be apparent.

As described herein, an acoustic package (for example, the first acoustic package 108a) may be removed from the ear interface (for example, the first ear interface 106a). The ear interface may be made of a material (for example, silicone) that may be subject to degradation from use. On some occasions, the acoustic package may not be positioned within the ear interface as securely as desired. Accordingly, a mechanism for further securing the acoustic package within the ear interface may be desirable.

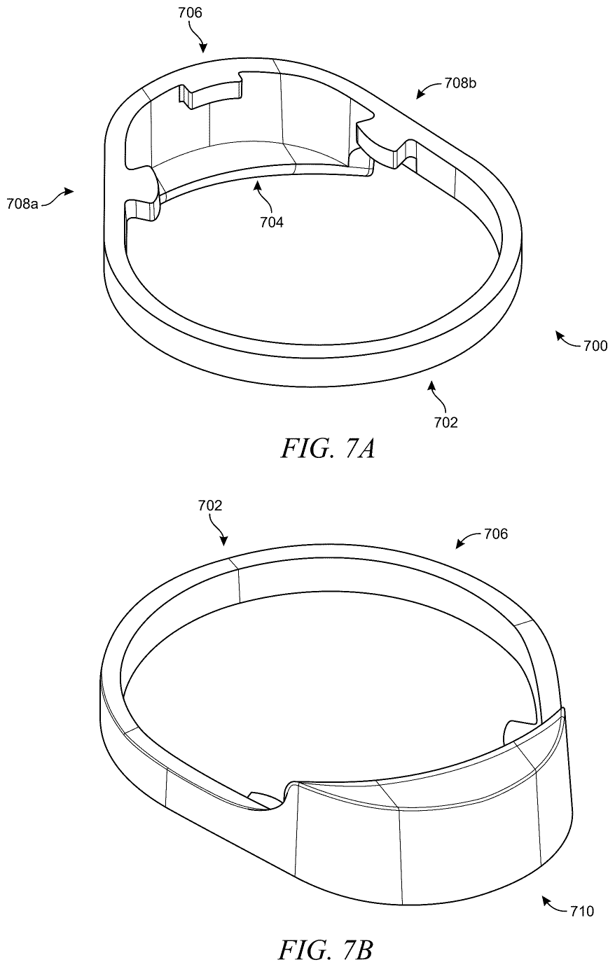

FIG. 7A is a rear bottom perspective view and FIG. 7B is a front top perspective view of a collar 700 for an ear-worn device in some embodiments. The collar 700 includes a strap portion 702 having a generally annular shape. A lifter portion 710 and a shelf portion 704 is opposite the apex of the strap portion 702. Protruding from the lifter portion 710 is a first wing portion 706. Protruding from the strap portion 702 is a second wing portion 708a and a third wing portion 708b.

The collar 700 is removably coupleable to the first ear interface 106a. When coupled to the first ear interface 106a, the collar 700 extends generally circumferentially around the proximal portion 340 proximate to the first opening 642. The shelf portion 704 abuts the cap 554 and the lifter portion 710 abuts a portion of the first ear interface 106a. The inner perimeter of the collar 700 may be generally the same or slightly smaller than the outer perimeter of the proximal portion 340 proximate to the first opening 642, so as to result in the collar 700 exerting pressure upon the proximal portion 340.

A function of the collar 700 is to further secure the first acoustic package 108a in the first ear interface 106a. The first wing portion 706, the second wing portion 708a, and the third wing portion 708b may mate with corresponding notches or grooves in the proximal portion 340 and assist with the securing function. Accordingly, the collar 700 may further secure the first acoustic package 108a within the first ear interface 106a. The collar 700 may also be used with the second ear interface 106b and the other ear interfaces described herein.

The ear interfaces described herein may provide a generally sealed acoustic fit between the ear interface and the ear in which the ear interface is positioned. The generally sealed acoustic fit may prevent exterior noises from reaching the ear canal, thus preventing exterior noises from interfering with the sound produced by the acoustic package.

However, changes in air pressure, such as when the wearer of a virtual auditory display device is changing elevation (for example, when the wearer is traveling in an airplane) may affect the sound produced by the acoustic package. For example, the dynamic driver may become pinned and unable to move, thus affecting the low frequency response of the acoustic package.

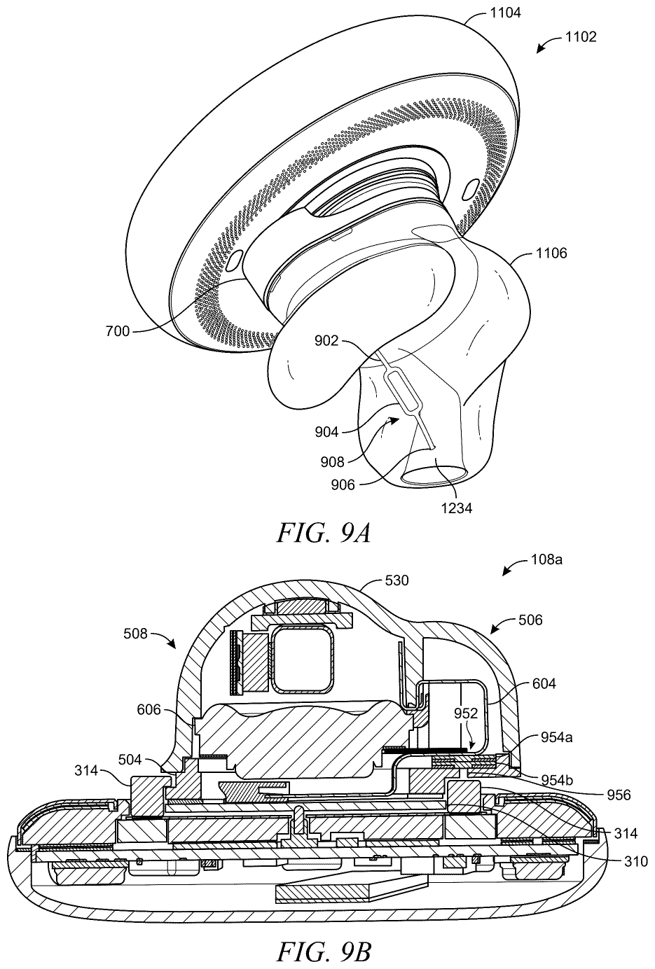

FIG. 9A is a rear perspective view of the ear-worn device 1102 including the collar 700, the electronics package 1104, the ear interface 1106, and a pressure-equalization vent 908 in the ear interface 1106 in some embodiments. The pressure-equalization vent 908 includes a first opening (not depicted in FIG. 9A) at an exterior of the ear interface 1106. For example, the first opening may be at a middle portion of the ear interface 1106 between the proximal portion and the distal portion.

The pressure-equalization vent 908 also includes a second opening 906 at the passage 1234 and a passage 902 between the first opening and the second opening 906. The diameter of the first opening or the second opening 906 may be approximately 0.1 mm. The diameter of the first opening or the second opening 906 may be approximately 0.1 mm, although the diameter of the first opening or the second opening may have other suitable sizes to allow for air passage. The passage 902 may have a diameter of approximately 0.1 mm at certain portions of the passage 902. A hollow plug 904 is positioned in the passage 902. The hollow plug 904 may function to ensure that air may travel through the passage 902. Air may pass through the first opening, the passage 902, and the second opening 906 to allow for static air pressure equalization between an air pressure in an ear canal of the wearer and an exterior air pressure without affecting the sound produced by the acoustic package. Furthermore, the pressure-equalization vent 908 may be sized to prevent undue ingress of particulate matter.

Although FIG. 9A depicts the pressure-equalization vent 908 having the second opening 906 in the passage 1234, the second opening 906 may be in the first cavity 632, in the second cavity 630, or in another suitable cavity in the ear interface 1106. The first opening may be at any suitable position in the ear interface 1106. Accordingly, the pressure-equalization vent 908 may be in any suitable position in the ear interface 1106 that allows for static air pressure equalization and provides acoustic resistance.

The pressure-equalization vent 908 may have any passage size or combination of passage sizes that allows for air flow between the exterior and the cavities of the ear interface 1106 while maintaining the desired acoustic resistance properties. Furthermore, in some embodiments, the pressure-equalization vent 908 may include one or more layers of acoustic mesh. For example, the pressure-equalization vent 908 may have a passage size larger than 0.1 mm and include one or more layers of acoustic mesh. It will be appreciated that the pressure-equalization vent 908 may have varying passage sizes and/or configurations to allow for the passage of air while achieving desired acoustic resistance properties.

FIG. 9B is a cross-sectional view of the first acoustic package 108a having another pressure-equalization vent 952 in the cap 504 in some embodiments. The pressure-equalization vent 952 is positioned in the cap 504 of the first acoustic package 108a. The pressure-equalization vent 952 includes a passage 956 in the cap 504 in a portion of the cap 504 that is proximate to the magnet 552. The passage 956 may have a diameter of about 0.4 mm to about 0.5 mm, such as approximately 0.44 mm. The pressure-equalization vent 952 also includes a first opening proximate to the flexible printed circuit board 604 and a second opening proximate to the magnet 314.

The pressure-equalization vent 952 may also include a first layer of acoustic mesh 954a and a second layer of acoustic mesh 954b. The acoustic mesh 954a and the acoustic mesh 954b are positioned between the cap 504 and the flexible printed circuit board 604. Each layer of acoustic mesh may be generally circular and have a rayl value of 900. The two layers of acoustic mesh may function as acoustic resistors that prevent interference from external noises while still allowing air to pass through the passage 956. The layers of acoustic mesh act as acoustic resistors in parallel, so that their values are additive. Acoustic meshes that have other rayl values may be utilized in some embodiments to provide the desired acoustic resistance. The pressure-equalization vent 952 may allow for static air pressure equalization between an air pressure in the second housing portion 506 of the housing 530 and an exterior air pressure without unduly affecting the acoustic performance of the first acoustic package 108a or allowing undue transmission of unwanted acoustic energy. Furthermore, the pressure-equalization vent 952 may be sized to prevent undue ingress of particulate matter.

The configuration of the pressure-equalization vent 952 may be varied to achieve static pressure equalization across a range of operational environments for the first acoustic package 108a, while providing sufficient resistance to acoustic energy. For example, the diameter of the passage 956 may be reduced and total resistive value of the one or more layers of acoustic mesh may be reduced in order to achieve these objectives. As another example, the diameter of the passage 956 may be increased and the number of layers of acoustic mesh may be increased in order to achieve these objectives. It will be appreciated that the pressure-equalization vent 952 may have varying passage sizes and/or configurations to allow for the passage of air while achieving desired acoustic resistance properties.

Although FIG. 9B depicts the pressure-equalization vent 952 as in the cap 504, the pressure-equalization vent 952 may be in any suitable position in the first acoustic package 108a that allows for static air pressure equalization and provides acoustic resistance.

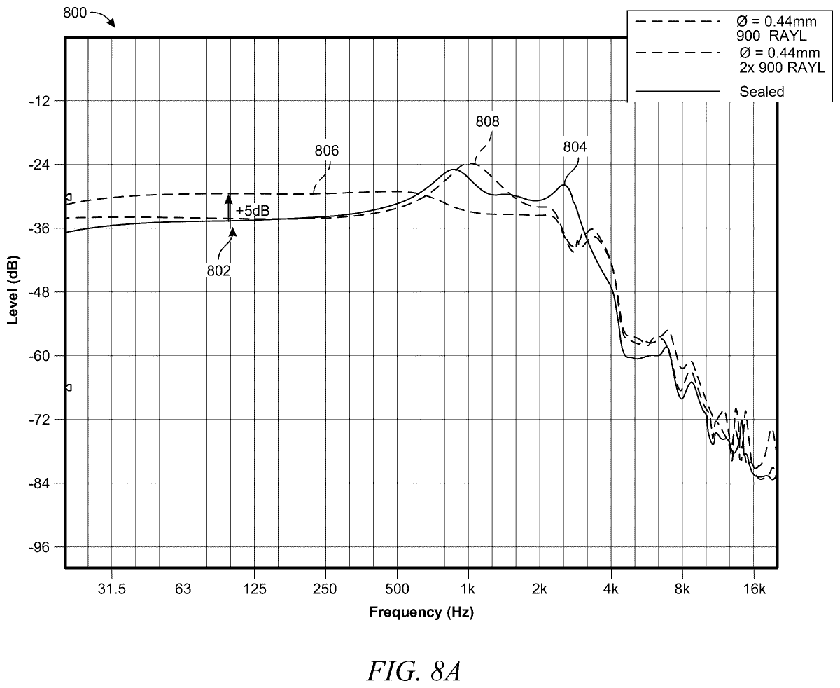

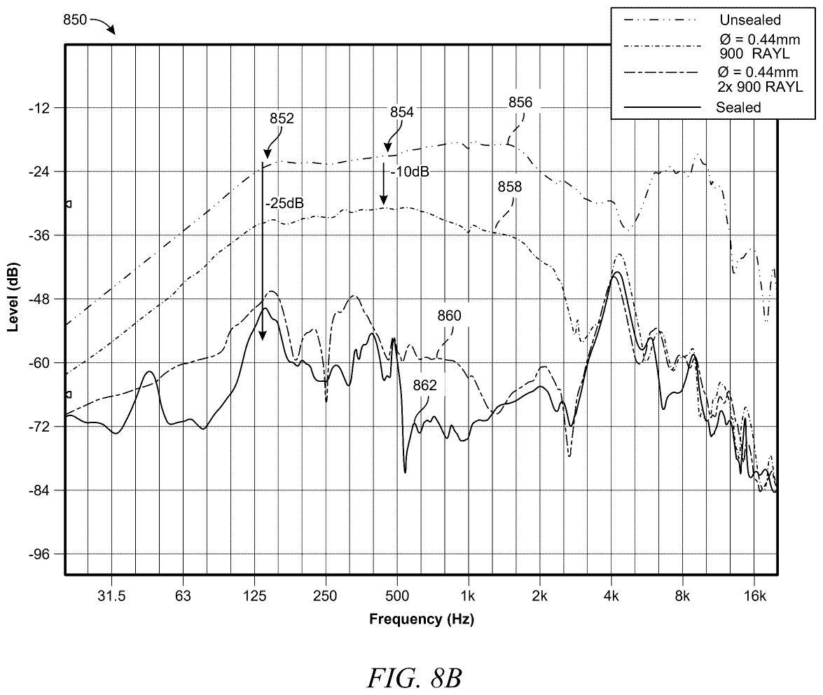

FIG. 8A is a graph 800 depicting frequency responses of multiple audio signals for acoustic packages according to various embodiments. A first audio signal 804 is for a first acoustic package without the pressure-equalization vent 952. A second audio signal 806 is for a second acoustic package with the pressure-equalization vent 952, having a single layer of acoustic mesh having a rayl value of 900. A third audio signal 808 is for a third acoustic package with the pressure-equalization vent 952 having two layers of acoustic mesh, each layer having a rayl value of 900.

The graph 800 indicates a difference in level between the second audio signal 806 and the third audio signal 808 of approximately five (5) decibels (dB) at a frequency region 802 between 63 hertz (Hz) and 125 Hz. Accordingly, the third acoustic package has an improved frequency response relative to that of the second acoustic package. However, the graph 800 indicates that that each of the frequency response of the second audio signal 806 and the frequency response of the third audio signal 808 generally corresponds to the frequency response of the first audio signal 804 throughout wide ranges of frequencies.

FIG. 8B is a graph 850 depicting frequency responses of multiple audio signals for acoustic packages according to various embodiments. A first audio signal 862 is for a first acoustic package without the pressure-equalization vent 952. A second audio signal 856 is for a second acoustic package with the pressure-equalization vent 952 but without any layers of acoustic mesh. A third audio signal 858 is for a third acoustic package with the pressure-equalization vent 952 having a single layer of acoustic mesh having a rayl value of 900. A fourth audio signal 860 is for a fourth acoustic package with the pressure-equalization vent 952 having two layers of acoustic mesh, each layer having a rayl value of 900.

The graph 850 indicates a difference in level between the second audio signal 856 and the first audio signal 862 of approximately 25 dB at a frequency region 852 between approximately 125 Hz and approximately 250 Hz. Accordingly, the frequency response of the second acoustic package does not track the frequency response of the first acoustic package well in the frequency region 852.

The graph 850 further indicates a difference in level between the second audio signal 856 and third audio signal 858 of approximately 10 dB at a frequency region 854 between approximately 250 Hz and approximately 500 Hz. Accordingly, the third acoustic package, with the pressure-equalization vent 952 having a single layer of acoustic mesh, has an improved frequency response relative to that of the second acoustic package with the pressure-equalization vent 952 but without any layers of acoustic mesh.

The graph 850 further indicates the frequency response of the fourth audio signal 860 generally corresponds to the frequency response of the first audio signal 862. Accordingly, the fourth acoustic package, with the pressure-equalization vent 952 having a double layer of acoustic mesh, has an improved frequency response relative to that of the second acoustic package and the third acoustic package.

Therefore, an ear-worn device having one or more pressure-equalization vents such as the pressure-equalization vent 908 and the pressure-equalization vent 952 may have desirable acoustic properties. Such an ear-worn device may be able to maintain a quality of the audio produced by the ear-worn device while blocking external sounds from being heard by a wearer and interfering with the audio.

Furthermore, an ear-worn device with one or more pressure-equalization vents such as the pressure-equalization vent 908 and the pressure-equalization vent 952 may allow for air pressure differentials between an air pressure in the cavities of the ear-worn device and an external air pressure to be reduced or eliminated. Such an ear-worn device may thus be more comfortable to wear during times when a wearer may experience changes in air pressure, such as when traveling in an airplane.

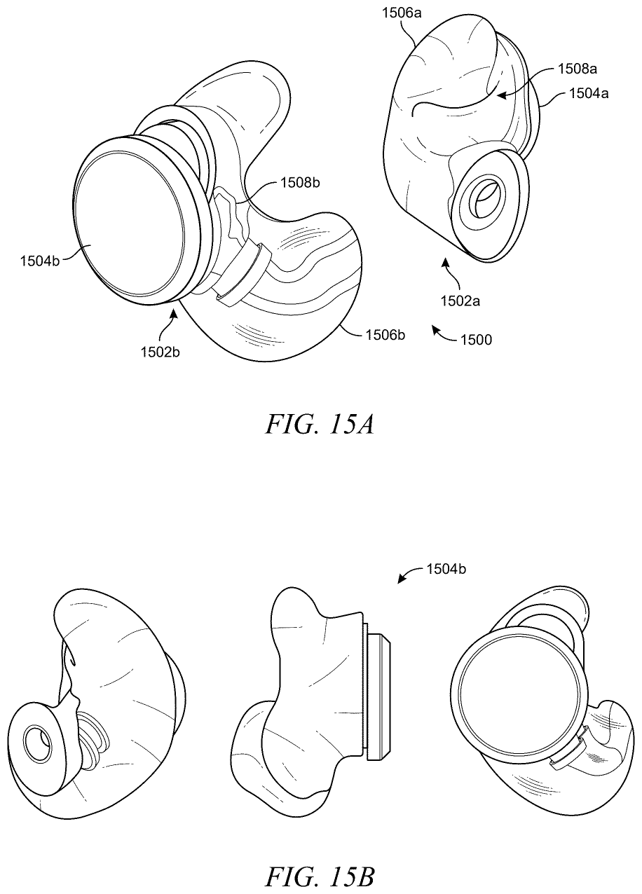

FIGS. 15A and 15B depict a virtual auditory display device 1500 according to another embodiment. The virtual auditory display device 1500 includes a first ear-worn device 1502a and a second ear-worn device 1502b. The first ear-worn device 1502a is for a left ear of a wearer and the second ear-worn device 1502b is for a right ear of the wearer.

Each of the first ear-worn device 1502a and the second ear-worn device 1502b includes an electronics package (shown as a first electronics package 1504a and a second electronics package 1504b), an ear interface (shown as a first ear interface 1506a and a second ear interface 1506b), and an acoustic package (shown individually as a first acoustic package 1508a and a second acoustic package 1508b). Certain components of each of the first ear-worn device 1502a and the second ear-worn device 1502b may be generally similar to certain components of the ear-worn device 1102 of FIG. 11.

The virtual auditory display device 1500 may be utilized for various purposes, such as providing passive noise protection for military personnel and first responders, as well as active noise enhancement. The virtual auditory display device 1500 may provide additional functionality.

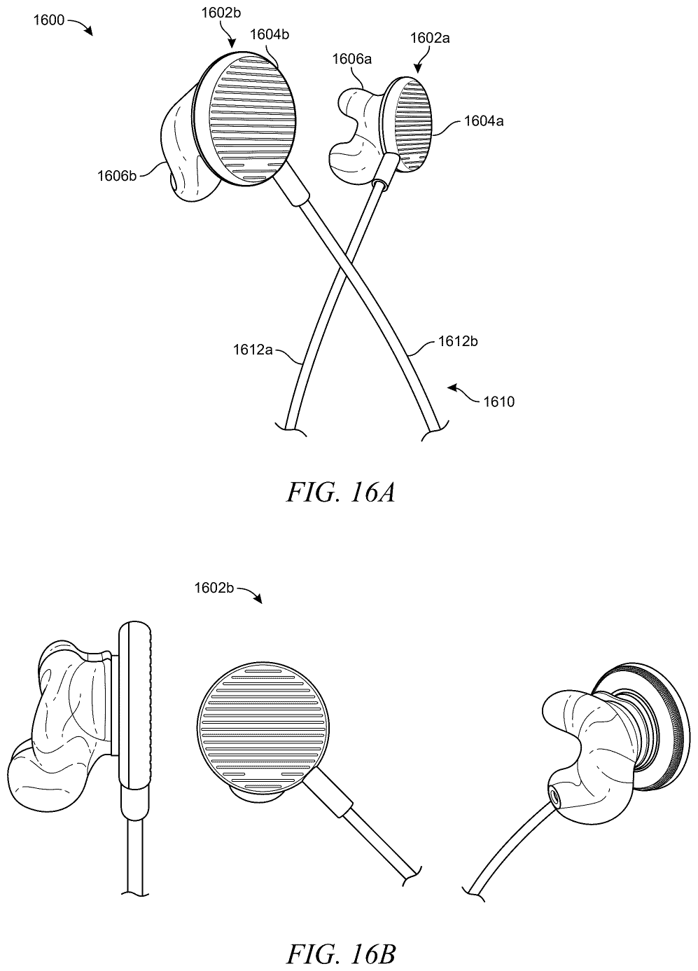

FIGS. 16A and 16B depict multiple views of a virtual auditory display device 1600 according to another embodiment. The virtual auditory display device 1600 includes a first ear-worn device 1602a, a second ear-worn device 1602b, and a cable 1610 that includes a first cable portion 1612a and a second cable portion 1612b. The first ear-worn device 1602a includes a first electronics package 1604a to which the first cable portion 1612a is connected, a first ear interface 1606a, and a first acoustic package (not illustrated in FIGS. 16A and 16B) positioned within the first ear interface 1606a that is removably magnetically coupleable to the first electronics package 1604a. The second ear-worn device 1602b also includes a second electronics package 1604b to which the second cable portion 1612b is connected, a second ear interface 1606b, and a second acoustic package (not illustrated in FIGS. 16A and 16B) positioned within the second ear interface 1606b that is removably magnetically coupleable to the second electronics package 1604b.

Certain components of each of the first ear-worn device 1602a and the second ear-worn device 1602b may be generally similar to certain components of the first ear-worn device 102a and of the second ear-worn device 102b of FIG. 1A.

The virtual auditory display device 1600 may be utilized for various purposes, such as for providing hyper-realistic training of military personnel and facilitating multi-threaded communications amongst military personnel.

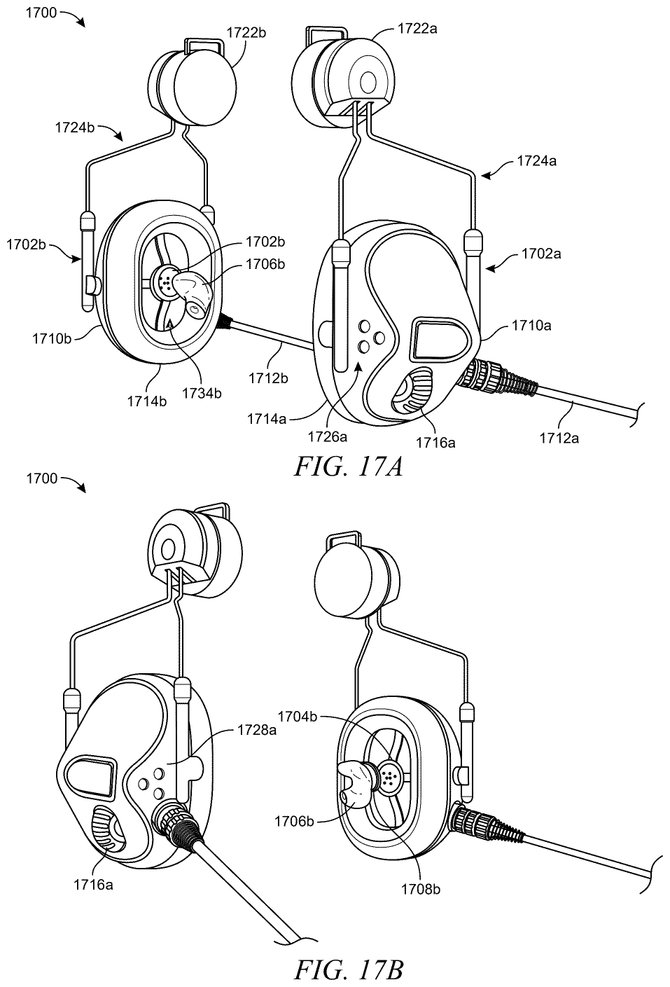

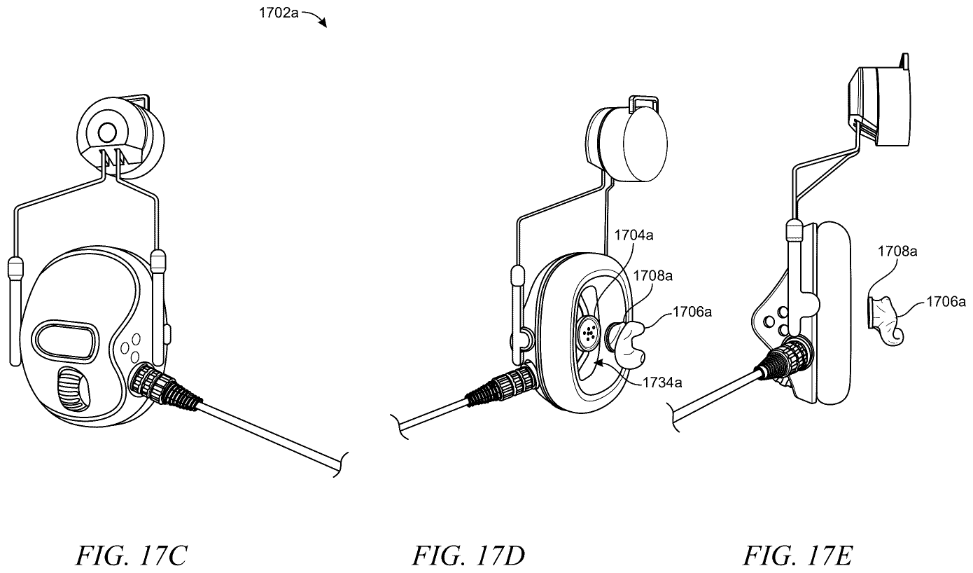

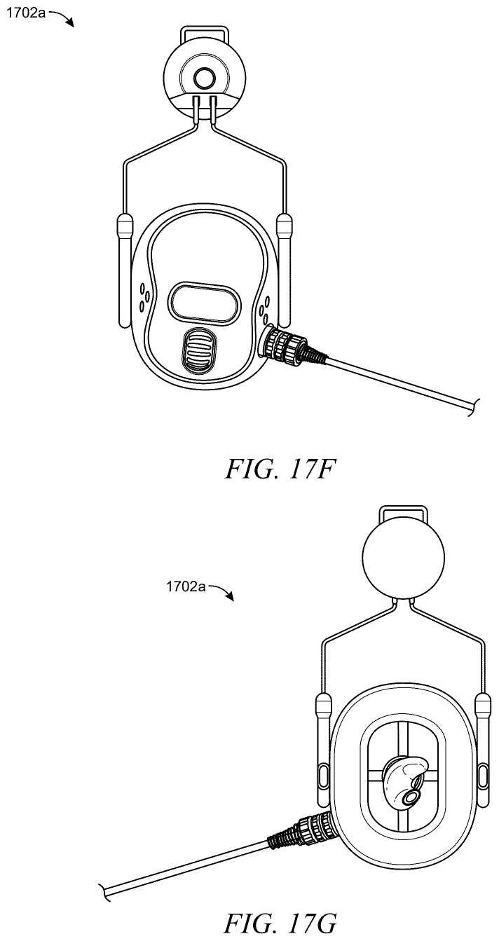

FIGS. 17A and 17B depict a front perspective view and a rear perspective view, respectively, of a virtual auditory display device 1700 including a first ear-worn device 1702a and a second ear-worn device 1702b according to an embodiment. FIGS. 17C through 17G depict views of the first ear-worn device 1702a. The first ear-worn device 1702a includes a main housing 1710a that includes a first set of microphones 1726a, a second set of microphones 1728a, and a volume control knob 1716a. The first ear-worn device 1702a also includes a compute housing 1722a connected to the main housing 1710a by multiple rigid connectors 1724a. The first ear-worn device 1702a also includes a first cable 1712a.

The first ear-worn device 1702a also includes an ear cup 1714a coupled to the main housing 1710a. A first electronics package 1704a is positioned in a center of the ear cup 1714a and is coupled to the ear cup 1714a by multiple bands 1734a. The first ear-worn device 1702a also includes a first ear interface 1706a that includes a first acoustic package 1708a.

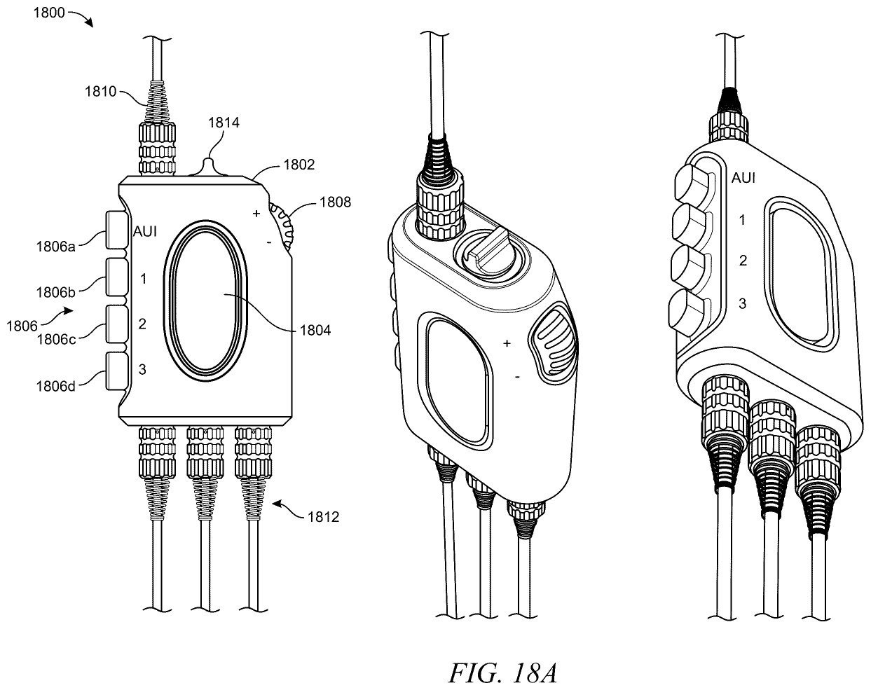

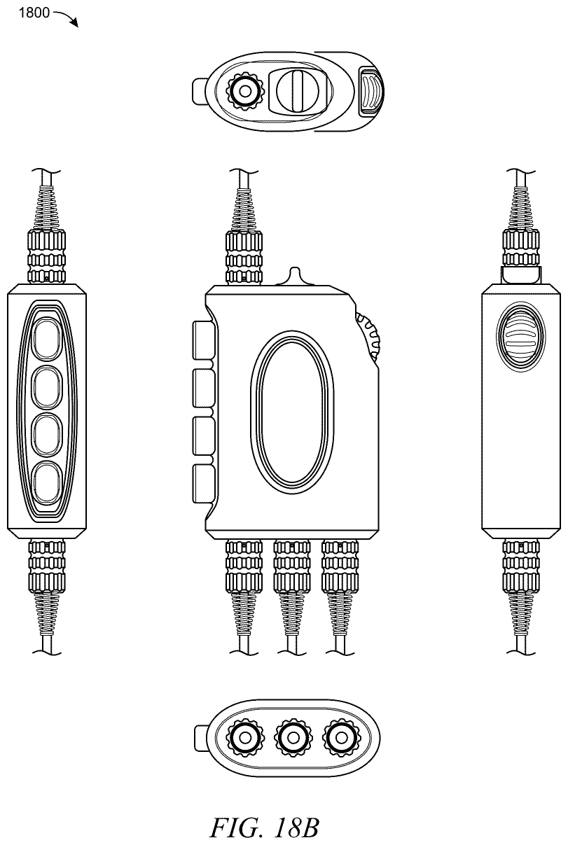

The second ear-worn device 1702b includes a main housing 1710b, an ear cup 1714b coupled to the main housing 1710b, and a compute housing 1722b connected to the main housing 1710b by multiple rigid connectors 1724b. The second ear-worn device 1702b also includes two sets of microphones and a volume control knob (not illustrated in FIGS. 17C through 17G) on the main housing 1710b. The second ear-worn device 1702b also includes a second electronics package 1704b, multiple bands 1734b, and a second ear interface 1706b containing a second acoustic package 1708b. The second ear-worn device 1702b also includes a second cable 1712b. The first cable 1712a and the second cable 1712b may join at a junction and the joined cable may connect to another device, such as a controller described with reference to, for example, FIGS. 18A and 18B.

The first electronics package 1704a and the second electronics package 1704b may be generally similar to the electronics package 1104 of the ear-worn device 1102 of FIG. 11. Similarly, the first acoustic package 1708a and the second acoustic package 1708b may be generally similar to the acoustic packages of the other virtual auditory display devices described herein.

Each of the compute housing 1722a and the compute housing 1722b may include multiple electronics components (for example, one or more processors, memory). The electronics package of the first ear-worn device 1702a may be electrically connected to the multiple electronics components of the compute housing 1722a. The second electronics package 1704b may be electrically connected to the multiple electronics components of the compute housing 1722b. Compute functionality may be shared between the electronics package and the multiple electronics components in the compute housing.

A wearer may insert the first ear interface 1706a into a left ear and the second ear interface 1706b into a right ear. The wearer may then place the first ear-worn device 1702a over the wearer's left ear and the second ear-worn device 1702b over the wearer's right ear, and the attractive magnetic forces between the first acoustic package 1708a and the first electronics package 1704a and between the second acoustic package 1708b and the second electronics package 1704b will cause the first acoustic package 1708a and the first electronics package 1704a to couple together and the second acoustic package 1708b and the second electronics package 1704b to couple together.

The generally sealed acoustic fit of the first ear interface 1706a and of the second ear interface 1706b, in combination with the ear cup 1714a and the ear cup 1714b, may provide passive ear protection for a wearer of the first ear-worn device 1702a and the second ear-worn device 1702b. The microphones on the main housing 1710a and the main housing 1710b may capture external sounds and use active noise cancellation technology to provide active ear protection for the wearer.

Additionally or alternatively, the first ear-worn device 1702a and/or the second ear-worn device 1702b may amplify external sounds captured by the microphones. The virtual auditory display device 1700 may thus enhance the hearing of the wearer of the first ear-worn device 1702a and the second ear-worn device 1702b, allowing the wearer to hear sounds that the wearer may not otherwise hear.

FIGS. 18A and 18B depict multiple views of a controller 1800 for the virtual auditory display device 1700 of FIGS. 17A through 17G. The controller 1800 includes a housing 1802 which includes a switch 1814, a volume control knob 1808, a push-to-talk button 1804, and multiple control buttons 1806. A first cable 1810 may be coupled to the controller 1800 and extend to the junction of the first cable 1712a and the second cable 1712b of the virtual auditory display device 1700. A set 1812 of multiple cables may also be coupled to the controller 1800 and to other devices (not illustrated in FIGS. 18A and 18B) that provide audio to the controller 1800, such as communications devices.

A wearer of the virtual auditory display device 1700 may turn the controller 1800 on and off using the switch 1814 and adjust an audio volume using the volume control knob 1808. When on, the controller 1800 may control audio interactions that a wearer of the virtual auditory display device 1700 may have. For example, the virtual auditory display device 1700 may have a transparency mode and an active noise cancellation mode. The wearer may select the transparency mode by selecting a button 1806a labeled “AUI” (auditory user interface). In this mode the virtual auditory display device 1700 may enhance the sounds captured by the first set of microphones on the virtual auditory display device 1700, thereby allowing the wearer to hear sounds that the wearer may not otherwise hear.

The wearer may also select either a button 1806b labeled “1”, a button 1806c labeled “2”, or a button 1806d labeled “3”. Selecting one of these three buttons may switch the virtual auditory display device 1700 into the active noise cancellation mode and cause the virtual auditory display device 1700 to emit audio received from an external device corresponding to the selected button. The wearer may push the push-to-talk button 1804 to transmit communications to the external device.

The form factor, ergonomics, and ability to switch between an enhanced hearing mode and multiple communications channels may make the virtual auditory display device 1700 and the controller 1800 suitable for challenging use cases, such as military use cases.

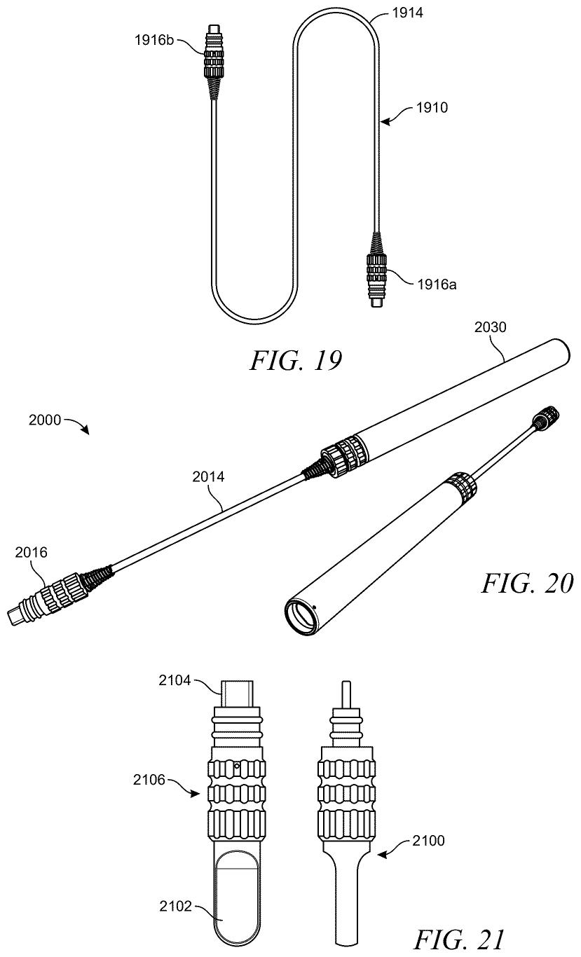

FIG. 19 depicts a cable 1910 that may be utilized with the virtual auditory display device 1700 and the controller 1800. The cable 1910 includes a first connector 1916a, a second connector 1916b, and a cable portion 1914. In some embodiments, the first connector 1916a and the second connector 1916b include USB-C connectors. The cable 1910 may provide power, data and communications interconnectivity for the virtual auditory display device 1700 and/or the controller 1800. For example, the first connector 1916a may be plugged into the controller 1800 and the second connector 1916b may be plugged into an external device, such as a communications device (for example, a military radio).

FIG. 20 depicts a battery assembly 2000 that may be utilized with the controller 1800 and the virtual auditory display device 1700. The battery assembly 2000 includes a battery housing 2030, a cable portion 2014, and a connector 2016. In some embodiments, the battery housing 2030 is sized to include AAA batteries. Additionally or alternatively, the battery housing 2030 may include lithium chemistry batteries. The connector 2016 may be plugged into the virtual auditory display device 1700 and/or the controller 1800 to provide an external power source in addition to the internal power sources of these devices.

FIG. 21 depicts a wireless communications device 2100 in some embodiments. The wireless communications device 2100 includes a connector 2104, a body portion 2106, and an end portion 2102. The wireless communications device 2100 may include wireless communications components such as Wi-Fi, Bluetooth, and/or cellular communications components. The wireless communications device 2100 may be connected to the virtual auditory display device 1700 and/or the controller 1800 and facilitate wireless communications between the device the wireless communications device 2100 is plugged into and any other device capable of wireless communications, such as another device into which another wireless communications device 2100 is plugged.

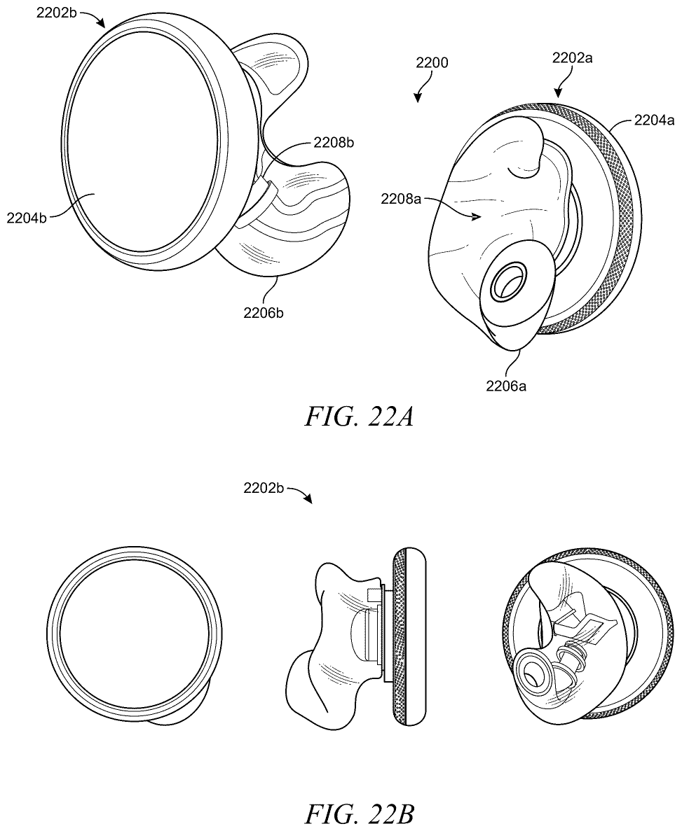

FIGS. 22A and 22B depict a virtual auditory display device 2200 according to another embodiment. The virtual auditory display device 2200 includes a first ear-worn device 2202a and a second ear-worn device 2202b. The first ear-worn device 2202a is for a left ear of a wearer and the second ear-worn device 2202b is for a right ear of the wearer.

Each of the first ear-worn device 2202a and the second ear-worn device 2202b includes an electronics package (shown as a first electronics package 2204a and a second electronics package 2204b), an ear interface (shown as a first ear interface 2206a and a second ear interface 2206b), and an acoustic package (shown individually as a first acoustic package 2208a and a second acoustic package 2208b). Certain components of each of the first ear-worn device 2202a and the second ear-worn device 2202b may be generally similar to certain components of the ear-worn device 1102 of FIG. 11.

The virtual auditory display device 2200 may provide the auditory user interface controls of the controller 1800. For example, a wearer of the virtual auditory display device 2200 may tap on the first electronics package 2204a and/or the second electronics package 2204b to switch between a first, transparency, mode and a second, active noise cancellation, mode. The first electronics package 2204a and/or the second electronics package 2204b may be touch-sensitive. Accordingly, the wearer may be able to move between different communications channels using touch gestures.

The first ear interface and the second ear interface of the virtual auditory display device 1500, the virtual auditory display device 1600, the virtual auditory display device 1700, and the virtual auditory display device 2200 may be custom made for the wearer's ears so as to provide a generally acoustically sealed fit for the wearer's ears. Accordingly, the virtual auditory display device 1500, the virtual auditory display device 1600, the virtual auditory display device 1700, and the virtual auditory display device 2200 may thus provide passive protection for wearer's ears.

Each of the virtual auditory display device 1500, the virtual auditory display device 1600, the virtual auditory display device 1700, and the virtual auditory display device 2200 may include components that allow for wireless transmission and reception of signals over IP-based networks and/or radio communication networks, such as those used by military personnel and public safety officers.

One advantage of the virtual auditory display devices described herein is that the virtual auditory display devices may enable wearers to hear sounds that are beyond the visible spectrum, hear sounds that may be too high or too low for human ears, and feel vibrations that may be too subtle to notice. For example, military personnel, such as military personnel on a battlefield, in a rescue mission, or performing normal duties, may utilize the virtual auditory display devices to detect threats before they become visible, hear enemy movements before they're audible, and feel changes in the environment before they're noticeable. Such virtual auditory display devices may provide military personnel with a competitive advantage and allow them to complete their missions with greater efficiency and safety.

As an example, military personnel could use the sensory augmentation features of the devices to identify the location of an enemy target. One possible scenario is that an enemy has made a brief sound that can be identified by digital signal processing. Examples of these sounds could be a gunshot, a footstep or other noise. The devices may identify the location of the sound and inform the military personnel the location of the target. Guidance to the military personnel could include a notification or continuous sound beacon placed in virtual auditory space or a spoken notification from a conversational user interface.

Another advantage of the virtual auditory display devices described herein is that such virtual auditory display devices may allow wearers to communicate with others in even loud environments and reduce interference. The virtual auditory display devices may filter out background noise and amplify the wearer's voice, thereby allowing the wearer to easily communicate with others and reducing distractions. The virtual auditory display devices may allow wearers to communicate with others clearly and effectively even if the wearers are in loud environments such as concerts and construction sites.

An HRTF may be for one person. Generating an individual HRTF typically requires a highly specialized environment and acoustic testing equipment. A person must remain still for approximately 30 minutes in an anechoic chamber while audio signals are emitted from different known locations. A microphone is placed in each ear of the person to capture the audio signals. However, this method presents challenges as there may be spurious responses due to factors such as the chamber, the audio signal source(s) and the microphone, that need to be eliminated in order to obtain an accurate Head Related Impulse Response (HRIR) which can then be converted to an HRTF. Furthermore, any movement by the person may affect the measurements, which may result in an inaccurate HRTF for the person. Another practical limitation of measuring an HRIR is that the time to collect directly scales with the number of discrete coordinates and practically limits the resolution of the resulting HRTF.

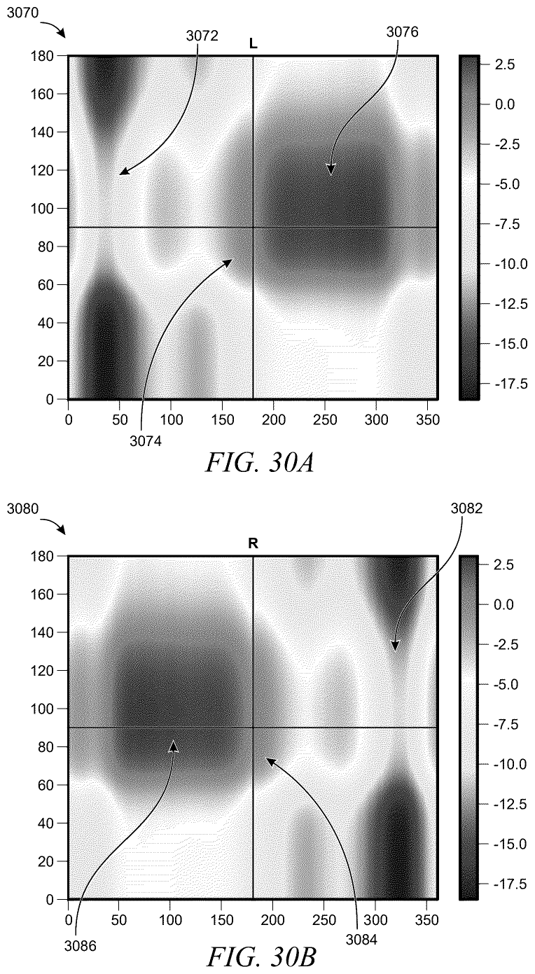

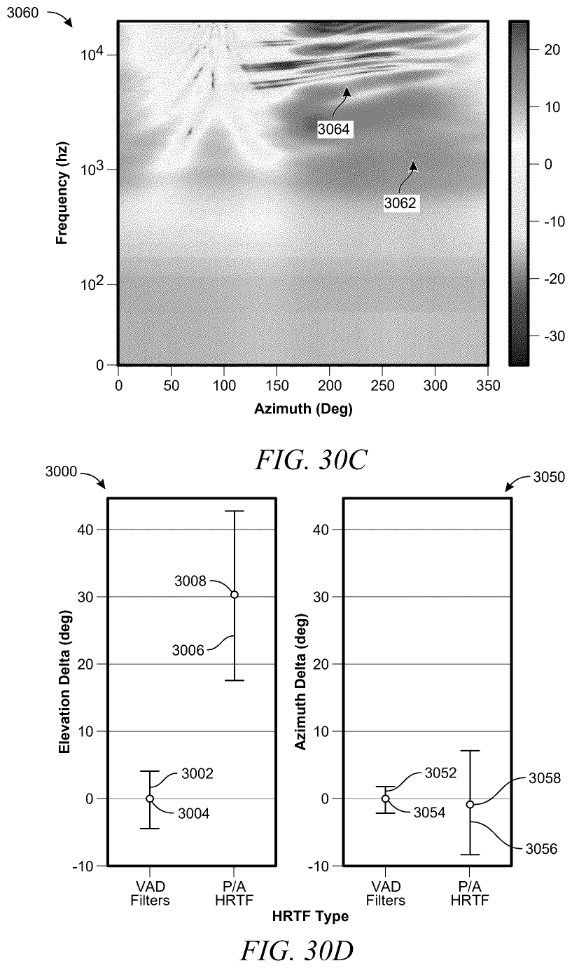

So-called universal HRTFs have been utilized to overcome disadvantages of individual HRTFs. Such universal HRTFs may be produced by averaging or otherwise combining measurements from multiple persons. However, such combining typically results in losing the individual characteristics of each person that are necessary to produce accurate virtual 3D sound for the person. As a result, such universal HRTFs may not accurately locate sound in virtual 3D space for all users, especially sound that is located directly in front of a user at approximately zero degrees azimuth and zero degrees elevation. FIG. 30E depicts an example HRTF 3010.

Another prior approach has attempted to simulate a personalized HRTF using photogrammetry of the head, torso, and pinna, or using other methods with highly precise head, torso, and pinna scanning via time of flight or structured light. A physical acoustics model is then generated based on the resulting scanned form. However, this approach may not yield convincing rendering of virtual 3D space, because after the physical scan is measured, the physics-based simulation of sound interacting with the modeled surface may introduce complexity and inaccuracy in the resulting psychoacoustic cues.

The technology described herein provides technical solutions to the technical problems of the prior approaches described above. The technology may utilize virtual auditory display filters that may result in accurately rendered sounds in their locations in virtual auditory space. The virtual auditory display filters may utilize spectral shaping techniques, using equalizers, filters, and/or dynamic range compression, to manipulate the frequency spectrum of audio signals. Virtual auditory display filters may be generated without resort to direct physical measurements (for example, measurements in an anechoic chamber, photogrammetry, etc.).

Virtual auditory display filters may be or include functions that manipulate a frequency spectrum of an audio signal. Virtual auditory display filters may be or include digital filters, such as parametric equalization (EQ) filters that allow for adjustment of parameters such as the center frequency, gain, quality (Q or q), cutoff frequency, slope, bandwidth and/or filter type. The parameters may be set as a function of a location of a sound in virtual auditory space. The functions or the digital filters may affect the frequency spectrum of an audio signal by creating notches and peaks in the audio signal. The notches, peaks, and other spectral shaping of the audio signal accurately places the resulting sound in virtual auditory space. Furthermore, the notches, peaks, and other spectral shaping of the audio signal produces a processed audio signal that may be used to output high-quality clear sound that, in the example of music recordings, may accurately represent the original recorded performance and allow listeners to hear subtleties and nuances of the original recorded performance. As described herein, a digital filter may refer to a digital filter, a function, and/or some combination of one or more functions or one or more digital filters.

Virtual auditory space may be described as a virtual 3D sound environment of a person in which the person may perceive a sound as emanating from any location in the virtual 3D sound environment. In the described technology, each location in virtual auditory space may have an associated function or digital filter that is applied to audio signals that have that location. The application of the function or digital filter to an audio signal with a location results in sound, which may be referred to as virtual auditory display sound, that is perceived by the person as coming from that location.

Accordingly, the person, who may be wearing headphones, earbuds, or other ear-worn devices, may experience virtual auditory display sound. Other advantages of the described technology will be apparent.

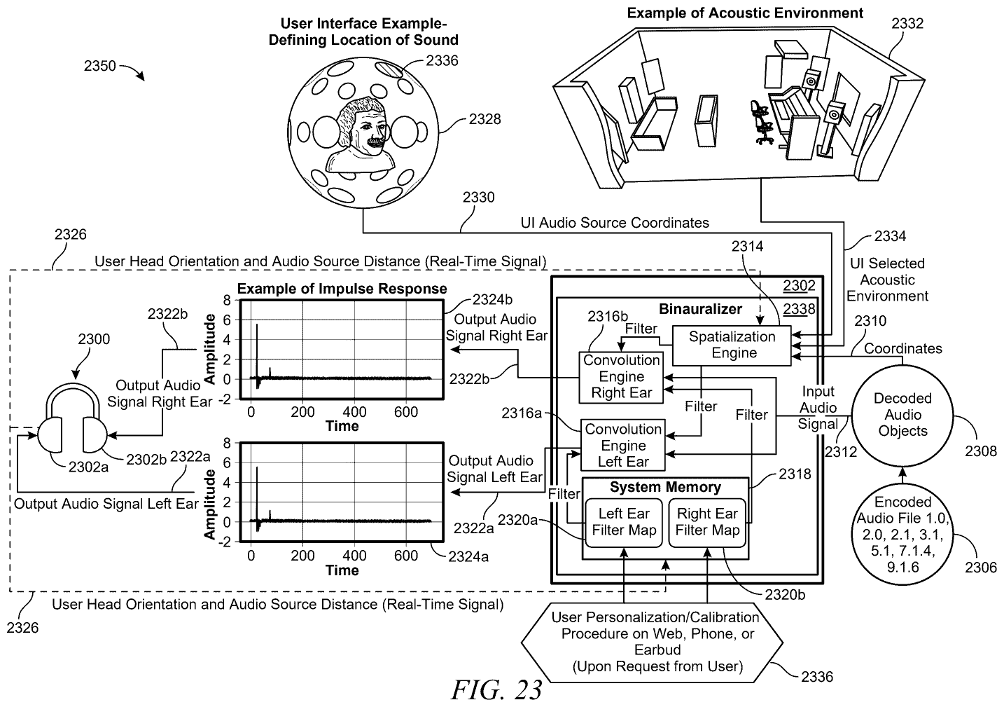

FIG. 23 is a diagram of an environment 2350 in which a virtual auditory display system and virtual auditory display devices that interface with the virtual auditory display system may operate in some embodiments. As depicted, the environment 2350 includes a virtual auditory display system 2302 and a virtual auditory display device 2300. The virtual auditory display system 2302 and the virtual auditory display device 2300 may together comprise a system. The virtual auditory display system 2302 and the virtual auditory display device 2300 may together render sounds in virtual auditory space for a wearer of the virtual auditory display device 2300.

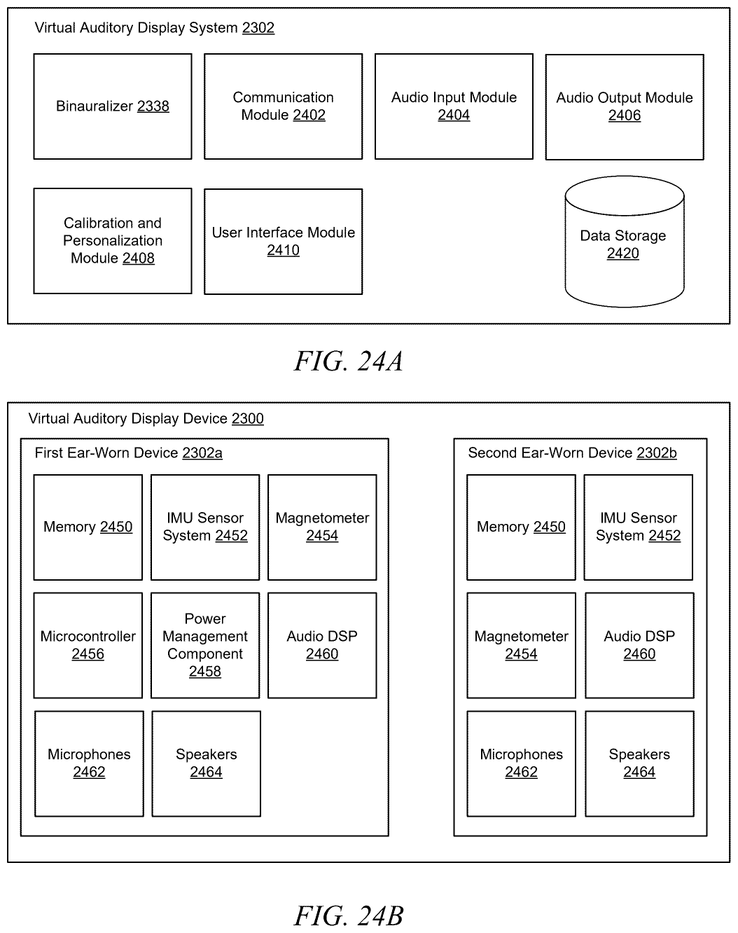

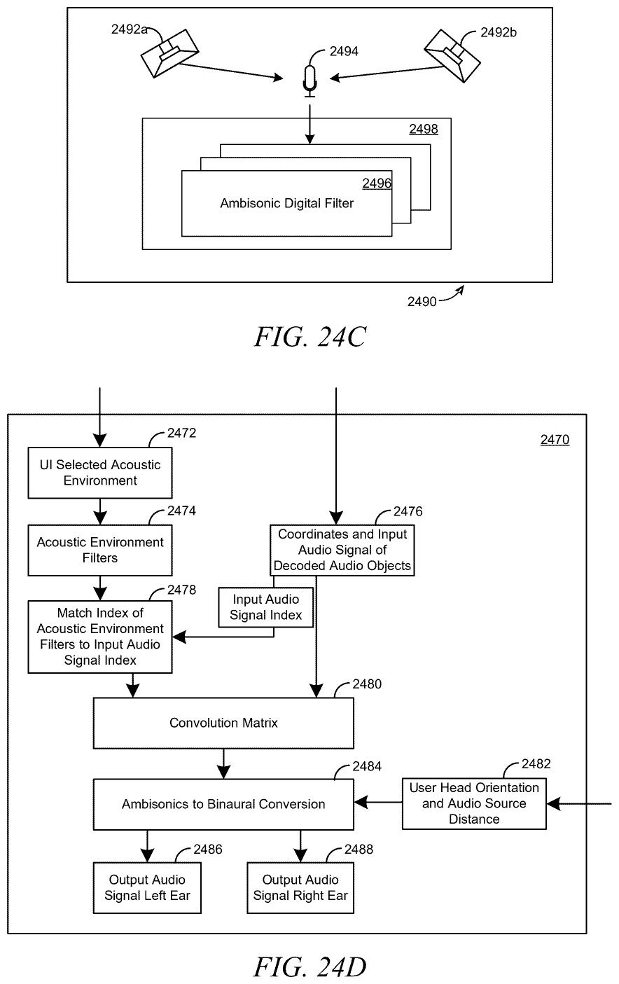

The virtual auditory display system 2302 may include a binauralizer 2338. The binauralizer may include a system memory 2318, which may include a left ear digital filter map 2320a and a right ear digital filter map 2320b. The binauralizer 2338 may also include a left ear convolution engine 2316a, a right ear convolution engine 2316b, and a spatialization engine 2314. The virtual auditory display system 2302 may also include other components, modules and/or engines, such as those described with reference to, for example, FIG. 24A.

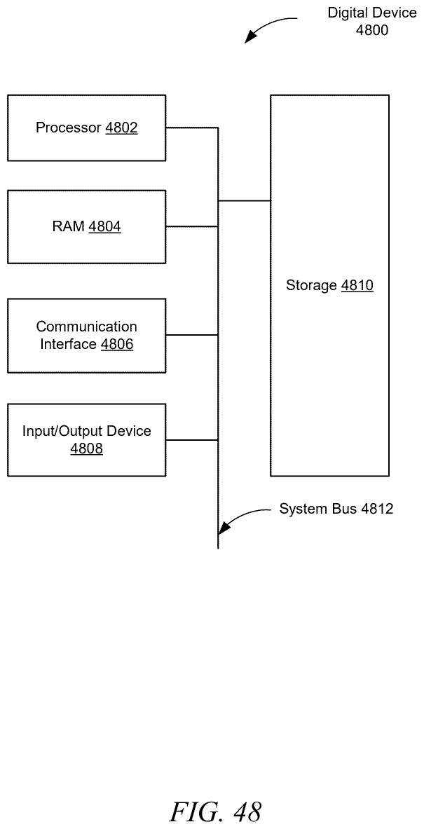

In some embodiments, the virtual auditory display system 2302 may be or include a software application that may execute on a digital device. A digital device is any device with at least one processor and memory. Digital devices are discussed further herein, for example, with reference to FIG. 48. For example, the virtual auditory display system 2302 may be a software application that executes on a general-purpose computing device, such as a laptop or desktop computer. As another example, the virtual auditory display system 2302 may be a software application that executes on a mobile device such as a phone or a tablet. In other embodiments, the virtual auditory display system 2302 be or include a software application or a firmware application that executes on a special-purpose computing device, such as on the virtual auditory display device 2300.

The virtual auditory display device 2300 may include a first ear-worn device 2302a and a second ear-worn device 2302b. The first ear-worn device 2302a and the second ear-worn device 2302b may each be any ear-worn, ear-mounted or ear-proximate device such as an earphone of a pair of earphones, an earbud of a pair of earbuds, a headphone of a headset, a speaker of a virtual reality headset, and the like. In some embodiments, the virtual auditory display device 2300 may be an embodiment of the virtual auditory display devices described herein. The first ear-worn device 2302a and/or the second ear-worn device 2302b may include components, such as an inertial measurement unit (IMU), an accelerometer, a gyroscope, and/or a magnetometer, that detect a head orientation of a wearer wearing the first ear-worn device 2302a and the second ear-worn device 2302b.

In some embodiments, a digital device (for example, a laptop or desktop computer) may receive an encoded audio file 2306 that has one or more channels of audio. Examples of an encoded audio file 2306 include 2.0 (two channels of audio), 2.1 (three channels of audio), 5.1 (six channels of audio), 7.1.4 (12 channels of audio), and 9.1.6 (16 channels of audio). The digital device may decode the encoded audio file 2306 to obtain decoded audio objects 2308 and an input audio signal 2312 that includes one or more audio sub-signals (alternately, audio channels). Each of the decoded audio objects 2308 and/or the audio sub-signals may have associated coordinates which identify the location of the audio object in virtual auditory space. The coordinates may be cartesian coordinates, spherical coordinates, and/or polar coordinates. Although specific examples of encoded audio files are described herein, the technology is not limited to such examples, and may be used with audio files that have any number of channels.

The digital device may send the coordinates 2310 to the spatialization engine 2314 and the input audio signal 2312 to the left ear convolution engine 2316a and the right ear convolution engine 2316b. In some embodiments, the virtual auditory display system 2302 receives the encoded audio file 2306 and decodes the encoded audio file 2306 to obtain the decoded audio objects 2308 and the input audio signal 2312.

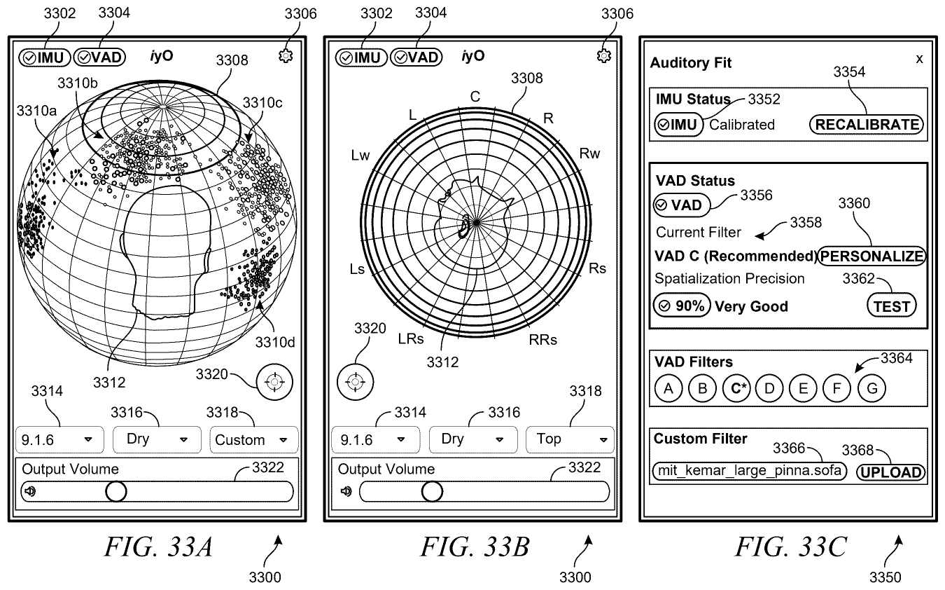

As described with reference to, for example, FIGS. 33A and 33B, a user interface component of the virtual auditory display system 2302 may provide a user interface that allows the user to select an acoustic environment. The spatialization engine 2314 may receive a selection 2334 of the acoustic environment 2332 via the user interface component from the wearer and utilize the selection 2334 to process audio signals that are sent to the first ear-worn device 2302a and the second ear-worn device 2302b of the virtual auditory display device 2300.

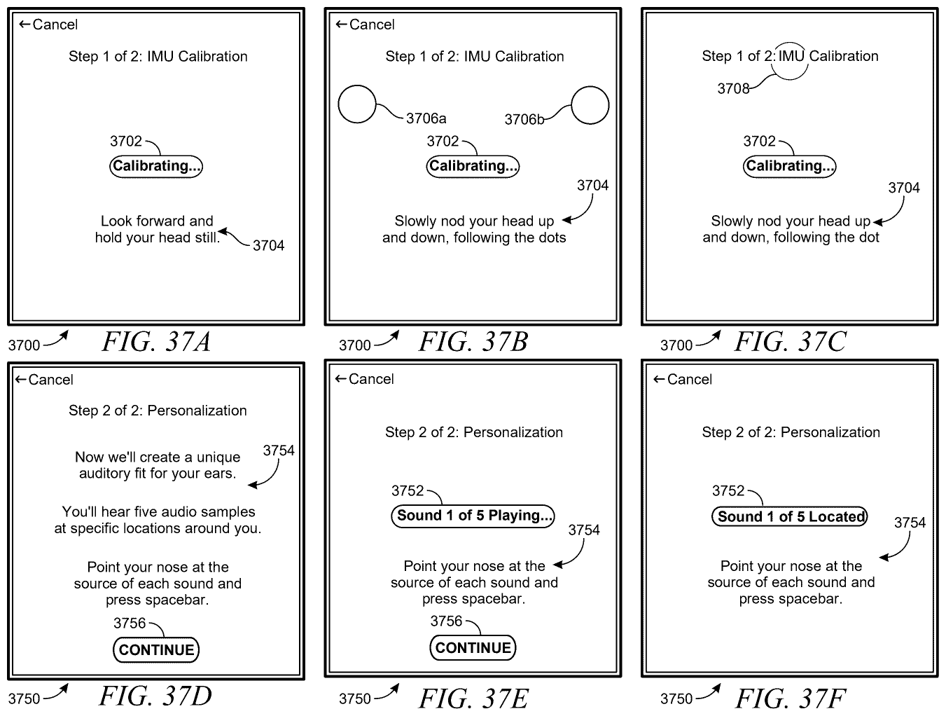

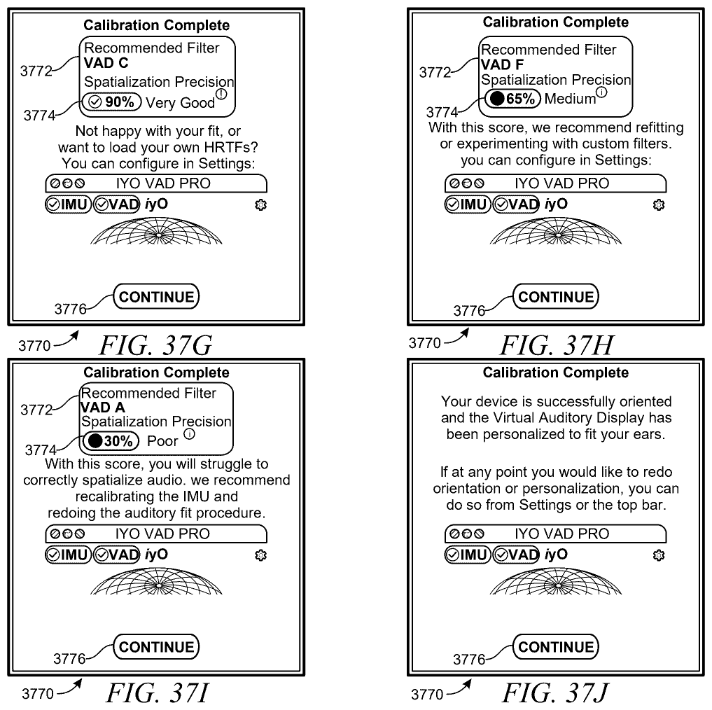

As described with reference to, for example, FIGS. 37A through 37J, the user interface component of the virtual auditory display system 2302 may provide a user interface 2328 that allows the user to perform a calibration and/or personalization procedure 2336 to calibrate and/or personalize the virtual auditory display system 2302. The wearer may use the user interface 2328 to personalize the virtual auditory display system 2302 so that the user's perception of the location of a sound matches the location of the sound in virtual auditory space. The user-perceived location of the sound may be sent in a signal 2330 to the spatialization engine 2314.

The spatialization engine 2314 may determine, based on the acoustic environment 2332, a first acoustic environment digital filter and a second acoustic environment digital filter. An acoustic environment digital filter may be or include a digital filter that is applied to an audio signal to manipulate the audio signal so as to produce the effect of the audio being played, generated or produced in a particular acoustic environment. The spatialization engine 2314 may provide the first acoustic environment digital filter to the left ear convolution engine 2316a and the second acoustic environment digital filter to the right ear convolution engine 2316b.

While the virtual auditory display system 2302 is receiving the input audio signal 2312, one or both of the first ear-worn device 2302a and the second ear-worn device 2302b may detect a head orientation of a wearer of the virtual auditory display device 2300 and provide the head orientation and an audio source distance 2326 (which may be specified by the wearer) to the virtual auditory display system 2302.

The binauralizer 2338 may, for each audio sub-signal of the one or more audio sub-signals, obtain multiple first processed audio sub-signals and multiple second processed audio sub-signals. The binauralizer 2338 may do so by determining, based on the virtual auditory space location associated with the audio sub-signal and the head orientation, a particular first location in the virtual auditory space for the audio sub-signal. The left ear digital filter map 2320a maps locations in virtual auditory space to digital filters and/or functions for the first ear-worn device 2302a and the right ear digital filter map 2320b maps locations in virtual auditory space to digital filters and/or functions for the second ear-worn device 2302b.

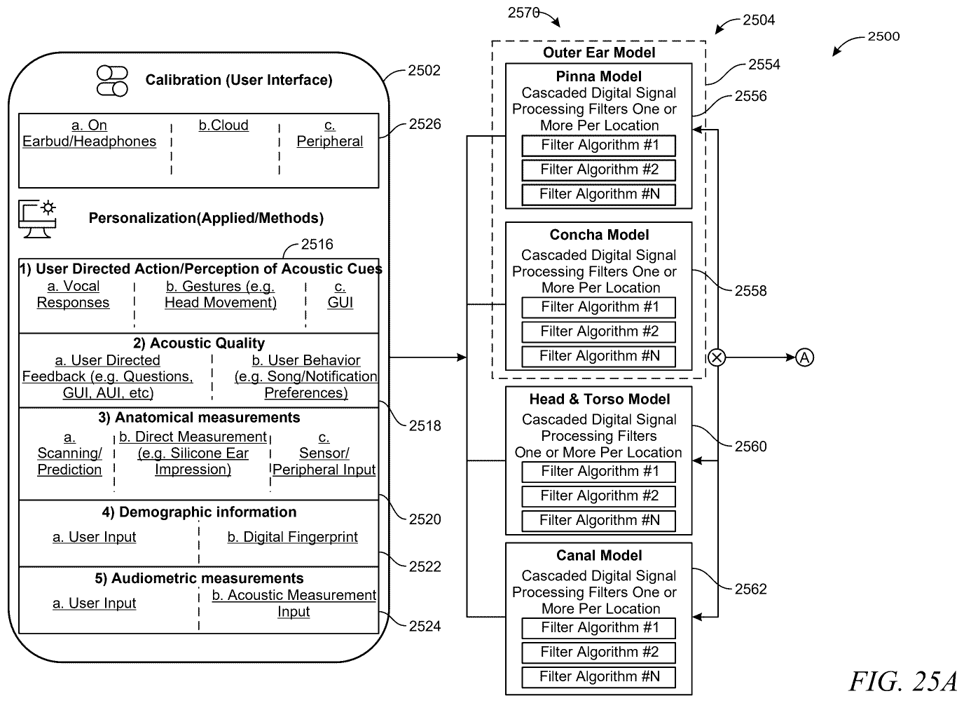

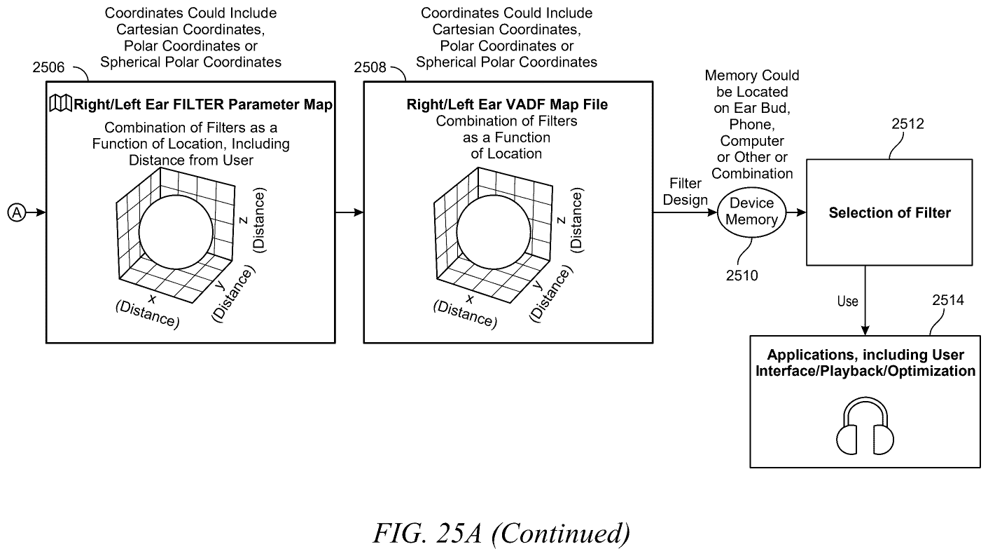

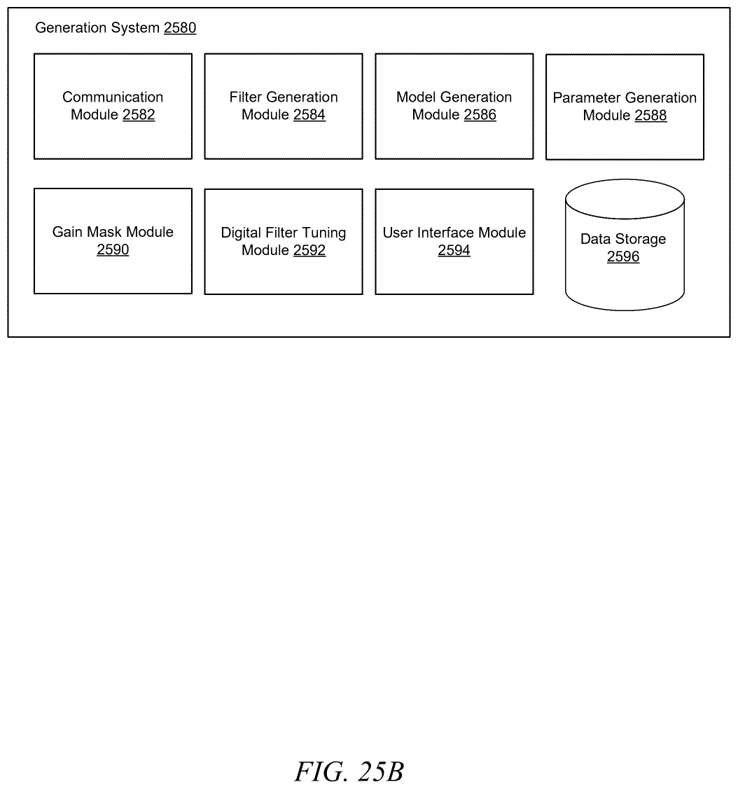

Virtual auditory display filters may be or include functions and/or digital filters that the virtual auditory display system 2302 applies to audio signals to create virtual auditory display sound. A generation system, discussed in more detail with reference to, for example, FIGS. 25A and 25B, may generate the virtual auditory display filters that the virtual auditory display system 2302 applies to audio signals.

The binauralizer 2338 may select a particular first digital filter and/or function from the left ear digital filter map 2320a and a particular second digital filter and/or function from the right ear digital filter map 2320b in the system memory 2318. The binauralizer 2338 may provide the particular first digital filter and/or function to the left ear convolution engine 2316a and the particular second digital filter and/or function to the right ear convolution engine 2316b.

The left ear convolution engine 2316a may apply the particular first digital filter and/or function and the first acoustic environment digital filter to the audio sub-signal to obtain a first processed audio sub-signal. The left ear convolution engine 2316a may then generate, based on the multiple first processed audio sub-signals, an output audio signal 2322a for the first ear-worn device 2302a. The right ear convolution engine 2316b may apply the particular second digital filter and/or function and the second acoustic environment digital filter to the audio sub-signal to obtain a second processed audio sub-signal. The right ear convolution engine 2316b may then generate, based on the multiple second processed audio sub-signals, an output audio signal 2322b for the second ear-worn device 2302b. The graph 2324a depicts an example impulse response for the output audio signal 2322a and the graph 2324b depicts an example impulse response for the output audio signal 2322b.

FIG. 24A is a block diagram depicting components of the virtual auditory display system 2302 in some embodiments. The virtual auditory display system 2302 may include the binauralizer 2338, a communication module 2402, an audio input module 2404, an audio output module 2406, a calibration and personalization module 2408, a user interface module 2410, and a data storage 2420.

The communication module 2402 may send requests and/or data between components of the virtual auditory display system 2302 and any other components or devices, such as the virtual auditory display device 2300 and a generation system 2580 (described with reference to, for example, FIGS. 25A and 25B). The communication module 2402 may also receive requests and/or data between components of the virtual auditory display system 2302 and any other components or devices.

The audio input module 2404 may receive the input audio signal 2312 from, for example, the general purpose computing device on which the virtual auditory display system 2302 executes. The audio output module 2406 may provide the output audio signal 2322a to the first ear-worn device 2302a and the output audio signal 2322b to the second ear-worn device 2302b.

The calibration and personalization module 2408 may calibrate IMUs and/or other sensors of the first ear-worn device 2302a and the second ear-worn device 2302b. The calibration and personalization module 2408 may also generate personalization audio signals and receive personalization information for personalizing filters. The user interface module 2410 may provide user interfaces that allow users to, among other things, select an acoustic environment, select an audio visualization, control audio volume, and request calibration and/or personalization procedures be performed by the virtual auditory display system 2302.

The data storage 2420 may include data stored, accessed, and/or modified by any of the engines, components, modules or the like of the virtual auditory display system 2302. The data storage 2420 may include any number of data storage structures such as tables, databases, lists, and/or the like. The data storage 2420 may include data that is stored in memory (for example, random access memory (RAM)), on disk, or some combination of in-memory and on-disk.

FIG. 24B is a block diagram depicting components of the first ear-worn device 2302a and the second ear-worn device 2302b in some embodiments. The first ear-worn device 2302a may include a memory 2450, an IMU sensor system 2452 (inertial measurement unit sensor system), a magnetometer 2454, a microcontroller 2456, a power management component 2458, an audio DSP 2460 (audio digital signal processor), microphones 2462, and speakers 2464. The second ear-worn device 2302b may include a memory 2450, an IMU sensor system 2452 (inertial measurement unit sensor system), a magnetometer 2454, an audio DSP 2460, microphones 2462, and speakers 2464.

The memory 2450 may store software and/or firmware. The IMU sensor system 2452 and/or the magnetometer 2454 may detect a head orientation of a wearer of the virtual auditory display device 2300 and/or user interactions with the virtual auditory display device 2300. The microcontroller 2456 may execute software and/or firmware stored in the memory 2450 or in the storage of the microcontroller 2456.

The power management component 2458 may provide power management. The audio DSP 2460 may process audio signals to perform functions such as noise cancellation. The microphones 2462 may capture audio, such as environmental audio and/or audio from a wearer of the first ear-worn device 2302a. The speakers 2464 may output sound based on the output audio signal 2322a and the output audio signal 2322b.

The first ear-worn device 2302a and/or the second ear-worn device 2302b may include components other than those depicted in FIG. 24B, such as switches, interconnects, and oscillators. The first ear-worn device 2302a may be the primary device and the second ear-worn device 2302b may be the secondary device. As such, the second ear-worn device 2302b may not include a microcontroller 2456. In some embodiments, the second ear-worn device 2302b includes a microcontroller 2456.

An engine, component, module, or the like of the virtual auditory display system 2302, the first ear-worn device 2302a, the second ear-worn device 2302b, or a generation system 2580 (described with reference to, for example FIG. 25B) may be hardware, software, firmware, or any combination. For example, each engine, component, module or the like may include functions performed by dedicated hardware (for example, an Application-Specific Integrated Circuit (ASIC), a Field Programmable Gate Array (FPGA), or the like), software, instructions maintained in memory, and/or any combination. Software and/or firmware may be executed by one or more processors.

Although a limited number of engines, components, and modules are depicted in FIGS. 24A and 24B and FIG. 25B, there may be any number of engines, components, and modules or the like. Further, individual engines, components, and modules may perform any number of functions, including functions of multiple modules as described herein. Moreover, although the virtual auditory display system 2302, the first ear-worn device 2302a, the second ear-worn device 2302b, and the generation system 2580 may be depicted as having a single one of several engines, components, or modules, the virtual auditory display system 2302, the first ear-worn device 2302a, the second ear-worn device 2302b, and the generation system 2580 may have multiple engines, components, modules, or the like that perform a particular function. For example, the first ear-worn device 2302a is depicted as having a single one of the audio DSP 2460, but the first ear-worn device 2302a may include multiple of the audio DSP 2460.

FIG. 25A is a block diagram of a method 2500 of personalizing, generating and applying digital filters in some embodiments. A generation system 2580 (see FIG. 25B) may perform the generation of digital filters (step 2504 through step 2510), and the virtual auditory display system 2302 may perform the personalization of digital filters (step 2502) and the application of digital filters (step 2512 through step 2514).

A digital filter may be or include one or more parametric equalization (EQ) filters that allow for adjustment of parameters such as the center frequency, gain, quality (Q or q), cutoff frequency, slope, bandwidth and/or filter type. The parametric EQ filters may be or include biquad filters. The biquad filters may be or include peaking, low shelf, and high shelf filters. In some embodiments, the digital filters may be or include one or more finite impulse response (FIR) filters. The FIR filters may be generated from or based on one or more infinite impulse response (IIR) filters. In some embodiments, the digital filters may be or include one or more IIR filters, or any other suitable type of digital filter.

The digital filters that the generation system 2580 generates may be organized into multiple groups. The groups of digital filters may include a group of notch filters, a group of head shadow filters, a group of shelf filters, a group of peak filters, a group of beam filters, a group of stereo filters, a group of rear filters, a group of top filters, a group of top transition filters, a group of bottom filters, a group of bottom transition filters, and a group of broadside filters. Other groups are possible. Certain digital filters or groups of digital filters may be utilized for purposes of setting the locations of sounds in virtual auditory space (for example groups of notch filters). Certain digital filters or groups of digital filters may be utilized for purposes of ensuring that sounds meet required thresholds of tonal quality, clarity, brightness, and the like.

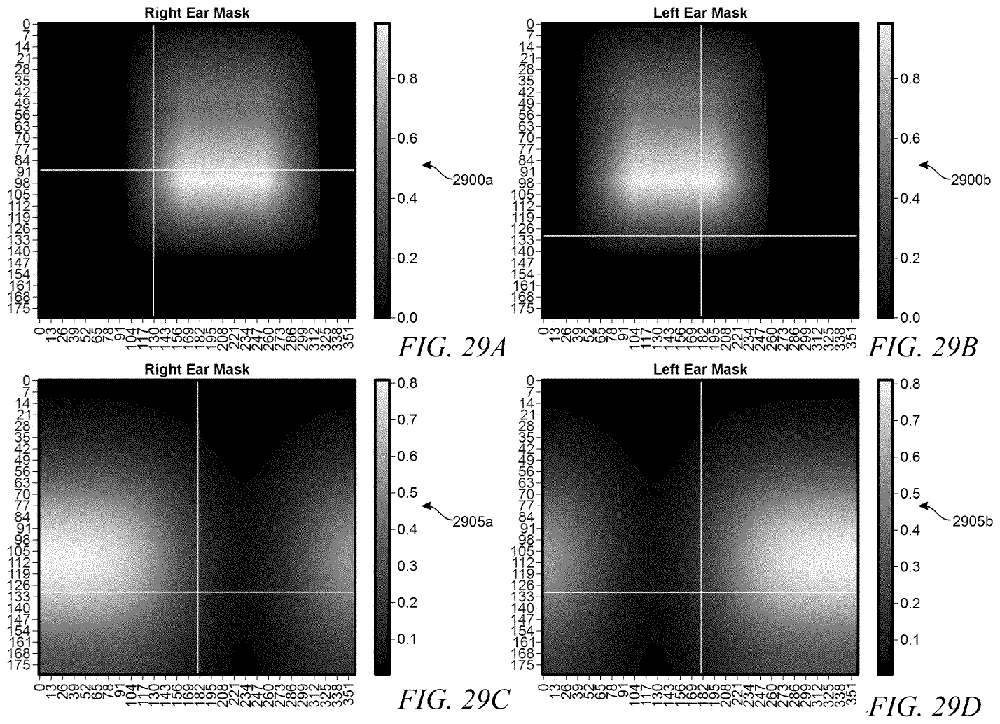

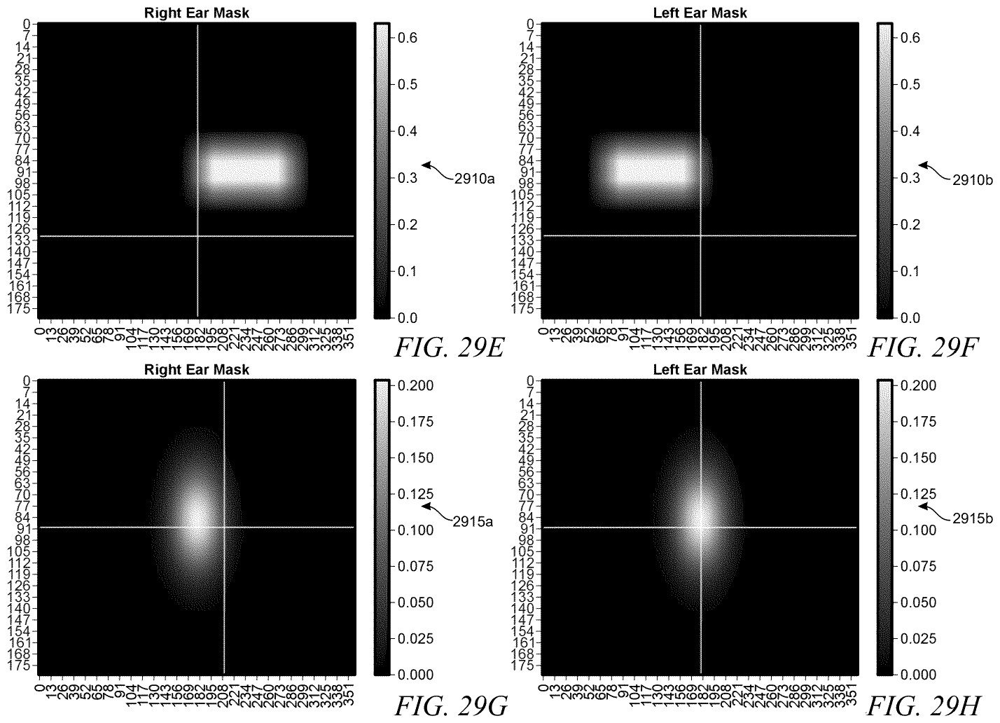

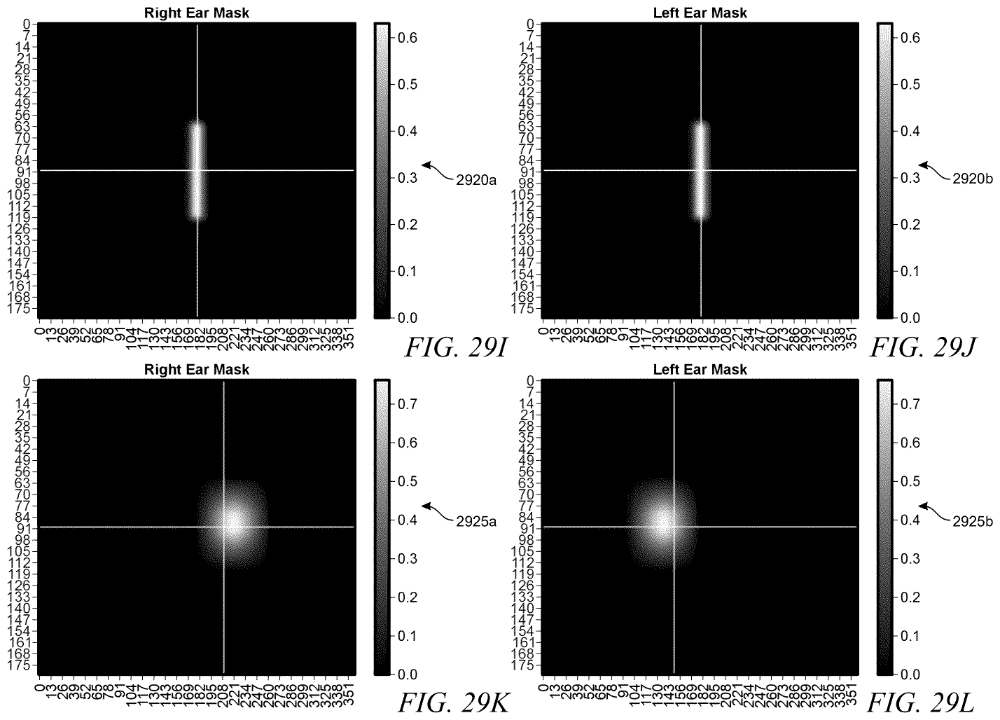

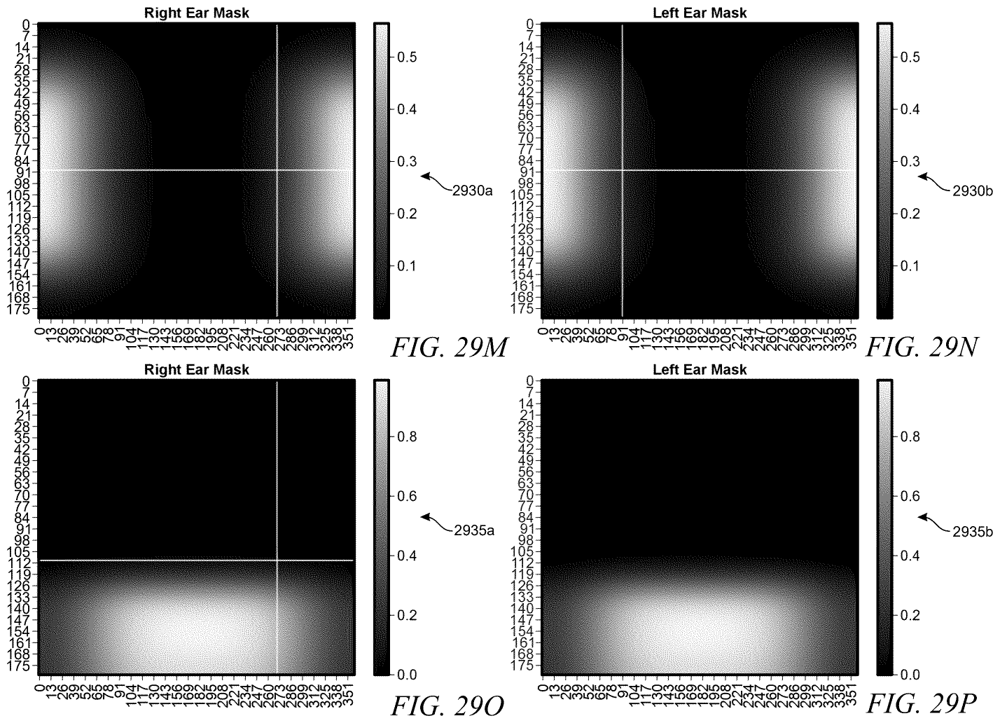

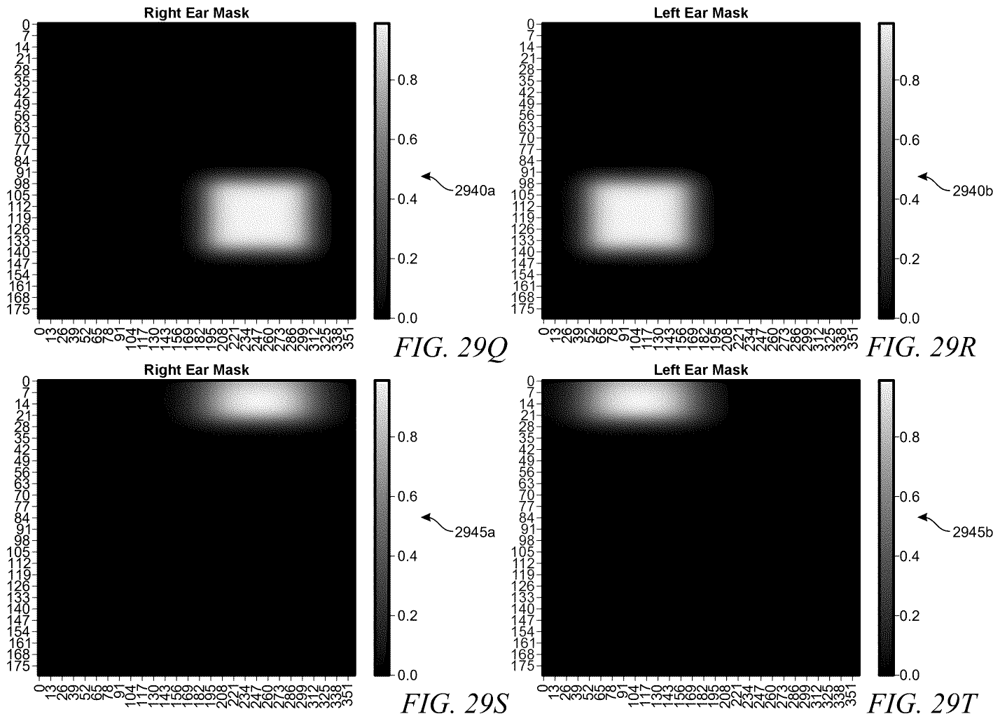

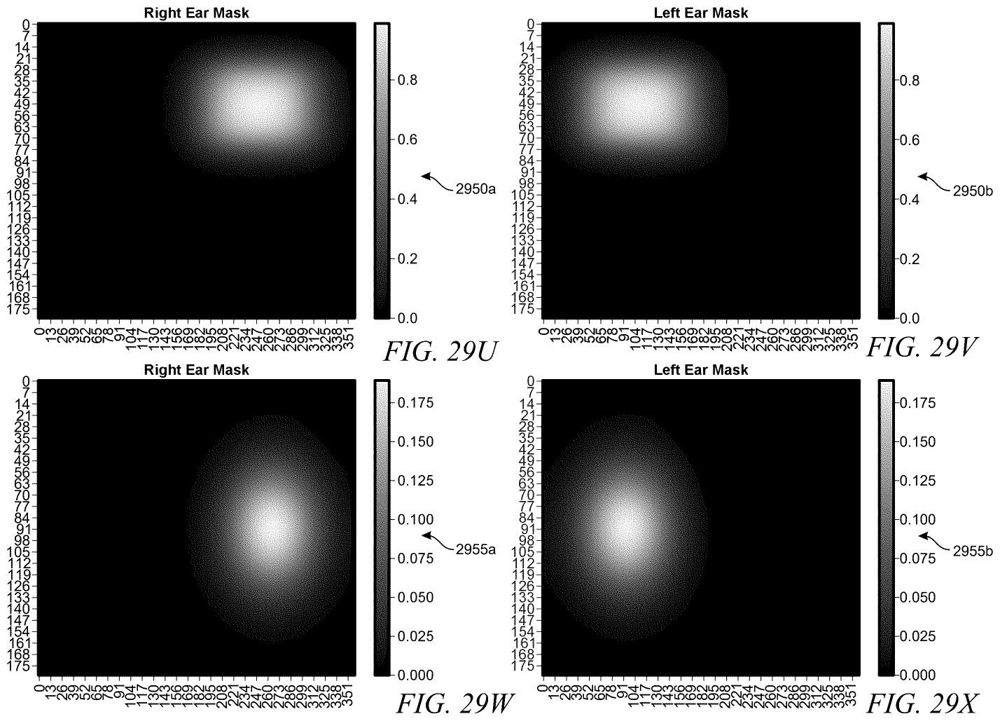

A digital filter may be or include an algorithm and one or more parameters for the algorithm. For example, the algorithm may be or include a high shelf, a low shelf, and a peaking algorithm. The one or more parameters may be or include a center frequency, a quality (Q or q), a gain, and a sampling frequency. For example, a notch digital filter may specify a peaking algorithm, an initial center frequency of 6600 Hz, a Q of 15, and an initial gain of −85 decibels (dB). The one or more parameters may be modified. For example, an initial center frequency may be shifted to obtain a shifted center frequency and an initial gain may be modified by a parameter modifier (see, for example, the discussion with reference to FIGS. 29A through 29X) and a factor that has any value, such as a value between 0 and 1, inclusive. The digital filter may be or include the one or more parameters as modified.

Digital filters may be generated and utilized based on how the digital filters represent individuals' geometries interact with sound waves. For example, a digital filter having a high shelf algorithm may produce a high shelf that may be a virtual representation of how the geometry of individual's concha bowl interacts with sound waves.

The method 2500 may include a step 2502 of calibration and/or personalization. The virtual auditory display system 2302 (for example, the calibration and personalization module 2408) may perform calibration of the IMUs and/or other sensors of the virtual auditory display device 2300 using various devices and/or services 2526, such as one or both of the first ear-worn device 2302a and the second ear-worn device 2302b, a cloud-based computing service, and/or a peripheral to a computing device, such as a camera.

The virtual auditory display system 2302 (for example, the calibration and personalization module 2408) may perform personalization of the virtual auditory display system using various methodologies and/or techniques, such as: 1) a user-directed action and/or perception of acoustic cues 2516; 2) acoustic quality user feedback 2518; 3) anatomical measurements 2520; 4) demographic information 2522; and 5) audiometric measurements 2524.

User-directed action and/or perception of acoustic cues 2516 may include capturing responses of a user to locations of acoustic cues. Responses may be vocal responses of a user captured using a microphone of a computing device, gestures (for example, head and/or arm movements) of a user captured using a camera of a computing device and/or one or both of the first ear-worn device 2302a and the second ear-worn device 2302b, and user input captured via a graphical user interface (GUI) of a computing device.

Acoustic quality user feedback 2518 may include user-directed feedback on acoustic quality (for example, responses to questions on quality metrics such as brightness, warmth, clarity, etc., responses to questions provided by a GUI or an Audio User Interface (AUI)), and observations of user behavior such as user song and/or notification preferences via, for example, a GUI or AUI.

Anatomical measurements 2520 may include measurements of user anatomical features, such as the head, the pinna, and/or the concha, via scanning or prediction. Anatomical measurements 2520 of one or more users may also include direct measurements (for example, via silicone ear impressions) and indirect measurements obtained via sensors and/or computer peripherals.

Demographic information 2522 may include information provided by users such as user age or other demographics and a digital fingerprint of a user generated from one or more user features such as age, gender, and/or other user characteristics.

Audiometric measurements 2524 may include those provided by user input and or obtained via acoustic measurements, such as in an anechoic chamber while audio signals are emitted from different known locations.

The method 2500 may include a step 2504 of the generation system 2580 (for example, a model generation module 2586 of the generation system 2580, see FIG. 25B) generating, modifying, and/or receiving multiple models 2570. The multiple models 2570 may include one or more outer ear models 2554, which may include one or more pinna models 2556 and one or more concha models 2558. The multiple models 2570 may also include one or more head and torso models 2560 and one or more canal models 2562. The generation system 2580 may generate the multiple models 2570 based on the calibration and/or personalization information obtained in step 2502.

For each model of the multiple models 2570, for each location in virtual auditory space, the generation system 2580 may generate one or more first digital filters (for the left ear) and one or more second digital filters (for the right ear) based on the model. Accordingly, for the multiple models 2570, for each location in virtual auditory space, the generation system 2580 may generate multiple first digital filters and multiple second digital filters.

For example, for the one or more head and torso models 2560, the generation system 2580 may generate one or more first digital filters and one or more second digital filters that take into account shoulder width and/or breadth, head diameter, neck height, and other factors. For the one or more concha models 2558 the generation system 2580 may generate one or more first digital filters and one or more second digital filters that represent the acoustic effects of the physical features of the concha. These features include (but are not limited to), concha depth, width, and angle.

As another example, for the one or more pinna models 2556, the generation system 2580 may generate one or more first digital filters and one or more second digital filters that represent the acoustic effects of the physical features of the pinna. These features include (but are not limited to), pinna height, width, depth, location on the head, and flare angle relative to head. For the one or more canal models 2562, the generation system 2580 may generate one or more first digital filters and one or more second digital filters that take into account the physical proportions of the pinna, concha, and other ear components.

Also at the step 2504, for each location in virtual auditory space, the generation system 2580 may sum, aggregate, or otherwise combine the multiple first digital filters into combined first digital filters, and may sum, aggregate, or otherwise combine the multiple second digital filters into combined second digital filters. The combined first digital filters may be or include one or more finite impulse response (FIR) filters. The combined second digital filters may also be or include one or more FIR filters. Accordingly, at the conclusion of the step 2504, for all the locations in virtual auditory space, there may be a set of combined first digital filters and a set of combined second digital filters.

At a step 2506, the generation system 2580 may generate a mapping or association of the combined first digital filters to their corresponding locations in virtual auditory space for the left ear. The generation system 2580 may also generate a mapping or association of the combined second digital filters to their corresponding locations in virtual auditory space for the right ear. The generation system 2580 may utilize cartesian, polar, and/or spherical polar coordinates for the mapping or association.

At a step 2508, the generation system 2580 may generate a file, a database, or other data structure that includes the mapping or association of the combined first digital filters to their corresponding locations in virtual auditory space and the mapping or association of the combined second digital filters to their corresponding locations in virtual auditory space.

At a step 2510, the generation system 2580 may provide or store the file, the database, or other data structure on one or more non-transitory computer-readable media of a device. The device may be the first ear-worn device 2302a and/or the second ear-worn device 2302b, a mobile device such as a phone or a tablet, a laptop or desktop computer, another device, or any combination of the foregoing.

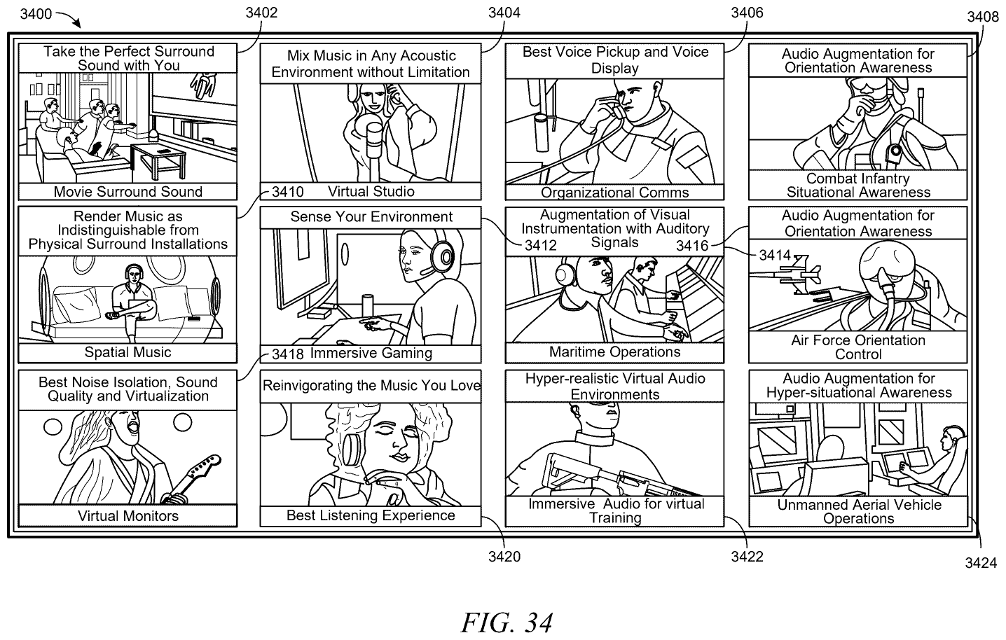

At a step 2512, the virtual auditory display system 2302 may select the combined first digital filters and the combined second digital filters for use. After selection, at a step 2514, the virtual auditory display system 2302 may utilize the combined first digital filters and the combined second digital filters in various applications, such as to render music. Various applications of the disclosed technology are discussed with reference to, for example, FIG. 34.

In some embodiments, at step 2504, for each model of the multiple models 2570, the generation system 2580 may generate one or more first digital filters and one or more second digital filters for each azimuth and elevation combination at locations in virtual auditory space of one degree increments of azimuth and elevation at a distance of one meter (1 m) from a center point representing a virtual listener in virtual auditory space. The one degree increments of azimuth are from approximately negative 180 degrees, inclusive, to approximately positive 180 degrees, inclusive. The one degree increments of elevation are from approximately negative 90 degrees, inclusive, to approximately 90 degrees, inclusive. Accordingly, there are 65,160 combinations of azimuth and elevation, and therefore 65,160 locations in virtual auditory space, each location being at a distance of 1 m from the center point. Therefore, the generation system 2580 may generate 65,160 sets of one or more first digital filters and 65,160 sets of one or more second digital filters.

In some embodiments, the method 2500 may include a step of the generation system 2580 reducing the number of locations in virtual auditory space for which digital filters are generated or stored. For example, after step 2504, the generation system 2580 may a select a proper subset from the set of combined first digital filters and a proper subset from the set of combined second digital filters.

In embodiments where there are 65,160 locations in virtual auditory space, the generation system 2580 may select a proper subset from the set of combined first digital filters that includes approximately 7,000, such as 7,220, combined first digital filters. Similarly, the generation system 2580 may select a proper subset from the set of combined second digital filters that includes approximately 7,000, such as 7,220, combined second digital filters.

The generation system 2580 may select a proper subset that adequately represent locations in virtual auditory space, while reducing the amount of storage required for the sets of digital filters and reducing the amount of time to select and process digital filters. The generation system 2580 may achieve these objectives in other ways, such as by generating mapping or associations for a reduced number of locations in virtual auditory space or storing the mapping or associations for a reduced number of locations in virtual auditory space.

In some embodiments, at step 2504 the generation system 2580 does not sum, aggregate, or otherwise combine the multiple first digital filters into combined first digital filters and the multiple second digital filters into combined second digital filters. Accordingly, at the conclusion of the step 2504, for all the locations in virtual auditory space, there may be a set of multiple first digital filters and a set of multiple second digital filters. A proper subset of the set of multiple first digital filters and a proper subset of the set of multiple second digital filters may be utilized as described herein.

In such embodiments, at step 2506 the generation system 2580 may instead generate a mapping or association of the multiple first digital filters to their corresponding locations in virtual auditory space for the left ear and generate a mapping or association of the multiple second digital filters to their corresponding locations in virtual auditory space for the right ear.

Further in such embodiments, at step 2508 the generation system 2580 may instead generate a file, a database, or other data structure that includes the mapping or association of the multiple first digital filters to their corresponding locations in virtual auditory space and the mapping or association of the multiple combined second digital filters to their corresponding locations in virtual auditory space.

In some embodiments, the generation system 2580 generates multiple sets of digital filters for the locations in virtual auditory space. The generation system 2580 may generate a first set of digital filters for the left ear and a first set of digital filters for the right ear as described herein. The generation system 2580 may then generate one or more second sets of digital filters for the left ear and one or more second sets of digital filters for the right ear based on the first set of digital filters for the left ear and the first set of digital filters for the right ear. Each pair of sets may be for a different archetype representing a different user population or grouping of users.

The generation system 2580 may generate the one or more second sets of digital filters for the left ear and the one or more second sets of digital filters for the right ear by modifying one or more parameters of the digital filters for the left ear and the digital filters for the right ear. For example, the generation system 2580 may modify the center frequency of notch filters that are included in the first set of digital filters for the left ear and the first set of digital filters for the right ear. The generation system 2580 may modify the center frequency of notch filters to personalize digital filters to a user, as described with reference to, for example, FIGS. 37A through 37F. The generation system 2580 may do so to adjust for a delta between an actual location of a sound in virtual auditory space and the location of the sound the wearer perceives.

In some embodiments, the generation system 2580 may generate a first set of digital filters for the left ear and a first set of digital filters for the right ear for a distance of 1 m from a center point representing a virtual listener in virtual auditory space, as described herein. The generation system 2580 may generate one or more second sets of digital filters for the left ear and the one or more second sets of digital filters for the right ear for other distances from the center point. The generation system 2580 may generate one or more second sets of digital filters for the left ear based on the first set of digital filters for the left ear and one or more second sets of digital filters for the right ear based on the first set of digital filters for the right ear. For example, the generation system 2580 may increase the gain of digital filters for distances closer than 1 m from the center point and may decrease the gain of digital filters for distances further than 1 m from the center point. Other methods will be apparent.

FIG. 25B is a block depicting components of the generation system 2580 in some embodiments. The generation system 2580 may include a communication module 2582, a filter generation module 2584, a model generation module 2586, a parameter generation module 2588, a parameter mask module 2590, a digital filter tuning module 2592, a user interface module 2594, and a data storage 2596.

The communication module 2582 may send requests and/or data between components of the generation system 2580 and any other systems, components or devices, such as the virtual auditory display system 2302. The communication module 2582 may also receive requests and/or data between components of the generation system 2580 and any other systems, components or devices.

The filter generation module 2584 may generate digital filters and the acoustic environment digital filters. A filter may be or include one or more algorithms and, optionally, one or more parameters for the one or more algorithms.

The model generation module 2586 may generate, modify, or access multiple models. The parameter generation module 2588 may generate parameters for digital filters.

The parameter mask module 2590 may generate parameter modifier masks. The parameter mask module 2590 may use image processing techniques to generate parameter modifier masks. The parameter mask module 2590 may determine one or more parameter modifiers to one or more parameter of filters using the parameter modifier masks. The parameter mask module 2590 may modify the one or more parameter using the one or more parameter modifiers.

The digital filter tuning module 2592 may receive parameters for digital filters from users and modify digital filters based on the received parameters. The user interface module 2594 may provide user interfaces that allow users to, among other things, listen to sound output from audio signals generated by application of digital filters and modify parameters of digital filters.

The data storage 2596 may include data stored, accessed, and/or modified by any of the engines, components, modules or the like of the generation system 2580. The data storage 2596 may include any number of data storage structures such as tables, databases, lists, and/or the like. The data storage 2596 may include data that is stored in memory (for example, random access memory (RAM)), on disk, or some combination of in-memory and on-disk.

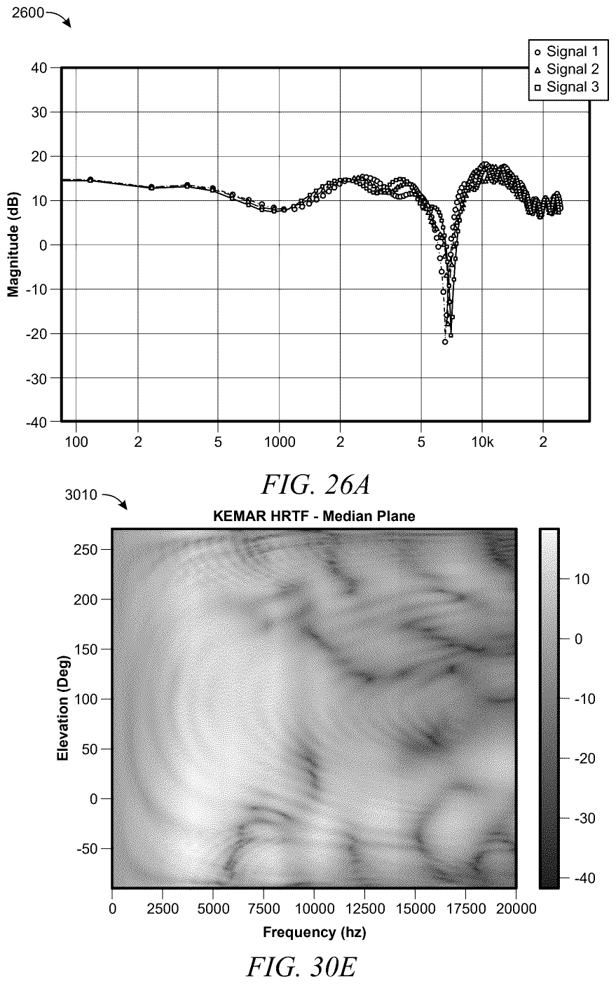

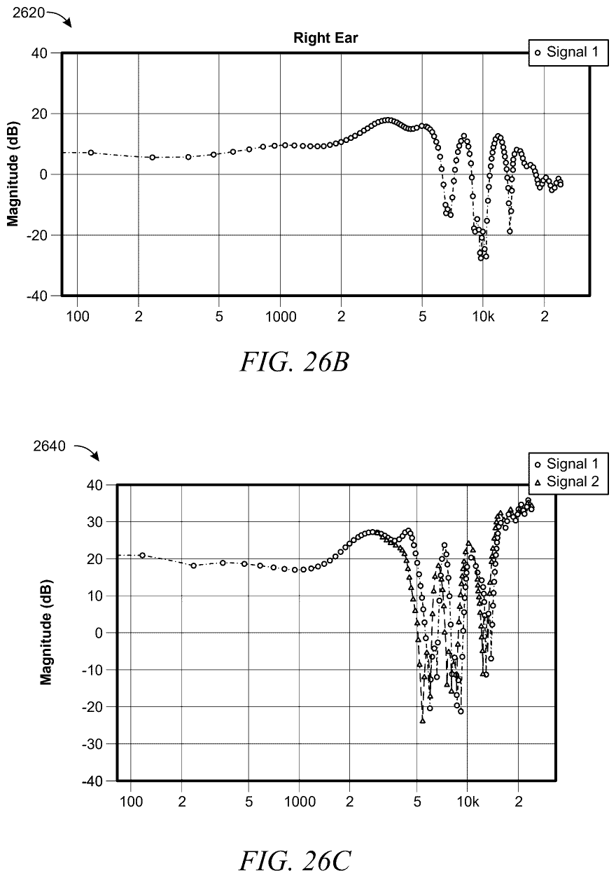

FIGS. 26A-26C are graphs of frequency responses of digital audio signals in some embodiments. FIG. 26A is a graph 2600 the frequency response for three audio signals. Each audio signal has a notch at a different center frequency. The center frequency of the notch is a factor in specifying the location in virtual auditory space of the sound corresponding to the audio signal, meaning where a user (for example, a wearer of the first ear-worn device 2302a and the second ear-worn device 2302b) perceives the location of the sound to be.

The first audio signal is for a first sound that has a first location in virtual auditory space at a distance of one (1) meter (m), zero degrees (0°) azimuth and zero degrees (0°) elevation. The second audio signal is for a second sound that has a second location in virtual auditory space at a distance of one (1) m, five degrees (5°) azimuth and zero degrees (0°) elevation The third audio signal is for a third sound that has a third location in virtual auditory space at a distance of one (1) m, ten degrees (10°) azimuth and zero degrees (0°) elevation. FIG. 26A shows the variation of the center frequency notch in the three signals due to the differences in locations in virtual auditory space. The virtual auditory display system 2302 has applied a notch filter to the three audio signals produce each notch in each of the three frequency responses in order to produce the three sounds at the specified locations in virtual auditory space. The notch filter may be or include parametric EQ filters with the parameters being the center frequency, the gain, and the bandwidth.

FIG. 26B is a graph 2620 of a frequency response of an audio signal to which digital filters have been applied according to some embodiments. The frequency response has three notches at three different center frequencies. The audio signal is for a sound that has a location in virtual auditory space at a distance of one (1) meter (m), zero degrees (0°) azimuth and zero degrees (0°) elevation. The virtual auditory display system 2302 has applied three notch filters to produce the three notches in the frequency response of the audio signal. The notch filters may be or include parametric EQ filters with the parameters being the center frequency, the gain, and the bandwidth.

FIG. 26C is a graph 2640 of frequency responses of two audio signals to which digital filters have been applied according to some embodiments. Each frequency response has a notch at a different center frequency. The virtual auditory display system 2302 has applied three notch filters to produce the three notches in each frequency response. The notch filters may be or include parametric EQ filters with the parameters being the center frequency, the gain, and the bandwidth.

In the examples depicted in FIGS. 26A-26C, the peak-to-trough decibel values of notches of the azimuthal values between negative ten degrees (−10°) to ninety-five degrees (95°) and the elevation values of between negative thirty degrees (−30°) to forty-five degrees (45°) reach<negative thirty (−30) decibels (dB). When a virtual sound-source exists within the proposed azimuth-elevation bounds, the peak-to-trough decibel value of −30 dB or more may be beneficial for producing accurate sound-source localization for the hearer.

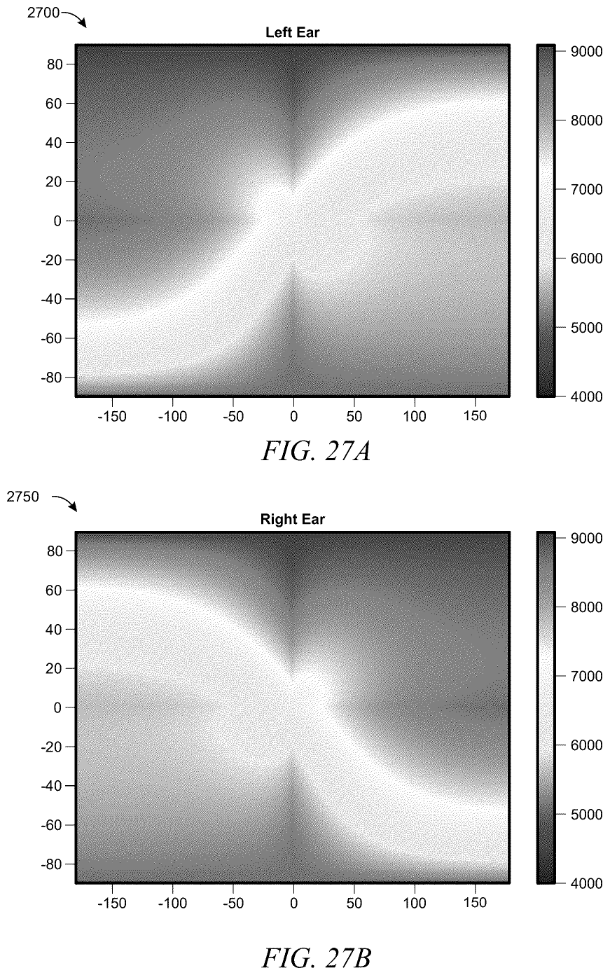

FIG. 27A depicts a distribution 2700 of center frequencies as a function of azimuth (x-axis) and elevation (y-axis) for the left ear. FIG. 27B depicts a distribution 2750 of center frequencies as a function of azimuth (x-axis) and elevation (y-axis) for the right ear. The distribution 2700 and the distribution 2750 indicate that, for any particular azimuth, the center frequencies follow a generally sigmoidal curve or have a generally sigmoidal shape or distribution. Similarly, for any particular elevation, the center frequencies follow a generally sigmoidal curve or have a generally sigmoidal shape or distribution.

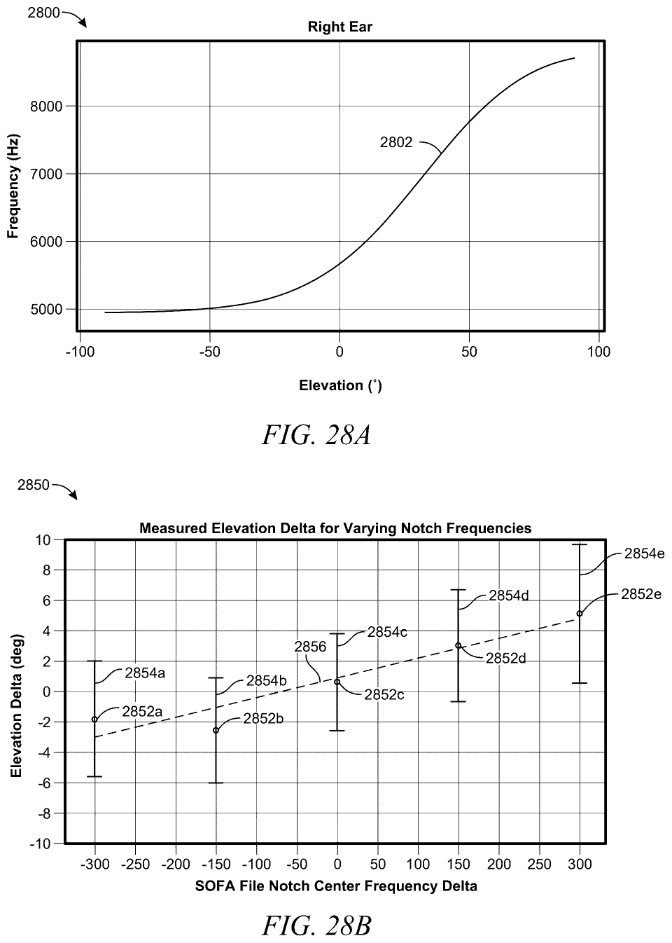

For example, FIG. 28A is a graph 2800 of a center frequency curve 2802 as a function of elevation (x-axis) for the right ear where the azimuth is zero degrees (0°). The center frequency values range from about approximately 4900 Hz to about approximately 8700 Hz from negative 90 degrees elevation to 90 degrees elevation. The center frequency curve 2802 has a generally sigmoidal shape or distribution.

Returning to FIGS. 27A and 27B, the virtual auditory display system 2302 may utilize the distribution 2700 and/or the distribution 2750 to determine the center frequencies for one or more notches in the frequency spectrums of audio signals. The virtual auditory display system 2302 may determine the center frequences for the one or more notches based on the location of the sounds in virtual auditory space that the audio signal will cause the first ear-worn device 2302a and the second ear-worn device 2302b to produce.

That is, based on the location (as specified by, for example, azimuth and elevation) of the sounds in virtual auditory space, the virtual auditory display system 2302 may determine the center frequencies for one or more notches in a frequency spectrum of the audio signals that cause the first ear-worn device 2302a and the second ear-worn device 2302b to produce the sounds. The virtual auditory display system 2302 may determine the center frequencies of the first notches in the frequency spectrums of the audio signals by accessing the distribution 2700 and the distribution 2750. The virtual auditory display system 2302 may determine the center frequencies of the second notches and subsequent notches in the frequency spectrums of the audio signals based on the distribution 2700 and the distribution 2750 and on one or more shifts from the center frequencies obtained from the distribution 2700 and the distribution 2750.

In some embodiments, in addition to or as an alternative to utilizing the distribution 2700 and/or the distribution 2750, the virtual auditory display system 2302 may utilize one or more center frequency curves, each of which may be for a different azimuth value, like the center frequency curve 2802 of FIG. 28A, or a different elevation value. The virtual auditory display system 2302 determines the center frequencies for one or more notches in a frequency spectrum of an audio signal, based on the location of the resulting sounds in virtual auditory space.

FIG. 28B is a graph 2850 of user experience data of multiple trials with five different digital filters, which vary as a function of notch center frequency, in some embodiments. Each of the point 2852a, the point 2852b, the point 2852c, the point 2852d, and the point 2852e is the mean of 15 user trials that collected real-time user feedback on perceived sound location in virtual auditory space, for a total of 75 user trials. The bar 2854a, the bar 2854b, the bar 2854c, the bar 2854d, and the bar 2854e each represent plus or minus one (1) standard deviation. The point 2852b, the point 2852c, the point 2852d and the point 2852e demonstrate that there is an observed delta of approximately 2.5° for each 150 Hz added to the notch center frequencies. The line 2856 can be fit to the points 2852. The virtual auditory display system 2302 may utilize the linear function that produced the line 2856 to determine the center frequency to use for one or more notches based on the elevation of the sound to be produced. For example, for certain ranges of elevations (for example, between approximately zero degrees and approximately 50 degrees, or between approximately 10 degrees and approximately 40 degrees), the virtual auditory display system 2302 may utilize the linear that produced the line 2856 to determine one or more shifts from a center frequency in the ranges. The virtual auditory display system 2302 may do so in addition to or as an alternative to utilizing the distribution 2700 and/or the distribution 2750 depicted in FIGS. 27A and 27B.

FIGS. 29A through 29X depict parameter modifier masks that may be applied to modify parameters used in generating digital filters in some embodiments. FIG. 29A depicts a right ear parameter modifier mask 2900a and FIG. 29B depicts a left ear parameter modifier mask 2900b for notch filters. FIG. 29C depicts a right ear parameter modifier mask 2905a and FIG. 29D depicts a left ear parameter modifier mask 2905b for head shadow filters. FIG. 29E depicts a right ear parameter modifier mask 2910a and FIG. 29F depicts a left ear parameter modifier mask 2910b for shelf filters. FIG. 29G depicts a right ear parameter modifier mask 2915a and FIG. 29H depicts a left ear parameter modifier mask 2915b for peak filters. FIG. 29I depicts a right ear parameter modifier mask 2920a and FIG. 29J depicts a left ear parameter modifier mask 2920b for beam filters. FIG. 29K depicts a right ear parameter modifier mask 2925a and FIG. 29L depicts a left ear parameter modifier mask 2925b for stereo filters.

FIG. 29M depicts a right ear parameter modifier mask 2930a and FIG. 29N depicts a left ear parameter modifier mask 2930b for rear filters. FIG. 29O depicts a right ear parameter modifier mask 2935a and FIG. 29P depicts a left ear parameter modifier mask 2935b for top filters. FIG. 29Q depicts a right ear parameter modifier mask 2940a and FIG. 29R depicts a left ear parameter modifier mask 2940b for top transition filters. FIG. 29S depicts a right ear parameter modifier mask 2945a and FIG. 29T depicts a left ear parameter modifier mask 2945b for bottom filters. FIG. 29U depicts a right ear parameter modifier mask 2950a and FIG. 29V depicts a left ear parameter modifier mask 2950b for bottom transition filters. FIG. 29W depicts a right ear parameter modifier mask 2955a and FIG. 29X depicts a left ear parameter modifier mask 2955b for broadside filters.

The parameter modifier masks depicted in FIGS. 29A-29X specify parameter modifier values as a function of a location in virtual auditory space as specified by, for example, azimuth and elevation. The parameter modifier values may range from between any two values. In some embodiments, the parameter modifier values range between zero (0), inclusive, and another value, such as one (1), 0.2, 0.4, 0.8, inclusive. The parameter mask module 2590 may generate the parameter modifier masks by specifying a particular region in virtual auditory space in which the values are to be one (1), and by specifying that regions other than the particular region have values of zero (0). For example, for the right ear parameter modifier mask 2900a of FIG. 29A, the particular region in virtual auditory space may be from approximately negative 50 (−50) degrees azimuth to approximately 110 degrees azimuth and from approximately negative 290 (−290) degrees elevation to approximately 30 degrees elevation. The parameter mask module 2590 may use other particular regions for the parameter modifier mask 2900a and the other parameter modifier masks in FIGS. 29A-29X.

The parameter mask module 2590 may use image processing algorithms to create continuous transitions of values between the particular region and the other regions to generate the parameter modifier masks with the parameter modifier values. For example, the parameter mask module 2590 may use image processing algorithms such as a gaussian function, a sharpening function, a contrast adjustment function, a color correction function, a thresholding function, an edge detection function, and/or a segmentation function. In some embodiments, the parameter mask module 2590 uses a gaussian blur mask to generate the parameter modifier values. The parameter mask module 2590 may generate the parameter modifier mask for a right ear and then reflect the parameter modifier mask for the right ear about a vertical axis at an azimuth value of zero (0) to obtain the parameter modifier mask for the right ear.

The filter generation module 2584 may utilize the parameter modifier masks depicted in FIGS. 29A-29X to select, based on a location for a sound in virtual auditory space, one or more parameter modifiers that the filter generation module 2584 may use to modify one or more parameters to obtain one or more modified parameters. For example, the filter generation module 2584 may utilize one or more parameter modifiers to modify the gain of digital filters. In some embodiments, the filter generation module 2584 multiplies the one or more parameters by the one or more parameter modifiers to obtain the one or more modified parameters. Other uses of parameter modifiers will be apparent.

FIG. 30A depicts a gain distribution 3070 for a head shadow for a left ear and FIG. 30B depicts a gain distribution 3080 for a head shadow for a right ear according to some embodiments. The gain distribution 3070 depicts how a gain changes as a sound source transitions from a location 3072 generally by the right ear to a location 3074 generally in front of the wearer to a location 3076 generally by the left ear. The gain distribution 3080 depicts how a gain changes as a sound source transitions from a location 3082 generally by the left ear to a location 3084 generally in front of the wearer to a location 3086 generally by the left ear.

FIG. 30C depicts a gain distribution 3060 of the application of digital filters to an audio signal according to some embodiments. The gain distribution 3060 shows several notches 3064 across a head shadow 3062. The several notches 3064 are at center frequencies between 10\hat{ }3 Hz and 10\hat{ }4 Hz.

FIG. 30D depicts user experience data for digital filters according to some embodiments and user experience data for a prior art head-related transfer function (HRTF). The prior art HRTF is used as a standard model for many past and present HRTF applications. Panel 3000 of FIG. 30D reports the difference between the user-perceived elevation of a virtual sound object and the actual elevation of the sound object for both the digital filters for 150 trials and the prior art HRTF for 150 trials. For the digital filters trials, point 3004 is the mean user-perceived elevation and band 3002 is the standard deviation of the user-perceived elevation. For the HRTF trials, point 3008 is the mean user-perceived elevation and band 3006 is the standard deviation of the user-perceived elevation.

Panel 3050 of FIG. 30D reports the difference between the user-perceived azimuth of a virtual sound object and the actual azimuth of the sound object for both the digital filters for 150 trials and the prior art HRTF for 150 trials. For the digital filters trials, point 3052 is the mean user-perceived azimuth and band 3054 is the standard deviation of the user-perceived azimuth. For the HRTF trials, point 3058 is the mean user-perceived azimuth and band 3056 is the standard deviation of the user-perceived azimuth.

For the elevation trials, the closer the elevation delta is to 0°, the more accurate the representation of the virtual sound object. Similarly, for the azimuth trials, the closer the elevation delta is to 0°, the more accurate the representation of the virtual sound object. The user experience data shows that the digital filters improve the elevation delta from a mean of approximately 30.19° with a standard deviation of approximately 12.54° to a mean of approximately −0.03° with a standard deviation of approximately 4.12°. The user experience data also shows the digital filters improves the azimuth delta from a mean of approximately −0.64° with a standard deviation of approximately 7.76° to a mean of approximately −0.02° with a standard deviation of approximately 2.04°. The data shows that the digital filters according to some embodiments improve the accuracy and precision of virtual sound objects.

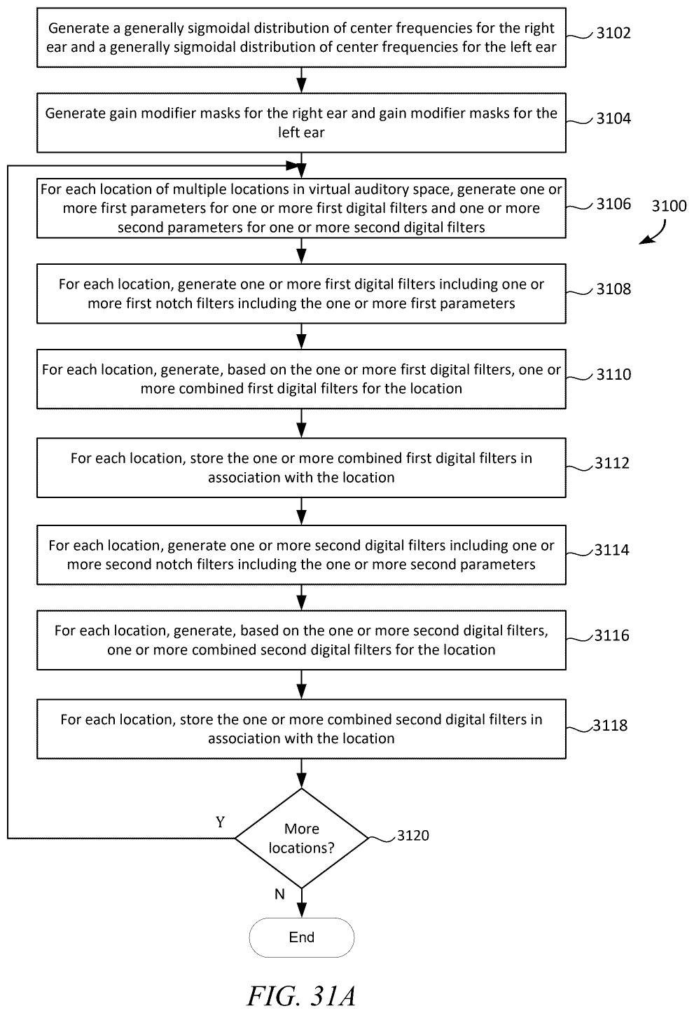

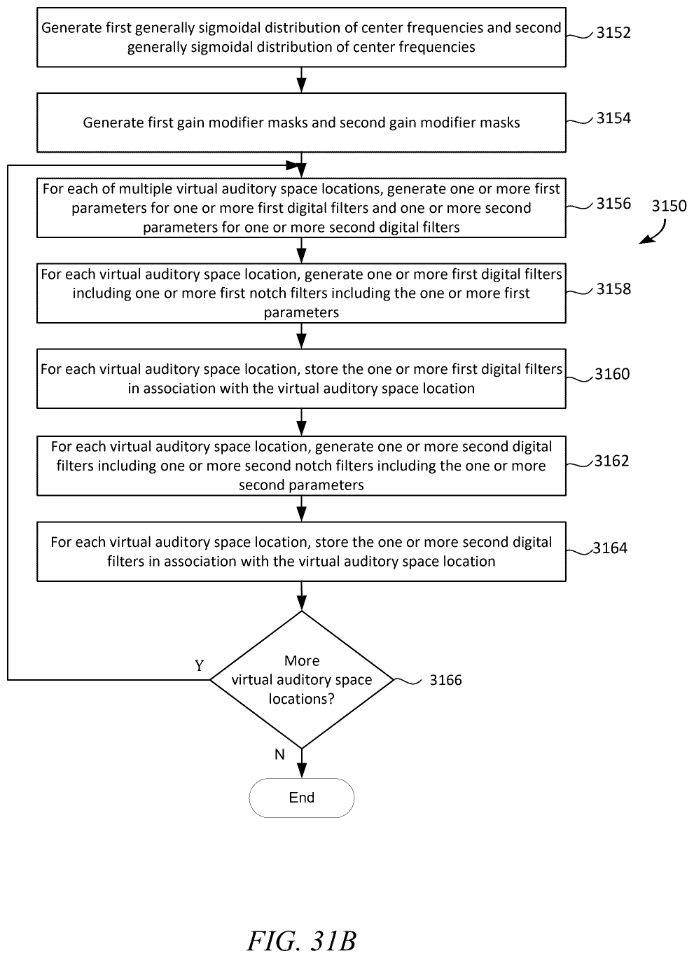

FIG. 31A depicts a method 3100 of generating digital filters according to some embodiments. The generation system 2580 may perform the method 3100. The generation system 2580 may perform the method 3100 to generate a set of combined first digital filters and a set of combined second digital filters. The method 3100 begins at a step 3102, where the generation system 2580 (for example, the filter generation module 2584) may generate a generally sigmoidal distribution of center frequencies for the right ear (see, for example, FIG. 27A) and a generally sigmoidal distribution of center frequencies for the left ear (see, for example, FIG. 27B).

At a step 3104 the generation system 2580 (for example, the parameter mask module 2590) generates parameter modifier masks for the right ear and parameter modifier masks for the left ear (see, for example, FIGS. 29A through 29X). The generation system 2580 may generate the parameter modifier masks using one or more image processing algorithms. The one or more image processing algorithms may include one or more of a gaussian function, a sharpening function, a contrast adjustment function, a color correction function, a thresholding function, an edge detection function, and a segmentation function.

At a step 3106, for each location of multiple locations in virtual auditory space, the generation system 2580 (for example, the parameter generation module 2588) may generate one or more first parameters for one or more first digital filters and one or more second parameters for one or more second digital filters. The one or more first parameters may include one or more first q's, one or more first gains, and one or more first center frequencies. The one or more second parameters may include one or more second q's, one or more second gains, and one or more second center frequencies.

The generation system 2580 may utilize the parameter modifier masks for the right ear and the parameter modifier masks for the left ear to select, based on the location in virtual auditory space, one or more parameter modifiers that the generation system 2580 may use to modify one or more parameter to obtain one or more modified parameter. In some embodiments, the generation system 2580 multiplies the one or more parameter by the one or more parameter modifiers to obtain the one or more modified parameter.

The generation system 2580 may utilize the generally sigmoidal distribution of center frequencies for the right ear and/or the generally sigmoidal distribution of center frequencies for the left ear to determine one or more center frequencies for one or more notches in the frequency spectrums of the audio signal for the right ear and the audio signal for the left ear. The generation system 2580 may determine the center frequences for the one or more notches based on the location in virtual auditory space.

At a step 3108, for each location, the generation system 2580 (for example, the filter generation module 2584) may generate one or more first digital filters including one or more first notch filters including the one or more first parameters. The generation system 2580 may utilize the one or more first q's, the one or more first gains, and the one or more first center frequencies to generate the one or more first notch filters. The one or more first notch filters are configured to produce one or more first notches in a first frequency spectrum of a first audio signal according to the one or more first q's, the one or more first gains, and the one or more first center frequencies when the generation system 2580 applies the one or more notch filters to an audio signal for the right ear.

At a step 3110, for each location, the generation system 2580 (for example, the filter generation module 2584) may generate, based on the one or more first digital filters, one or more combined first digital filters for the location. In some embodiments, the one or more first digital filters are IIR filters, and the one or more combined first digital filters are FIR filters.

At a step 3112, for each location, the generation system 2580 may store the one or more combined first digital filters in association with the location (in, for example, the data storage 2420).

At a step 3114, for each location, the generation system 2580 (for example, the filter generation module 2584) may generate one or more second digital filters including one or more second notch filters including the one or more second parameters. The generation system 2580 may utilize the one or more second q's, the one or more second gains, and the one or more second center frequencies to generate the one or more second notch filters. The one or more second notch filters are configured to produce one or more second notches in a second frequency spectrum of a second audio signal according to the one or more second q's, the one or more second gains, and the one or more second center frequencies when the generation system 2580 applies the one or more notch filters to an audio signal for the left ear.

At a step 3116, for each location, the generation system 2580 (for example, the filter generation module 2584) may generate, based on the one or more second digital filters, one or more combined second digital filters for the location. In some embodiments, the one or more second digital filters are IIR filters, and the one or more combined second digital filters are FIR filters.

At a step 3118, for each location, the generation system 2580 may store the one or more combined second digital filters in association with the location (in, for example, the data storage 2420).

At a step 3120 the generation system 2580 tests to see if there are more locations for which the generation system 2580 is to generate digital filters. If so, the method 3100 returns to step 3106. The generation system 2580 may perform the method 3100 multiple times to generate multiple sets of combined first digital filters and multiple sets of combined second digital filters. Each pair of sets of digital filters may be for a different archetype

In some embodiments, the generation system 2580 may perform the method 3100 several times to generate multiple sets of combined first digital filters and combined second digital filters. Each pair of sets may be for a different archetype representing a different user population or grouping of users.

FIG. 31B depicts a method 3150 of generating digital filters in some embodiments. The generation system 2580 may perform the method 3100. The method 3150 includes certain steps that may be generally similar to certain steps of the method 3100. The generation system 2580 (for example, various components of the generation system 2580) may perform the method 3150. The generation system 2580 may perform the method 3150 to generate a set of first digital filters and a set of second digital filters.

The method 3150 begins at a step 3152, where the generation system 2580 (for example, the parameter generation module 2588) may generate a first generally sigmoidal distribution of center frequencies and a second generally sigmoidal distribution of center frequencies. At a step 3154 the generation system 2580 (for example, the parameter mask module 2590) may generate first parameter modifier masks and second parameter modifier masks.

At a step 3156, for each of multiple virtual auditory space locations, the generation system 2580 (for example, the parameter generation module 2588) may generate one or more first parameters for one or more first digital filters and one or more second parameters for one or more second digital filters. The one or more first parameters may include one or more first q's, one or more first gains, and one or more first center frequencies. The one or more second parameters may include one or more second q's, one or more second gains, and one or more second center frequencies.

At a step 3158, for each virtual auditory space location, the generation system 2580 may generate one or more first digital filters including one or more first notch filters including the one or more first parameters. Step 3158 is generally similar to step 3108 of the method 3100.

At a step 3160, for each virtual auditory space location, the generation system 2580 may store the one or more first digital filters in association with the virtual auditory space location. Step 3160 is generally similar to step 3112 of the method 3100.

At a step 3162, for each virtual auditory space location, the generation system 2580 may generate one or more second digital filters including one or more second notch filters including the one or more second parameters. Step 3162 is generally similar to step 3114 of the method 3100.

At a step 3164, for each virtual auditory space location, the generation system 2580 may store the one or more second digital filters in association with the virtual auditory space location. Step 3164 is generally similar to step 3118 of the method 3100.

At a step 3166 the generation system 2580 tests to see if there are more virtual auditory space locations for which the generation system 2580 is to generate digital filters. If so, the method 3100 returns to step 3156. The generation system 2580 may perform the method 3150 multiple times to generate multiple sets of one or more first digital filters and multiple sets of one or more second digital filters.

The method 3100 and the method 3150 may include additional steps. For example, the generation system 2580 may provide for testing digital filters. The generation system 2580 (for example, the user interface module 2594) may provide a user interface that allows for sound generated by audio signals to which digital filters have been applied to be played. A user may listen to the sounds and determine that one or more parameters of the digital filters should be modified. For example, the user may modify parameters of digital filters to ensure that sounds meet required thresholds of tonal quality, clarity, brightness, and the like. The generation system 2580 may provide another user interface that allows the user to modify the one or more parameters of the digital filters. The generation system 2580 (for example, the digital filter tuning module 2592) may receive the one or more parameters of the digital filters from users and modify digital filters based on the received one or more parameters.

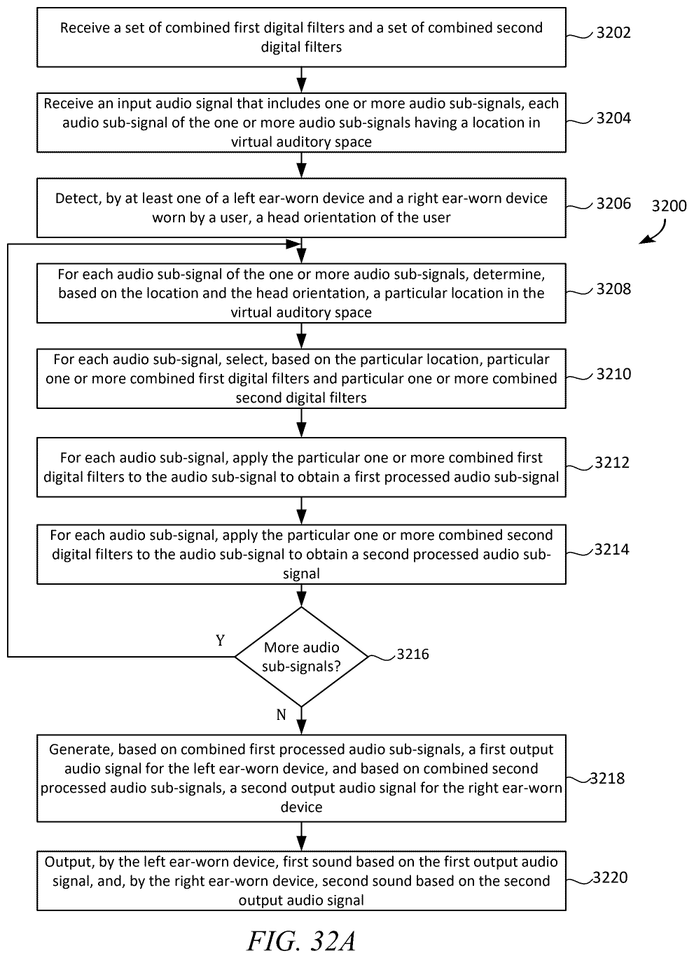

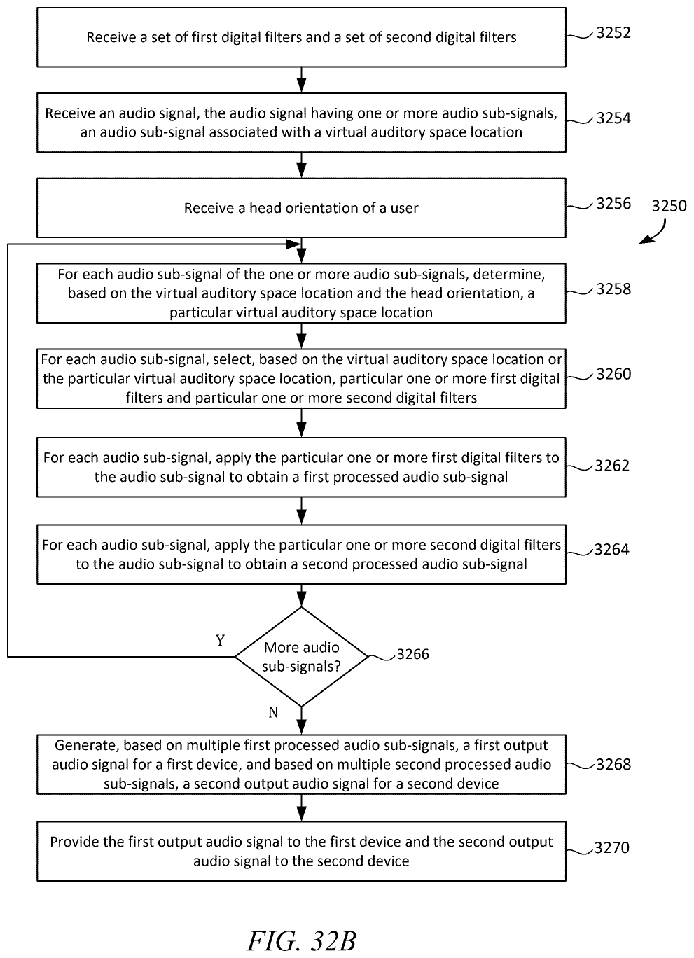

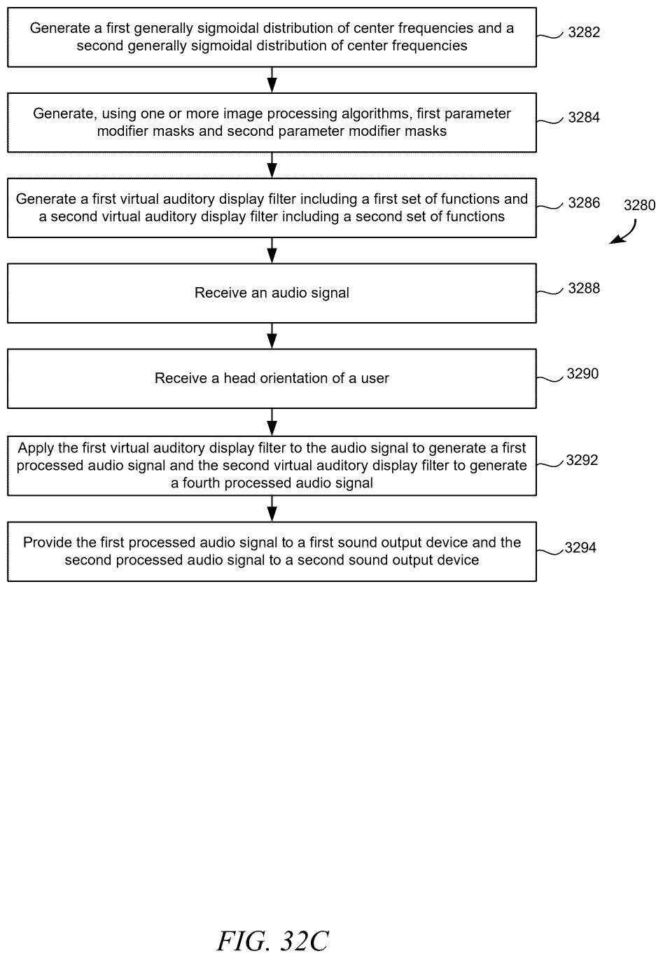

FIG. 32A depicts a method 3200 of applying digital filters according to some embodiments. The virtual auditory display system 2302 and the virtual auditory display device 2300 may perform the method 3200. The method 3200 begins at a step 3202, where the virtual auditory display system 2302 (for example, the binauralizer 2338) receives a set of combined first digital filters and a set of combined second digital filters.

At a step 3204 the virtual auditory display system 2302 (for example, the binauralizer 2338) receives an input audio signal that includes one or more audio sub-signals. Each audio sub-signal of the one or more audio sub-signals has a location in virtual auditory space.

While receiving the input audio signal, the virtual auditory display system 2302 performs step 3206 through step 3220 of the method 3200. At step 3206 one or both of the first ear-worn device 2302a and the second ear-worn device 2302b detects a head orientation of the user wearing the first ear-worn device 2302a and the second ear-worn device 2302b. The first ear-worn device 2302a and/or the second ear-worn device 2302b provide the head orientation to the virtual auditory display system 2302.

At a step 3208, for each audio sub-signal of the one or more audio sub-signals, the virtual auditory display system 2302 determines, based on the location of the audio sub-signal and the head orientation, a particular location in the virtual auditory space. At a step 3210, for each audio sub-signal, the virtual auditory display system 2302 selects, based on the particular location, particular one or more combined first digital filters and particular one or more combined second digital filters.

At a step 3212, for each audio sub-signal, the virtual auditory display system 2302 applies the particular one or more combined first digital filters to the audio sub-signal to obtain a first processed audio sub-signal. At a step 3214, for each audio sub-signal, the virtual auditory display system 2302 applies the particular one or more combined second digital filters to the audio sub-signal to obtain a second processed audio sub-signal.

At a step 3216 the virtual auditory display system 2302 tests to see if there are more audio sub-signals to process. If so, the method 3200 returns to step 3208. If not the method 3200 continues to step 3218. After processing all the audio sub-signals the virtual auditory display system 2302 obtains multiple first processed audio sub-signals and multiple second processed audio sub-signals.

At a step 3218 the virtual auditory display system 2302 generates, based on the multiple first processed audio sub-signals, a first output audio signal for the left ear-worn device, and based on the multiple second processed audio sub-signals, a second output audio signal for the right ear-worn device. The virtual auditory display system 2302 provides the first output audio signal to the first ear-worn device 2302a and the second output audio signal to the second ear-worn device 2302b.

At a step 3220 the first ear-worn device 2302a outputs first sound based on the first output audio signal and the second ear-worn device 2302b outputs second sound based on the second output audio signal. The virtual auditory display system 2302 may thus utilize the method 3200 to provide virtual auditory display sound based on an audio signal that may have multiple audio sub-signals (or channels) that would typically require multiple speakers to produce a surround sound effect. The virtual auditory display system 2302 may provide the virtual auditory display sound to the user using only the first ear-worn device 2302a and the second ear-worn device 2302b.

FIG. 32B depicts a method 3250 of applying digital filters according to some embodiments. The method 3250 includes certain steps that may be generally similar to certain steps of the method 3200. The virtual auditory display system 2302 may perform the method 3250.

The method 3250 begins at a step 3252, where the virtual auditory display system 2302 (for example, the binauralizer 2338) receives a set of one or more first digital filters and a set of one or more second digital filters. At a step 3254 the virtual auditory display system 2302 (for example, the binauralizer 2338) receives an audio signal that has one or more audio sub-signals. Each audio sub-signal of the one or more audio sub-signals is associated with a virtual auditory space location.

At a step 3256 the virtual auditory display system 2302 receives a head orientation of a user. At a step 3258, for each audio sub-signal of the one or more audio sub-signals, the virtual auditory display system 2302 determines, based on the virtual auditory space location and the head orientation, a particular virtual auditory space location. At a step 3260, for each audio sub-signal, the virtual auditory display system 2302 selects, based on the virtual auditory space location or the particular virtual auditory space location, particular one or more first digital filters and particular one or more second digital filters.

At a step 3262, for each audio sub-signal, the virtual auditory display system 2302 applies the particular one or more first digital filters to the audio sub-signal to obtain a first processed audio sub-signal. At a step 3264, for each audio sub-signal, the virtual auditory display system 2302 applies the particular one or more second digital filters to the audio sub-signal to obtain a second processed audio sub-signal.

At a step 3266 the virtual auditory display system 2302 tests to see if there are more audio sub-signals to process. If so, the method 3250 returns to step 3258. If not the method 3200 continues to step 3268. After processing all the audio sub-signals the virtual auditory display system 2302 obtains multiple first processed audio sub-signals and multiple second processed audio sub-signals.

At a step 3268 the virtual auditory display system 2302 generates, based on multiple first processed audio sub-signals, a first output audio signal for a first device, and based on multiple second processed audio sub-signals, a second output audio signal for a second device. The first device may be or include, for example, the first ear-worn device 2302a, and the second device may be or include, for example, the second ear-worn device 2302b. At a step 3270 the virtual auditory display system 2302 provides the first output audio signal to the first device and the second output audio signal to the second device.

FIG. 32C depicts a method 3280 of generating and applying virtual auditory display filters in some embodiments. The generation system 2580 and the virtual auditory display system 2302 may perform the method 3200. The method 3280 begins at a step 3282 where the generation system 2580 (for example, the parameter generation module 2588) may generate a first generally sigmoidal distribution of center frequencies and a second generally sigmoidal distribution of center frequencies. At a step 3284 the generation system 2580 (for example, the parameter mask module 2590) may generate first parameter modifier masks and second parameter modifier masks, including a first notch parameter modifier mask and a second notch parameter modifier mask.

At a step 3286 the generation system 2580 (for example, the filter generation module 2584) may generate a first virtual auditory display filter and a second virtual auditory display filter. The first virtual auditory display filter may include a first set of first functions. One or more first functions, when applied to a first audio signal having a first location in virtual auditory space, may generate a first processed audio signal having a first frequency response with one or more first notches at one or more first center frequencies that are based on the first location. The one or more first notches may have one or more first peak-to-trough depths of at most −10 dB (for example, approximately −30 dB).

The second virtual auditory display filter may include a second set of second functions. One or more second functions, when applied to the first audio signal, may generate a second processed audio signal having a second frequency response with one or more second notches at one or more second center frequencies that are based on the second location. The one or more second notches may have one or more second peak-to-trough depths of at most −10 dB (for example, approximately −30 dB).

At a step 3288 the virtual auditory display system 2302 may receive an audio signal having a second location in the virtual auditory space. For example, the virtual auditory display system 2302 may receive the audio signal from a digital device on which the virtual auditory display system 2302 is executing. At a step 3290 the virtual auditory display system 2302 may receive a head orientation of a user, for example, from the virtual auditory display device 2300 that the user is utilizing.

At a step 3292 the virtual auditory display system 2302 may apply the first virtual auditory display filter, including a first subset of first functions selected based on the second location, to the second audio signal to generate a third processed audio signal having a third frequency response. At a step 3294 the virtual auditory display system 2302 may apply the second virtual auditory display filter, including a second subset of second functions selected based on the second location, to the second audio signal to generate a fourth processed audio signal having a fourth frequency response. At a step 3294 the virtual auditory display system 2302 may provide the first processed audio signal to a first sound output device (for example, the first ear-worn device 2302a) and the second processed audio signal to a second sound output device (for example, the second ear-worn device 2302b).

The virtual auditory display system 2302 may perform step 3288 through step 3294 of the method 3280 while the virtual auditory display system 2302 is receiving an input audio signal that may correspond to, for example, a song file, an audio stream, a podcast, or any other audio.

The method 3200, the method 3250, and the method 3280 may include additional steps not illustrated in FIGS. 32A through 32C. For example, these methods may include a step of the virtual auditory display system 2302 receiving a selection of an acoustic environment and a step of the virtual auditory display system 2302 determining, based on the acoustic environment, a first acoustic environment digital filter and a second acoustic environment digital filter. The acoustic environment may be represented by one or more ambisonic arrays. The virtual auditory display system 2302 may determine the acoustic environment digital filters based on the one or more ambisonics arrays. The virtual auditory display system 2302 may apply the digital filters and the acoustic environment digital filters to obtain the processed audio sub-signals. Other modifications to these methods will be apparent.

FIG. 24C is a block diagram depicting a process 2490 for generating acoustic environment digital filters in some embodiments. A first speaker 2492a and a second speaker 2492b may be in a particular acoustic environment, such as a concert hall, a vehicle, a night club, or the like. Sound output by the first speaker 2492a and the second speaker 2492b are captured by a microphone 2494 and converted into signals. The virtual auditory display system 2302 (for example, the filter generation module 2584) generates one or more ambisonics digital filters 2496 based on the signals. The one or more ambisonics digital filters 2496 are a set of one or more acoustic environment digital filters 2498.

FIG. 24D is a block diagram depicting operations of a spatialization engine 2470 of the virtual auditory display system 2302 in some embodiments. The spatialization engine 2470 may be part of the binauralizer 2338 or a separate component. The spatialization engine 2470 receives a user interface (UI) selected acoustic environment at a block 2472 and determines acoustic environment digital filters based on the selected acoustic environment at a block 2474. The spatialization engine 2470 receives coordinates and the input audio signal of decoded audio objects at a block 2476. At a block 2478 the spatialization engine 2470 matches an index of the acoustic environment digital filters to an input audio signal index. At a block 2480 the spatialization engine 2470 applies a convolution matrix to the output of the block 2478 and the coordinates and the input audio signal.

At a block 2482 the spatialization engine 2470 receives the user head orientation and audio source distance signal. At a block 2484 the spatialization engine performs an ambisonics to binaural conversion based on the output of the block 2480 and the user head orientation and audio source distance signal, by applying digital filters to the audio signals received at a block 2476 based on the locations of the audio signals in virtual auditory space. At a block 2486 the spatialization engine 2470 outputs the audio signal for the left ear and at a block 2488 the spatialization engine 2470 outputs the audio signal for the right ear.

FIGS. 33A and 33B depict an example user interface 3300 for displaying a representation of a virtual audio display in some embodiments. The virtual auditory display system 2302 (for example, the user interface module 2410) may provide the user interface 3300. FIGS. 33A and 33B are described with reference to the virtual auditory display device 2300, but the virtual auditory display system 2302 may provide the user interface 3300 for other devices.

The user interface 3300 includes an icon 3304 labeled “VAD” indicating that the virtual auditory display device 2300 is connected to the virtual auditory display system 2302 and an icon 3302 labeled “IMU” indicating that the IMU-based sensor systems of the virtual auditory display device 2300 are calibrated. The user interface 3300 also includes an encoding representation dropdown 3314 that allows the wearer to select how the virtual auditory display system 2302 should represent audio received by the virtual auditory display system 2302. Example encoding representations are mono (a single audio channel), stereo (two channels of audio), 5.1 5.1 (six channels of audio), 7.1 (eight channels of audio), 7.1.4 (12 channels of audio), and 9.1.6 (16 channels of audio).

The user interface 3300 also includes an acoustic environment dropdown 3316 that allows the wearer to select an acoustic environment in which the virtual auditory display system 2302 should render the virtual auditory display. Example acoustic environments include a dry acoustic environment, a studio acoustic environment, a car acoustic environment, a phone acoustic environment, a club acoustic environment, and a headphone acoustic environment. The virtual auditory display system 2302 may select an acoustic environment digital filter based on the selected acoustic environment and apply the acoustic environment digital filter along with the virtual auditory display filters. The virtual auditory display sounds will sound different for the wearer based on the selected acoustic environment. The user interface 3300 also includes an output volume slider 3322 allowing the wearer to adjust the volume of the sound output by the virtual auditory display device 2300.

The user interface 3300 also includes a representation 3308 of a virtual audio display. In FIG. 33A, the virtual auditory display system 2302 depicts the representation 3308 as a virtual sphere surrounding a head 3312 representing the head of the wearer from a top rear perspective. The user interface 3300 also displays sounds at their locations in virtual auditory space relative to the head of the wearer at corresponding locations relative to the head 3312 on the representation 3308. For example, sounds 3310a are depicted as to the left of, below, and to the rear of the head 3312. This is because the actual sounds corresponding to the sounds 3310a have those locations in virtual auditory space. Sounds 3310b are depicted as above, behind, and slightly to the left of the head 3312. Sounds 3310c are depicted as in front of and to the right of the head 3312. Sounds 3310d are depicted as to the right of, below, and to the rear of the head 3312.

While outputting sounds, the virtual auditory display device 2300 detects head orientations of the wearer and sends the head orientation to the virtual auditory display system 2302. The virtual auditory display system 2302 updates the representation 3308 based on the detected head orientations. The virtual auditory display system 2302 may move the head 3312 and the sounds 3310 based on the detected head orientations.

The user interface 3300 also includes a virtual auditory display representation dropdown 3318 that allows the wearer to select how the virtual auditory display system 2302 provides the virtual auditory display representation. Example virtual auditory display representations include a custom representation (depicted in FIG. 33A), which provides the wearer a top right rear perspective of the representation 3308, a top representation (depicted in FIG. 33B), which provides the wearer a top perspective of the representation 3308 (from the top of the sphere in FIG. 33A), and a back representation, which provides the wearer a rear perspective of the representation 3308 (from the rear of the sphere in FIG. 33A).

The user interface 3300 also includes a location button 3320 which, if selected by the wearer, may cause the virtual auditory display system 2302 to change the representation 3308 such that the location specified by a certain coordinate (for example, zero degrees azimuth, zero degrees elevation) may be directly in front of the head 3312. The user interface 3300 also includes a settings icon 3306 which, if selected by the wearer, may cause the virtual auditory display system 2302 to provide an example user interface for adjusting settings for a virtual audio display.

FIG. 33C depicts an example user interface 3350 for adjusting settings for a virtual audio display in some embodiments. The virtual auditory display system 2302 (for example, the user interface module 2410) may provide the user interface 3350. The user interface 3350 includes an icon 3352 labeled “IMU” indicating that the IMU-based sensor systems of the virtual auditory display device 2300 are calibrated. The user interface 3350 also includes a button 3354 labeled “Recalibrate” that the wearer may select to have the virtual auditory display system 2302 perform the calibration part of the calibration and/or personalization process.

The user interface 3350 also includes an icon 3356 labeled “VAD” indicating that the virtual auditory display device 2300 is connected to the virtual auditory display system 2302, a recommendation 3358 of a virtual auditory display filter, and a button 3360 labeled “Personalize” that the wearer may select to have the virtual auditory display system 2302 perform the personalization part of the calibration and/or personalization process. The user interface 3350 also indicates the spatialization precision estimate of the virtual auditory display of the wearer and a button 3362 labeled “Test” that the wearer may select to have the virtual auditory display system 2302 provide a test procedure for the wearer to allow the wearer to test to see if the wearer can accurately locate virtual auditory display sounds.

The user interface 3350 also includes a group 3364 of icons (labeled “A” through “G”) that indicates the set of virtual auditory display filters that create the virtual auditory display for the wearer. As depicted, the current set of virtual auditory display filters is “VAD C.” The wearer may select a different set of virtual auditory display filters by selecting a different icon in the group 3364. The wearer may then perform the calibration part of the calibration and/or personalization process by selecting the button 3354 and/or perform the personalization part of the calibration and/or personalization process by selecting the button 3360.

The user interface 3350 also allows the wearer to select a custom set of digital filters for the virtual auditory display system 2302 to use to generate the virtual auditory display. The wearer may do so by selecting a button 3368 labeled “Upload,” which allows the wearer to upload a file containing a custom set of digital filters to the virtual auditory display system 2302. The user interface element 3366 may then display the name of the file. This functionality may be desirable for wearers who already have a custom HRTF and want the virtual auditory display system 2302 to utilize the custom HRTF.

FIG. 34 is multiple images 3400 depicting example use cases of virtual auditory display filter technology described in this application in some embodiments. One example use case is for improved virtual surround sound for television or movies using only a pair of speakers, as depicted in image 3402. A group of example use cases relates to producing or listening to music. Image 3410 depicts an example use case of listening to music on headphones. The virtual auditory display filter technology may render music played on headphones as indistinguishable from music played using physical surround sound installations.

Image 3418 depicts the use of virtual auditory display filter technology in virtual monitors to provide noise isolation, sound quality, and virtualization to musicians. Image 3404 depicts the use of the virtual auditory display filter technology to mix music in any acoustic environment. Image 3420 depicts how the virtual auditory display filter technology may provide a listening experience that reinvigorates the music that listeners love for them. Image 3412 depicts using virtual auditory display filter technology in games to provide an immersive gaming experience. virtual auditory display filter technology may allow users to hear sounds emanating from locations that are not shown on users' displays and thus improve users' awareness.

Another group of example use cases relate to military, non-military (for example, first responders such as police and firefighters) and/or other organizational applications. For example, military personnel may use military radio systems to communicate with fellow soldiers, commanders, and other military personnel. The present technology may be utilized in scenarios including military operations, emergency services, aviation, marine and others.

Image 3406 depicts virtual auditory display filter technology providing improved voice pickup and voice display for organizational communications. Image 3414 depicts virtual auditory display filter technology providing augmentation of visual instrumentation with auditory signals in maritime operations. Image 3422 depicts virtual auditory display filter technology providing hyper-realistic virtual audio environments which facilitates virtual training for military and/or non-military personnel.

Image 3408 depicts virtual auditory display filter technology providing audio augmentation for orientation awareness for combat infantry situational awareness. Image 3416 depicts virtual auditory display filter technology providing audio augmentation for orientation awareness for air force orientation control. For example, pilots may use the localization of virtual beacons to assist in situational awareness. Image 3424 depicts virtual auditory display filter technology providing audio augmentation for hyper-situational awareness for unmanned aerial vehicle operations.

Another example use case of virtual auditory display filter technology involves phone calls or video conferences. For example, multiple people may talk at the same time in a phone call or video conference, making it difficult for listeners to focus on the speaker they want to hear, which may lead to confusion and misunderstandings. The present technology allows users to virtually select which talker they want to listen to through the simple movement of a head or other gesture. This attention selection mechanism may help avoid confusion and make meetings more productive.

As another example, air traffic controllers use radio messages to communicate with pilots. The air traffic controllers monitor the position, speed and altitude of aircraft in their assigned airspace visually and by radar and give directions to the pilots by radio. Often, air traffic controllers will need to communicate with multiple pilots simultaneously. Today, these situations requiring multiple pilot communications are addressed by physical switch boards that do not allow for user directed attention selection. The present technology may allow an air traffic controller to use gestures (for example, movement of a head or a hand) or other actions to localize radio communications so that there is seamless attention selection. In a simple example, multiple radio communication signals are statically arranged in unique virtual locations. The air traffic controller then looks at these predefined locations to hear the radio signal. In other examples, the radio communication signals are dynamically updated with the position, speed and altitude of the aircraft.

Other example use cases include virtual auditory display notifications to localize notifications such as voice, text-to-speech messages, email alerts, phone messages or other audio notifications, spatial navigation to use virtual auditory display cues to communicate direction and distance of virtual or real objects, which may also be used for wayfinding or orientation awareness, and spatial ambience to give a user a virtual sound environment that can be mixed with local or virtual sounds (for example, to experience music as if in a concert hall). Other example use cases of virtual auditory display filter technology are possible.

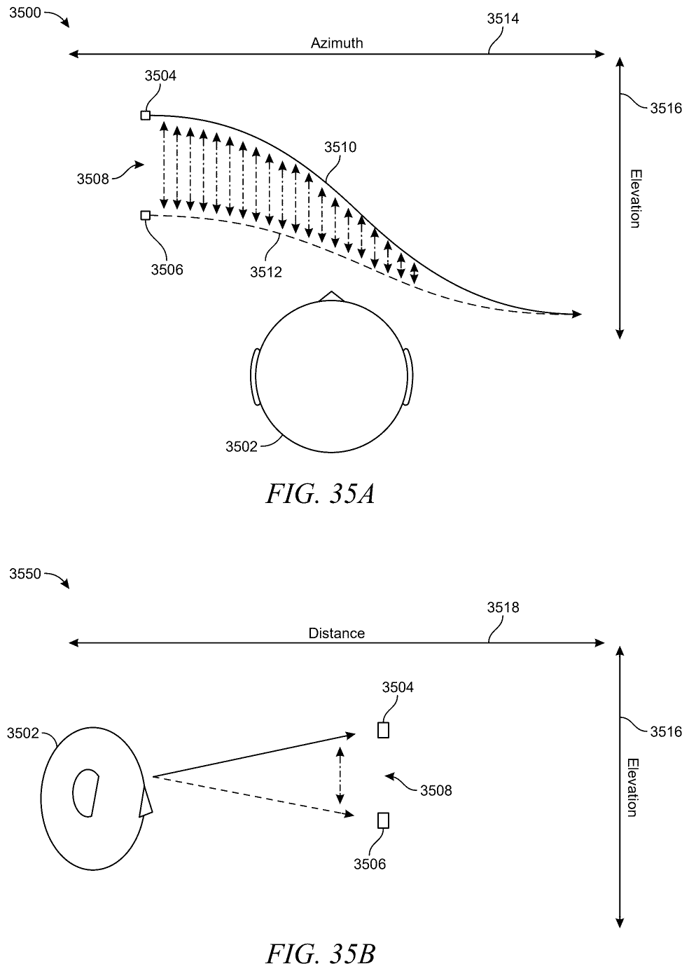

FIGS. 35A and 35B are diagrams of a method of personalizing digital filters in some embodiments that involves providing an action (for example, playing a sound) and detecting a user perception of the action. As described herein, the user may indicate perception of the action in various ways, such as by pointing his or her head, making one or more gestures, indicating where the sound is on a graphical user interface, and the like.

FIG. 35A depicts a view 3500 indicating how the location of a sound in virtual auditory space as indicated by azimuth 3514 and elevation 3516 may be perceived by a user. FIG. 35B depicts a view 3550 indicating how of how the location of a sound in virtual auditory space as indicated by distance 3518 and elevation 3516 may be perceived by a user. In both the view 3500 and the view 3550, the user 3502 is wearing the first ear-worn device 2302a and the second ear-worn device 2302b (not illustrated in FIGS. 35A and 35B). The virtual auditory display system 2302 may provide instructions to the user 3502 to follow a sound in virtual auditory space with the user's head as the user hears the sound. The virtual auditory display system 2302 may then generate audio signals that cause the first ear-worn device 2302a and the second ear-worn device 2302b to output one or more sounds that have a location 3504 in virtual auditory space. As the user 3502 hears the one or more sounds, the user 3502 may point his or her head towards a perceived location 3506 the user perceives the sound to be coming from, which may be different from the location 3504. In pointing his or her head towards the perceived location 3506, it may appear as if the user 3502 is looking in the direction of where the user 3502 perceives the sound to be. Other gestures the user may make with his or her head include nodding, shaking, tilting, and turning. Other head gestures will be apparent.

As the user 3502 moves his or her head to point towards the perceived location 3506 of the one or more sounds, one or both of the first ear-worn device 2302a and the second ear-worn device 2302b (for example, using the IMU sensor system 2452 and/or the magnetometer 2454) may detect a head orientation of the user 3502. The virtual auditory display system 2302 may utilize the detected head orientation to determine the perceived location 3506. The virtual auditory display system 2302 may then determine a delta 3508 between the location 3504 and the perceived location 3506. The virtual auditory display system 2302 may calculate the delta 3508 based on differences between the azimuth 3514 and/or elevation 3516 of the location 3504 and the azimuth 3514 and/or elevation 3516 of the perceived location 3506.

The user 3502 may user other gestures to indicate distance, such as extending an arm a specified amount, and the virtual auditory display system 2302 may use such gestures to determine the delta 3508 based on differences between the distance 3518 of the location 3504 and the distance 3518 of the perceived location 3506.

The virtual auditory display system 2302 may generate audio signals that cause the first ear-worn device 2302a and the second ear-worn device 2302b to output one or more subsequent sounds whose locations in virtual auditory space change, as indicated by solid line 3510. The user 3502 may move his or her head to follow the movement of the one or more subsequent sounds, and the perceived locations of the one or more sounds may change, as indicated by dashed line 3512.

One or both of the first ear-worn device 2302a and the second ear-worn device 2302b may detect subsequent head orientations of the user 3502 as he or she moves his or her head. The virtual auditory display system 2302 may utilize the detected subsequent head orientations to determine perceived locations of the one or more subsequent sounds. The virtual auditory display system 2302 may then determine one or more subsequent deltas between the location of the one or more subsequent sounds and the perceived locations of the one or more subsequent sounds.

The virtual auditory display system 2302 may store the deltas that the virtual auditory display system 2302 determines and utilize the deltas to modify the digital filters so as to cause the user 3502 to perceive the location of sounds in virtual auditory space to be closer to the actual locations in virtual auditory space. In some embodiments, the virtual auditory display system 2302 modifies the digital filters by selecting a different set of digital filters that the virtual auditory display system 2302 determines will reduce or minimize the deltas for the user 3502. The virtual auditory display system 2302 may then use the different set of digital filters for the user 3502.

In some embodiments, the virtual auditory display system 2302 modifies the parameters of the digital filters. For example, the virtual auditory display system 2302 may modify parameters such as center frequencies, gains, and/or q's. For example, the user 3502 may have an elevation delta of several degrees. The virtual auditory display system 2302 may modify the center frequency of a notch, a pair of notches, or a group of notches (see, for example, FIG. 28B) to modify the elevation of a virtual sound object and thereby reduce the elevation delta. The virtual auditory display system 2302 may then utilize the modified digital filters during real-time audio playback.

The virtual auditory display system 2302 may repeat the personalization procedure one or more times until the virtual auditory display system 2302 determines that the deltas are within certain ranges or thresholds.

In some embodiments, the virtual auditory display system 2302 and/or other devices may capture other actions that the user may make in response to the user hearing a sound in virtual auditory space to indicate where the user perceives the location of the sound to be. Example actions may include vocal responses by the user, gestures by the user using parts of the user's body other than the user's head (for example, pointing with a finger or an arm of the user, waving, clapping, tapping and hand signals). Such actions may be captured by a device connected to the virtual auditory display system 2302, such as a microphone, camera or a motion sensing device.

Other example actions include the user indicating the perceived location of the sound using a graphical user interface and/or user input devices of a digital device such as a phone, tablet or laptop or desktop computer. For example, the virtual auditory display system 2302 may provide a graphical user interface that graphically represents virtual auditory space for the user, and the user may utilize an input device (mouse, keyboard, touchscreen, and/or voice command) to indicate the perceived location of the sound on the graphical representation of the virtual auditory space. It will be appreciated that there are various methods to capture user actions in response to the user perception of the location of the sound, and that the virtual auditory display system 2302, optionally in cooperation with other devices, may utilize the various methods.

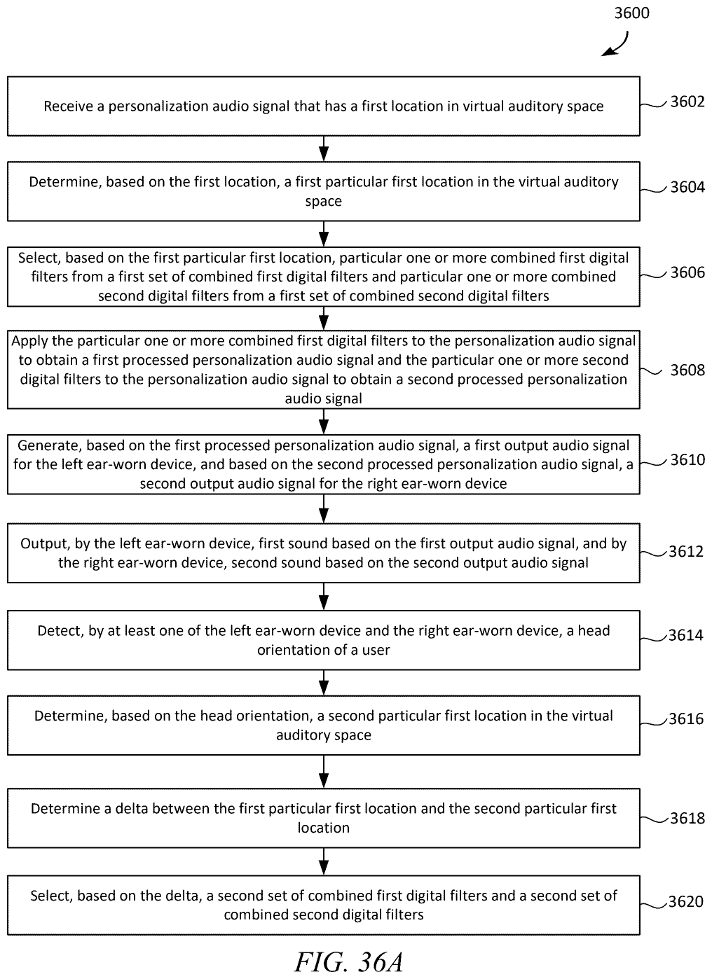

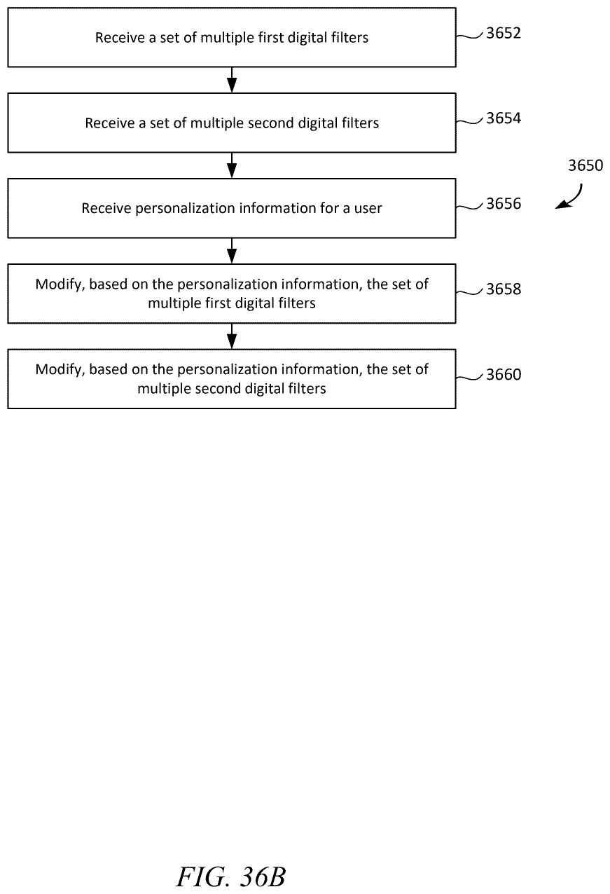

FIG. 36A depicts a method 3600 of personalizing digital filters in some embodiments. The virtual auditory display system 2302 may perform the method 3600. The method 3600 begins at a step 3602 where the virtual auditory display system 2302 (for example, the binauralizer 2338) receives a personalization audio signal that has a first location in virtual auditory space. At a step 3604 the virtual auditory display system 2302 (for example, the binauralizer 2338) determines, based on the first location, a first particular first location in the virtual auditory space.

At a step 3606 the virtual auditory display system 2302 selects, based on the first particular first location, particular one or more combined first digital filters from a first set of combined first digital filters and particular one or more combined second digital filters from a first set of combined second digital filters.

At a step 3608 the virtual auditory display system 2302 applies the particular one or more combined first digital filters to the personalization audio signal to obtain a first processed personalization audio signal and the particular one or more combined second digital filters to the personalization audio signal to obtain a second processed personalization audio signal.

At a step 3610 the virtual auditory display system 2302 generates, based on the first processed personalization audio signal, a first output audio signal for a left ear-worn device, and based on the second processed personalization audio signal, a second output audio signal for a right ear-worn device. At a step 3612 the left ear-worn device outputs first sound based on the first output audio signal and the right ear-worn device outputs second sound based on the second output audio signal.

At a step 3614 one or both of the left ear-worn device and the right ear-worn device detects a head orientation of a user wearing the left ear-worn device and the right ear-worn device. At a step 3616 the virtual auditory display system 2302 determines, based on the head orientation, a second particular first location in the virtual auditory space.

At a step 3618 the virtual auditory display system 2302 determines a delta between the first particular first location and the second particular first location. At a step 3620 the virtual auditory display system 2302 selects, based on the delta, a second set of combined first digital filters and a second set of combined second digital filters. The virtual auditory display system 2302 may use the second set of combined first digital filters and the second set of combined second digital filters while receiving a subsequent input audio signal.

FIG. 36B depicts a method 3650 of personalizing digital filters in some embodiments. The method 3650 includes certain steps that may be generally similar to certain steps of the method 3600. The virtual auditory display system 2302 (for example, various components of the virtual auditory display system 2302) may perform the method 3650.

At a step 3652 the virtual auditory display system 2302 receives a set of multiple first digital filters. At a step 3654 the virtual auditory display system 2302 receives a set of multiple second digital filters. There are one or more first digital filters and one or more second digital filters generated for each of multiple virtual auditory space locations.

At a step 3656 the virtual auditory display system 2302 receives personalization information for a user. Personalization information may include user-directed action or perception of acoustic cues, acoustic quality information, user anatomical measurements, user demographic information, and/or user audiometric measurements.

At a step 3658 the virtual auditory display system 2302 modifies, based on the personalization information for the user, the set of multiple first digital filters. At a step 3660 the virtual auditory display system 2302 modifies, based on the personalization information for the user, the set of multiple second digital filters.

In some embodiments, modifying, based on the personalization information, the set of multiple first digital filters includes modifying one or more first center frequencies of the multiple first digital filters. Moreover, modifying, based on the personalization information, the set of multiple second digital filters includes modifying one or more second center frequencies of the multiple second digital filters.

In some embodiments, modifying, based on the personalization information, the set of multiple first digital filters includes selecting a different set of multiple first digital filters. Further, modifying, based on the personalization information, the set of multiple second digital filters includes selecting a different set of multiple second digital filters.

The virtual auditory display system 2302 may provide a calibration and/or personalization process that allows a wearer of a virtual auditory display device to calibrate the virtual auditory display device and/or to personalize a virtual auditory display provided by the virtual auditory display device.

The calibration and/or personalization process may include a calibration part and a personalization part. The virtual auditory display device may include an inertial measurement unit (IMU). Calibrating the virtual auditory display device may refer to calibrating the IMU. Personalizing the virtual auditory display may refer to selecting a set of virtual auditory display filters for the wearer and/or modifying an existing set of virtual auditory display filters so that the virtual auditory display provided by the virtual auditory display device is customized to the wearer. The virtual auditory display system 2302 may allow the wearer to perform both the calibration part and the personalization part of the calibration and/or personalization process, just the calibration part, or just the personalization part.

FIGS. 37A through 37C depict an example user interface 3700 for calibrating a virtual auditory display device in some embodiments. The virtual auditory display device may be the virtual auditory display device 2300 which includes the first ear-worn device 2302a and the second ear-worn device 2302b. FIGS. 37A through 37F are described with reference to the virtual auditory display device 2300, but other virtual auditory display devices may be calibrated and/or personalized.

The virtual auditory display system 2302 (for example, the user interface module 2410) may provide the user interface 3700. The wearer may start a calibration and/or personalization process by selecting a button labeled “Start” (not shown in FIGS. 37A through 37C) displayed by the virtual auditory display system 2302. FIG. 37A depicts the user interface 3700 providing a user interface element 3702 indicating the point in the calibration part of the calibration and/or personalization process at which the wearer is, and instructions 3704 for the wearer.

FIG. 37B depicts the user interface 3700 providing a first circle 3706a and a second circle 3706b. The virtual auditory display system 2302 may cause the first circle 3706a and/or the second circle 3706b to move up and down on the user interface 3700 and instruct the wearer to nod their head up and down to follow the first circle 3706a and the second circle 3706b.

FIG. 37C depicts the user interface 3700 providing a circle 3708. The virtual auditory display system 2302 may cause the circle 3708 to move up and down on the user interface 3700 and instruct the wearer to nod their head up and down to follow the circle 3708. Additionally or alternatively, the virtual auditory display system 2302 may cause the circle 3708 to move from side to side on the user interface 3700 and instruct the wearer to move their head from side to side to follow the circle 3708.

While the virtual auditory display system 2302 performs the calibration part of the calibration and/or personalization process, the virtual auditory display system 2302 may receive detections of head orientations of the head of the wearer from the virtual auditory display device 2300 based on data obtained from the IMU-based sensor system and/or other sensors of the first ear-worn device 2302a and/or the second ear-worn device 2302b. The virtual auditory display system 2302 may use the detections of head orientations and other factors, such as a known or estimated distance from a display providing the user interface 3700, a width and height of the display, positions of the first circle 3706a, the second circle 3706b, and/or the circle 3708, and/or other data from the IMU-based sensor system to calibrate the IMU-based sensor system.

FIGS. 37D through 37F depict an example user interface 3750 for personalizing a virtual auditory display provided by a virtual auditory display device in some embodiments. The virtual auditory display system 2302 (for example, the user interface module 2410) may provide the user interface 3750.

The wearer of the virtual auditory display device 2300 may start the personalization part of the calibration and/or personalization process after completing the calibration part. The virtual auditory display system 2302 may cause the virtual auditory display device 2300 to play sounds at several locations (for example, five locations). The sounds may include, for example, sounds produced by objects that appear to the wearer as moving around his or her head, such as airplanes, helicopters, birds, and other flying creatures. FIG. 37D depicts the user interface 3750 providing instructions 3754 instructing the wearer to point their nose at the source of each sound as the virtual auditory display device 2300 plays the sound. The wearer may begin the personalization part of the calibration and/or personalization process by selecting the button 3756 labeled “Continue.”

FIG. 37E depicts the user interface 3750 providing a user interface element 3752 indicating the point in the personalization part of the calibration and/or personalization process at which the wearer is, and the instructions 3754. FIG. 37F depicts the user interface 3750 with the user interface element 3752 indicating that the wearer has located a sound that the virtual auditory display device 2300 played at a first location. The virtual auditory display system 2302 may cause the virtual auditory display device 2300 to play sounds at subsequent locations and update the user interface 3750 accordingly.

While the virtual auditory display system 2302 performs the personalization part of the calibration and/or personalization process, the virtual auditory display system 2302 may receive detections of head orientations of the head of the wearer from the virtual auditory display device 2300 based on data obtained from the IMU-based sensor system and/or other sensors of the first ear-worn device 2302a and/or the second ear-worn device 2302b. The virtual auditory display system 2302 may use the detections of head orientations and the locations of the sounds generated by the virtual auditory display system 2302 to calculate one or more deltas, as described with reference to, for example, FIGS. 35A and 35B. The virtual auditory display system 2302 may use the calculated one or more deltas to select a set of virtual auditory display filters and estimate a spatialization precision of the virtual auditory display for the wearer.

FIGS. 37G through 37J depict an example user interface 3770 for providing information on calibration of a virtual auditory display device and personalization of a virtual auditory display of the virtual auditory display device in some embodiments. The user interface 3770 includes a recommendation 3772 of a set of virtual auditory display filters. In some embodiments, as described herein with reference to, for example, FIGS. 35A and 35B, the virtual auditory display system 2302 may select a set of virtual auditory display filters from among multiple sets of virtual auditory display filters based on the results of the calibration and/or personalization process. The user interface 3770 also includes an estimate 3774 of a spatialization precision of the virtual auditory display for the wearer.

The virtual auditory display system 2302 may categorize the spatialization precision of the virtual auditory display for the wearer based on the estimate 3774, such as “Very Good” (FIG. 37G), “Medium” (FIG. 37H), and “Poor” (FIG. 37I). The virtual auditory display system 2302 may provide recommendations to redo the calibration part and/or the personalization part of the calibration and/or personalization process and/or to use custom filters. The user interface 3770 also includes a button 3776 labeled “Continue” that the wearer may select to return to the user interface 3300 depicted in FIGS. 33A and 33B.

Although the virtual auditory display system 2302 is described as using circles, the virtual auditory display system 2302 may utilize other visual user interface elements in the calibration and/or personalization process. Furthermore, although the virtual auditory display system 2302 is described as receiving detections of head orientations from the virtual auditory display device 2300 in the calibration and/or personalization process, the virtual auditory display system 2302 may receive detections of head orientations from other devices connected to the virtual auditory display system 2302, such as cameras, motion sensing devices, virtual reality headsets, and the like.

One advantage of the calibration and/or personalization process is that the virtual auditory display system 2302 may personalize a set of virtual auditory display filters for a wide range of individuals. The virtual auditory display system 2302 may personalize the set of virtual auditory display filters by modifying the set of virtual auditory display filters. The virtual auditory display system 2302 may have pre-configured multiple sets of virtual auditory display filters and may modify the set of virtual auditory display filters by selecting a different set of virtual auditory display filters based on the results of the calibration and/or personalization process for a user.

Additionally or alternatively, the virtual auditory display system 2302 may modify the set of virtual auditory display filters by modifying the digital filters or functions included in the set of virtual auditory display filters. For example, where the set of virtual auditory display filters includes digital filters, the virtual auditory display system 2302 may modify parameters of the digital filters, such as the center frequencies, gains, q's, algorithm type, or other parameters based on the results of the calibration and/or personalization process for a user.

Personalization of virtual auditory display filters allows a wide range of individuals to experience immersive, accurately rendered sound in a virtual auditory space. Moreover, such individuals would not have to have HRTFs generated for them using potentially difficult and/or unreliable physical measurement procedures. Such individuals could obtain a personalized set of virtual auditory display filters simply by having the virtual auditory display system 2302 perform the calibration and/or personalization process for them. The modification of virtual auditory display filters may be performed at an initial setup procedure for the person and at any subsequent point during the person's use of the virtual auditory display system 2302 and/or virtual auditory display device 2300.

One advantage of virtual auditory display filters is that sounds in far more locations in virtual auditory space may be rendered in comparison to existing technologies. For example, a 9.1.6 configuration has 16 virtual speakers and thus may be limited to accurately rendering sounds for only those 16 virtual speaker locations. Such configurations may render sounds from other locations by smearing sounds from virtual speaker locations to represent the other locations, but such artifacts may be noticeable to listeners.

In contrast, virtual auditory display filters may be able to render sound at far more locations. For example, using locations at one degree increments of azimuth and elevation results in 65,160 locations. However, the described technology may generate virtual auditory display filters at smaller increments, resulting in even more locations at which the virtual auditory display filters may render sound. Moreover, typical approaches render sound at a modeled distance of 1 m from a center point representing the listener. The described technology may generate virtual auditory display filters for any number of distances from the center point. Accordingly, the described technology may accurately render sounds at varying distances.

One advantage of the described technology is that the described technology accurately renders virtual auditory display sound in virtual auditory space, meaning that sound is perceived by a listener as coming from the location that the creator of the sound intended for the sound. Another advantage of the described technology is that the described technology may be utilized with any ear-worn device, such as headphones, headset, and earbuds. Another advantage is that the virtual auditory display sound is high-quality and clear. Another advantage is the described technology may emphasize or deemphasize sounds in certain regions or locations of virtual auditory space so as to focus a listener's attention on those certain regions or locations. Such an approach may increase the listener's hearing abilities and allow the listener to hear sounds that the listener would not otherwise hear.

Another advantage of the described technology is that any digital device with suitable storage and processing power may store and apply the virtual auditory display filters. As described herein, a general purpose computing device such as a laptop or desktop computer may store and apply the virtual auditory display filters to audio signals to generate processed audio signals. The laptop or desktop computer may then send the processed audio signals to ear-worn devices to generate sound based on the processed audio signals. Similarly, a digital device such as a phone, tablet, or a virtual reality headset may store and apply the virtual auditory display filters to audio signals to generate processed audio signals and send the processed audio signals to ear-worn devices.

Additionally or alternatively, ear-worn devices, such as the virtual auditory display device 2300 described herein, may store and apply the virtual auditory display filters. The ear-worn devices may receive an input audio signal from, for example, a digital device with which the ear-worn devices are paired such as a phone or tablet, or from a cloud-based service. The ear-worn devices may apply the stored virtual auditory display filters to the input audio signal to generate processed audio signals and output virtual auditory display sound based on the processed audio signals. Another example is that a cloud-based service may store and apply the virtual auditory display filters to generate processed audio signals and send the processed audio signals to ear-worn devices. Other advantages will be apparent.

### Auditory User Interfaces

Described herein are auditory user interfaces that provide context-aware auditory experiences and facilitate audio interactions, such as audio interactions with artificial intelligence agents or other applications. An auditory operating system may implement the auditory user interface. The auditory operating system may have a multi-agent architecture in which multiple specialized agents perform tasks within their respective domains. The auditory operating system may include an auditory operating system shell that serves as the primary interface for user interactions with the multiple specialized agents. The auditory operating system shell may control and monitor the multiple specialized agents.

When the user of an auditory user interface speaks a command or query, the auditory operating system shell may receive the user input. The auditory operating system shell may utilize natural language processing (NLP) to identify the domain or agent type required to respond to the user command or query. Each agent may handle one domain (for example, music streaming, scheduling, home automation). The auditory operating system shell may select an agent based on the identified domain or agent type. The auditory operating system shell may provide relevant task details to the selected agent.

Agents may have controlled access to application programming interfaces (APIs) or hardware components of user devices. The auditory operating system shell may enforce boundaries on an agent's access to data and system privileges to maintain user privacy and device stability. The auditory operating system shell may provide global context management. If a user switches domains mid-conversation, the auditory operating system shell may preserve the relevant context. The auditory operating system shell may provide seamless handoffs from one agent to another agent. If a user request evolves from one domain to another (for example, from playing music to checking the artist's tour schedule), the auditory operating system shell may transition between specialized agents without losing continuity.

The auditory operating system shell may provide a unified user experience with a single entry point. Users may not be required to memorize separate wake words or skill names to invoke agents. In some cases, users may simply address the auditory operating system shell. Additionally or alternatively, the auditory operating system shell may determine, based on analysis of the content of the user's speech or from the context, that the user is addressing the auditory operating system shell. The auditory operating system shell may then orchestrate the best-suited agent to respond to the user's command or query. The auditory operating system shell may also standardize response formatting to ensure an integrated and cohesive style of replies, whether from a music agent, a weather agent, or another agent.

Certain user devices may implement spatial audio, which may also be referred to as spatial sound, three-dimensional (3D) audio or 3D sound. For such user devices, the auditory operating system shell may implement a spatial audio framework for agents. The auditory operating system shell may grant each agent a distinct virtual position relative to the user. Through advanced audio rendering, the auditory operating system shell may precisely simulate direction and distance cues for each agent's voice. The placement of each agent may be configurable and may be continuously updated based on factors such as interaction context, user movements, head orientation, environmental factors, and agent identity and role.

For example, if one agent is presenting essential guidance (for example, navigation instructions), the auditory operating system shell may move the agent closer or to a prominent location, while secondary agents remain in the periphery. As another example, as the user turns or changes position, the agents' virtual locations update accordingly, thereby reinforcing the sensation of their presence in a shared space. As another example, different voices or functionalities can be consistently associated with specific directions or distances to enhance recognition and reduce cognitive load.

The auditory operating system shell may integrate real-time user tracking, head position/orientation sensors, and audio rendering algorithms to dynamically adapt the agents' positions so that they appear to emanate from realistic, stable points in the auditory scene. This may not only improve realism but may also foster a sense of distinct entity presence, enabling users to localize and differentiate multiple agent voices in a seamless manner.

For devices that implement spatial audio, the auditory operating system shell may fuse real-world audio with digital content. The auditory operating system shell may utilize spatial audio rendering, environmental noise adaptation, and selective sound filtration to enable users to maintain or enhance their environmental awareness while also listening to digital audio. The auditory operating system shell may implement dynamic spatial audio rendering by positioning in virtual auditory space sounds in the user's perceived soundfield to avoid confusing overlap with real-world audio. The auditory operating system shell may also implement environmental noise adaptation through adaptive volume control and real-time equalization. The auditory operating system shell may continuously monitor the ambient sound profile and adjust digital audio parameters to harmonize or contrast with real-world acoustics.

The auditory operating system shell may implement selective sound filtration by a hear-through mode, in which the auditory operating system shell selectively filters or attenuates specific frequencies of external noises. The auditory operating system shell may let safety-critical sounds (for example, sirens, alarms) remain audible while reducing less relevant background chatter. The auditory operating system shell may allow users to define which real-world sounds are essential (for example, traffic signals, coworker's voice) and let the auditory operating system shell maintain those audio cues in the mix.

The auditory operating system shell may implement personalized control and interfaces through user preferences and gesture or voice commands. The auditory operating system shell may provide customizable settings that let individuals modify the degree of environmental blending or digital audio emphasis. The auditory operating system shell may also allow for quick on-the-fly adjustments through gestures or voice commands to allow users to switch modes (for example, silent, ambient emphasis, or fully immersive) without removing devices. By integrating and enhancing the natural soundscape, users can stay aware of their surroundings while enjoying digital audio experiences.

An agent may refer to a computational system, software module, or device—whether standalone or embedded—that is capable of autonomous perception, decision-making, learning, or interaction with digital or physical environments, including interaction with human users via text, speech, gesture, or other input modalities. An agent may utilize artificial intelligence techniques, such as machine learning, rule-based reasoning, or statistical inference, to generate outputs in response to inputs, prompts, or environmental stimuli. As used herein, an agent may also be referred to as an artificial intelligence agent, a synthetic intelligence agent, a digital assistant, a voice assistant, an artificial agent, or as an assistant.

The following description provides more details regarding auditory user interfaces, the auditory operating system, and the auditory operating system shell.

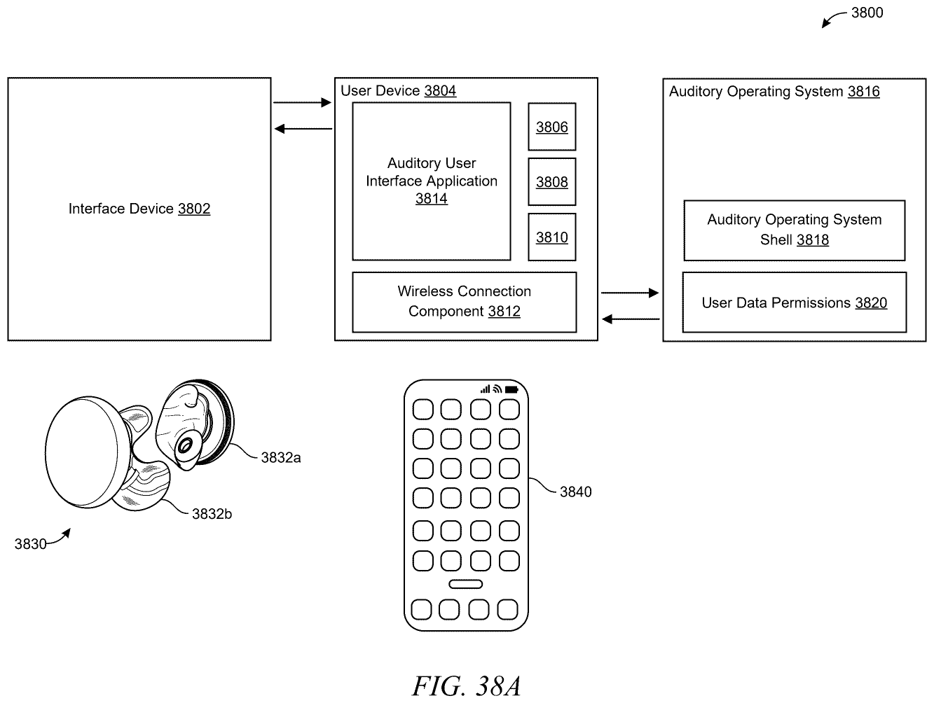

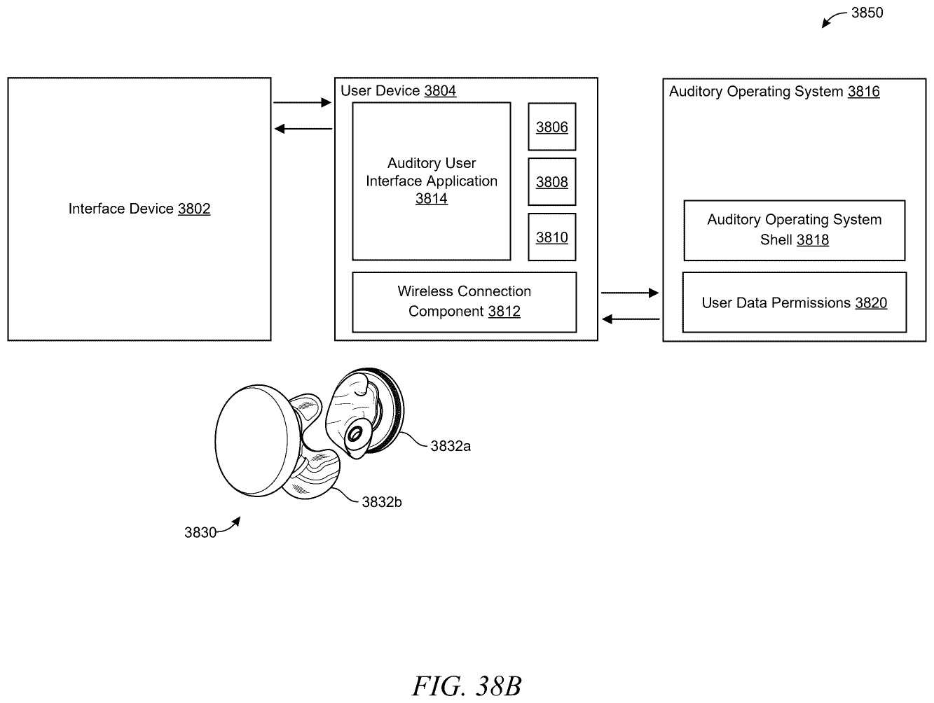

FIG. 38A depicts an example configuration 3800 for implementing an auditory user interface in some embodiments. The configuration 3800 includes an interface device 3802, a user device 3804, and an auditory operating system 3816. Each of the interface device 3802, the user device 3804, and the auditory operating system 3816 may be or include any number of digital devices. A digital device is any device with at least one processor and memory. Digital devices are discussed further herein, for example, with reference to FIG. 48.

The interface device 3802 may include one or more one or microphones or other devices configured to capture sounds or vibrations, such as speech of a user or environmental noise, and one or more sound output devices configured to output sounds or vibrations. The interface device 3802 may also include other components or modules configured to provide or enable other functionality, such as wireless connection components that allow the interface device 3802 to wirelessly connect to other systems or devices, such as the user device 3804 (for example, using a Bluetooth Low Energy (BLE) connection).

The user device 3804 may include memory 3806, such as flash memory, one or more GPS components 3808, one or more processors 3810 (for example, one or more digital signal processors (DSPs)), one or more wireless connection components 3812 that enable the user device 3804 to connect wirelessly to other devices or systems, an auditory user interface application 3814 that may enable interaction with the user device 3804, the interface device 3802, or the auditory operating system 3816, and other components or modules configured to provide or enable other functionality.

The auditory operating system 3816 may include an auditory operating system shell 3818, user data permissions 3820, and other components or modules configured to provide or enable other functionality, such as connection components that allow the interface device 3802 to connect to other systems or devices, such as the user device 3804. The auditory operating system shell 3818 may be considered as a device-level or system-level audio user interface through which a user interacts with the auditory operating system 3816. During usage of the interface device 3802 or the user device 3804, the auditory operating system shell 3818 may always be listening (unless deactivated by the user) for conversation cues to trigger actions, such as to bring up a particular application or agent or to access system settings.

As described in more detail herein, the auditory operating system shell 3818 may coordinate, control, monitor, or interact with one or more machine learning or artificial intelligence systems. A machine learning or artificial intelligence system may be or include one or more machine learning or artificial intelligence models, such as speech-to-text models such as acoustic models or language models, large language models, or other models that receive an input and provide an output based on the input or that are applied to data to process the data and provide a result. A machine learning or artificial intelligence system may also be or include one or more artificial intelligence agents that utilize machine learning or artificial intelligence models or reasoning techniques to provide output, such as output in response to an input or a prompt. An artificial intelligence agent may be referred to herein as a digital assistant, a voice assistant, as an artificial agent, or as an agent or an assistant. The auditory operating system shell 3818 may also coordinate, control, monitor, or interact with non-machine learning or artificial intelligence systems, such as music services.

The auditory operating system 3816 may be or include one or more devices or servers, such as one or more servers operated on-premises of an entity operating the auditory operating system 3816 or off-premises at a facility operated by another entity, or in other configurations, such as a mixture of on-premises and off-premises. Although the configuration 3800 depicts a single one of the auditory operating system 3816, it is to be understood that there may be multiple auditory operating systems 3816.

The interface device 3802 may interface with a user or wearer of the interface device 3802 and provide privacy, security, and portability. The interface device 3802 may detect voice input from the user or wearer, provide natural language output, and may provide or facilitate additional functionality. The user device 3804 may connect to the Internet or other networks, store data, and provide secondary processing functionality. In addition, the user device 3804 may provide location information, an additional user interface, such as a screen, and may provide or facilitate additional functionality. The auditory operating system 3816 may provide primary processing functionality, may utilize or interact with machine learning or artificial intelligence systems, such as artificial intelligence agents, and may utilize or interact with application programming interfaces (APIs), utilize or interact with tools, data or services, and may provide or facilitate additional functionality.

As described in more detail herein, the interface device 3802, the user device 3804, and the auditory operating system 3816 may cooperate to provide an auditory user interface for a user or wearer of the interface device 3802. The auditory user interface may provide for or facilitate functionality including device control by user voice input, augmented contextual audio such as hearing applications, services utilizing conversational agents such as conversation applications, audio applications such as music or podcast applications, and other location-based or augmented reality experiences.

FIG. 38A also depicts an audio computing device 3830 that may be or function as the interface device 3802 in some embodiments. The audio computing device 3830 includes a first ear-worn device 3832a and a second ear-worn device 3832b. The first ear-worn device 3832a is for a left ear of a wearer and the second ear-worn device 3832b is for a right ear of the wearer. Each of the first ear-worn device 3832a and the second ear-worn device 3832b has a three-part configuration: an electronics package that includes electronics components, such as an array of microphones, an acoustic package that includes analog components such as one or more sound output devices, and an ear interface configured to be inserted into an ear of the wearer. U.S. Patent Application Publication No. 2024/0334112, titled “VIRTUAL AUDITORY DISPLAY DEVICES AND ASSOCIATED SYSTEMS, METHODS, AND DEVICES” and filed Mar. 29, 2024, describes the audio computing device 3830 in more detail, and is incorporated in its entirety herein by reference.

The array of microphones in the electronics package may capture ambient sound from substantially all directions (for example, providing substantially 4060° or spherical coverage) which enables context-sensitive input (for example, detecting a location of the wearer, environmental cues, or interactions with other speakers). The audio computing device 3830 may utilize algorithms to localize and interpret sound sources to facilitate responses to input and real-time adjustments. The array of microphones may also capture speech of the wearer. The audio computing device 3830 may perform beamforming with the array of microphones to isolate the speech from environmental noise.

The audio computing device 3830 also may include other components, such as one or more in-canal microphones in the acoustic package that may capture speech of the wearer in the ear canal. Other components may include electronics package components such as one or more global positioning system (GPS) components that may be utilized to determine a location of the audio computing device 3830, one or more inertial measurement unit (IMU)-based sensor systems (which may be referred to as an IMU) that may be utilized to determine user orientation, velocity, or acceleration, one or more magnetometers, one or more microcontrollers, one or more digital signal processors (DSPs), one or more memories, and one or more other sensors that may be utilized to determine if the audio computing device 3830 is being worn by the wearer.

The electronics package may be rotatable relative to the acoustic package. The audio computing device 3830 may thus provide a rotatable user interface for the wearer. The wearer may rotate the electronics package to cause the audio computing device 3830 to perform certain functions, such as to adjust a sound volume. In addition, the audio computing device 3830 may allow the wearer to interact with the audio computing device 3830 in other ways. For example, the audio computing device 3830 may allow the following interactions: a single tap on the electronics package may shut down any manipulations to the user's auditory stream to allow full passthrough of environmental noise (which may be referred to as presence); a double tap on the electronics package may enable or re-enable audio output manipulations (which may be referred to as immersion); and a tap and hold on the electronics package may activate or deactivate audio input through the one or more in-canal microphones and the array of microphones. Some embodiments of the audio computing device 3830 may include physical buttons or capacitive sensors and thus permit additional interactions.

The audio computing device 3830 may implement a virtual auditory display (VAD) that provides a virtual three-dimensional (3D) sound environment in which a person may perceive a sound as emanating from any location in the virtual 3D sound environment. The virtual 3D sound environment may be referred to as virtual auditory space. The VAD may allow the audio computing device 3830 to generate the perception that voices, such as agent voices, alerts, such as notifications, or other audio elements are coming from specific directions in the wearer's environment. Additionally or alternatively, the audio computing device 3830 may change the volume, timbre, or position of audio cues to match user context, personal preferences, or environmental changes, such as background noise. For example, the audio computing device 3830 may lower certain background sounds, convert certain unpleasant sounds into pleasant auditory experiences, and augment the audio scene with virtual sound objects. The audio computing device 3830 may allow the wearer to experience a seamless, screen-free interface, supporting hands-free, eyes-free operation in a wide array of scenarios.

Certain aspects of the technology described herein may be described as implemented by or in the audio computing device 3830. The input components (for example the spatial array of microphones, the one or more in-canal microphones, and the GPS), the output components (for example, the VAD), and the software of the audio computing device 3830 may enable or provide certain functionality or user experiences that other devices may not be capable of providing. For example, the audio computing device 3830 may superimpose sound objects in an auditory scene of a wearer to provide immersive sound experiences for the user. As another example, the audio computing device 3830 may, due to the acoustically sealed fit provided by the ear interface, allow for full or near-full ear occlusion, thereby assisting in reducing or eliminating environmental noises. The audio computing device 3830 may, for example, allow for full or partial contextual audio pass-through, such as in response to user input, so as to allow the user to hear their surroundings. Certain aspects of the technology described herein may be implemented by or in other types of devices, such as earbuds, headsets, and mobile phones. FIG. 38A also depicts a mobile phone 3840 as an example of the user device 3804 in some embodiments.

FIG. 38B depicts another example configuration 3850 for implementing an auditory user interface according to some embodiments. The example configuration 3850 may be generally similar to the example configuration 3800 of FIG. 38A. One difference is that in the example configuration 3850, the audio computing device 3830 may be or function as both the interface device 3802 and the user device 3804 in some embodiments.

Other examples of devices that may function as the interface device 3802, the user device 3804, or both the interface device 3802 and the user device 3804 include wearable devices such as headsets, headphones, earbuds, augmented reality or virtual reality headsets or augmented reality or mixed reality glasses, watches, pins, rings, clips, or necklaces, home devices such as appliances, home audio, or home automation devices, vehicle infotainment systems, mobile devices such as tablets or laptops, non-mobile devices such as desktop computers. Accordingly, the technology is not necessarily limited to being embodied in the audio computing device 3830 or in the mobile phone 3840.

### Auditory Operating System and Auditory Operating System Shell

As previously noted, the auditory operating system shell 3818 may be considered as a device-level or system-level audio user interface through which a user interacts with the auditory operating system 3816. The auditory operating system 3816 and the auditory operating system shell 3818 may be implemented in a wide range of computing devices, including wearable devices such as the interface device 3802, user computing devices such as the user device 3804, and other devices or systems, including smart speakers, Internet of Things (IoT) devices, automotive or other vehicle systems, laptops or desktops, AR or VR headsets. During usage of the interface device 3802 or the user device 3804, the auditory operating system shell 3818 may always be listening (unless deactivated by the user) for conversation cues to trigger actions, such as to bring up a particular application or agent or to access system settings. The auditory operating system shell 3818 may have system privileges, up to and including full root access where available and necessary, to perform various functions, such as adding or removing applications or agents, setting or modifying application or agent permissions in the user data permissions 3820, controlling access of applications or agents to user data, and generating, modifying, or otherwise controlling audio streams that are sent to the user device 3804 or the interface device 3802 for the user. In some embodiments, the auditory operating system shell 3818 responds to a keyword, (for example, “Shell”), but in other cases the auditory operating system shell 3818 may respond based on the content of the input provided by the user.

The auditory operating system 3816 and the auditory operating system shell 3818 follow a multi-agent model and allow users to interact with multiple agents. In some embodiments, each agent has a specific domain (for example, music, messaging, scheduling) and handles tasks within that domain. Each agent can be wrapped in its own conversational interface and intentionally invoked by the user (for example “Shell, load the music app.”). Allowing multiple agents evokes a familiar paradigm for users, who are used to conversational interactions with individual persons. Another advantage of a multi-agent system is that third party developers may develop agents for use with the auditory operating system 3816 and the auditory operating system shell 3818.

For devices that support spatial audio, such as the audio computing device 3830, the auditory operating system shell 3818 can precisely position where a sound object, notification, application or agent is relative to the center of the user's head. As human perception tends to exist on the horizon line, the auditory operating system shell 3818 may utilize spatial audio positions perceived as “inside a user's head” or directly above or below those positions for privileged information (for example, the auditory operating system shell 3818 or critical alerts). The auditory operating system shell 3818 may use distance as an analog to priority. For example, the auditory operating system shell 3818 may place higher priority audio streams closer to the user's head than lower priority audio streams. The auditory operating system shell 3818 may use other ways to indicate priority, such as by using narrower or broader spatial locations, different modes of audio (for example, earcons or agent conversation), or may process audio streams to indicate priority, such as by EQ filtering the audio stream.

The auditory operating system shell 3818 may offload tasks. Rather than have the user directly control every step of every process, the auditory operating system shell 3818 may require agents to gather as much information as needed to faithfully execute a task (remembering as much as possible to limit intent clarification in the future), and execute the task on behalf of the user. In addition, the auditory operating system shell 3818 may implement foregrounding and backgrounding of tasks. The auditory operating system shell 3818 may arrange agents in virtual auditory space to provide for user focus. For example, an agent executing a task that may take less than one second may stay in the foreground. However, for an agent performing a task that may take 30 seconds, the auditory operating system shell 3818 may cause the agent to recede into the background, thereby making space for active agents. The background agent may surface with a notification when it is ready again for user attention.

Conversational agents can be either present (in an active conversation), on deck (in the periphery of focus or passively listening in waiting for a cue to act), occupied elsewhere (running an operation), waiting on a response from an external operation, ready with a response for the user, or in another state. In some embodiments, the auditory operating system 3816 has agent-level states that pass state status to the auditory operating system shell 3818 to orchestrate for the user. As agent or application operations may require a time delay, the auditory operating system shell 3818 may utilize earcons (for example, legible audio notifications) for these states so that the states are clear to the user.

Different types of agents may have different levels of access to user personal information and have different roles (for example conversation only, conversation and generic tools like search, agent, cluster of services wrapped in a single agent, etc.). The auditory operating system shell 3818 may utilize the audio equivalent of a chip or tag so that it is clear to the user what type of agent the user is speaking to.

The auditory operating system shell 3818 may implement arrangements of agents. An arrangement may be a collection of agents arranged in a single shared conversational space that a user can configure, save, and call up as needed.

In some embodiments, the auditory operating system shell 3818 does not use wakewords. Instead, the auditory operating system shell 3818 may infer invocation intent using natural language processing techniques. Such actions by the auditory operating system shell 3818 may be referred to herein as natural language invocation or user intent inference. This has the advantage of allowing conversation to flow seamlessly between device interactions and interactions with other persons.

The auditory operating system shell 3818 may utilize contextual information. Contextual information may be ephemeral (for example, time of day, weather, location, etc.) or persistent (for example, username, biography, birthdate, close points of contact or social graph, user preference information, etc.). Persistent contextual information may accrete over time and be corrected or self-correct over time.

In some embodiments, the auditory operating system shell 3818 allows users to provide context actively, so as to make the auditory operating system shell 3818 behave as the user expects. For example, to add a label (and an expected behavior) to a place by saying “Shell, this is my apartment/bedroom—always turn off mic input when I'm in here” or “Shell, this is my desk at work—keep a record in a protected folder of my conversations so I can search back over them for relevant info when I'm here.” The auditory operating system shell 3818 may allow users to inspect the context the auditory operating system shell 3818 has for them and correct the record if there are errors present (which may be referred to as inspectability.) The auditory operating system shell 3818 may implement permissions to protect user privacy.

### Auditory Operating System Application or Aquent Model

The auditory operating system 3816 may define a set of hardware features and user information that an application or an agent has access to. The auditory operating system shell 3818 may have privileged root-level permissions across the interface device 3802. The auditory operating system 3816 or the auditory operating system shell 3818 may scope permissions per application to allow users to maintain control over their information. In some embodiments, the auditory operating system shell 3818 allows users to share contextual information either once, for a limited period of time, or until revoked with applications or agents.

The arrangement and status of applications or agents in the auditory user interface may depend upon user preferences, context, and level of concurrent activity. Accordingly, the auditory user interface may be highly parametric, meaning that a set of rules may govern the properties of the auditory user interface as experienced by the user. The auditory operating system shell 3818 may serve as the orchestrator of events on behalf of the user by fielding states and requests from applications or agents.

The auditory operating system shell 3818 may manage requests from applications or agents for locations in a user's virtual auditory display, in line with user preferences. A user could set the interface device 3802 to maximum information density, in which case many applications or agents of many different kinds and sizes would occupy space in their auditory perception in parallel. Or a user could set the interface device 3802 to maximum focus or attention on fewer items at a time, in which case the auditory operating system shell 3818 would constrain access to the user's attention with foregrounding and backgrounding, and for example attenuate individual conversational application or agent settings to be terser. The auditory operating system shell 3818 may also manage requests from applications or agents for notifications. For example, applications or agents may set state, which may trigger state notification requests managed by the auditory operating system shell 3818. This allows for consistency of user experience and legibility of application or agent-level states and actions.

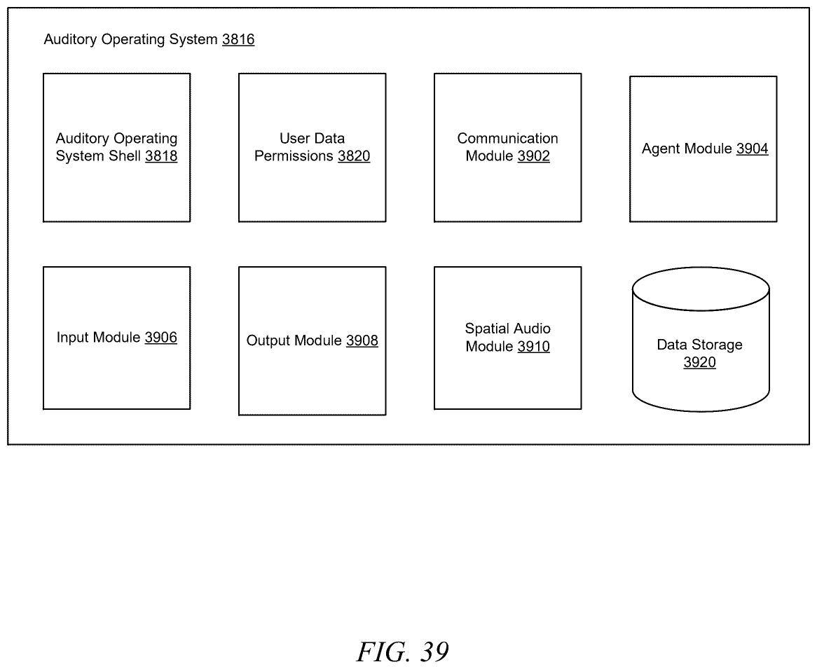

FIG. 39 is a block diagram depicting the auditory operating system 3816 according to some embodiments. The auditory operating system 3816 includes the auditory operating system shell 3818, the user data permissions 3820, a communication module 3902, an agent module 3904, an input module 3906, an output module 3908, a spatial audio module 3910, and a data storage 3920. Although modules may be illustrated as part of the auditory operating system 3816, the modules may be part of the auditory operating system shell 3818 or otherwise accessible to or used by the auditory operating system shell 3818 to perform various functions.

The communication module 3902 may send or receive requests or data between the auditory operating system 3816 and any other system or device. For example, the communication module 3902 may receive requests or data from the user device 3804 or from agents. The communication module 3902 may also send requests or data to the user device 3804 or to agents.

The agent module 3904 may, for example, provide instructions to agents, receive responses from agents, monitor tasks being performed by agents, such as foreground tasks and background tasks, and control whether or not agents receive audio streams or user data.

The input module 3906 may receive input, such as input obtained from speech of a user, and analyze the input to identify the content, such as to identify whether the input contains commands or queries.

The output module 3908 may generate output to be provided to users or coordinate output from agents that is to be provided to users. The spatial audio module 3910 may determine spatial audio locations for audio streams. For example, the spatial audio module 3910 may determine spatial audio locations based on the source of the audio stream (for example, the domain of the agent that generated the audio stream), based on user-defined rules, or based on environmental noises.

The data storage 3920 may include data stored, accessed, or modified by any of the modules of the auditory operating system 3816, such as the auditory operating system shell 3818. The data storage 3920 may include any number of data storage structures such as tables, databases, lists, or the like.

A module of the auditory operating system 3816 may be hardware, software, firmware, or any combination. For example, each module may include functions performed by dedicated hardware (for example, an Application-Specific Integrated Circuit (ASIC), a Field Programmable Gate Array (FPGA), or the like), software, instructions maintained in ROM, or any combination. Software may be executed by one or more processors. Although a limited number of modules are depicted in FIG. 39, there may be any number of modules. Furthermore, individual modules may perform any number of functions, including functions of multiple modules as shown herein.

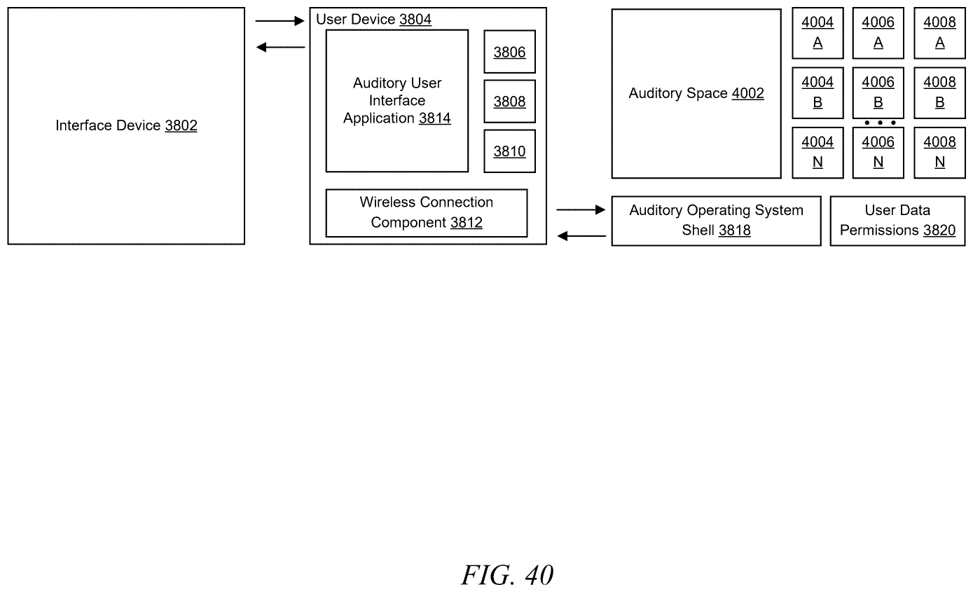

FIG. 40 depicts functionality of the auditory operating system 3816 and the auditory operating system shell 3818 in some embodiments. The auditory operating system 3816 may generate an auditory space 4002 where a user of the interface device 3802 may interact with one or more agents 4004 (shown individually as agent 4004A and agent 4004B through agent 4004N). The interface device 3802 may receive input, such as speech input, from the user, and provide the input to the user device 3804 to be provided to the auditory operating system 3816. The auditory operating system shell 3818 may receive the input, analyze the input, and perform various actions based on the analysis, such as sharing the input or portions of the input with the agents 4004. The auditory operating system shell 3818 controls which agents 4004 may join the auditory space 4002. The auditory operating system shell 3818 may perform various actions with respect to agents 4004 that have joined the auditory space 4002, such as muting or unmuting agents 4004, deafening or undeafening agents 4004, and positioning agents in 3D space for interface devices 3802 that implement spatial audio. The auditory operating system shell 3818 may take the focus of the auditory space 4002, meaning that audio streams from the auditory operating system shell 3818 may be prioritized over audio streams from agents 4004. The auditory operating system shell 3818 may also perform other tasks for the auditory space 4002, such as controlling the auditory complexity of the auditory space 4002.

The agents 4004 may utilize tools and APIs 4006 (shown individually as tools and APIs 4006A and tools and APIs 4006B through tools and APIs 4006N). The agents 4004 may also store application data 4008 (shown individually as application data 4008A and application data 4008B through application data 4008N), such as for use by the agents 4004. As described in more detail herein, the auditory operating system shell 3818 may allow agents to selectively access the user data permissions 3820 to perform tasks or respond to user commands or queries. Also as described in more detail herein, multiple users and their associated agents 4004 may join the auditory space 4002.

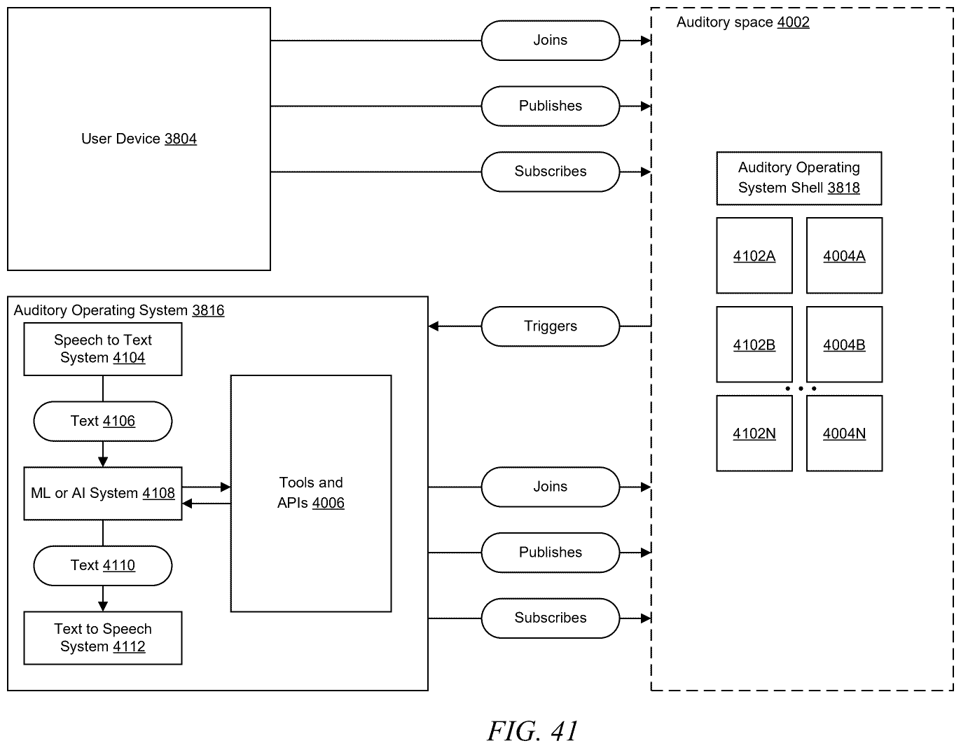

FIG. 41 depicts interactions between the user device 3804, the auditory space 4002, and the auditory operating system 3816 according to some embodiments. The auditory space 4002 may include the auditory operating system shell 3818, users 4102 (shown individually as user 4102A and user 4102B through user 4102N), and agents 4004 (shown individually as agent 4004A and agent 4004B through agent 4004N). Both the user device 3804 and the auditory operating system 3816 may join the auditory space 4002 and may publish audio streams to the auditory space 4002 or subscribe to audio streams in the auditory space 4002. The auditory operating system 3816 or the auditory operating system shell 3818 may determine which entities (users, agents, etc.) may receive audio streams and send audio streams. Events or actions that occur in the auditory space 4002 may trigger events or actions by the auditory operating system 3816.

The auditory operating system 3816 may include or interface with a speech to text system 4104, a machine learning (ML) or artificial intelligence (AI) system 4108, such as a large language model, and a text to speech system 4112. The auditory operating system 3816 may receive speech or other vocal input, and utilize the speech to text system 4104 to convert the speech into text 4106. The auditory operating system 3816 may provide the text 4106 to the ML or AI system 4108 along with any prompts or other input. The ML or AI system 4108 may provide text 4110 to the auditory operating system 3816. The auditory operating system 3816 may utilize the text to speech system 4112 to convert the text into speech. The auditory operating system 3816 may then provide the speech audio stream to various entities, such as the user via the user device 3804 or the interface device 3802 or the auditory operating system shell 3818.

### Auditory Operating System Shell

### 1. Multi-Agent Conversational Interface

Most existing voice assistants and conversational platforms are built around a single-agent approach, whereby one AI entity handles all user queries and tasks. This one-size-fits-all model can limit functionality—particularly when users have diverse or specialized needs (for example, financial planning, cooking guidance, technical support). As conversational devices and AI assistants grow more complex, users often interact with a range of specialized agents—one for music streaming, another for task scheduling, others for home automation, etc. Yet, most existing voice interfaces operate as singular monolithic assistants, forcing the user to remember specific invocation phrases or skill commands. This can lead to confusion and inefficiency.

The described technology provides technical solutions to these technical problems. The auditory operating system shell 3818 may serve as the primary interface for user interactions across multiple specialized agents. When the user speaks a command or query, the auditory operating system shell 3818 may receive the user input, such as incoming voice commands or text input. Through natural language possessing, the auditory operating system shell 3818 may identify the domain or agent type required (for example, “Play Abba's greatest hits”→Music Playback Agent). The auditory operating system shell 3818 may provide relevant task details (for example, song titles, artist info, recommended actions) to the appropriate specialized agent.

In some embodiments, after the auditory operating system shell 3818 has invoked an agent, the auditory operating system shell 3818 continues to receive user input and provides relevant information to the agent. In some embodiments, after the auditory operating system shell 3818 has invoked the agent, the agent receives user input, and the agent can access APIs or data as permitted by the auditory operating system shell 3818. In various embodiments, both the auditory operating system shell 3818 and the agent receive user input.

Each agent may handle one domain (for example, music streaming, scheduling, home automation). Agents may have controlled access to APIs or hardware components. The auditory operating system shell 3818 may enforce boundaries on each agent's data usage and system privileges to maintain user privacy and device stability. The auditory operating system shell 3818 may provide global context management. The auditory operating system shell 3818 may retain high-level session data. Even if the user switches domains mid-conversation, the auditory operating system shell 3818 may preserve relevant context. The auditory operating system shell 3818 may provide seamless handoffs from one agent to another agent. If a user request evolves from one domain to another (for example, from playing music to checking the artist's tour schedule), the auditory operating system shell 3818 may transition between specialized agents without losing continuity.

The auditory operating system shell 3818 may provide a unified user experience with a single entry point. Users may not be required to memorize separate wake words or skill names. In some embodiments, users may simply address the auditory operating system shell 3818. In some embodiments, the auditory operating system shell 3818 may determine, based on analysis of the content of the user's speech or the context, that the user is addressing the auditory operating system shell 3818. The auditory operating system shell 3818 may then orchestrate the best-suited agent to respond to the user's command or query. The auditory operating system shell 3818 may also standardize response formatting, ensuring an integrated and cohesive style of replies, whether from a music agent, a weather agent, or another agent.

As demand grows for tailored and multi-domain assistance, a multi-agent approach offers the potential to improve user experience, allowing more flexibility and depth in responses while supporting seamless transitions between domains. Moreover, user data access or interfacing on the user's behalf with specific APIs benefits from multiple narrowly scoped agents.

One potential application of the auditory operating system shell 3818 is for wearable devices, such as a watch or ear-worn device with multiple domain-focused agents—fitness tracking, notifications, voice dictation—managed seamlessly by the auditory operating system shell 3818. Other potential applications include home hubs, where the auditory operating system shell 3818 may manage multiple internal agents (lighting control, climate settings, media playback), each specialized to its domain, and automotive infotainment systems, where the auditory operating system shell 3818 may delegate commands or queries from drivers related to navigation, music, or communication tasks to domain-focused agents. Another potential application is for enterprise workflow assistants, where distinct agents handle file management, project updates, or meeting scheduling, while the auditory operating system shell 3818 routes user commands or queries to the correct agent.

One advantage of the auditory operating system shell 3818 may be that the auditory operating system shell 3818 implements a modular architecture that specialized agents, which are narrowly scoped, simpler to develop and maintain, and less prone to collisions or confusion, may be plugged into. Another advantage is that users interact with a single interface rather than juggling numerous separate skills or applications. Moreover, new domain agents can be added without overhauling the entire system, as the auditory operating system shell 3818 orchestrates tasks. The auditory operating system shell 3818 also may also enforce rigorous API access controls, preventing specialized agents from overreaching or leaking data. The auditory operating system shell 3818 is also context-aware because the auditory operating system shell 3818 tracks top-level conversation context and may therefore seamlessly switch tasks or re-route requests between agents if user needs shift mid-interaction.

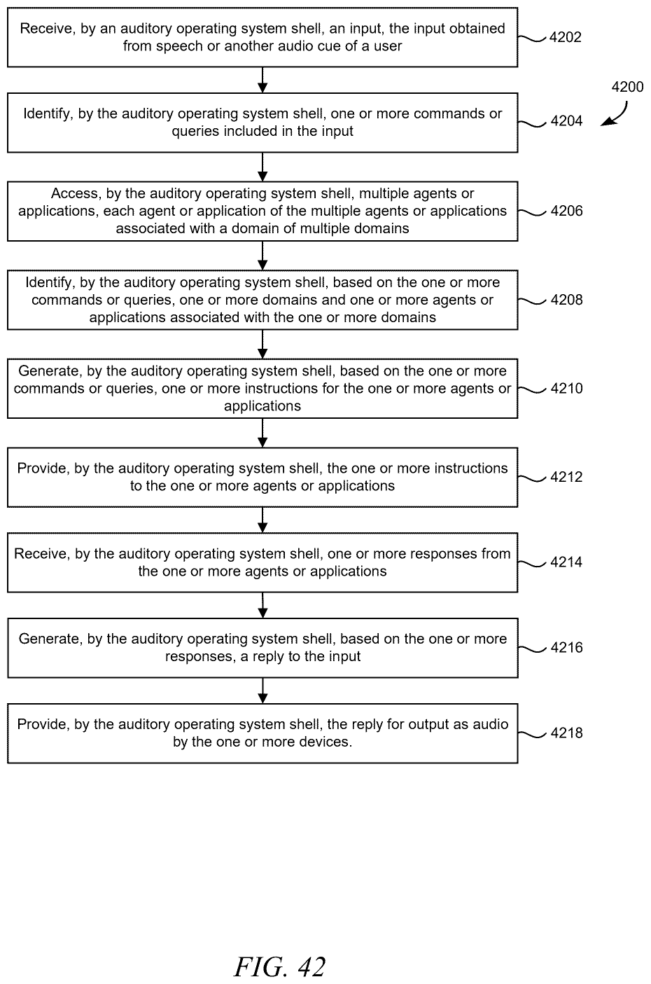

FIG. 42 is a flow diagram illustrating an example method 4200 that some embodiments of aspects of the described technology may perform. The method 4200 and the other methods herein may be described as being at least partially performed by the auditory operating system shell 3818, but it is to be understood that other systems or devices may perform some or all of the steps of the method 4200. Furthermore, other devices, such as the interface device 3802, the user device 3804 or other devices or systems, may perform some or all of the steps of the method 4200 and the other methods herein.

The method 4200 may begin at step 4202, where the auditory operating system shell 3818 receives an input obtained from speech or another audio cue of a user, such as a user of the interface device 3802 or the user device 3804. At step 4204 the auditory operating system shell 3818 identifies one or more commands or queries included in the input. At step 4206 the auditory operating system shell 3818 accesses multiple agents or applications. Each agent or application of the multiple agents or application is associated with a domain. As there may be multiple agents or applications, each of which is associated with a domain, there are multiple domains. For example, an agent may be an email agent, and the associated domain is email, an agent may be a music agent, and the associated domain is music, or an agent may be a calendar agent, and the associated domain is scheduling. In various embodiments, an agent may be associated with more than one domain of the multiple domains.

At step 4208 the auditory operating system shell 3818 identifies, based on the one or more commands or queries, one or more domains and one or more agents or applications associated with the one or more domains. The auditory operating system shell 3818 may identify an agent or application without the input including a name of the agent or application. Accordingly, the user does not necessarily have to (although the user may) specify a wakeword, a hotword, or a keyword of an agent in order for the auditory operating system shell 3818 to identify the agent or application.

At step 4210 the auditory operating system shell 3818 generates, based on the one or more commands or queries, one or more instructions for the one or more agents or applications. At step 4212 the auditory operating system shell 3818 provides the one or more instructions to the one or more agents or applications. The one or more agents or applications perform, based on the one or more instructions, one or more actions that are responsive to the one or more commands or queries.

The method 4200 may include additional steps related to receiving response from agents. For example, at step 4214, the auditory operating system shell 3818 may receive one or more responses from the one or more agents or applications. At step 4216 the auditory operating system shell 3818 may generate, based on the one or more responses, a reply to the input. At step 4218 the auditory operating system shell 3818 may provide the reply for output as audio by one or more devices, such as the interface device 3802 or the user device 3804.

Additional steps may be performed, such as for devices that may output spatial audio, such as the audio computing device 3830. In such cases, the auditory operating system shell 3818 may determine a first spatial audio location for first spatial audio corresponding to a first action of a first agent or application and a second spatial audio location for second spatial audio corresponding to a second action of a second agent or application. The auditory operating system shell 3818 may then cause the device, such as the audio computing device 3830, to output the first spatial audio at the first spatial audio location and the second spatial audio at the second spatial audio location.

In some aspects, the techniques described herein relate to a method including: receiving, by an auditory operating system shell, an input, the input obtained from speech or another audio cue of a user; identifying, by the auditory operating system shell, one or more commands or queries included in the input; accessing, by the auditory operating system shell, multiple agents or applications, each agent or application of the multiple agents or applications associated with a domain of multiple domains; identifying, by the auditory operating system shell, based on the one or more commands or queries, one or more domains and one or more agents or applications associated with the one or more domains, wherein the auditory operating system shell may identify an agent or application without the input including a name of the agent or application; generating, by the auditory operating system shell, based on the one or more commands or queries, one or more instructions for the one or more agents or applications; and providing, by the auditory operating system shell, the one or more instructions to the one or more agents or applications, wherein the one or more agents or applications perform, based on the one or more instructions, one or more actions, the one or more actions responsive to the one or more commands or queries.

In some aspects, the techniques described herein relate to a method wherein the multiple agents or applications may be permitted access to functions or data associated with the user and the auditory operating system shell controls access of the multiple agents to the functions or the data.

In some aspects, the techniques described herein relate to a method wherein the speech of the user is captured by one or more devices configured to capture the speech of the user and output audio, and further including: receiving, by the auditory operating system shell, one or more responses from the one or more agents; generating, by the auditory operating system shell, based on the one or more responses, a reply to the input; and providing, by the auditory operating system shell, the reply for output as audio by the one or more devices.

In some aspects, the techniques described herein relate to a method wherein the speech of the user is captured by one or more devices configured to capture the speech of the user and output audio, providing, by the auditory operating system shell, the one or more instructions to the one or more agents or applications includes providing, by the auditory operating system shell, first instructions to a first agent or application to perform a foreground action and second instructions to a second agent or application to perform a background action, and further including: receiving, by the auditory operating system shell, a first indication from the first agent or application that the foreground action is complete; and receiving, by the auditory operating system shell, a second indication from the second agent or application that the background action is complete, wherein the one or more devices output first audio indicating that the foreground action is complete at a first time and second audio indicating that the background action is complete at a second time later than the first time.

In some aspects, the techniques described herein relate to a method wherein the speech of the user is captured by one or more devices configured to capture the speech of the user and output spatial audio, the one or more actions include a first action and a second action, and further including: determining a first spatial audio location for first spatial audio corresponding to the first action and a second spatial audio location for second spatial audio corresponding to the second action, wherein the one or more devices output the first spatial audio at the first spatial audio location and the second spatial audio at the second spatial audio location.

In some aspects, the techniques described herein relate to a method wherein the user is a first user, the speech of the first user is in a presence of a second user, and further including determining, by the auditory operating system shell, that the one or more commands or queries are directed to the auditory operating system shell and not to the second user.

In some aspects, the techniques described herein relate to a method wherein the multiple agents or applications may be permitted access to user preference data associated with the user and device data associated with a device of the user, the auditory operating system shell controls access of the multiple agents or applications to the user preference data and the device data, and the one or more agents or applications utilize the user preference data or the device data to perform the one or more actions.

In some aspects, the techniques described herein relate to a method wherein the multiple agents or applications may be permitted access to data associated with the user, the data including ephemeral data and persistent data, the auditory operating system shell controls access of the multiple agents or applications to the data, the one or more agents or applications include a first agent or application and a second agent or application, and further including: receiving, by the auditory operating system shell, a first request from a first agent or application to access at least a first portion of the ephemeral data to perform a first action and a second request from a second agent or application to access at least a second portion of the persistent data to perform a second action; accessing, by the auditory operating system shell, one or more rules defined or approved by the user regarding access to the ephemeral data and persistent data; determining, by the auditory operating system shell, based on the one or more rules, that the first agent or application is permitted to access at least the first portion of the ephemeral data and that the second agent or application is permitted to access at least the second portion of the persistent data; and granting, by the auditory operating system shell, access to at least the first portion of the ephemeral data to the first agent or application and access to at least the second portion of the persistent data to the second agent or application.

In some aspects, the techniques described herein relate to a method wherein the speech of the user is captured by one or more devices configured to capture the speech of the user and output audio, and further including: determining, by the auditory operating system shell, a confidence score for the one or more commands or queries for identifying an agent or application; determining, by the auditory operating system shell, that the confidence score is below a threshold for identifying an agent or application; generating, by the auditory operating system shell, a first request for clarification of the one or more commands or queries; providing, by the auditory operating system shell, the first request for clarification for first output as first audio by the one or more devices; receiving, by the auditory operating system shell, a first clarification of the one or more commands or queries, wherein identification of the one or more agents or applications by the auditory operating system shell is further based on the first clarification; determining, by the auditory operating system shell, that a portion of the one or more commands or queries is ambiguous; generating, by the auditory operating system shell, a second request for clarification of the portion of the one or more commands or queries; providing, by the auditory operating system shell, the second request for clarification for second output as second audio by the one or more devices; and receiving, by the auditory operating system shell, a second clarification of the portion of the one or more commands or queries, wherein providing of the one or more instructions to the one or more agents or applications by the auditory operating system shell is further based on the second clarification.

In some aspects, the techniques described herein relate to a method wherein the speech is first speech, the first clarification is obtained from second speech of the user, and the second clarification is obtained from third speech of the user.

In some aspects, the techniques described herein relate to a method wherein the one or more devices are further configured to detect a gaze, a head orientation, or a dwell time of the user, the first clarification is obtained from first gaze, head orientation, or dwell time detection of the user, and the second clarification is obtained from second gaze, head orientation, or dwell time detection of the user.

In some aspects, the techniques described herein relate to a method wherein the speech is first speech, the one or more devices are further configured to detect a head orientation of the user, identification of the one or more agents by the auditory operating system shell is further based on a first detected head orientation of the user, and the second clarification is obtained from a second detected head orientation of the user or second speech of the user.

In some aspects, the techniques described herein relate to one or more non-transitory computer-readable media including executable instructions that when executed by one or more processors of a system cause the system to perform a method including: receiving, by an auditory operating system shell, an input, the input obtained from speech of a user; identifying, by the auditory operating system shell, one or more commands or queries included in the input; accessing, by the auditory operating system shell, multiple agents or applications, each agent or application of the multiple agents or applications associated with a domain of multiple domains; identifying, by the auditory operating system shell, based on the one or more commands or queries, one or more domains and one or more agents or applications associated with the one or more domains, wherein the auditory operating system shell may identify an agent or application without the input including a name of the agent; generating, by the auditory operating system shell, based on the one or more commands or queries, one or more instructions for the one or more agents or applications; and providing, by the auditory operating system shell, the one or more instructions to the one or more agents or applications, wherein the one or more agents or applications perform, based on the one or more instructions, one or more actions, the one or more actions responsive to the one or more commands or queries.

In some aspects, the techniques described herein relate to one or more non-transitory computer-readable media wherein the multiple agents or applications may be permitted access to functions or data associated with the user and the auditory operating system shell controls access of the multiple agents or applications to the functions or the data.

In some aspects, the techniques described herein relate to one or more non-transitory computer-readable media wherein the speech of the user is captured by one or more devices configured to capture the speech of the user and output audio, and the method further includes: receiving, by the auditory operating system shell, one or more responses from the one or more agents or applications; generating, by the auditory operating system shell, based on the one or more responses, a reply to the input; and providing, by the auditory operating system shell, the reply for output as audio by the one or more devices.

In some aspects, the techniques described herein relate to one or more non-transitory computer-readable media wherein the speech of the user is captured by one or more devices configured to capture the speech of the user and output audio, providing, by the auditory operating system shell, the one or more instructions to the one or more agents or applications includes providing, by the auditory operating system shell, first instructions to a first agent or application to perform a foreground action and second instructions to a second agent or application to perform a background action, and the method further includes: receiving, by the auditory operating system shell, a first indication from the first agent or application that the foreground action is complete; and receiving, by the auditory operating system shell, a second indication from the second agent or application that the background action is complete, wherein the one or more devices output first audio indicating that the foreground action is complete at a first time and second audio indicating that the background action is complete at a second time later than the first time.

In some aspects, the techniques described herein relate to one or more non-transitory computer-readable media wherein the speech of the user is captured by one or more devices configured to capture the speech of the user and output spatial audio, the one or more actions include a first action and a second action, and the method further includes: determining a first spatial audio location for first spatial audio corresponding to the first action and a second spatial audio location for second spatial audio corresponding to the second action, wherein the one or more devices output the first spatial audio at the first spatial audio location and the second spatial audio at the second spatial audio location.

In some aspects, the techniques described herein relate to one or more non-transitory computer-readable media wherein the user is a first user, the speech of the first user is in a presence of a second user, and further including determining, by the auditory operating system shell, that the one or more commands or queries are directed to the auditory operating system shell and not to the second user.

In some aspects, the techniques described herein relate to one or more non-transitory computer-readable media wherein the multiple agents or applications may be permitted access to user preference data associated with the user and device data associated with a device of the user, the auditory operating system shell controls access of the multiple agents or applications to the user preference data and the device data, and the one or more agents or applications utilize the user preference data or the device data to perform the one or more actions.

In some aspects, the techniques described herein relate to one or more non-transitory computer-readable media wherein the multiple agents or applications may be permitted access to data associated with the user, the data including ephemeral data and persistent data, the auditory operating system shell controls access of the multiple agents or applications to the data, the one or more agents or applications include a first agent or application and a second agent or application, and the method further includes: receiving, by the auditory operating system shell, a first request from a first agent or application to access at least a first portion of the ephemeral data to perform a first action and a second request from a second agent or application to access at least a second portion of the persistent data to perform a second action; accessing, by the auditory operating system shell, one or more rules defined or approved by the user regarding access to the ephemeral data and persistent data; determining, by the auditory operating system shell, based on the one or more rules, that the first agent or application is permitted to access at least the first portion of the ephemeral data and that the second agent or application is permitted to access at least the second portion of the persistent data; and granting, by the auditory operating system shell, access to at least the first portion of the ephemeral data to the first agent or application and access at least the second portion of the persistent data to the second agent.

In some aspects, the techniques described herein relate to one or more non-transitory computer-readable media wherein the speech of the user is captured by one or more devices configured to capture the speech of the user and output audio, and the method further includes: determining, by the auditory operating system shell, a confidence score for the one or more commands or queries for identifying an agent; determining, by the auditory operating system shell, that the confidence score is below a threshold for identifying an agent; generating, by the auditory operating system shell, a first request for clarification of the one or more commands or queries; providing, by the auditory operating system shell, the first request for clarification for first output as first audio by the one or more devices; receiving, by the auditory operating system shell, a first clarification of the one or more commands or queries, wherein identification of the one or more agents or applications by the auditory operating system shell is further based on the first clarification; determining, by the auditory operating system shell, that a portion of the one or more commands or queries is ambiguous; generating, by the auditory operating system shell, a second request for clarification of the portion of the one or more commands or queries; providing, by the auditory operating system shell, the second request for clarification for second output as second audio by the one or more devices; and receiving, by the auditory operating system shell, a second clarification of the portion of the one or more commands or queries, wherein providing of the one or more instructions to the one or more agents or applications by the auditory operating system shell is further based on the second clarification.

In some aspects, the techniques described herein relate to one or more non-transitory computer-readable media wherein the speech is first speech, the first clarification is obtained from second speech of the user, and the second clarification is obtained from third speech of the user.

In some aspects, the techniques described herein relate to one or more non-transitory computer-readable media wherein the one or more devices are further configured to detect a gaze, a head orientation, or a dwell time of the user, the first clarification is obtained from first gaze, head orientation, or dwell time detection of the user, and the second clarification is obtained from second gaze, head orientation, or dwell time detection of the user.

In some aspects, the techniques described herein relate to one or more non-transitory computer-readable media wherein the speech is first speech, the one or more devices are further configured to detect a head orientation of the user, identification of the one or more agents or applications by the auditory operating system shell is further based on a first detected head orientation of the user, and the second clarification is obtained from a second detected head orientation of the user or second speech of the user.

In some aspects, the techniques described herein relate to a system including at least one processor and at least one memory including executable instructions that when executed by the at least one processor cause the system to: receive, by an auditory operating system shell, an input, the input obtained from speech of a user; identify, by the auditory operating system shell, one or more commands or queries included in the input; access, by the auditory operating system shell, multiple agents or applications, each agent or application of the multiple agents or applications associated with a domain of multiple domains; identify, by the auditory operating system shell, based on the one or more commands or queries, one or more domains and one or more agents or applications associated with the one or more domains, wherein the auditory operating system shell may identify an agent or application without the input including a name of the agent; generate, by the auditory operating system shell, based on the one or more commands or queries, one or more instructions for the one or more agents or applications; and provide, by the auditory operating system shell, the one or more instructions to the one or more agents or applications, wherein the one or more agents or applications perform, based on the one or more instructions, one or more actions, the one or more actions responsive to the one or more commands or queries.

### 2. Conversational Abstraction Layer for Multi-Agent Virtual Workers

Current consumer and enterprise voice assistants typically feature a single AI agent—often with minimal concurrency—primarily handling one request at a time. Complex tasks or user requests that involve multiple steps or switching between domains can force the user to break down instructions into strictly formed commands or explicitly specify which skill to invoke. These limitations become especially evident in an audio-only environment, where the conversation's bandwidth is inherently constrained.

Current systems may allow third-party “skills” or “actions,” but the user usually must explicitly name or invoke each skill. Meanwhile, spatial audio attempts to raise the output bandwidth by placing sounds directionally, yet alone cannot fully resolve the constraint of verbal commands that are inherently ambiguous or incomplete. An intelligent conversational abstraction layer that uses context plus multiple specialized agents can handle parallel tasks and ambiguous requests more fluidly-something prior solutions have not comprehensively addressed.

The described technology provides technical solutions to these technical problems. A system according to the described technology provides a conversational abstraction layer that allows users to interact with a multi-agent platform through audio in/audio out, while seamlessly managing tasks across various specialized virtual workers. Features or components of the system include a centralized conversational interface, virtual workers and tool access, spatial audio display, and conversational abstraction and confidence.

A centralized conversational interface may include a single user interface that receives imprecise or ambiguous commands in natural language. The system may refer to user context (preferences, schedules, environment) to interpret meaning more precisely. The centralized conversational interface may also route tasks to multiple workers (for example, “managing email,” “purchasing groceries,” “booking travel”) concurrently, hiding complexity from the user.

Virtual workers and tool access may include API integration, in that each specialized agent may be associated with domain-specific APIs (email, calendar, e-commerce, etc.) or built-in device functions (storage, camera, connectivity). Once invoked, these specialized agents can proceed asynchronously, updating the user with short voice confirmations or using spatial audio cues for immersive feedback.

Spatial audio display may include the system repositioning agent responses or notifiers in 3D audio space (for example, an email agent's update “to the left,” a travel agent's confirmation “behind”), offering more parallel feedback channels. Conversational abstraction and confidence may include ambiguous command resolution: because the system has a broad context and user profile, it can interpret incomplete requests (“hey, get me groceries for next week, just do the usual . . . ”) and distribute tasks accordingly (for example, to a grocery ordering agent); and confidence thresholds and confirmation: when requests are too ambiguous, the system may prompt the user for clarifications or disclaimers, maintaining high confidence while avoiding mistakes.

An example use case is as follows: a user wearing a hands-free, voice-driven headset says: “Shell, I need to catch up on emails and schedule a meeting. Oh, also reorder the groceries from last time.” The system may interpret the user's parallel tasks and dispatch multiple agents, such as an email agent to summarize unread messages and compose replies per the user's spoken instructions; a calendar agent to suggest meeting times based on user's schedule context and then invite participants; and a shopping agent to create a grocery reorder list from prior purchases, check the user's saved recipes for missing items, and place the order. The system may provide spatial audio feedback: brief updates from each agent emanate from distinct virtual “locations” around the user's auditory field, allowing them to track ongoing tasks concurrently. Each specialized agent may report completion in short, unobtrusive voice prompts or via a single summarizing update at the end of all tasks.

Advantages of the system include parallel, high-confidence task fulfillment: the system alleviates the need for step-by-step instructions or frequent user intervention by delegating tasks to specialized virtual workers; natural language interaction: the user can provide partial, ambiguous, or multi-part instructions, relying on the system's contextual intelligence to fill gaps; enhanced usability over audio I/O: spatial audio cues and conversation management increase throughput beyond typical audio interfaces, reducing user friction; the system may be extensible and scalable: developers can add or update specialized agents without overhauling the entire system, supporting new domain-specific APIs and user contexts; and the system may improve productivity and accessibility: by handling multiple tasks seamlessly via a single voice conversation, the system empowers users in both personal and professional contexts.

### 3. Dynamic Ambiguity Resolution in Multi-Agent Conversational Shell

Conversational AI systems typically rely on explicit or high-confidence triggers (for example, “Play Spotify” or “Set an alarm”). If the system is unsure of intent, many solutions default to partial or irrelevant responses. Further, single-agent designs lack intermediate steps to clarify whether the request is best served by one skill or another. While some voice assistants prompt clarifications, they seldom triage across multiple domain agents, nor do they fully leverage context to fill in details. This gap produces incomplete or incorrect results when user instructions are ambiguous (for example, “Play me some music,” or “Check with Sam about the meeting”).

The described technology provides technical solutions to these technical problems. The auditory operating system shell 3818, according to the described technology, provides two stages of dynamic ambiguity resolution in a multi-agent conversational system: a first stage related to agent selection (auditory operating system shell-level ambiguity) and a second stage related to task definition (agent-level ambiguity).

At the first stage, when the auditory operating system shell 3818 parses a user command (for example, “Play me some music”), the auditory operating system shell 3818 may have low confidence on whether the user wants the music agent, podcast agent, or another domain. Instead of guessing, the Shell may pose a clarifying question: “Were you asking me to play music or start an audiobook?” This ensures user intent is validated before dispatching. When multiple plausible agents exist (“Do you want me to open MusicApp, or stream from your news agent?”), the Shell may enumerate these choices in short, comprehensible voice prompts for user selection. While voice prompts are used in this example, other modalities such as visual displays or haptic feedback may also be used to present clarification options.

At the second stage, once an agent is selected, if the command remains vague—“Play me some music”—the agent or the auditory operating system shell 3818 may check user/device context (for example, user's prior listening history, time of day, location) to propose relevant options. The agent or the auditory operating system shell 3818 may ask, “What are you in the mood for?” or “Shall I resume Abba's Greatest Hits playlist?” If the user confirms, the agent or the auditory operating system shell 3818 finalizes the request; if not, the agent or the auditory operating system shell 3818 seeks further refinement. When the user's request references incomplete details (“Book a flight,” but no destination), the agent or the auditory operating system shell 3818 may consult user data (for example, known frequent destinations) or prompt a direct question for missing info.

By combining auditory operating system shell-level disambiguation with agent-level clarifications, the auditory operating system shell 3818 gracefully handles uncertain or incomplete user commands, maximizing accuracy and user satisfaction without forcing rigid command structures.

An example use case is as follows: The user says: “Shell, can you read me the latest . . . ?” The auditory operating system shell 3818 sees this could refer to news headlines, emails, or social media feed. The auditory operating system shell 3818 asks: “Do you want the news from your headlines agent, or your recent emails?” The user may provide a clarification, such as “I want to hear my unread emails.” The auditory operating system shell 3818 may then route the request to the email agent. The email agent may detect that the user wants a summary, but the email agent may be uncertain whether to read only important flagged messages. The email agent or the auditory operating system shell 3818 may request a second clarification, such as by asking: “Shall I read you all new emails, or just those marked urgent?” Once confirmed, the email agent may proceed.

This layered approach ensures each user request is handled by the right agent or application with properly resolved tasks, while reducing or minimizing user friction or cognitive load.

4. Dynamic Ambiguity Resolution in Multi-Agent Conversational Shell with Gestural or Semantic Focus

Conversational AI systems typically rely on explicit or high-confidence triggers (for example, “Play MusicApp” or “Set an alarm”). If the system is unsure of intent, many solutions default to partial or irrelevant responses. Further, single-agent designs lack intermediate steps to clarify whether the request is best served by one skill or another.

While some voice assistants prompt clarifications, they seldom triage across multiple domain agents or use physical cues (for example, the user facing a certain virtual agent display, pointing at a smart speaker) to guide resolution. This gap produces incomplete or incorrect results when user instructions are ambiguous (for example, “Play me some music,” or “Check with Sam about the meeting”). Additionally, conventional systems do not incorporate non-verbal focus indicators—like a user's head pose, dwell time, or look direction—that can disambiguate which agent is being addressed, especially in environments with multiple interactive endpoints

The described technology provides technical solutions to these technical problems. The auditory operating system shell 3818 according to the described technology provides two stages of dynamic ambiguity resolution in a multi-agent conversational system, augmented by action/perception mechanisms (head gestures, look direction, etc.) to clarify user focus: a first stage related to agent selection (auditory operating system shell-level ambiguity) and a second stage related to task definition (agent-level ambiguity).

At the first stage, when the auditory operating system shell 3818 parses a user command (for example, “Play me some music”), the auditory operating system shell 3818 may have low confidence on whether the user wants the music agent, podcast agent, or another domain. The auditory operating system shell 3818 also factors in non-verbal cues—such as head pose oriented toward a device recognized as the “music agent” hub—to boost or lower confidence. Instead of guessing, the Shell may pose a clarifying question: “Were you asking me to play music or start an audiobook?” If the user dwells on the device representing the music agent (or verbally confirms), the Shell dispatches the request. When multiple plausible agents exist (“Do you want me to open Deejay, or stream from your news agent?”), the auditory operating system shell 3818 may enumerate choices. The user may direct their gaze at the relevant device or say “Yes” while looking at it, confirming the agent selection.

At the second stage, once an agent is selected, if the command remains vague—“Play me some music”—the agent or the auditory operating system shell 3818 may check user/device context (for example, user's prior listening history, time of day, location) to propose relevant options. If the auditory operating system shell 3818 detects the user is still “focused” on that agent (head pose maintained), the auditory operating system shell 3818 may proceed. The agent or the auditory operating system shell 3818 may ask, “What are you in the mood for?” or “Shall I resume Abba's Greatest Hits playlist?” If the user verbally hesitates or shifts gaze away, the agent or the auditory operating system shell 3818 might say “Hm?” or “Still interested?” to re-engage or confirm. When the request references incomplete details (“Book a flight” but no destination), the agent or the auditory operating system shell 3818 may consult user data. If the user's look direction shifts to an on-screen itinerary, the agent or the auditory operating system shell 3818 may infer partial acceptance or clarification, further disambiguating.

As an example of indicating focus, if the user points their head toward a specific smart display or device for a set period, it signals interest in that particular agent's domain. The auditory operating system shell 3818 may respond with a subtle utterance like “Hm?” to confirm readiness. As another example, in public or noisy environments, the user might rely on dwell-based focus selection—looking at the device or agent icon for a second or two—prompting the auditory operating system shell 3818 to route the conversation accordingly. As another example, if the user abruptly switches head orientation to another device mid-clarification, the auditory operating system shell 3818 may interpret this as an attempt to hand off the conversation or request to that agent. As another example, a user may be talking to another person in the room. The user device may locate the source of the person's speech and tell that the user is directing focus at the person while talking. The user may stop or interrupt that human-to-human conversational focus by looking to the right and saying “pause music.” This action by the user may increase a confidence score that this utterance is directed at the user device as opposed to the other person.

By combining auditory operating system shell-level disambiguation with agent-level clarifications and physical focus cues, the auditory operating system shell 3818 gracefully handles uncertain or incomplete user commands in a multi-agent environment. Non-verbal gestures may reduce the need for explicit verbal triggers, making agent selection and conversation flow more natural and intuitive.

An example use case is as follows: The user says, “Shell, can you read me the latest . . . ?” but also turns their head toward a news display. The auditory operating system shell 3818 sees this could refer to headlines, social media feed, or emails.

However, the auditory operating system shell 3818 observes the user's look direction at the news interface, raising the probability that they want headlines. The auditory operating system shell 3818 may provide a follow-up prompt, such as “Were you asking for news headlines or emails?” The user confirms “News.” The auditory operating system shell 3818 routes the request to the news agent. The news agent detects the user wants a summary but is unsure if the user wants local or international news. The news agent notices the user continues to face the news device. The news agent or the auditory operating system shell 3818 may provide a follow-up prompt: “Shall I start with local updates or top international stories?” The user nods or verbally responds, clarifying further.

In a head-gesture scenario, the user might remain silent, only maintaining gaze at the “local news” icon. The system interprets the dwell as confirmation, finalizing agent selection. This layered approach ensures each user request is handled by the right agent, with properly resolved tasks and improved context from non-verbal cues.

5. Dynamic Ambiguity Resolution in Multi-Agent Conversational Shell with Gestural Focus in a Virtual Auditory Space

Traditional voice assistants typically provide a single, central point of interaction. Multi-agent systems have emerged, but they lack robust methods to: manage agent selection, as the user may not explicitly name which agent they want; leverage user gestures, as gestures or gaze rarely inform agent choice in standard voice UI approaches; and support spatially distinct agent locations as conventional interfaces do not anchor agent voices in a 3D sound field.

While some voice assistants implement spatial audio for immersive effects, they do not use head tracking or gaze direction to clarify ambiguous requests among multiple agents. Additionally, shell-level triage across specialized agents remains limited, often defaulting to partial guesses or forced clarifications

The described technology provides technical solutions to these technical problems. A system according to the described technology provides two stages of dynamic ambiguity resolution in a 3D auditory environment: a first stage related to agent selection (auditory operating system shell-level ambiguity) and a second stage related to task definition (agent-level ambiguity). Agents are arranged virtually around the user's head so that as the user turns or tilts their head, each agent's audio remains fixed to its designated spot in the virtual sound field. This arrangement is combined with user gestures (head orientation, dwell time, or gaze direction) to supplement speech-based intent detection.

At the first stage, when the auditory operating system shell 3818 parses a user utterance (for example, “Play me some music”), the auditory operating system shell 3818 may have low confidence on whether the user wants the music agent, podcast agent, or another domain. The auditory operating system shell 3818 also monitors head pose: If the user's head turns in the direction of the “Music Agent's” location in the 3D auditory space, that agent's probability increases. The auditory operating system shell 3818 may generate short clarifications-“Were you asking me to play music or start a podcast?”—anchored in virtual space. The user may confirm by facing the “music” location or verbally saying, “Yes.” For multiple plausible agents, the auditory operating system shell 3818 may enumerate them with spatially distinct prompts. The user's focus (which direction they look toward or dwell on) helps finalize agent choice.

At the second stage, once an agent is chosen, if the user request is vague—“Play me something fun”—the agent or the auditory operating system shell 3818 may reference context (time of day, user history). The user's continued orientation toward that agent's virtual location further indicates engagement with that agent. The agent or the auditory operating system shell 3818 may ask, “Are you in the mood for pop or jazz?” The user's head orientation can remain locked on the same agent's position in the auditory field, signifying a consistent conversation. When details are incomplete—like “Check flights to Tokyo” but no specific date—non-verbal cues or additional clarifications may be solicited. If the user suddenly turns to another agent's direction, the agent or the auditory operating system shell 3818 can interpret a hand-off or that the user is exploring a different specialized function.

Each agent occupies a unique, stable coordinate in a virtual 3D soundscape. As the user moves or rotates their head, spatialization ensures the agent's voice emanates from the same direction. Sensors in a headset or wearable detect subtle changes in orientation. A threshold dwell time or orientation angle can be recognized as focus or “look direction.” When the auditory operating system shell 3818 detects the user has dwelled on an agent's location for a few moments, the auditory operating system shell 3818 may respond with a subtle sound or short utterance like “Hm?” to confirm that the auditory operating system shell 3818 is listening.

By combining shell-level disambiguation with agent-level clarifications and harnessing 3D auditory spatial cues plus head gesture data, the auditory operating system shell 3818 may streamline multi-agent interactions. The user may benefit from more natural engagement-simply looking at the agent's position in the 3D space can resolve ambiguity without requiring repeated agent names or explicit commands.

An example use case is as follows: he user says, “Shell, please help me with something . . . ” while turning their head to the left, toward the location of the “Productivity Agent” in the 3D sound field. Observing the user's orientation, the auditory operating system shell 3818 suspects they want “Productivity” functions (to-do lists, email, scheduling) vs. “Entertainment.” Still uncertain, it asks: “Do you want Productivity or Entertainment?” The user dwells on the left side, where the Productivity Agent is anchored. The auditory operating system shell 118's confidence in “Productivity” agent selection rises. The chosen Productivity Agent notes the user's vague request—“Help me plan something.” It checks contextual data for upcoming events. Are you planning a meeting or a trip?” The user continues to face the same spot, confirming he or she is conversing with that agent, then says “Meeting.” The agent finalizes the request with the user's schedule.

This layering of spatial orientation and dialogue allows the system to elegantly handle uncertain or incomplete user commands across a multi-agent ecosystem, ensuring each request is routed to the correct agent with minimal confusion.

6. Conversational Abstraction Layer for Multi-Agent Virtual Workers with Extended Background Task Execution

Traditional voice-based AI assistants typically handle quick, one-off commands (for example, “What's the weather?” or “Play a song”). More complex tasks—like generating detailed summaries, running data analytics, or waiting on multiple asynchronous conditions—are either not supported or require manual workarounds. Standard UIs (like desktop or mobile apps) let users “minimize” or move to another window while a task runs in the background, displaying a notification or status update upon completion.

In multi-agent setups, each specialized agent might handle a different domain (for example, scheduling, data retrieval, report generation). Existing voice or AR/VR interfaces typically lack a unified abstraction layer that: orchestrates tasks across multiple specialized agents; handles background execution for tasks that take considerable time; and notifies users non-intrusively in a virtual auditory space, and possibly through complementary visual means (head-mounted display, smartphone UI, etc.).

The described technology provides technical solutions to these technical problems. A system according to the described technology provides a conversational abstraction layer (CAL) that coordinates multi-agent tasks, allowing them to run in the background and re-surface to the user once a specific trigger or completion event occurs. Features or components of the system include a layered conversation model, long-running task management, notification and focus switching, and a unified abstraction layer.

The system may implement a layered conversation model by implementing foreground and background tasks or contexts. For example, users can issue a command—such as “Generate a sales report”—and then seamlessly shift to other tasks. The agent moves to the background, performing lengthy operations with minimal user intervention. Once the task finishes (for example, a 10-minute data processing job), the user is notified spatially (audio prompt from the “agent's location” in 3D auditory space, or a subtle overlay in a head-mounted display) that “Your sales report is ready.”

The system may implement long-running task management by monitoring each virtual worker's progress. If a user asks, “Is my report done yet?” the system may retrieve an updated status from the relevant agent. The user can interrupt or reprioritize tasks, for example, “Pause the report generation; I need to schedule a meeting first.” If the user changes priorities, the CAL can cancel or put tasks back in queue, clarifying verbally or visually if partial results are preserved.

The system may implement notification and focus switching using spatial audio queues. For example, in a 3D auditory environment, each agent's voice or notification can be anchored to a stable point in virtual space. When a background job completes, the system may provide the user with an audio cue emanating from that agent's location. In devices that include head-mounted displays, such as AR or VR headsets, the system may provide an optional overlay or minimized task card in the user's field of view. Selecting it (with head gaze or voice confirmation) brings the conversation with that agent back to the foreground. When the user returns, the agent might say: “Your 10-minute data analysis is done. Would you like me to display the summary or just read out the highlights?”

The system may implement a unified abstraction layer by routing tasks to one or more specialized agents behind the scenes, managing concurrency and data handoffs. The system may preserver the user's context, which allows the user to fluidly switch from task to task (for example, “Please remind me in 10 minutes to check the sales report.”). The system maintains continuity and timers across these tasks.

By providing a transparent and flexible approach to handle long-running tasks, the system ensures multi-agent systems behave more like a traditional operating system—capable of background processing, progress notifications, and easy re-entry—bridging the gap between quick voice commands and complex user workflows.

An example use case is as follows: The user says: “Hey Shell, ask the Timer Agent to set a 25-minute timer for my break.” The Timer Agent acknowledges, then runs in the background. The user continues talking to a different agent about scheduling tasks. When 25 minutes pass, the Timer Agent uses the spatial audio anchor to issue a prompt: “Time is up! Your break timer just finished,” re-entering the conversation foreground.

Another example use case is the following: The user instructs a “Data Analytics Agent” to run a multi-step sales report that typically takes 10-15 minutes. The user verbally says, “Do that in the background, and let me know when it's done.” The user moves on to talk to a “Calendar Agent” about rearranging appointments. Once the analytics complete, the user hears a subtle chime or sees a small overlay notification: “Sales report is ready. Would you like details now?” The user confirms, pulling the Data Analytics Agent's conversation back to the foreground, hearing or viewing the final results.

Through this model, long operations do not stall the conversation flow, and the user can handle multiple tasks concurrently—just as in a graphical UI with minimized windows and pop-up notifications.

### Input

### 1. Audio-Based Gesture Recognition System for Intuitive User Control

Gesture-based controls have grown increasingly popular for their hands-free, intuitive user experience—particularly in the fields of wearable technology, smart homes, and interactive media. However, many existing gesture-recognition solutions rely on camera-based or infrared systems, which can be incompatible with certain environments (for example, poor lighting) or with purely auditory user interfaces (AUIs). This limitation can restrict adoption in scenarios where visual detection is impractical or undesirable.

The described technology provides technical solutions to these technical problems. An audio-centric gesture recognition system according to the described technology identifies distinct sound patterns (such as claps, finger snaps, or voiced syllables) as user commands to control device functions. By analyzing acoustic characteristics (for example, timing, amplitude, frequency signatures), it can reliably interpret user intent. Features or components of the system include signal capture and preprocessing, feature extraction and classification, command execution, and continuous learning and personalization

Signal capture and preprocessing may include multiple microphones (or a single microphone with an optimized acoustic design) capturing user-generated sounds from different angles or distances and noise filtering, where adaptive algorithms isolate short, high-intensity bursts (for example, a clap) or specific frequency components (for example, a finger snap) from background noise.

Feature extraction and classification may include spectral and temporal analysis, where the system extracts unique patterns such as onset time, peak frequency, and energy distribution to distinguish gestures from random noises, and utilizing a gesture database that includes a library of recognized sound-based gestures (for example, double clap, finger snap, short vocal utterances) alongside user preferences or context-specific mappings.

Command execution may include mapping gestures to functions: each detected gesture may be tied to an action-like adjusting volume, toggling playback, skipping tracks, or launching a virtual assistant; and context awareness: the system may adapt its interpretations based on environment or user-defined modes (for example, ignoring snapping sounds when music is very loud).

Continuous learning and personalization may include use of adaptive thresholds: the system may evolve to user habits or environmental changes, thereby reducing or minimizing false positives. The system may also utilize user-defined gestures to allow individuals to record personal sounds that the system learns to recognize as commands, ensuring a more customized experience.

Potential applications of the system include wearable devices, where the system may provide an eyes-free, hands-free interface for AR/VR headsets, smart earbuds, or other personal electronics; smart home systems, where the system may let users control lights, thermostats, or media playback by issuing simple audible gestures—even when their hands are occupied; interactive installations: in museums or retail environments, visitors can trigger immersive features with claps or snaps, preserving a contactless experience; and hygiene and safety uses: ideal for clinical or industrial settings where physical contact may be restricted or unsanitary, reducing the need for shared surfaces or touchscreens.

One advantage of the system may be that the system may reduce or eliminate reliance on visual detection or manual interfaces, supporting users in contexts where sight or touch is unavailable or infeasible. Another advantage may be enhanced accessibility: the system may expand the usability of devices for those with mobility or visual impairments who find voice or visual gestures less feasible. Another advantage is that users can tailor the system with unique gestures and thresholds, supporting a broad range of personal or cultural preferences. Another advantage may pertain to promotion of hygiene by enabling interactions without physical touch, beneficial in healthcare facilities, public spaces, or specialized work areas. The system may also be integrated into existing AUI platforms or systems that rely predominantly on auditory feedback and voice commands.

### 2. Predictive Input Processing for Low-Latency Conversational Interfaces

Voice-based UI experiences often suffer noticeable response delays while the user's entire utterance is captured, processed, and recognized. Conventional approaches typically wait for a clear endpoint—the user has paused—and then route the recognized text to a language model or agent for interpretation. This can create a perceptible lag that breaks conversational flow.

Large Language Models (LLMs) inherently predict the next token based on context, but these capabilities are traditionally used only for text generation, not real-time user speech prediction. Existing solutions like partial or incremental ASR (Automatic Speech Recognition) can provide in-progress transcripts, yet seldom integrate with a model that continuously forecasts the user's likely completion of an utterance. Consequently, the assistant's final response is still delayed until the user fully finishes speaking and the recognized text is stable.

The described technology provides technical solutions to these technical problems. A predictive input system according to the described technology continuously guesses the remainder of a user's utterance as they speak, allowing high-confidence predictions to be preemptively processed by the system's agent(s). Features or components of the system include incremental ASR and partial transcripts, next-token prediction using large language models, preemptive task processing, turn-taking and final confirmation, and continuity and parallelization.

Incremental ASR and partial transcripts aspects may include word-by-word updates: as the user speaks, an automatic speech recognizer streams partial transcripts in near real-time; and confidence scoring: each partial transcript segment carries an ASR confidence measure.

Next-token prediction using large language models may include contextual forecasting: the partial transcript may be fed into a large language model that suggests probable continuations (for example, “play abba's greatest hits . . . ”); and dynamic probability thresholding: the system may monitor the confidence distribution of the large language model. If the confidence distribution surpasses a set threshold (“high confidence”), the system tentatively locks in that predicted utterance.

Preemptive task processing may include early agent routing: as soon as the system is confident in the full user command, it routes the task to the appropriate agent before the user finishes speaking; and parallel hypotheses: if multiple high-likelihood completions exist, the system can precompute a set of possible outcomes, each matched with a potential response.

Turn-taking and final confirmation may include endpointing: when speech input ends (or the user's pause is detected), the system may compare the actual final transcript with the predicted version; seamless response: if the final transcript closely matches the prediction, the system may instantly deliver the precomputed response, yielding near-zero perceived latency; and mismatch fallback: if a significant discrepancy occurs, the system may quickly adjust, clarify, or regenerate a response aligned with the true user input. A user may even perceive negative latency if the system has high enough confidence in its prediction and high confidence about an imminent endpoint that the system barges in during user speech.

Continuity and parallelization may include low latency, natural flow: by anticipating the user's likely request, conversation can proceed with minimal downtime-akin to human conversation overlap; and context accumulation: the system uses ongoing context (previous conversation turns, user preferences) to refine prediction accuracy further.

An example use of the system is as follows: a user wearing a voice-driven headset says, “shell, schedule a meeting on . . . ” Incremental ASR: as user pronounces “sche- . . . meet . . . on,” the partial transcripts come in. Large language model prediction: the system recognizes a high probability the user will say, “schedule a meeting on Friday at 10 am.” Preemptive processing: with moderate confidence, the system internally prepares a “schedule meeting” agent call, tentatively setting Friday at 10 am. The user finishes: actual utterance is “Shell, schedule a meeting on Friday at 10 am with the product team.” The final recognized text is 90% identical to the predicted text, only adding “with the product team.” The agent call is quickly updated with the extra detail, but the base scheduling request is already done. Instantaneous or near-instantaneous response: the system effectively responds the moment user stops speaking, “your meeting on Friday at 10 am with the product team is set,” avoiding the usual processing delay.

### 3. Intelligent Conversational Endpointing for Natural Voice Interactions

Traditional voice assistants and speech recognizers often rely on simple timeouts or fixed silence thresholds to infer when the user is done speaking. This can lead to interruptions if the user is merely pausing to think, or awkwardly delayed responses if the user expects a quick back-and-forth. While some advanced systems attempt partial solutions—like incremental ASR or barge-in detection—most lack context-aware endpointing that factors in user-specific speaking styles, semantic content, and environmental cues. The result is frequently a robotic feeling of wait-then-respond, rather than the rapid and overlapping dynamic found in organic human conversation.

The described technology provides technical solutions to these technical problems. An intelligent endpointing system according to the described technology may manage real-time conversation flow in audio user interfaces (AUIs). The system may marry speech analysis, user context data, and device-level sensing (gestures, orientation) to adapt turn-taking boundaries in a natural way. Features or components of the system include multi-modal input and semantic cues, adaptive turn-taking logic, conversational style modules, and device and gestural input integration.

Multi-modal input and semantic cues may include incremental speech analysis: the system may monitor user speech word-by-word, noting timing, pitch shifts, and partial semantic meaning; and context and user profile: the system may leverage known user speech patterns (for example, frequent short pauses, typical filler words) and conversation context (time of day, location, ongoing topic).

Adaptive turn-taking logic may include hesitation vs. completion detection: the system may distinguish between a user who's searching for words and a user who's finished by measuring speech rate, intonation, and silence length in combination with semantic indicators (such as incomplete phrases); and natural overlaps: the system may allow for short, affirmative interjections or “barge-ins,” emulating how two humans might speak simultaneously to express agreement or to jump in with relevant info.

Conversational style modules may include modes of interaction: the system may utilize configurable style profiles (for example, “quick brainstorming” vs. “formal, turn-by-turn mode”) that adapt endpointing thresholds and interrupt rules; and individual calibration: over time, the system may refine how quickly it responds to each user's manner of speaking, personal pausing length, or gestures that signal continuing thoughts.

Device and gestural input integration may include physical cues: the system may look for gestures such as shifting gaze or raising a hand (where device hardware permits), helping the system decide if the user is mid-thought or seeking a response; and environmental signals: the system may consider external distractions (like sudden noise) or user posture changes that might cause an extended pause without final intent.

By dynamically determining when to end or bump in on a user's turn, the system may reduce user frustration from premature interruptions while enabling faster, more organic dialogues.

An example use of the system is as follows: a user is wearing smart earbuds that run the system. In a creative brainstorming conversation with the AI, the user frequently interrupts themselves or shifts topics mid-sentence. The system recognizes the user's slowed speech but also observes from prior turns that this user often leaves short silent gaps. Instead of concluding the user is done, the system waits. After a short hesitation, the user continues, “actually, let me refine that idea . . . ” Meanwhile, if the user exclaims “yes, exactly!” after the system begins to respond, the system gracefully yields, letting the user confirm or add input. This minimal friction and tight turn-taking fosters a truly collaborative style, much like two humans brainstorming side-by-side.

Advantages of the system include natural and human-like conversations: the system deftly manages overlaps, quick confirmations, and user pauses, reducing perceived “robotic” behavior; reduced user frustration: fewer false endpoints mean the ai doesn't interrupt mid-thought, while faster responses eliminate the feeling of lag; context-aware behavior: ephemeral context (like environment noise) and personal user patterns feed into dynamic logic, tailoring endpoint decisions to each situation; improved responsiveness: when the user finishes a sentence definitively, the system quickly offers a response, supporting faster back-and-forth; and broad application: the system may be integrated into a variety of voice-activated devices—smart earbuds, in-car systems, or augmented/virtual reality audio interfaces—where real-time conversation flow is important.

### Intent

### 1. Natural Language Triaging for Multi-Agent Conversational Systems

Most voice-activated AI systems rely on explicit wakewords (for example, “Hey Assistant”) or structured commands. However, such systems often fail when the user speaks ambiguous or natural utterances amid a human-to-human conversation. They also struggle to route tasks to specialized apps when multiple domain agents exist. While some solutions detect wakewords, these do not comprehensively address two-step triaging: (1) determining if the system is being addressed or if the user is talking to another person, and (2) identifying which agent or application is best suited to fulfill the request. Conventional approaches often produce errors in busy or fluid conversation contexts and demand more rigid, less user-friendly commands.

The described technology provides technical solutions to these technical problems. The auditory operating system shell 3818 according to the described technology provides a two-stage intent understanding. At the first stage, the auditory operating system shell 3818 may distinguish between speech aimed at the auditory operating system shell 3818 and speech intended for another human present. The auditory operating system shell 3818 may analyze context (for example, user glances, phrase patterns), acoustic cues, and conversation flow. If the auditory operating system shell 3818 confirms that the user is indeed speaking to the auditory operating system shell 3818, the auditory operating system shell 3818 may proceed to the second stage.

At the second stage, once the auditory operating system shell 3818 recognizes system-directed speech, the auditory operating system shell 3818 may determine which specialized agent or application is relevant. For instance, a user might request music playback or lighting adjustment. The auditory operating system shell 3818 may use natural language processing to parse commands (explicit or implicit) and route them appropriately. Users can employ explicit wakewords (“Shell, open MusicApp”) or rely on context-driven utterances (“Turn down the volume.”), which may be ambiguous. The auditory operating system shell 3818 may interpret these utterances, decides if it is a known application domain (for example, the music agent), and forward the request with necessary details (for example, “user wants to lower the volume of music output”). Additionally or alternatively, the auditory operating system shell 3818 may determine that the auditory operating system shell 3818 is relevant, if for example, the user commands refer to device control or systems settings.

This natural language invocation strategy allows users to switch fluidly between human conversation and system commands—sometimes even embedding a command mid-sentence. The auditory operating system shell 3818 may thus mitigate confusion that is often found in multi-agent environments by determining who or what is being addressed and how best to fulfill the user's request.

The following scenario illustrates a use of the auditory operating system shell 3818: two friends are chatting while music plays from a multi-agent audio system. One friend says, “Yeah, totally. Turn down the volume. Sorry, these things are a little loud right now.” The auditory operating system shell 3818 analyzes that “turn down the volume” is not addressed to the friend but is a system-level request. Interpreting the user's speech as referring to music playback, the auditory operating system shell 3818 routes “turn down the volume” to the music agent and ignores everything else. The music agent lowers audio output. The conversation with the friend resumes uninterrupted, demonstrating seamless, mid-conversation invocation. This example highlights context recognition (system vs. human address) and application triaging (which agent is relevant), thereby delivering a natural, unobtrusive user experience.

### 2. Context-Aware Disambiguation for Multi-Agent Conversational Systems

Conventional voice assistants or chatbots often rely on user commands that are explicit or limited to a single domain (for example, “Set an alarm for 7 a.m.”). When encountering ambiguous statements—like “Remind me to finish the report,” or “What's happening later today?”—these systems may struggle without prior context about user schedules or location. While some advanced AI solutions incorporate partial user data, they fail to integrate multiple layers of context in real time (for example, date/time, user preferences, location) to provide robust disambiguation. This shortfall can result in incorrect or irrelevant responses to user requests.

The described technology provides technical solutions to these technical problems. The auditory operating system shell 3818 according to the described technology utilizes a context-aware disambiguation mechanism for multi-agent conversational platforms.

The auditory operating system shell 3818 may collect user data such as user preferences (for example, user's favorite music genre, dietary restrictions), schedule data (appointments, deadlines), and the current date/time. The auditory operating system shell 3818 may also retrieve device data such as the user's location (GPS), local environment data (for example, noise level), and other relevant parameters (battery status, connectivity) for use in disambiguating user commands or queries.

When a user issues a vague or incomplete command-“Should we check the latest events tonight?”, the auditory operating system shell 3818 may automatically append relevant context (current time, user's free/busy calendar slots, location) to the user request. The receiving agent (for example, an events recommendation agent) may use this appended context to disambiguate meaning (for example, “tonight” refers to the next available time slot on the user's calendar in the user's current city). Each agent has specialized reasoning. With user data and device data, the agent may finalize precise interpretations. For instance, “Remind me to finish the report” might map to scheduling a reminder at the next feasible work hour based on the user's location (office or traveling) and any relevant user preferences. If the user's data indicates traveling at the expected time, the auditory operating system shell 3818 may ask clarifying questions or propose an alternative plan.

The agent may use the context data to respond to the user or to ask clarifying questions. For example, the agent may state: “I see you have a meeting at 3 p.m. in your schedule. Would you like me to remind you about finishing the report before or after that meeting?” By utilizing user context, the auditory operating system shell 3818 may resolve ambiguities gracefully, reducing error and increasing relevancy.

An example scenario is as follows: A user says to the auditory operating system shell 3818, “Book me a table at my usual spot tonight.” The auditory operating system shell 3818 identifies (a) user's favorite restaurant (user preference data), (b) current time and day, and (c) user's calendar to check if “tonight” has open availability. The “Reservations Agent” receives the request along with context (restaurant preference, timeslot from user schedule, location for travel time). The agent sees “tonight” is a weekday, recognizes the user is free from 7 p.m. to 9 p.m., and the “usual spot” is the user's preferred Italian restaurant located 2 miles away. The agent automatically picks 7:30 p.m. at the Italian restaurant, verifying with the user “Shall I reserve for 7:30 p.m. at your usual Italian place?” The user confirms, and the agent books a table-seamlessly bridging vague input with user-specific and device context.

### Context

### 1. Contextual Awareness and Response System

Many modern devices—ranging from wearables to mobile phones—offer diverse features yet often lack contextual intelligence. For instance, a smartphone might continue playing audio at a fixed volume even if the user moves from a quiet living room to a busy street. Traditional interfaces generally do not adapt to environmental factors such as user motion, location, or ambient noise, limiting their potential to deliver a personalized, dynamic experience

The described technology provides technical solutions to these technical problems. A contextual awareness system according to the described technology leverages GPS, inertial measurement units (IMUs), and microphone arrays to interpret the user's surrounding environment and usage context, then dynamically adjusts device behaviors accordingly.

The system may use GPS to determine a location of the user for purposes of adapting an application or interface settings. For example, the system may automatically switch to a quiet mode in libraries or adjust navigation preferences based on the environmental setting (for example, urban or rural settings). The system may utilize the IMUs to observes acceleration, velocity, and orientation to infer states such as walking, driving, or running. The system may then tailor notifications, screen engagement, or audio announcements to minimize distraction or enhance safety. The system may utilize the microphone arrays to assess ambient noise levels, speech patterns, or potential hazards (for example, sirens), or to modify volume, playback characteristics, and notification cues. The system may thus assist in maintaining clarity or respecting social contexts.

By blending these data streams, the system may contextualize device operations in real time. For example, if the user is moving quickly through a loud city environment, the system may automatically increase audio output volume, shift notification styles to vibration or narrower beep frequencies, and optimize speech recognition engines to handle background noise. This may yield a dynamic, personalized experience that adjusts as the user's situation evolves.

One potential application of the system is in wearable devices such as watches or earbuds that adapt workout music volume or coaching prompts based on user motion and nearby traffic noise. Another potential application of the system is in home systems to automatically adjust climate or lighting settings when the user is detected entering or leaving, and to alter voice assistant output volume based on current activity. The system may also be utilized in mobile devices such as mobile phones to shift notification settings and display brightness depending on the user's location, orientation, and background sound conditions. Another potential application of the system may be in personal assistants to enhance voice recognition accuracy and feedback style in busy public areas (as compared to quiet offices), thereby reducing false activations

The system provides numerous advantages. One advantage is that the system may dynamically tailor device behavior to user context, thereby improving user convenience and satisfaction. The system may enhance engagement by providing quick adaptive responses to external conditions and thus may foster more natural interactions and fewer disruptions. Another advantage is that the system may facilitate reduced power consumption by limiting or changing certain functionalities when such functionalities are not contextually relevant. Another advantage is that the system may reduce or minimize distraction during activities like driving or running by proactively adjusting output for different user needs or environmental constraints.

### 2. Dynamic User Profiling for Personalized Auditory Experience

Auditory interfaces often serve a broad user base, each with unique listening preferences, varying hearing capabilities, and context-specific needs (for example, working in a noisy environment vs. relaxing at home). Traditional solutions rely on static settings or manual controls, which can be tedious to adjust frequently. This leads to suboptimal experiences, where the user's changing environment or personal state is not continuously factored into the device's auditory output.

The described technology provides technical solutions to these technical problems. A dynamic user profiling system according to the described technology continuously learns and adapts to user preferences and environmental contexts in real time in order to improve or optimize the auditory experience for users. Features or components of the system include machine learning-based preference modeling, contextual awareness and environmental sensing, continuous profile refinement, and a seamless user experience.

The system may implement machine learning-based preference modeling by gathering data on user interactions—for example, manual volume adjustments, content selections, or spoken feedback—and utilizing machine learning techniques to discover patterns or trends. For example, the system may utilize one or more machine learning or artificial intelligence models to analyze the user interaction data to determine patterns or trends in how the user utilizes the auditory user interface. The system may modify volume levels, speech synthesis speed or pitch, or other audio parameters based on the patterns or trends.

The system may provide contextual awareness and environmental sensing by continuously monitoring surrounding sound levels to automatically raise or lower system volume or activate noise-canceling features. The system may identify when the user moves to a quieter or more public setting and adjust earcon usage, notifications, or voice command prompts to fit the context.

The system may implement continuous profile refinement by updating a user-specific profile over time, thereby capturing changes in behavior or environment. This continuous adaption may be useful for users with evolving needs, such as users with hearing sensitivity shifts. The system may share profiles across devices (for example, phone, earbuds, smart speakers) in order to provide consistent personalized settings across the devices.

The system may provide a seamless user experience by reducing or minimizing explicit user intervention by learning and reacting to cues in the background. The system may provide user-configurable limits on auto-adjustments, maintaining a sense of control while enabling adaptive intelligence.

One potential application of the system is in personal audio devices such as earbuds or headphones. The system may automatically adjust levels, equalization, and ambient passthrough based on user context. Another potential application is for facilitating adaptive media consumption, such as in streaming platforms or e-readers that modify narration speed, voice type, or background music volume according to user engagement. The system may also be used in educational platforms to customize audio-based lessons to suit each learner's pace, attention span, and noise environment. Another potential application of the system is in public or shared spaces. For example, libraries, offices, or hospitals may utilize the system to adapt notifications or conversation volume to respect privacy and ambient sound levels.

One advantage of the system is that the system may increase user satisfaction, as the system allows for creation of customized listening environment by accommodating user preferences without constant manual changes. Another advantage relates to improved accessibility, as the system may adapt over time to accommodate changes in hearing ability, user behavior, or environment. The system may also leverage environmental data to deliver only relevant and properly balanced auditory content. Another advantage of the system is that the system may reduce or minimize cognitive load on the user by reducing the effort required to repeatedly adjust settings, thereby allowing the user to focus on tasks at hand. The system may also be scalable and device-agnostic: the system may synchronize user profiles across devices and ecosystems to preserve continuity of personalization for the user.

### 3. Context Engine for Secure, Personalized Conversational AI

Many voice assistants and AI systems rely on shallow context (for example, user location, time of day) to improve relevance, but do not thoroughly address structured user data (for example, birthdays, social graph) or robust privacy controls. Existing solutions typically store user data in central databases but fail to provide fine-grained permission settings, inspectability for users to correct data, or strong access gating to protect personal info. This can lead to either overexposure of user data or underutilization of valuable context. A context engine that balances rich personalization with security is lacking in conventional platforms.

The described technology provides technical solutions to these technical problems. a system according to the described technology implements a context engine for multi-agent conversational systems, ensuring that each domain agent receives only the relevant context required to complete its task while protecting sensitive user data. components or features of the system include structured context management, selective access control and privacy safeguards, active user input and inspectability, and conversational inference and task execution.

The system may implement structured context management by obtaining ephemeral data (for example, data such as location, time of day, nearby points of interest, and weather) and persistent data (for example, user profile data such as name, and birthdate, user preferences, and social graph) and organizing each data category into layers with specific access rules (for example, ephemeral location data for navigation vs. persistent user contact list for messaging).

The system may implement selective access control and privacy safeguards by enforcing granular permissions. When a specialized agent (for example, a restaurant reservation agent) requests context, the system may selectively share only relevant data (for example, city-level location, dining preferences) while withholding nonessential or sensitive details (for example, birthdate, home address). In some embodiments, the system may utilize zero-knowledge approaches for allowing access to data. For example, the system may use cryptographic methods to ensuring that external apps can confirm user details without directly accessing them.

The system may implement active user input and inspectability by allowing users to specify additional context rules verbally or non-verbally (for example, “Shell, this is my bedroom—disable mic input automatically here”), by allowing users to record corrections, or by implementing contextual labels and access tiers. For example, the system may allow a user to utilize a companion interface or voice input to view or revise the user's stored context (for example, “that's not my workplace, correct it”). As another example, the system may allow users to label certain places or data categories as off-limits or restricted, which may determine if or how the system discloses info to agents.

The system may implement conversational inference and task execution by utilizing both ephemeral data (for example, current time) and persistent data (for example, user's typical coffee preference). The system may thereby handle ambiguous requests seamlessly. Moreover, the system may mediate context flow to multiple agents concurrently, ensuring each agent sees only the segments of user data needed for that domain (for example, calendar agent gets user's schedule, music agent gets preference history).

An example use of the system is as follows: A user verbally defines, “Shell, I am at my home office. Keep logs of all my voice commands here but do not share my location with third-party apps.” Later, the user says, “Book a meeting with Sarah tomorrow.” The calendar agent requests the user's schedule and contact info for “Sarah.” The system releases only the necessary details—time slots and Sarah's email—while withholding other private data. If the user's next command references “what's the weather near me?” the system may provide approximate location data to the weather agent without disclosing the user's precise address, depending on user-defined privacy preferences.

One advantage of the system is that the system provides enhanced personalization with strict privacy, as the system harnesses ephemeral and persistent user data for better accuracy but shares minimal required info with each agent. Another advantage relates to contextual integrity: the system facilitates users confidently delegating tasks knowing that the system respects place-specific, user-specified rules for microphone usage or data logging. The system also empowers users by providing inspectability features that allow for continuous oversight and correction of stored user context, which may increase user trust and ensure data fidelity. The system also provides a scalable multi-agent architecture that enforces consistent access policies without re-exposing sensitive data even as new specialized agents are utilized by the user. Another advantage of the system is that by providing access to pertinent context, the system may shorten user-agent dialogues—no repeated clarifications—while privacy layers remain intact.

### Audio Output

### 1. Adaptive Auditory Scene Management for Enhanced User Focus and Privacy

In shared or open environments, multiple audio streams can overlap—for example, background music, notifications, voice interactions, and ambient noise—causing listening fatigue and challenges in maintaining focus or privacy. Conventional solutions rely on manual volume adjustment or noise cancellation, which may not adapt swiftly to dynamic user needs such as receiving an important notification or ensuring a conversation remains private.

The described technology provides technical solutions to these technical problems. A dynamic, context-aware auditory scene management system according to the described technology orchestrates audio sources according to user engagement, focus requirements, and privacy settings. Features or components of the system include audio stream prioritization, automatic gain control and mixing, spatial repositioning, and personalized and context-aware controls.

The system may implement audio stream prioritization through real-time monitoring of audio streams. The system may identify and classify active audio streams (for example, music, voice calls, system notifications) and assign priorities to audio streams based on priority based on current tasks, user profile data, or explicit user preferences (for example, meeting vs. leisure time). The system may rank audio streams based on assigned priorities.

The system may implement automatic gain control and mixing by adjusting the volume of audio streams and using crossfading. For example, the system may raise or lower the gains of certain audio sources to prevent cognitive overload or to highlight critical information—such as lowering ambient music when a message arrives. As another example, the system may adjust transition and fades to reduce or minimize abrupt changes, thereby preserving a natural auditory experience.

The system may implement spatial repositioning by, for example, modifying or adjusting the spatial locations of audio streams based on their ranks or priorities. For example, the system may shift sensitive audio (for example, phone calls, private alerts) closer to the user's listening focal point (for example, in-canal earphone audio) to reduce the chance of eavesdropping. The system may also facilitate focused listening by the user by placing non-essential audio further away in the user's perceived sound field. This may free up mental bandwidth for important streams.

The system may implement personalized and context-aware controls through user-defined rules or objectives (for example, “work mode,” “relax mode,” or “travel mode”). The rules may dictate how the system should balance or filter audio streams. Moreover, the system may adapt in real time to respond to situational cues—such as an incoming call or a scheduled reminder—to apply temporary or permanent changes in the audio scene.

By blending these elements, the system may ensure optimal audio experiences across diverse settings—reducing distractions, protecting privacy, and enhancing user comfort.

A potential application of the system is in personal audio devices such as earbuds or headsets that auto-adjust entertainment audio to highlight urgent communications or mask private conversations. Another potential application is in productivity tools to provide workplace solutions where multiple streams (for example, collaboration calls, background music, chat notifications) may coordinate to maintain focus. Another potential application is in public spaces such as co-working offices, libraries, or cafes. The system may use location-based preferences to direct or dampen audio, preserving quiet zones or ensuring conversation confidentiality. The system may also be used in specialized environments such as healthcare facilities, control rooms, or law enforcement operations. In such settings the system may provide fine-tuned audio prioritization that facilitates safety and privacy.

One advantage of the system is that the system may provide enhanced focus and efficiency for users. By automatically prioritizing or muting audio, the system may free users from manual volume adjustments, which may result in smoother workflows for users. Another advantage relates to customizable privacy. Users control how and where private audio is rendered, which may reduce the chance of sensitive information leakage. Another advantage is that the system may provide personalized soundscapes, as adaptive algorithms may create a tailored audio bubble for a user that matches the user context (for example, tasks, location, daily schedule). The system may also reduce or mitigate the cognitive load of competing audio sources through the use of crossfading and context-based mixing. The system may also be integrated into or applicable to various types of hardware, such as earbuds, speakers, and mixed-reality headsets and software ecosystems, from consumer gadgets to professional solutions.

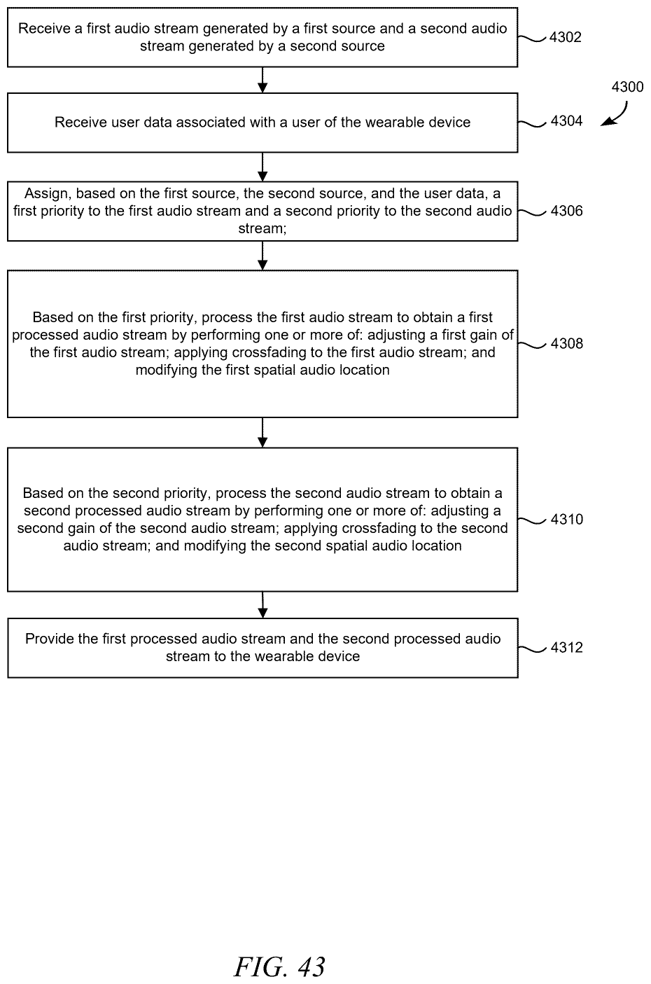

FIG. 43 is a flow diagram illustrating an example method 4300 that some embodiments of aspects of the described technology may perform. The method 4300 may begin at step 4302, where the auditory operating system shell 3818 receives a first audio stream generated by a first source and a second audio stream generated by a second source. The first audio stream and the second audio stream are to be output as first sound in a first spatial audio location and second sound in a second spatial audio location by one or more sound output devices of a wearable device.

At step 4304 the auditory operating system shell 3818 receives user data associated with a user of the wearable device. At step 4306 the auditory operating system shell 3818 assigns, based on the first source, the second source, and the user data, a first priority to the first audio stream and a second priority to the second audio stream. At step 4308, the auditory operating system shell 3818, based on the first priority, processes the first audio stream to obtain a first processed audio stream by performing one or more of: adjusting a first gain of the first audio stream; applying crossfading to the first audio stream; and modifying the first spatial audio location. At step 4310, the auditory operating system shell 3818, based on the second priority, processes the second audio stream to obtain a second processed audio stream by performing one or more of: adjusting a second gain of the second audio stream; applying crossfading to the second audio stream; and modifying the second spatial audio location. At step 4312 the auditory operating system shell 3818 provides the first processed audio stream and the second processed audio stream to the wearable device for output by the one or more sound output devices of the first sound at the first spatial audio location and the second sound at the second spatial audio location. Additional or alternative steps are possible

In some aspects, the techniques described herein relate to a method including: receiving a first audio stream generated by a first source and a second audio stream generated by a second source, the first audio stream and the second audio stream for output as first sound in a first spatial audio location and second sound in a second spatial audio location by one or more sound output devices of a wearable device; receiving user data associated with a user of the wearable device; assigning, based on the first source, the second source, and the user data, a first priority to the first audio stream and a second priority to the second audio stream; based on the first priority, processing the first audio stream to obtain a first processed audio stream by performing one or more of: adjusting a first gain of the first audio stream; applying crossfading to the first audio stream; and modifying the first spatial audio location; based on the second priority, processing the second audio stream to obtain a second processed audio stream by performing one or more of: adjusting a second gain of the second audio stream; applying crossfading to the second audio stream; and modifying the second spatial audio location; and providing the first processed audio stream and the second processed audio stream to the wearable device for output by the one or more sound output devices of the first sound at the first spatial audio location and the second sound at the second spatial audio location.

In some aspects, the techniques described herein relate to a method, further including receiving user preference data associated with the user, wherein the first audio stream and the second audio stream are further processed based on the user preference data.

In some aspects, the techniques described herein relate to a method, further including receiving one or more rules defined by the user, wherein the first audio stream and the second audio stream are further processed based on the one or more rules.

In some aspects, the techniques described herein relate to one or more non-transitory computer-readable media including executable instructions that when executed by one or more processors of a system cause the system to perform a method including: receiving a first audio stream generated by a first source and a second audio stream generated by a second source, the first audio stream and the second audio stream for output as first sound in a first spatial audio location and second sound in a second spatial audio location by one or more sound output devices of a wearable device; receiving user data associated with a user of the wearable device; assigning, based on the first source, the second source, and the user data, a first priority to the first audio stream and a second priority to the second audio stream; based on the first priority, processing the first audio stream to obtain a first processed audio stream by performing one or more of: adjusting a first gain of the first audio stream; applying crossfading to the first audio stream; and modifying the first spatial audio location; based on the second priority, processing the second audio stream to obtain a second processed audio stream by performing one or more of: adjusting a second gain of the second audio stream; applying crossfading to the second audio stream; and modifying the second spatial audio location; and providing the first processed audio stream and the second processed audio stream to the wearable device for output by the one or more sound output devices of the first sound at the first spatial audio location and the second sound at the second spatial audio location.

In some aspects, the techniques described herein relate to one or more non-transitory computer-readable media, the method further including receiving user preference data associated with the user, wherein the first audio stream and the second audio stream are further processed based on the user preference data.

In some aspects, the techniques described herein relate to one or more non-transitory computer-readable media, the method further including receiving one or more rules defined by the user, wherein the first audio stream and the second audio stream are further processed based on the one or more rules.

In some aspects, the techniques described herein relate to a system including at least one processor and at least one memory including executable instructions that when executed by the at least one processor cause the system to: receive a first audio stream generated by a first source and a second audio stream generated by a second source, the first audio stream and the second audio stream for output as first sound in a first spatial audio location and second sound in a second spatial audio location by one or more sound output devices of a wearable device; receive user data associated with a user of the wearable device; assign, based on the first source, the second source, and the user data, a first priority to the first audio stream and a second priority to the second audio stream; based on the first priority, process the first audio stream to obtain a first processed audio stream by performing one or more of: adjusting a first gain of the first audio stream; applying crossfading to the first audio stream; and modifying the first spatial audio location; based on the second priority, process the second audio stream to obtain a second processed audio stream by performing one or more of: adjusting a second gain of the second audio stream; applying crossfading to the second audio stream; and modifying the second spatial audio location; and provide the first processed audio stream and the second processed audio stream to the wearable device for output by the one or more sound output devices of the first sound at the first spatial audio location and the second sound at the second spatial audio location.

### 2. Customizable Earcon-Based Notification System for Auditory User Interfaces

Traditional user interfaces rely heavily on visual notifications—icons, banners, or pop-ups—to alert users of messages, statuses, or system updates. In a purely auditory user interface (AUI), these visual cues no longer apply. Instead, earcons, which may be or include short, distinctive auditory signals, may become the primary means of communicating different types of notifications or states. Designing earcons that effectively convey meaning without overwhelming or confusing the user is a unique challenge for AUIs.

The described technology provides technical solutions to these technical problems. A system according to the described technology creates, manages, and delivers earcons in an auditory user interface. Features or components of the system include an earcon library and classification, user-driven customization, adaptive delivery and management, and integration with multiple services.

The system may implement the earcon library by providing a collection of earcons, such as a set of predefined sounds, each mapped to a particular notification category (for example, incoming message, error, system alert). The system may also generate sounds dynamically based on procedural aspects such as application type and state. The system may classify or categorize sounds by urgency, priority, or function (for example, critical alert vs. friendly reminder).

The system may implement user-driven customization by allowing users to select or upload their own audio clips to replace default earcons. The system may allow for contextual adaptation by modifying or swapping earcons automatically based on factors like time of day, user location, or current activity (for example, silent mode when at work).

The system may implement adaptive delivery and management by providing dynamic volume and tempo adjustment or by notification queueing and scheduling. For example, the system may adapt earcon volume, pitch, or tempo based on ambient noise level or user engagement. As another example, the system may buffer or delay earcons to avoid confusion during voice commands or high cognitive-load situations, ensuring clarity and non-intrusive alerts.

The system may be integrated with multiple services by supporting multiple platforms, such as wearables, smart home devices, automotive infotainment systems, and smartphones can share consistent earcon themes for a unified user experience. Moreover, earcons generated by different applications or system modules can be orchestrated to prevent overlap or auditory clutter.

By offering an earcon-centric notification strategy and robust customization, the system significantly improves the user's auditory experience-particularly for those with limited or no access to visual cues, or in scenarios where eyes-free operation is preferred.

One potential application of the system is in wearable devices, such as watches, earbuds, or AR headsets where visual real estate may be limited or nonexistent. Another potential application is in assistants and home devices for agents that provide voice-based notifications, complemented by distinct earcons for status or alerts. The system may also be used to facilitate accessible computing. For example, for users with visual impairments, earcons can denote system states and events, thereby allowing independent interaction with digital systems. The system may also be used in vehicles such as automotive infotainment systems to provide in-dash notifications that reduce driver distraction by minimizing reliance on visual attention.

The system provides multiple advantages. One advantage is that the system is non-intrusive and intuitive, as sound-based cues can be quickly recognized without requiring the user's visual attention. The system enhances accessibility by improving usability for visually impaired individuals or in situations where sight is otherwise occupied. Another advantage is the personalized experience that the system provides: users can select or create earcons, lending a sense of ownership and reducing alert fatigue. The system may also be adaptive and context-aware by dynamically adjusting earcon playback to ensure clarity and relevance in different environments or contexts. Yet another advantage is that the system also supports platform-agnostic integration: by allowing for consistent, centralized control of auditory notifications across various devices and applications.

### 3. Integrated Auditory Navigation and Information System for Public and Private Spaces

Navigating large or complex physical environments—be they public spaces (museums, shopping centers) or private facilities (offices, campuses)—can be challenging, especially for individuals with visual impairments or users who cannot devote visual attention to a map or signage. While some digital tools offer mobile navigation, they often rely heavily on visual cues, leaving auditory feedback as a secondary feature or providing minimal contextual details about surroundings.

The described technology provides technical solutions to these technical problems. A system according to the described technology assists users in finding their way while also delivering contextual information about the environment. Features or components of the system include spatial audio guidance, environmental sound recognition, natural language interaction and information delivery, and user profile and customization.

The system may implement spatial audio guidance by providing 3D sound cues that utilize spatial audio to convey directional information (for example, turn left, proceed forward) and relative distance to landmarks or points of interest). The system may make real-time route adjustments based on user location to ensure accurate guidance if the user deviates from a planned path.

The system may implement environmental sound recognition by performing acoustic analysis in real time to identify critical ambient sounds (for example, approaching vehicles, alarms, escalators). This allows the system to warn users of potential hazards or changes in the environment. The system may also provide contextual sound clues by blending recognized sounds with location data, thereby reinforcing user mental maps of the area.

The system may implement natural language interaction and information delivery by allowing users to provide voice input and providing spatialized responses to the input. For example, users can ask for directions (“where is the nearest restroom?”) or request details on points of interest (“tell me more about this exhibit”). The system may deliver answers or relevant info via localized audio cues, which may enable users to pinpoint the direction of the information source.

The system may implement user profile and customization via personalized settings, such as volume levels, language, frequency of updates, and detail depth adapt to user preferences or sensory requirements, and accessibility features that may be configurable to provide step-by-step instructions, hazard detection, or advanced descriptive cues for individuals with low or no vision.

A potential application of the system is in assistive technology where the system may provide robust navigation and environment awareness for people with visual impairments, supporting independent travel. Another potential application is in indoor navigation solutions, as the system may enhance user experience in large complexes like malls, airports, or corporate campuses by offering real-time, hands-free guidance. The system may also be used in museums and educational spaces to deliver location-based commentary, historical anecdotes, or interactive learning tasks, accessible via auditory engagement. Another potential application of the system is in augmented or mixed reality systems. The system may merge physical and virtual worlds, situating guided tours or game elements as layered spatial audio overlays that users can follow or interact with.

The system provides multiple advantages. One advantage is improved spatial awareness. 3D sound cues may help users form mental maps of their surroundings, improving both orientation and safety. Another advantage relates to increased accessibility—the system may address the needs of those with visual impairments, offering them greater autonomy in navigating public or private venues. Another advantage pertains to contextual learning—the system may provide educational or descriptive audio that enhances user engagement and retention, particularly in museum or cultural settings. The system implements user-centric design in that personalizable parameters ensure the solution adapts to individual comfort levels, abilities, and environment noise conditions. The system may also be integrated into existing hardware (for example, phones, AR or VR headsets) or dedicated wearable devices, broadening deployment flexibility.

### 4. Virtual Auditory Display

Many headphones and earbuds isolate the user from external sounds, creating a situation where ambient noise and environmental cues are greatly diminished. Although noise isolation can be beneficial in certain settings, this can also pose safety risks (for example, while walking in busy streets) and reduce situational awareness. In augmented reality (AR) or other immersive experiences, purely digital audio can overshadow important real-world cues, compromising the user's sense of presence and safety.

The described technology provides technical solutions to these technical problems. A virtual auditory display system according to the described technology seamlessly fuses real-world audio with digital content. The system employs spatial audio rendering, environmental noise adaptation, and selective sound filtration to enable users to maintain or enhance their environmental awareness while also listening to digital audio. Features or components of the system include dynamic spatial audio rendering, environmental noise adaptation, selective sound filtration, and personalized control and interfaces.

The system may implement dynamic spatial audio rendering by positioning in virtual auditory space sounds in the user's perceived soundfield to avoid confusing overlap with real-world audio. The system may also provide user-centric calibration by adapting to individual ear shapes and head movements, ensuring consistent localization of both real and virtual sound sources.

The system may implement environmental noise adaptation through adaptive volume control—if external noise spikes (for example, a passing vehicle), the system may automatically balance audio levels, preventing sudden audio overshadowing or user disorientation—and real-time equalization—the system may monitor the ambient sound profile and adjusts digital audio parameters to harmonize or contrast with real-world acoustics.

The system may implement selective sound filtration by a hear-through mode, in which dedicated microphones capture external noises, selectively filtering or attenuating specific frequencies, letting safety-critical sounds (for example, sirens, alarms) remain audible while less relevant background chatter is reduced. The system may allow users to define which real-world sounds are essential (for example, traffic signals, coworker's voice) and let the system intelligently maintain those audio cues in the mix.

The system may implement personalized control and interfaces through user preferences and gesture or voice commands. The system may provide customizable settings that let individuals modify the degree of environmental blending or digital audio emphasis. The system may also allow for quick on-the-fly adjustments through gestures or voice commands to allow users to switch modes (for example, silent, ambient emphasis, or fully immersive) without removing devices.

By integrating and enhancing the natural soundscape, users can stay aware of their surroundings while enjoying digital audio experiences, offering greater safety, comfort, and immersion.

One potential application of the system is in wearable devices such as earbuds or AR or VR headsets that deliver music, notifications, or directions without fully blocking external sounds. Another potential application pertains to assistive hearing technologies, as the system may be utilized in devices that help users with hearing impairment integrate environmental sounds more clearly while also enhancing speech or other important cues. Another potential application of the system is in gaming, especially immersive gaming, where the system may merge real-world auditory elements with in-game spatial audio to reinforce presence and situational awareness. The system may also be utilized to provide augmented reality experiences. The system may seamlessly layer location-based or context-driven audio over the natural environment for tourism, education, or interactive storytelling.

One advantage of the system may be improved safety and awareness: users may retain crucial environmental cues (for example, traffic sounds, approaching individuals) while experiencing digital audio. Another advantage is that the system may provide immersive audio blending by mixing real and virtual soundscapes, thereby heightening realism and engagement, especially in AR or VR and gaming. The context-adaptive audio of the system through dynamic volume and filtering adjustments may reduce user fatigue, preventing overly loud or masking effects. Another advantage of the system relates to the customizable user experience: the system allows a range of settings for personal preference, from near total immersion to minimal interference with real-world audio. The system also has numerous use cases: the system may be applicable in everyday consumer scenarios, professional environments (for example, factory floors), or specialized domains like hearing aids.

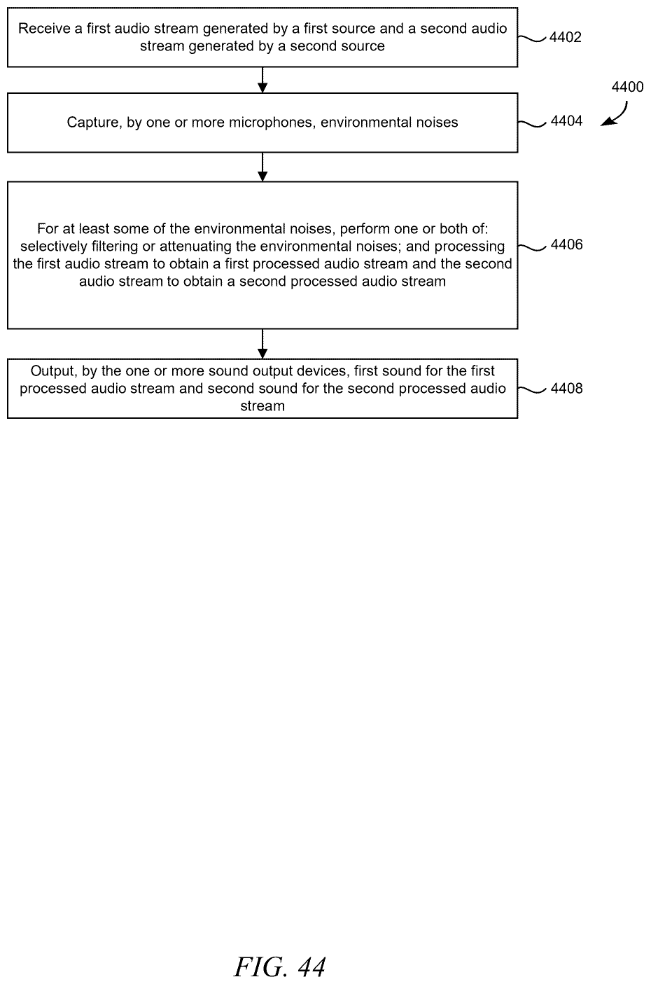

FIG. 44 is a flow diagram illustrating an example method 4400 that some embodiments of aspects of the described technology may perform. The method 4400 may begin at step 4402, where a wearable device having one or more sound output devices and one or more microphones receives a first audio stream generated by a first source and a second audio stream generated by a second source. The first audio stream and the second audio stream are to be output as first sound in a first spatial audio location and second sound in a second spatial audio location by one or more sound output devices.

At step 4404 the wearable device captures, by one or more microphones, environmental noises. At step 4406 the wearable device, for at least some of the environmental noises, performs one or both of selectively filtering or attenuating the environmental noises and processing the first audio stream to obtain a first processed audio stream and the second audio stream to obtain a second processed audio stream. At step 4408 the wearable device outputs, by the one or more sound output devices, first sound for the first processed audio stream and second sound for the second processed audio stream. Additional or alternative steps are possible

In some aspects, the techniques described herein relate to a method including: receiving a first audio stream generated by a first source and a second audio stream generated by a second source, the first audio stream and the second audio stream for output as first sound in a first spatial audio location and second sound in a second spatial audio location by one or more sound output devices of a wearable device, wherein the wearable device further includes one or more microphones for capturing environmental noise; capturing, by the one or more microphones, environmental noises; for at least some of the environmental noises, performing one or both of: selectively filtering or attenuating the environmental noises; and processing the first audio stream to obtain a first processed audio stream and the second audio stream to obtain a second processed audio stream; and outputting, by the one or more sound output devices, first sound for the first processed audio stream and second sound for the second processed audio stream.

In some aspects, the techniques described herein relate to a method, further including, for the at least some of the environmental noises: determining locations of the environmental noises; and modifying, based on the locations of the environmental noises, one or both of the first spatial audio location and the second spatial audio location.

In some aspects, the techniques described herein relate to a method, further including, for the at least some of the environmental noises, classifying the environmental noises, wherein selectively filtering or attenuating the environmental noises is further based on classifications of the environmental noises.

In some aspects, the techniques described herein relate to a method, further including, for the at least some of the environmental noises, receiving one or more rules defined by a wearer of the wearable device for processing the environmental noises, wherein selectively filtering or attenuating the environmental noises is further based on the one or more rules.

In some aspects, the techniques described herein relate to a method, further including, for the at least some of the environmental noises, receiving a user input for processing the environmental noises, wherein selectively filtering or attenuating the environmental noises is further based on the user input.

In some aspects, the techniques described herein relate to a method wherein the user input includes one or both of a spoken input or a gestural input.

In some aspects, the techniques described herein relate to one or more non-transitory computer-readable media including executable instructions that when executed by one or more processors of a system cause the system to perform a method including: receiving a first audio stream generated by a first source and a second audio stream generated by a second source, the first audio stream and the second audio stream for output as first sound in a first spatial audio location and second sound in a second spatial audio location by one or more sound output devices of a wearable device, wherein the wearable device further includes one or more microphones for capturing environmental noise; capturing, by the one or more microphones, environmental noises; for at least some of the environmental noises, performing one or both of: selectively filtering or attenuating the environmental noises; and processing the first audio stream to obtain a first processed audio stream and the second audio stream to obtain a second processed audio stream; and outputting, by the one or more sound output devices, first sound for the first processed audio stream and second sound for the second processed audio stream.

In some aspects, the techniques described herein relate to one or more non-transitory computer-readable media, the method further including, for the at least some of the environmental noises: determining locations of the environmental noises; and modifying, based on the locations of the environmental noises, one or both of the first spatial audio location and the second spatial audio location.

In some aspects, the techniques described herein relate to one or more non-transitory computer-readable media, the method further including, for the at least some of the environmental noises, classifying the environmental noises, wherein selectively filtering or attenuating the environmental noises is further based on classifications of the environmental noises.

In some aspects, the techniques described herein relate to one or more non-transitory computer-readable media, the method further including, for the at least some of the environmental noises, receiving one or more rules defined by a wearer of the wearable device for processing the environmental noises, wherein selectively filtering or attenuating the environmental noises is further based on the one or more rules.

In some aspects, the techniques described herein relate to one or more non-transitory computer-readable media, the method further including, for the at least some of the environmental noises, receiving a user input for processing the environmental noises, wherein selectively filtering or attenuating the environmental noises is further based on the user input.

In some aspects, the techniques described herein relate to one or more non-transitory computer-readable media wherein the user input includes one or both of a spoken input or a gestural input.

In some aspects, the techniques described herein relate to a system including at least one processor and at least one memory including executable instructions that when executed by the at least one processor cause the system to: receive a first audio stream generated by a first source and a second audio stream generated by a second source, the first audio stream and the second audio stream for output as first sound in a first spatial audio location and second sound in a second spatial audio location by one or more sound output devices of a wearable device, wherein the wearable device further includes one or more microphones for capturing environmental noise; capture, by the one or more microphones, environmental noises; for at least some of the environmental noises, performing one or both of: selectively filter or attenuate the environmental noises; and process the first audio stream to obtain a first processed audio stream and the second audio stream to obtain a second processed audio stream; and output, by the one or more sound output devices, first sound for the first processed audio stream and second sound for the second processed audio stream.

### 5. Adaptive Environmental Sound Enhancement for Personalized Auditory Experiences

Modern life frequently involves exposure to noisy or cluttered auditory environments—restaurants, offices, transportation hubs—where specific sounds (like a person's voice) are drowned out by ambient chatter, traffic, or machinery. While some noise-canceling solutions mitigate overall external sound, they rarely provide selective enhancement of sounds that users do want to hear. Achieving dynamic, personalized control over what the user hears—and does not hear—has remained a technical challenge, particularly in real-time scenarios.

The described technology provides technical solutions to these technical problems. A system according to the described technology enhances desirable environmental sounds while suppressing background noise. The system uses advanced signal processing and AI-driven personalization to continuously analyze the user's surroundings, filtering or boosting specific audio sources. Features include adaptive sound selection, real-time processing and personalization, user control and interface, and integration into other devices.

The system may implement adaptive sound selection through focus and preference recognition and active noise suppression. For example, the system may detect which sound source a user wants to emphasize—such as a single conversation partner—based on voice recognition, manual user selection, or learned user behaviors. The system may also actively suppress or attenuate other ambient noises (for example, background chatter, HVAC systems, traffic) in real time for greater clarity.

The system may implement real-time processing and personalization through machine learning profiles and adaptive updating. For example, over time, the system may learn the user's typical preferences (for example, always boost a particular coworker's voice, or ignore background music). As another example, when the environment changes—like moving from a quiet office to a crowded café—the system recalibrates to maintain the optimal auditory mix.

The system may implement user control and interface through manual overrides and multi-source management. As an example, the system may allow users to manually adjust levels (for example, a slider for “conversation focus” or a toggle for “reduce engine noise”) and to individually enhance or diminish specific voices or sound sources, such as voices or sound sources in group settings.

The system may be integrated into wearable devices, such as earbuds or headsets, to allow the wearable devices to apply the system's enhancements to real-time audio streams, and into fixed installations, such as home or workspace systems with microphone arrays, to allow such systems to facilitate location-based sound enhancements.

One potential application of the system is in assistive hearing devices, to allow users to better distinguish speech in noisy settings, improving communication for those with hearing impairments. Another potential application of the system is to facilitate personal audio tuning. For example, individuals traveling in busy areas can selectively maintain awareness of important sounds (announcements, colleague's voice) while minimizing distractions. The system may also be used in immersive entertainment and education settings, such as real-world museum tours or AR or VR experiences combining physical and digital soundscapes for deeper engagement. Another potential application of the system is in professional and collaborative environments, such as offices, conferences, or call centers where speech clarity is crucial among large groups.

The system provides multiple advantages. One such advantage relates to enhanced clarity and focus. The system may allow users gain the ability to highlight critical sounds or voices in real-world contexts. Another advantage pertains to improved communication, as the system may allow users to discern speech in loud environments more easily, thereby fostering better social and professional interactions. The system may allow for user-centric customization by providing manual controls and AI-driven profiles so as to offer flexible, adaptive experiences suited to individual needs. Another advantage of the system is that the system may be versatile and scalable in that the system may be implemented in various devices or systems, such as wearable devices, home audio systems, or large-scale installations with microphone arrays. Yet another advantage of the system is that the system may provide increased comfort and safety. By canceling or attenuating noise, the system allows users to remain aware of key sounds without total isolation from their surroundings.

### Agents

### 1. Spatial Locations of Agents

As auditory interfaces evolve towards more immersive and context-aware experiences, there is a growing need to simulate the real-world phenomenon of sound originating from specific locations in space. Conventional conversational agents—for example, AI voice assistants—are typically rendered in a mono or simple stereo format, lacking positional cues that would otherwise bolster realism, immersion, or facilitate user comprehension. This limitation diminishes user engagement and can result in confusion or poor orientation, especially in mixed reality or virtual reality (VR) environments where multi-sensory immersion is the goal.

The described technology provides technical solutions to these technical problems. A system according to the described technology provides a spatial audio framework specifically designed for agents, granting each agent a distinct virtual position relative to the user. Through advanced audio rendering (such as HRTF-based 3D sound or binaural spatialization), the system precisely simulates direction and distance cues for every agent's voice. The placement of each agent is configurable and continuously updated based on factors such as interaction context, user movements, head orientation, environmental factors, and agent identity and role.

For example, if one agent is presenting essential guidance (for example, navigation instructions), the system may move the agent closer or to a prominent location, while secondary agents remain in the periphery. As another example, as the user turns or changes position, the agents' virtual locations update accordingly, reinforcing the sensation of their “presence” in a shared space. The system may also account for reflective surfaces, obstacles, or rooms that affect reverberation and sound propagation in augmented or mixed reality settings. As another example, different voices or functionalities can be consistently associated with specific directions or distances to enhance recognition and reduce cognitive load.

The system may integrate real-time user tracking, head position/orientation sensors, and audio rendering algorithms to dynamically adapts the agents' positions so that they appear to emanate from realistic, stable points in the auditory scene. This not only improves realism but also fosters a sense of distinct entity presence, enabling users to localize and differentiate multiple AI voices in a seamless manner. Moreover, by spatializing agents or sound sources, the system allows users to better attend to or ignore specific sources when many are present.

One potential application of the system is immersive gaming: the system may provide more convincing AI-controlled companions or non-player characters (NPCs), each occupying a unique location in the player's auditory environment. Another potential application is for virtual meetings and collaborations. The system may place remote participants' voices in individualized locations, which may reduce overlap and enhance voice clarity in group discussions. Other potential applications are educational and training simulations, where the system may enhance situational awareness by associating voices with specific areas or objects in a virtual environment, improving learning retention; and assistive technologies, where the system may offer visually impaired users a multi-agent interface with distinct spatial cues, facilitating orientation and more intuitive navigation. The system may also be used to provide audio-rich entertainment, as the system may add dimension and realism to interactive narratives, podcasts, or museum guides where multiple AI or narrator voices participate.

One advantage of the system may be heightened realism and engagement, as spatial separation of agent voices mimics real-life conversational dynamics, thereby increasing immersion and comprehension. Another advantage relates to improved orientation: associating each agent with a distinct direction or location helps users rapidly identify and recall which agent provided which information. Yet another advantage pertains to natural interaction, in that users can turn to face a particular agent's voice, reinforcing the illusion of co-presence and streamlining multi-agent dialogues. The system may also enhance multitasking: with voices located at different positions, overlapping speech or parallel instructions become more manageable and less cognitively taxing. Still another advantage is accessibility support: the system provides spatial context for visually impaired or otherwise encumbered users, helping them navigate complex or unfamiliar environments.

Whether in fully immersive VR or augmented mixed reality contexts, by placing each agent in a 3D sound stage, the system amplifies user engagement, streamlines complex dialogues, and opens new possibilities for multi-agent or collaborative auditory experiences. The result is a more intuitive, realistic, and effective interface for both entertainment and practical applications.

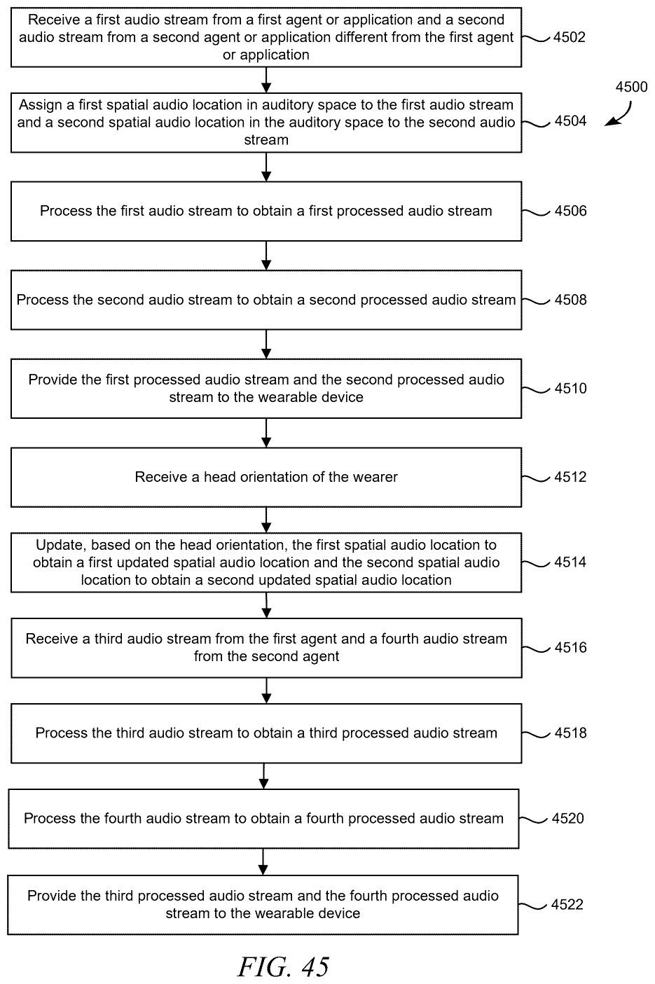

FIG. 45 is a flow diagram illustrating an example method 4500 that some embodiments of aspects of the described technology may perform. The method 4500 may begin at step 4502, where the auditory operating system shell 3818 receives a first audio stream from a first agent or application and a second audio stream from a second agent or application different from the first agent or application. The first audio stream is generated from a first response by the first agent to first commands or queries received from a wearer of a wearable device and the second audio stream is generated from a second response by the second agent to second commands or queries received from the wearer. The wearable device includes one or more microphones for capturing speech of the wearer, one or more sound output devices for outputting sound, one or more components for determining a head orientation of a wearer of the wearable device, and one or more components for determining a location of the wearable device.

At step 4504 the auditory operating system shell 3818 assigns a first spatial audio location in auditory space to the first audio stream and a second spatial audio location in the auditory space to the second audio stream. The first spatial audio location is different from the second spatial audio location. At step 4506 the auditory operating system shell 3818 processes the first audio stream to obtain a first processed audio stream that, when provided to a wearable device that includes, causes the one or more sound output devices to output first sound at the first spatial audio location. At step 4508 the auditory operating system shell 3818 processes the second audio stream to obtain a second processed audio stream that, when provided to the wearable device, causes the one or more sound output devices to output second sound at the second spatial audio location.

At step 4510 the auditory operating system shell 3818 provides the first processed audio stream and the second processed audio stream to the wearable device. At step 4512 the auditory operating system shell 3818 receives a head orientation of the wearer. At step 4514 the auditory operating system shell 3818 updates, based on the head orientation, the first spatial audio location to obtain a first updated spatial audio location in the auditory space and the second spatial audio location to obtain a second updated spatial audio location in the auditory space. At step 4516 the auditory operating system shell 3818 receives a third audio stream from the first agent and a fourth audio stream from the second agent. At step 4518 the auditory operating system shell 3818 processes the third audio stream to obtain a third processed audio stream that, when provided to the wearable device, causes the one or more sound output devices to output third sound at the first updated spatial audio location. At step 4520 the auditory operating system shell 3818 processes the fourth audio stream to obtain a fourth processed audio stream that, when provided to the wearable device, causes the one or more sound output devices to output fourth sound at the second updated spatial audio location. At step 4522 the auditory operating system shell 3818 provides the third processed audio stream and the fourth processed audio stream to the wearable device. Additional or alternative steps are possible

In some aspects, the techniques described herein relate to a method including: receiving a first audio stream from a first agent or application and a second audio stream from a second agent or application different from the first agent or application, wherein: the first audio stream is generated from a first response by the first agent or application to first commands or queries received from a wearer of a wearable device and the second audio stream is generated from a second response by the second agent or application to second commands or queries received from the wearer; and the wearable device includes one or more microphones for capturing speech of the wearer, one or more sound output devices for outputting sound, one or more components for determining a head orientation of a wearer of the wearable device, and one or more components for determining a location of the wearable device; assigning a first spatial audio location in auditory space to the first audio stream and a second spatial audio location in the auditory space to the second audio stream, the first spatial audio location different from the second spatial audio location; processing the first audio stream to obtain a first processed audio stream that, when provided to a wearable device that includes, causes the one or more sound output devices to output first sound at the first spatial audio location; processing the second audio stream to obtain a second processed audio stream that, when provided to the wearable device, causes the one or more sound output devices to output second sound at the second spatial audio location; providing the first processed audio stream and the second processed audio stream to the wearable device; receiving a head orientation of the wearer; updating, based on the head orientation, the first spatial audio location to obtain a first updated spatial audio location in the auditory space and the second spatial audio location to obtain a second updated spatial audio location in the auditory space; receiving a third audio stream from the first agent or application and a fourth audio stream from the second agent or application; processing the third audio stream to obtain a third processed audio stream that, when provided to the wearable device, causes the one or more sound output devices to output third sound at the first updated spatial audio location; processing the fourth audio stream to obtain a fourth processed audio stream that, when provided to the wearable device, causes the one or more sound output devices to output fourth sound at the second updated spatial audio location; and providing the third processed audio stream and the fourth processed audio stream to the wearable device.

In some aspects, the techniques described herein relate to a method wherein the first spatial audio location is at a first absolute position in the auditory space, the first updated spatial audio location is at the first absolute position, the second spatial audio location is at a second absolute position in the auditory space, and the second updated spatial audio location is at the second absolute position.

In some aspects, the techniques described herein relate to a method, further including: receiving preference data for the wearer of the wearable device; analyzing the first audio stream; receiving environmental data generated from environmental noise captured by the one or more microphones; and modifying, based on one or more of the preference data, analysis of the first audio stream, or the environmental data, at least one of a gain of the first processed audio stream and the first spatial audio location.

In some aspects, the techniques described herein relate to a method, further including: receiving acoustic properties associated with an environment of the wearer; and generating, based on the acoustic properties, acoustic modifier settings, the acoustic modifier settings simulating one or more of reverberation, echo, occlusion, or absorption in the environment, wherein the first audio stream and the second audio stream are further processed based on the acoustic modifier settings.

In some aspects, the techniques described herein relate to a method wherein the environment is a virtual environment.

In some aspects, the techniques described herein relate to one or more non-transitory computer-readable media including executable instructions that when executed by one or more processors of a system cause the system to perform a method including: receiving a first audio stream from a first agent or application and a second audio stream from a second agent or application different from the first agent or application, wherein: the first audio stream is generated from a first response by the first agent or application to first commands or queries received from a wearer of a wearable device and the second audio stream is generated from a second response by the second agent or application to second commands or queries received from the wearer; and the wearable device includes one or more microphones for capturing speech of the wearer, one or more sound output devices for outputting sound, one or more components for determining a head orientation of a wearer of the wearable device, and one or more components for determining a location of the wearable device; assigning a first spatial audio location in auditory space to the first audio stream and a second spatial audio location in the auditory space to the second audio stream, the first spatial audio location different from the second spatial audio location; processing the first audio stream to obtain a first processed audio stream that, when provided to a wearable device that includes, causes the one or more sound output devices to output first sound at the first spatial audio location; processing the second audio stream to obtain a second processed audio stream that, when provided to the wearable device, causes the one or more sound output devices to output second sound at the second spatial audio location; providing the first processed audio stream and the second processed audio stream to the wearable device; receiving a head orientation of the wearer; updating, based on the head orientation, the first spatial audio location to obtain a first updated spatial audio location in the auditory space and the second spatial audio location to obtain a second updated spatial audio location in the auditory space; receiving a third audio stream from the first agent or application and a fourth audio stream from the second agent or application; processing the third audio stream to obtain a third processed audio stream that, when provided to the wearable device, causes the one or more sound output devices to output third sound at the first updated spatial audio location; processing the fourth audio stream to obtain a fourth processed audio stream that, when provided to the wearable device, causes the one or more sound output devices to output fourth sound at the second updated spatial audio location; and providing the third processed audio stream and the fourth processed audio stream to the wearable device.

In some aspects, the techniques described herein relate to one or more non-transitory computer-readable media wherein the first spatial audio location is at a first absolute position in the auditory space, the first updated spatial audio location is at the first absolute position, the second spatial audio location is at a second absolute position in the auditory space, and the second updated spatial audio location is at the second absolute position.

In some aspects, the techniques described herein relate to one or more non-transitory computer-readable media, the method further including: receiving preference data for the wearer of the wearable device; analyzing the first audio stream; receiving environmental data generated from environmental noise captured by the one or more microphones; and modifying, based on one or more of the preference data, analysis of the first audio stream, or the environmental data, at least one of a gain of the first processed audio stream and the first spatial audio location.

In some aspects, the techniques described herein relate to one or more non-transitory computer-readable media, the method further including: receiving acoustic properties associated with an environment of the wearer; and generating, based on the acoustic properties, acoustic modifier settings, the acoustic modifier settings simulating one or more of reverberation, echo, occlusion, or absorption in the environment, wherein the first audio stream and the second audio stream are further processed based on the acoustic modifier settings.

In some aspects, the techniques described herein relate to one or more non-transitory computer-readable media wherein the environment is a virtual environment.

In some aspects, the techniques described herein relate to a system including at least one processor and at least one memory including executable instructions that when executed by the at least one processor cause the system to: receive a first audio stream from a first agent or application and a second audio stream from a second agent or application different from the first agent or application, wherein: the first audio stream is generated from a first response by the first agent or application to first commands or queries received from a wearer of a wearable device and the second audio stream is generated from a second response by the second agent or application to second commands or queries received from the wearer; and the wearable device includes one or more microphones for capturing speech of the wearer, one or more sound output devices for outputting sound, one or more components for determining a head orientation of a wearer of the wearable device, and one or more components for determining a location of the wearable device; assign a first spatial audio location in auditory space to the first audio stream and a second spatial audio location in the auditory space to the second audio stream, the first spatial audio location different from the second spatial audio location; process the first audio stream to obtain a first processed audio stream that, when provided to a wearable device that includes, causes the one or more sound output devices to output first sound at the first spatial audio location; process the second audio stream to obtain a second processed audio stream that, when provided to the wearable device, causes the one or more sound output devices to output second sound at the second spatial audio location; provide the first processed audio stream and the second processed audio stream to the wearable device; receive a head orientation of the wearer; update, based on the head orientation, the first spatial audio location to obtain a first updated spatial audio location in the auditory space and the second spatial audio location to obtain a second updated spatial audio location in the auditory space; receive a third audio stream from the first agent or application and a fourth audio stream from the second agent or application; process the third audio stream to obtain a third processed audio stream that, when provided to the wearable device, causes the one or more sound output devices to output third sound at the first updated spatial audio location; process the fourth audio stream to obtain a fourth processed audio stream that, when provided to the wearable device, causes the one or more sound output devices to output fourth sound at the second updated spatial audio location; and provide the third processed audio stream and the fourth processed audio stream to the wearable device.

### 2. Applying Congruent Room Acoustics to Conversational Agents

In virtual and augmented reality, as well as various digital media, acoustic realism often lags behind visual fidelity. When a user interacts with a conversational agent in these environments, the agent's voice may sound disconnected from the apparent setting—lacking the room acoustics or reverberations one would expect in the depicted scene. This mismatch reduces immersion and believability, disrupting the user's sense of presence.

The described technology provides technical solutions to these technical problems. A dynamic acoustic simulation system according to the described technology applies congruent room acoustics to conversational agents, aligning their audio output with the visual or contextual environment—whether real or virtual. The system may analyze environmental characteristics. For example, the system may determine relevant acoustic properties, such as room size, surface materials, and ambient noise levels. This analysis may involve direct measurement (in a real room) or metadata extraction (in a virtual or rendered space).

The system may also apply acoustic modeling. For example, the system may adjust the agent's voice output to match these characteristics, simulating reverberation, echo, occlusion, or absorption as would naturally occur in that environment. The system may also update the agent's voice in real time in response to changes. For example, a user may move into a different virtual room or may shift between environments. The system may modify the agent's voice consistently congruent with the new acoustic context. The system may also integrate with existing spatial audio or binaural rendering systems, ensuring that not only the agent voice itself but also its directionality or location and distance cues reinforce the environment's illusion. By aligning auditory cues with visual or implied contextual elements, the system substantially improves the realism of interactions with digital agents, helping users perceive them as natural parts of the environment.

Potential applications of the system include virtual and augmented reality platforms, as the system may enhance immersion during gameplay, simulations, or interactive storytelling by ensuring agent voices match the environment's acoustic profile; and online meetings and virtual conferences, where the system may make remote participants or AI-driven meeting assistants feel as if they are present in a shared, realistic-sounding space.

Other potential applications of the system include educational and training simulations: the system may promote deeper learning by embedding realistic auditory cues, helping trainees associate the agent's instructions with the surrounding context; and interactive media and installations: the system may engage audiences by aligning multiple agent voices with thematic or scenically rendered environments.

Advantages of the system may include that the system may provide enhanced realism and immersion: consistent auditory cues that match visual settings may increase user engagement and believability; the system may be adaptive and context-aware: the system may make real-time updates to acoustic parameters ensure that the agent's voice remains congruent even as the user's environment changes; and the system may provide improved user orientation: by reflecting environmental acoustics, users can rely on natural auditory instincts for spatial navigation and orientation.

Other advantages is that the system may work with various hardware setups—VR headsets, mixed reality devices, or standard audio systems—and scales for simple or complex environments, and the system may provide greater user satisfaction, as cohesive audio-visual experiences produce more compelling interactions, ultimately elevating the user's overall impression of the platform.

### Security and Privacy

### 1. User-Centric Privacy and Control in Auditory User Interfaces

As voice-activated and always-listening devices become more prevalent, users have growing concerns regarding privacy, data security, and the lack of transparency about when and how their data is used. Conventional voice interfaces often require broad, general permissions without giving the user granular control over what is captured or shared. This can undermine user trust and limit the adoption of otherwise convenient and beneficial auditory technologies.

The described technology provides technical solutions to these technical problems. A system according to the described technology provides a framework to ensure user privacy and control within auditory interfaces. Features of the system include permission scoping and granular controls, secure information vaults, transparent communication of system states and actions, and centralized interface control.

The permission scoping and granular controls may allow users to set customized permissions by allowing users to specify the types of data (for example, personal info, location, or voice input) the system can access, and for what purposes. Moreover, permissions can be requested at the point of need, ensuring transparency and informed decisions, instead of blanket consent.

The secure information vaults may allow for centralized data management—a secure module within the interface may stores sensitive user data (voiceprints, personal preferences, contact info)—and encryption and access control—data is encrypted and only accessible through authenticated system actions that the user has approved.

The system may facilitate or require transparent communication of system states and actions. An auditory user interface may alert a user visually, audibly, or haptically to indicate when the microphone is actively listening or when data is being shared. The system may also require that auditory user interfaces maintains activity records that users can review, showing what was captured, processed, and transmitted to any external service.

Another feature of the system relates to centralized interface control: the system may require auditory user interfaces to provide a single interface for reviewing and modifying privacy settings across all compatible apps or services. Moreover, when circumstances change—like a new environment or user context—the system can recommend or automatically adjust permission levels, always subject to user override.

By combining secure storage, granular permissions, and transparent state indications, the framework establishes trust between users and their auditory devices, addressing privacy concerns at every stage of interaction.

Potential applications of the system include Wearable Technology, such as earbuds or watches that listen for commands and gather user data, benefiting from secure on-device processing and explicit permission controls and Home Devices, such as Voice-enabled hubs that only record or process data when explicitly permitted by household members, enforcing role-based or context-based restrictions. Another potential application of the system is for mobile phones or other devices that include personal assistants. The system can facilitate the development of personal assistants that respect user-defined data boundaries, providing confidence in always-on listening features. Another potential application is in enterprise and government settings. The system may be utilized to develop applications or systems for secure environments ensuring that sensitive voice data or command logs are adequately protected and managed.

One advantage of the system is that the system facilitates user trust and adoption, in that clear control mechanisms and transparent states may reduce apprehensions about continuous listening devices. As the system may be obtaining longitudinal context through all-day, everyday wear of devices, robust trust and privacy management may be an important foundational aspect that enables exposure to the full breadth of a user's experience. Such exposure then may make the system work better as a companion or augmentation to users' lives. The system may enhance privacy and security through encryption, activity logs, and strict permission scoping so as to guard against unintended data leaks or misuse. Another advantage is that the system may enable context-aware permissions that adapt to user situations, thereby preventing or reducing unnecessary data collection while maintaining usability. The system also may enable a single privacy dashboard that simplifies oversight, offering a consistent user experience across multiple platforms or services. Yet another advantage relates to compliance with industry or national standards—the system may facilitate adherence to data protection regulations (for example, GDPR), thereby potentially reducing legal and reputational risk for companies.

### 2. Platform-Based App Model and Permissions System for Multi-Agent Conversational Devices

In conventional mobile or smart home ecosystems, applications commonly request permissions for features like GPS, microphone, or contacts. However, in multi-agent systems—especially those that combine wearable devices, advanced sensors, and integrated voice interfaces—the need for fine-grained and domain-specific permissions, such as to context-specific, ephemeral data, is heightened. Current solutions sometimes lump broad privileges together or rely on a single OS-level prompt that does not account for specialized multi-agent use cases. This can lead to either overly broad access or excessive friction for users trying to navigate complex permission flows. A developer studio that clearly delineates permission categories and user authentication requirements is essential to ensure flexibility, security, and usability in multi-agent, voice-driven environments.

The described technology provides technical solutions to these technical problems. A system according to the described technology utilizes a platform-based application model and permissions system for multi-agent conversational devices. The system may include the following features: categorization of device and user information, a declarative permissions model, user authentication and linked services, a developer studio and compliance, and real-time permission management.

With regard to the categorization of device and user information, the system may collect device state and sensor information, such as battery level, location (GPS), orientation/look direction (IMU, magnetometer), hearing/media volume, microphone input streams, and output mode. The system may also collect user data, such as user-specified information such as language or preferences, known contacts, payment methods, or authentication tokens. The system may also determine whether access to third-party integrations, for example, Google Calendar or Spotify, that require the user to authenticate externally is necessary.

The system enforces a declarative permissions model, in that when a developer creates an application, the developer explicitly declares which categories of data or controls (read/write) are needed. For instance, a fitness tracker application might request read access to location data and user summary but not payment methods. Moreover, the user is given clear, contextual prompts to grant or reject each requested permission category (for example, “Allow this app to see your location?”). The user can also configure partial or time-limited access.

For user authentication and linked services, the user must explicitly sign in via that service's standard authentication flow. The application receives a restricted token, ensuring no direct credential sharing. The token is revocable—the user can revoke these linked service permissions at any time, severing the app's integration.

The developer studio may include development tools, such as an IDE and documentation to guide application creators in properly declaring permissions and incorporating user authentication flow. The system may also perform automated compliance checks to ensure that applications do not exceed declared permissions or attempt unauthorized data access.

The system may also manage permissions in real time. For example, the system may perform dynamic re-authorization: if an application attempts a new action mid-lifecycle (for example, reading user location for the first time), the system may prompt the user for immediate approval. The system may also provide a central permissions dashboard that allows the user to modify or revoke permissions, or reassign them to different agent contexts.

By segmenting privileges into well-defined categories and enforcing user-driven approval, the system ensures transparency and accountability. This permissions model fosters a more robust, privacy-aware environment where multi-agent applications can flourish without exposing sensitive data or capabilities beyond user intention.

An example use case is the following. A user is wearing a multi-agent conversational headset with multiple domain apps (music, fitness, notes, etc.). A developer builds a new fitness-tracking agent that requests read access to the user's location data and step count (via IMU). The user installs the fitness-tracking agent. The system prompts the user: “FitnessPro wants to track your location and motion data to chart running routes. Allow these permissions?” The user chooses to integrate with a mapping service, so the app also requires a location-based API token. The user logs in via the service's official sign-in. During a run, the fitness-tracking tracks location but must not access the user's contacts or payment details because it was not granted those privileges. Later, the user decides the app no longer needs location data and revokes that permission in the “Permissions Dashboard.” The agent's real-time route tracking ceases accordingly.

### Auditory User Interface Applications

### 1. Auditory Spatial Learning and Memory Enhancement Techniques

In auditory user interfaces (AUIs), users often navigate and process information in a sound-only environment, without the benefit of visual landmarks or spatial cues. This can make it difficult to locate, organize, and remember information within the interface. While conventional methods of presenting audio (for example, linear menus, single audio stream) suffice for simple tasks, they do not easily scale for complex or high-volume data where visual frameworks typically provide structure and cognitive support.

The described technology provides technical solutions to these technical problems. A system according to the described technology provides techniques and methodologies to enable spatial learning and memory enhancement within an auditory environment. It leverages 3D audio cues and mnemonic sound patterns to help users map and recall functions, data points, or navigational paths more effectively.

Features of the system may include 3d auditory positioning, mnemonic sound patterns, contextual prompting and reinforcement, and user customization and accessibility.

3d auditory positioning may include spatial mapping of information: assigning distinct virtual locations to various app functions or data segments, giving users an auditory “mental map” of the interface, and directional sound cues: users may hear data or menu items emanate from different angles, heights, or distances, facilitating easier recall and orientation.

mnemonic sound patterns may include sound signatures for categories: each category or type of information is associated with a signature motif (for example, short tune or chord progression), reinforcing recognition and recall, and linked sequences: complex data sequences or multi-step tasks can be accompanied by progressive auditory patterns, guiding the user through an ordered process.

contextual prompting and reinforcement may include adaptive reminders: if the user struggles to find or remember a previously visited location, subtle directional cues or mnemonic “refreshers” can be triggered, and progressive learning: gradual introduction of new audio cues ensures users build a robust mental map without overwhelming them initially.

user customization and accessibility may include configurable soundscapes: advanced users can define how and where items are spatially or mnemonically represented, tailoring the interface to personal memory strategies, and accessibility enhancements: for users with visual impairments, precise 3d audio helps replicate the spatial benefits of visual interfaces, improving orientation and independence.

potential applications of the system include educational software, such as in interactive lessons that place concepts in distinct virtual locations to boost memory retention and in memory aids and productivity tools, to allow for quick recall of to-do lists, notes, or schedules by anchoring them to audible locations. Another potential application is in navigation tools for the visually impaired to provide spatial audio-based directions and environment mapping and to assist in orientation and mobility tasks. Yet another potential application relates to complex data analysis: large-scale data “landscapes” can be sonically sculpted to guide analysts through multiple datasets or hierarchical structures.

One advantage of the system may be enhanced cognitive mapping—spatial partitioning of audio may foster quicker assimilation of the interface layout, thereby reducing confusion and search time. Another advantage may be that the system improves recall and retention, as mnemonic patterns reinforce memory formation, helping users more easily retrieve stored information. The system may also provide for intuitive navigation, as directions and submenus can be discovered by listening for localized audio cues, thereby streamlining complex tasks. The system may also be inclusive and accessible: the system integrates well with assistive technologies, enabling visually impaired users to benefit from structured, multi-layered audio. The system may also provide or facilitate customizable learning paths: by adapting or personalizing auditory cues, the system can match diverse user learning styles and contexts.

### 2. Conversational Music Composition and Adaptation

Music experiences are typically passive, with listeners having limited ways to influence or guide the content. While streaming services may tailor playlists to user preferences, they rarely adapt the musical arrangement or mood in real time based on voice commands or emotional context. A system that enables dynamic composition and interactive playback—where users verbally direct changes in tempo, instrumentation, and genre—could open up a new realm of personalized and immersive music engagement.

The described technology provides technical solutions to these technical problems. A conversational AI-driven system according to the described technology allows users to actively shape a piece of music through voice commands or through other actions. By processing natural language input (for example, “slow it down,” “add more strings,” “make it more upbeat,” “lower the bass,” or “switch to a calm mood”), the system modifies the music's tempo, instrumentation, arrangement, or mood in real time. In some embodiments, the system may change music to align with user actions or behaviors. For example, the system may align the music of a soundtrack to the pace of a user's walk. Components or features of the system include: a natural language processing (NLP) engine, an adaptive composition and arrangement module, a playback and feedback loop module, and a personalization and memory module.

The natural language processing (NLP) engine may provide voice command recognition by translating user utterances into structured parameters that reflect desired musical changes; and semantic understanding by interpreting descriptive terms (for example, “melancholic,” “epic,” “ambient”) and mapping them to relevant musical modifications.

The adaptive composition and arrangement module may provide real-time music generation by applying changes such as tempo shifts, instrument layering, or dynamic harmonic progression; and contextual theming by taking user-provided context (for example, current activity or emotional state) and using it to set or maintain an overarching musical theme.

The playback and feedback loop module may provide instantaneous or near-instantaneous response by updating the ongoing music stream in real time, offering continuous feedback that the user can refine further; and utilize emotional and situational inputs. for example, the playback and feedback loop module may optionally leverage data from wearables (for example, heart rate) or environment sensors (for example, noise level) to autonomously propose musical alterations.

The personalization and memory module may store user preferences, frequently used commands, or favored genres/instruments to expedite adaptation in future sessions in user profiles and provide historical tracking by learning from past interactions, refining how it interprets user instructions and recommended changes over time.

A potential application of the system includes personalized music experiences: listeners can orchestrate background music suited for relaxation, workouts, or study sessions on the fly. Another potential application is in therapeutic and wellness applications: mental health practitioners might adjust music in real time to match therapy session goals or patient comfort levels. Creative tools for musicians may benefit from the system, as composers can prototype and refine ideas verbally, testing different styles, arrangements, or moods without manual reprogramming. Moreover, educational platforms may utilize the system to allow music students or novices to explore fundamental concepts (for example, tempo, key changes) through guided voice commands for interactive learning.

One advantage of the system may include enhanced user engagement: the system enables moving beyond passive listening, inviting users into a co-creative process with the music. Other advantages relate to context and mood adaptation: shifts in emotional state or environment can trigger rapid, relevant musical transformations; and real-time responsiveness: immediate adjustments maintain a dynamic feedback loop, enabling iterative refinement of the audio experience. Another advantage is that the system may provide personalized experiences suited to individual tastes, daily routines, or specific situational demands, from productivity boosts to relaxation therapy. The system may also be accessible and intuitive, as voice-driven commands remove technical barriers, allowing novices or visually impaired users to shape music.

### 3. Spatial Audio Processing for Real-time Conversational Translation

While real-time language translation is widely available through apps and digital services, current solutions can be disruptive to natural conversation flows—particularly in environments with high background noise or where several speakers are present. Many translation tools simply overlay a translated audio track without preserving spatial context or focusing on the speaker's position. As a result, users may struggle to differentiate who is speaking and when, making interactions less natural and more confusing.

The described technology provides technical solutions to these technical problems. A system according to the described technology provides a real-time conversational translation system that integrates spatial audio processing to maintain the speaker's positional context while delivering a translated output. Components or features of the system may include speech extraction and beamforming, a live language translation engine, spatial audio rendering, and contextual mode switching.

Speech extraction and beamforming may include direction-based filtering: a microphone array or directional sensors may focus on the active speaker, reducing interference from other voices or background noise; and dynamic noise suppression: adaptive algorithms may isolate the target speech signal, ensuring clean input for reliable translation.

The live language translation engine may automatically convert the captured speech to text in the source language, process it through machine translation, and then regenerate audio in the target language. The live language translation engine may also be optimized for low-latency so as to minimize lag so that the translated speech is delivered quickly, preserving near-real-time conversation flow. The system may also extract semantic information from a real-time audio stream and manipulate it in real time to provide information to a user. For example, the system may assist in explaining cultural references, idioms, or other concepts within a language to a user that another user has uttered. The system may thus assist in conversation between persons of different generations or cultural backgrounds that occurs in the same language.

Spatial audio rendering may include directional output: assigning the translated audio to the same spatial coordinates as the original speaker's location, so the user perceives the translated voice emanating from that same direction; and user-specific calibration: accommodating different ear shapes or headphone profiles, ensuring that positional cues are clear and consistent.

Contextual mode switching may include support for multiple speakers: when multiple participants speak different languages, the system may concurrently process each stream, maintaining distinct directional output; and user preferences and controls: the system may provide options for muting original voices, adjusting translation volume, or disabling translation for certain speakers.

By combining beamforming, high-fidelity translation, and spatial audio rendering, users can naturally engage in multilingual conversations while retaining positional awareness of each speaker.

A potential application of the system is for multilingual conversations, such as in business meetings or social gatherings where participants speak different languages yet wish to communicate fluidly or in international travel to facilitate real-time interactions with local residents, tour guides, or service personnel in noisy tourist spots. Another potential application is in educational tools to allow language learners to experience live translation while practicing conversation in real-life or simulated environments. Another potential application is at conferences or events to allow attendees to seamlessly follow presentations or panel discussions in their preferred language without losing sight of who is speaking.

One advantage of the system is that the system may provide clear and immersive communication: the system may enhance comprehension by matching the translated audio with the speaker's location, preserving natural conversational cues. Another advantage is that the system may reduce the cognitive load on users, as users may not be required to mentally map the translated voice to each speaker, enabling more fluid interaction. Another advantage relates to noise resilience, as focused beamforming and noise suppression ensure the translation engine receives a clean, high-quality speech signal. The system is adaptive and scalable—the system may accommodate small group chats or large conference settings with multiple speakers, each potentially requiring translation. The system may also improve inclusion and accessibility by breaking down language barriers, thereby broadening participation and collaboration across diverse linguistic communities.

### 4. Privacy-Preserving Real-Time Conversational Translation

Real-time conversational translation bridges language barriers by enabling people to communicate fluidly regardless of differing linguistic backgrounds. However, many existing solutions rely on cloud-based processing, transmitting sensitive data to external servers and raising privacy and security concerns-particularly in confidential settings such as business negotiations, medical consultations, or legal discussions. These concerns can deter the use of translation services precisely where they would be most beneficial.

The described technology provides technical solutions to these technical problems. A system according to the described technology a privacy-preserving real-time translation system designed for secure, instant multilingual communication. components or features of the system may include end-to-end encryption, local processing, conversational context handling, and user and data protection measures.

End-to-end encryption may include ensuring that audio and text data remain encrypted during transmission (if any) and are not exposed to third parties and allowing users to control encryption keys locally, thereby reducing reliance on external entities for decryption.

Local processing may include on-device or on-premise translation. The system may deploy ASR (automatic speech recognition), NMT (neural machine translation), and TTS (text-to-speech) modules locally, thus avoiding sending raw audio data to external servers. The system may also optimize for reduced latency by utilizing compact, optimized models and hardware acceleration strategies to achieve real-time performance without compromising privacy.

Conversational context handling may include context-aware translations: the system may maintain a history of the conversation (in encrypted form), ensuring consistent usage of specific terms and idiomatic expressions, and adaptive language models: the system may learn user vocabulary preferences (for example, industry-specific jargon) over time, while preserving user anonymity and data confidentiality.

User and data protection measures may include selective logging: the system may permit or disallow data logging according to strict user preferences—logs may remain encrypted and locally stored, if kept at all; and access control and authentication: the system may ensure only authorized participants can engage in or access the translation session, preventing unauthorized interception or eavesdropping.

One potential application of the system relates to confidential business meetings: the system may enable secure cross-lingual discussions for multinational deals or sensitive negotiations without exposing conversation logs externally. Another is for medical consultations: the system may facilitate doctor-patient communication in diverse languages, ensuring patient confidentiality in compliance with privacy regulations. Another potential application relates to legal discussions: the system may assist attorneys and clients in translating complex legal terminology in real time, maintaining privileged communication. The system may also be used in secure call centers to facilitate handling customer service interactions securely to ensure sensitive user data can be kept private, even across language barriers.

One advantage of the system is that the system may be highly secure and private, as the system may eliminate the vulnerability of sending raw audio to external servers, fostering user trust and regulatory compliance. Another advantage of the system relates to rapid, real-time translation: the system may deliver near-instant results despite local or on-premise data processing, ensuring smooth conversation flow. The system is also contextual and adaptive, as it retains and applies conversation context for more accurate translations that account for user-specific terminology. The system can be flexibly deployed as an on-device or an on-premise solution that scales to enterprise-level requirements or consumer hardware. The system also encourages sensitive use cases by prioritizing data security and privacy, thereby being viable for high-stakes or confidential scenarios.

### 5. Contextual Conversational Agent for Dynamic Interaction and Support

Traditional conversational agent solutions generally apply a one-size-fits-all approach, offering replies based on generic language models. They often lack the ability to factor in user context, emotional states, or recent conversation history, resulting in a less personalized and effective interaction. As users increasingly expect assistants to provide empathetic and context-aware responses (for example, in mental health or customer support scenarios), it becomes important for systems to adapt their conversation style and content in real time based on environmental and emotional cues.

The described technology provides technical solutions to these technical problems. A system according to the described technology provides a contextual conversational AI system designed for dynamic interaction and emotional support. By integrating user context—such as location, activity, or emotional tone—the system tailors its responses to be more meaningful and supportive. Components or features of the system include context-aware language processing, emotional tone detection and adaptation, personalized and relevant responses, and multi-domain support.

Context-aware language processing may include sensor and data integration, as the system may draw on signals from user devices or external sources (for example, calendar events, biometric sensors, or location data) to understand the user's current situation; and history and memory management, as the system may retain conversation logs and user preferences, referencing them for consistent, long-term engagement (for example, recalling previous topics or concerns).

Emotional tone detection and adaptation may include sentiment analysis, as the system may monitor user voice or text input for emotional indicators (for example, stress, sadness, excitement) and classifies them in real time; and response modulation, as the system may adjust the agent's tone, empathy level, and style of support based on detected user emotions, offering reassurance or guidance as necessary.

Personalized and relevant responses may include dynamic content recommendations, as the system may suggest relevant information, tips, or next steps tailored to the user's current conversation context and emotional state; and adaptive conversational flow, as the system may change conversation strategies (for example, short concise statements vs. detailed guidance) according to user preferences and situational cues.

Multi-domain support may include health and wellness, as the system may provide mental health check-ins or motivational support, reacting sensitively to user tone; customer service, as the system may resolve issues promptly, remembering user-specific details and exhibiting empathy when frustration is detected; and educational tools, as the system may adjust teaching methods and complexity based on user engagement and feedback.

A potential application of the system includes personal virtual assistants—agents that evolve with the user's daily routines, emotions, and environment for more intuitive guidance. Another potential application is in mental health support apps: the system may provide emotional responsiveness for providing comfort and intervention in moments of stress or crisis. The system may also be used in context-aware customer service bots to enhance user satisfaction by detecting frustration, personalizing solutions, and recalling prior interactions. The system may also be used in adaptive learning platforms as an educational agent that modifies lesson difficulty and style depending on student mood, progress, or learning preferences.

One advantage of the system may include heightened personalization, as the agent may respond in a manner aligned with the user's unique context and emotional state, increasing relevance and empathy. Another is improved user satisfaction: by considering historical context and emotional cues, interactions feel more natural and supportive. Another advantage relates to increased effectiveness: the system may offer prompt, context-informed solutions or emotional reassurance, boosting trust and positive outcomes in service or learning environments. Other advantages include providing a holistic experience, as the system may integrate data from multiple sources (for example, sensors, conversation logs) to create a multi-faceted understanding of user needs and being versatile to implement, as the system can be extended or customized for different industry requirements-wellness, customer service, education, etc.

### Social Audio

### 1. Multi-User, Multi-Agent Collaboration in Shared Audio Mixed Reality Spaces

Present-day voice assistant ecosystems typically assume one user engaging with one device or a singular multi-agent platform. Although some solutions support multiple user profiles on a shared device, they do not handle real-time, peer-to-peer collaboration with distributed personal agents. Applications like phone calls or group calls rely on standard telecommunication channels without robust agent orchestration or context-sensitive data exchange. Meanwhile, collaborative tools often limit themselves to text-based or visually oriented frameworks, lacking immersive audio-only or spatial experiences. None of these fully address the challenge of coordinating multiple individuals and multiple AI agents in a single auditory conversation, especially where each participant's privacy and context must be protected.

The described technology provides technical solutions to these technical problems. A system according to the described technology provides multi-agent, audio-based conversational interfaces that may be deployed on wearable devices (for example, smart earbuds) and that support shared, group-level experiences. By merging multiple users and their respective agents into a common auditory environment, the system enables coordinated interactions—while upholding privacy and permission rules for each participant. The system may address the exponential complexity of multi-user, multi-agent collaboration in an audio environment. Features or components of the system include shared audio space with partitioned access, per-user and group permissions, context and task management for multiple users, and status indicators and transparency.

A shared audio space with partitioned access may include a merged space, where users and their agents join a common auditory room akin to a group call, except each user's personal agents (music agent, booking agent, etc.) may receive audio only if explicitly permitted, and group/space-scoped agents, where an ephemeral agent or an agent dedicated to the space can mediate group tasks—like summarizing conversation outcomes or booking a group reservation—based on group consensus.

Per-user and group permissions may include agent hearing rules, where each user's private agents receive only that user's voice feed (and chosen contextual data), unless the user explicitly grants a wider scope, and space-level authorization: if a user shares group-relevant info (for example, schedules, preferences), the ephemeral space agent or other participant agents receive that subset. Consent prompts can ensure everyone is aware of data sharing (“shall I share your available weekends with the group?”).

Context and task management for multiple users may include parallel agent orchestration: the system may orchestrate potentially dozens of simultaneous tasks (for example, user a's travel agent calculating routes, user b's finance agent managing shared expenses) while preventing cross-user data leakage, and negotiation and consent: if a group plan emerges—like booking accommodations—the ephemeral space agent can gather each user's relevant constraints, confirm decisions, and pass final instructions to the user or group.

Status indicators and transparency may include audible or spoken cues, such as short signals or descriptive confirmations inform participants about which agent is “listening” or “speaking,” clarifying that an agent is actively interpreting group conversation, and access logging and notifications: if any user's personal agent requests group audio data, the system notifies the group or prompts a consent request, ensuring trust in the space.

By partitioning user-specific audio feeds and employing controlled, deliberate data exchange among group and personal agents, participants gain the benefits of collaborative assistance without sacrificing clarity about where their conversation data goes or who can utilize it. One advantage of the system may include

An example use case is the following: a group of four friends in a shared auditory space, each wearing smart earbuds with personal agents. They aim to plan a weekend getaway. In the group conversation, they discuss potential destinations. The ephemeral “Space Agent” listens only to conversation content relevant to group travel tasks, capturing each friend's availability. Each friend's private agent hears only their user's direct utterances and context (like flight preferences or frequent flyer status). If friend A says, “Agent, find flights from my local airport,” only that agent receives the request; the rest of the group does not get that data.

The space agent aggregates each user's weekend constraints, lodging preferences, and budgeting. Once the group decides, it orchestrates a communal booking step-requesting each user's confirmation and partial payment method from each user's personal agent. If the ephemeral agent needs to share friend B's special dietary restrictions with a restaurant booking agent for friend A, it requests B's consent: “B, is it okay to share your dietary restrictions so we can ensure the group meal is suitable?” This example illustrates how each user's agency is preserved while enabling parallel, multi-agent tasks in a single conversation flow.

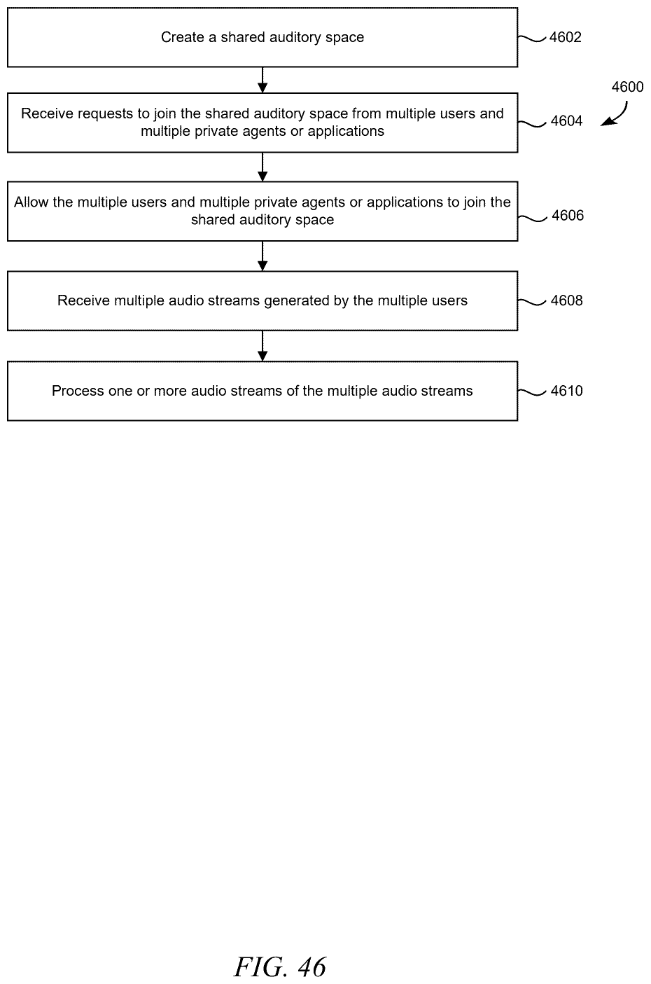

FIG. 46 is a flow diagram illustrating an example method 4600 that some embodiments of aspects of the described technology may perform. The method 4600 may begin at step 4602, where the auditory operating system shell 3818 creates a shared auditory space. At step 4604 the auditory operating system shell 3818 receives requests to join the shared auditory space from multiple users and multiple private agents or applications. Each private agent of the multiple private agents or applications is associated with a user of the multiple users. At step 4606 the auditory operating system shell 3818 allows the multiple users and multiple private agents or applications to join the shared auditory space. At step 4608 the auditory operating system shell 3818 receives multiple audio streams generated by the multiple users. At step 4610 the auditory operating system shell 3818 processes one or more audio streams of the multiple audio streams. The auditory operating system shell 3818 may process the one or more audio streams by, for the one or more audio streams of the multiple audio streams, determining if the one or more audio streams are only for one or more private agents or applications associated with the user that generated the one or more audio streams. If the one or more audio streams are only for the one or more private agents or applications, the auditory operating system shell 3818 provides the one or more audio streams to the one or more private agents or applications. If the one or more audio streams are not only for the one or more private agents or applications, the auditory operating system shell 3818 provides the one or more audio streams to at least one other private agent or application associated with a different user in the shared auditory space, and notifies the user that generated the one or more audio streams that the one or more audio streams are provided to the at least one other private agent or application. Additional or alternative steps are possible.

In some aspects, the techniques described herein relate to a method including: creating a shared auditory space; receiving requests to join the shared auditory space from multiple users and multiple private agents or applications, each private agent or application of the multiple private agents or applications associated with a user of the multiple users; allowing the multiple users and multiple private agents or applications to join the shared auditory space; receiving multiple audio streams generated by the multiple users; and for one or more audio streams of the multiple audio streams: determining if the one or more audio streams are only for one or more private agents or applications associated with the user that generated the one or more audio streams; if the one or more audio streams are only for the one or more private agents or applications, providing the one or more audio streams to the one or more private agents or applications; and if the one or more audio streams are not only for the one or more private agents or applications: providing the one or more audio streams to at least one other private agent or application associated with a different user in the shared auditory space; and notifying the user that generated the one or more audio streams that the one or more audio streams are provided to the at least one other private agent.

In some aspects, the techniques described herein relate to a method wherein determining if the one or more audio streams are only for the one or more private agents or applications includes checking permissions defined or approved by the user that the one or more private agents or applications are associated with.

In some aspects, the techniques described herein relate to a method, further including generating a group agent that joins the shared auditory space and is provided with particular audio streams of the multiple audio streams.

In some aspects, the techniques described herein relate to a method wherein if the one or more audio streams are not only for the one or more private agents or applications, further including: determining that the one or more audio streams are to be provided to the group agent; providing the one or more audio streams to the group agent; and performing, by the group agent, one or more actions based on the one or more audio streams provided to the group agent.

In some aspects, the techniques described herein relate to a method wherein performing, by the group agent, the one or more actions includes: requesting, by the group agent, from the user that generated the one or more audio streams, permission to share the one or more audio streams with the at least one other private agent; and receiving, by the group agent, permission to share the one or more audio streams with the at least one other private agent, wherein the group agent provides the one or more audio streams to the at least one other private agent or application and notifies the user that generated the one or more audio streams that the one or more audio streams are provided to the at least one other private agent.

In some aspects, the techniques described herein relate to a method wherein each user of the multiple users is associated with user data accessible to the one or more private agents or applications associated with the user, and further including: requesting, by the group agent, from the user that generated the one or more audio streams, permission to access the user data associated with the user; and receiving, by the group agent, permission to access the user data, wherein the group agent utilizes the user data to perform the one or more actions.

In some aspects, the techniques described herein relate to one or more non-transitory computer-readable media including executable instructions that when executed by one or more processors of a system cause the system to perform a method including: creating a shared auditory space; receiving requests to join the shared auditory space from multiple users and multiple private agents or applications, each private agent or application of the multiple private agents or applications associated with a user of the multiple users; allowing the multiple users and multiple private agents or applications to join the shared auditory space; receiving multiple audio streams generated by the multiple users; and for one or more audio streams of the multiple audio streams: determining if the one or more audio streams are only for one or more private agents or applications associated with the user that generated the one or more audio streams; if the one or more audio streams are only for the one or more private agents or applications, providing the one or more audio streams to the one or more private agents or applications; and if the one or more audio streams are not only for the one or more private agents or applications: providing the one or more audio streams to at least one other private agent or application associated with a different user in the shared auditory space; and notifying the user that generated the one or more audio streams that the one or more audio streams are provided to the at least one other private agent.

In some aspects, the techniques described herein relate to one or more non-transitory computer-readable media wherein determining if the one or more audio streams are only for the one or more private agents or applications includes checking permissions defined or approved by the user that the one or more private agents or applications are associated with.

In some aspects, the techniques described herein relate to one or more non-transitory computer-readable media, the method further including generating a group agent that joins the shared auditory space and is provided with particular audio streams of the multiple audio streams.

In some aspects, the techniques described herein relate to one or more non-transitory computer-readable media wherein if the one or more audio streams are not only for the one or more private agents or applications, the method further including: determining that the one or more audio streams are to be provided to the group agent; providing the one or more audio streams to the group agent; and performing, by the group agent, one or more actions based on the one or more audio streams provided to the group agent.

In some aspects, the techniques described herein relate to one or more non-transitory computer-readable media wherein performing, by the group agent, the one or more actions includes: requesting, by the group agent, from the user that generated the one or more audio streams, permission to share the one or more audio streams with the at least one other private agent; and receiving, by the group agent, permission to share the one or more audio streams with the at least one other private agent, wherein the group agent provides the one or more audio streams to the at least one other private agent or application and notifies the user that generated the one or more audio streams that the one or more audio streams are provided to the at least one other private agent.

In some aspects, the techniques described herein relate to one or more non-transitory computer-readable media wherein each user of the multiple users is associated with user data accessible to the one or more private agents or applications associated with the user, and further including: requesting, by the group agent, from the user that generated the one or more audio streams, permission to access the user data associated with the user; and receiving, by the group agent, permission to access the user data, wherein the group agent utilizes the user data to perform the one or more actions.

In some aspects, the techniques described herein relate to a system including at least one processor and at least one memory including executable instructions that when executed by the at least one processor cause the system to: create a shared auditory space; receive requests to join the shared auditory space from multiple users and multiple private agents or applications, each private agent or application of the multiple private agents or applications associated with a user of the multiple users; allow the multiple users and multiple private agents or applications to join the shared auditory space; receive multiple audio streams generated by the multiple users; and for one or more audio streams of the multiple audio streams: determine if the one or more audio streams are only for one or more private agents or applications associated with the user that generated the one or more audio streams; if the one or more audio streams are only for the one or more private agents or applications, provide the one or more audio streams to the one or more private agents or applications; and if the one or more audio streams are not only for the one or more private agents or applications: provide the one or more audio streams to at least one other private agent or application associated with a different user in the shared auditory space; and notify the user that generated the one or more audio streams that the one or more audio streams are provided to the at least one other private agent or application.

### Developer Platform and Tools

### 1. App Model and Developer Studio for Auditory User Interfaces

While visual application development is supported by mature tools and frameworks (for example, graphical user interface (GUI) designers, prototyping software, interaction pattern libraries), auditory user interfaces—ranging from voice-driven assistants to immersive audio applications—lack similarly robust support. Developers face complexities such as multi-modal input (speech, environmental sound), natural language processing, and sound-based user experience design. Existing integrated development environments (IDEs) and platforms provide little guidance or integrated tooling for these audio-centric use cases, resulting in fragmented workflows and inconsistent user experiences.

The described technology provides technical solutions to these technical problems. A system according to the described technology provides a developer studio and application model designed specifically for creating applications for auditory user interfaces. The system includes an auditory interaction design framework, simulation and testing tools, moderation and policy features, and guidelines and best practices for auditory interaction design. The system may enable developers to create agents for auditory user interfaces. In some embodiments, developers may create agents without necessarily writing software code by responding to system prompts and by providing additional inputs.

The auditory interaction design framework may enable conversation flow modeling by providing graphical or script-based editors that let developers define user-agent dialogues, branching logic, and fallback scenarios without necessarily relying on a visual user interface metaphor. The auditory interaction design framework may also enable acoustic cues and sound design by providing built-in asset management for sound effects, musical motifs, and voice samples and methods for incorporating contextual auditory feedback into agents or other auditory user interface components.

The simulation and testing tools may provide virtual environment simulation by emulating diverse acoustic conditions (for example, quiet rooms, noisy streets) to determine how an application's auditory interactions hold up in real-world usage. The simulation and testing tools may integrate speech to text (STT) and text to speech (TTS) engines to provide for rapid prototyping and debugging, thereby allowing developers to preview user experiences quickly.

The moderation and policy features may facilitate content moderation by providing automated or semi-automated tools to review spoken outputs or potential user inputs for inappropriate content, ensuring compliance with system and legal guidelines. The moderation and policy features may also provide accessibility checks by allowing developers to perform verification routines that assess how well the auditory user interface supports users with different hearing, speech, or cognitive needs.

The system also include guidelines and best practices for auditory interaction design, including auditory user experience (UX) principles in the form of documentation and code samples illustrating common patterns in voice prompts, error handling, and user feedback timing. The system may also provide developer community support in the form of libraries of open-source templates and forums where developers can exchange solutions, which may fuel innovation in emerging audio-centric domains.

The system lowers entry barriers for building immersive, high-quality audio applications. By providing integrated simulation, moderation, and design resources, the system allows developers to iteratively refine auditory experiences—resulting in consistent, user-friendly interfaces for voice-controlled applications, conversational agents, and audio-based entertainment.

Developers may use the system to create various applications. The various applications may include auditory applications and games, such as story-driven audio games, fitness coaches, or interactive entertainment adapted for voice control and minimal visual engagement; conversational agents such as domain-specific voice assistants (for example, medical, financial) featuring robust testing frameworks for real-world acoustic conditions; education and training applications such as language learning tools and immersive simulations that use auditory cues, interactive voice prompts, and real-time feedback; and applications integrated into home appliances, such as appliances or household devices that communicate status and alerts through contextual voice prompts or sound signals.

One advantage of the system is that it provides a purpose-built environment for developing auditory user interfaces that addresses the unique complexities of audio-based development rather than relying on adapted visual frameworks. Another advantage is that the system facilitates an end-to-end workflow by bridging concept, prototyping, testing, and deployment in one system, thereby streamlining development cycles. The system enhances quality and consistency through built-in guidelines and best practices which enable developers to create cohesive user experiences. Another advantage is that by being scalable and open, the system encourages community-driven extensions and libraries for advanced auditory interactions or domain-specific features. The system also lowers barriers to adoption by reducing friction for new developers entering the voice or audio domain, thereby expanding potential innovation in auditory tech.

### 2. Auditory Interface Design Toolkit for Developers

Designing auditory user interfaces (AUIs) introduces complexities not encountered in traditional visual user interface (UI) development. Creating sound-based prompts, accommodating multiple user contexts (for example, noisy or quiet environments), and ensuring accessibility for diverse hearing capabilities require unique processes and tools. Currently, developers often adapt visual-centric frameworks, lacking dedicated resources for audio-first prototyping, testing, and refinement. However, the unique challenges of designing for auditory user interfaces require specialized tools and frameworks that can help developers prototype, test, and refine auditory experiences.

The described technology provides technical solutions to these technical problems. A system according to the described technology provides a toolkit for developers focused on auditory user interface design. The system includes a library of design patterns and audio components, simulation and testing environments, best practice guidelines and accessibility standards, and a rapid prototyping and iteration framework. The toolkit may be in the form of a software development kit (SDK) that developers may use to create auditory user interface applications, such as agents.

The library of design patterns and audio components may include reusable templates such as audio prompts, earcon libraries, and conversation-flow layouts that embody best practices for clarity and user engagement. The library of design patterns and audio components may also include interaction models that provide recommendations for call-and-response, context switching, and fallback behaviors tailored to audio interactions.

The simulation and testing environments may include acoustic emulators that replicate various environmental noise profiles—such as busy urban streets, quiet libraries, or moderate office chatter—so developers can assess AUI performance.

The simulation and testing environments may include promote inclusive auditory conditions by providing emulation modes for hearing impairments (for example, high-frequency loss). This may allow developers to ensure their designs remain intelligible and user-friendly.

The best practice guidelines and accessibility standards may include documentation and case studies that provide references to successful AUI designs and problem-solving patterns for common audio-interaction hurdles (for example, overlapping prompts, unclear error handling). The best practice guidelines and accessibility standards may also include accessibility recommendations that provide approaches to volume calibration, speech clarity, and alternate feedback (haptic, visual assist) when sound cues alone are insufficient.

The rapid prototyping and iteration framework may include code samples and integrations such as pluggable modules for voice input, audio output handling, and logic flow, thereby reducing the need to implement them from scratch. The rapid prototyping and iteration framework may also include real-time testing and metrics tools for monitoring user responses, error rates, and perceived usability, enabling ongoing iteration and data-driven improvements.

By centralizing these capabilities in one toolkit, the system allows developers to accelerate the creation of robust, intuitive, and accessible auditory interfaces across a range of platforms and devices offering a library of design patterns, audio components, testing simulations for different acoustic environments, and guidelines for creating accessible and user-friendly auditory interfaces.

The toolkit may be utilized for development for wearable devices such as earbuds, augmented reality headsets, or fitness trackers, as these and similar devices may require consistent, clear audio prompts for user interaction. The toolkit may also be utilized to develop voice-driven appliances or control hubs for the home that may benefit from tested and refined audio cues for daily tasks. Developers may also utilize the toolkit for automotive systems such as in-vehicle infotainment systems, where eyes-free controls and audible feedback improve driver safety. The toolkit may also be used for general auditory user interface development to develop environments or products that may require hands-free, screen-free, or accessibility-forward design.

One advantage of the system is that it provides for a faster development cycle by consolidating AUI design resources, thereby reducing complexity and time to market. Another advantage relates to enhanced accessibility and inclusiveness, as the system encourages compliance with diverse hearing needs via built-in simulation tools and guidelines. The system promotes best practices through pattern libraries and reference designs, which may reduce guesswork, thereby elevating the quality of auditory interactions. Another advantage is that by providing iterative testing and feedback in realistic environmental simulations, the system ensures prototypes are developed and tuned for real-world scenarios. The system may also adapt to evolving audio technologies, user behavior patterns, or new platforms.

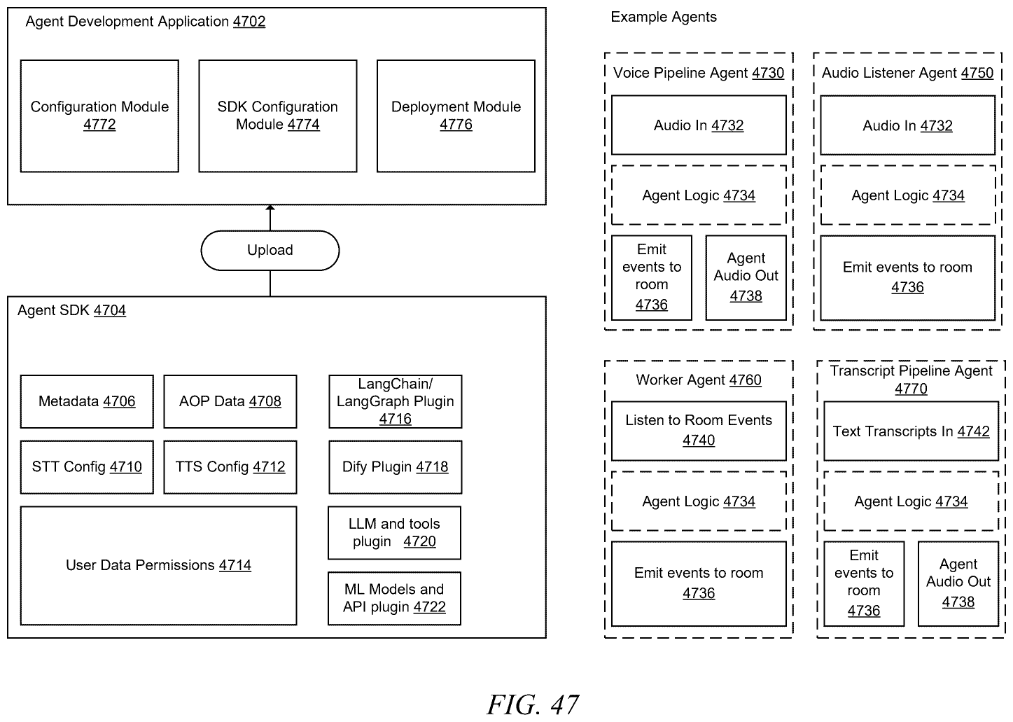

FIG. 47 depicts an agent development application 4702 and an agent SDK 4704 for developing agents according to some embodiments. The agent development application 4702 may allow developers to create agents without necessarily writing software code by responding to system prompts and by providing additional inputs. The agent development application 4702 includes a configuration module 4772, an SDK configuration module 4774, and a deployment module 4776. The configuration module 4772 may receive configuration information for an agent, such as whether the agent supports text to speech (TTS) or speech to text (STT). The configuration information may also include metadata and logic plugins such as tools (for example, Dify or LangChain) and third-party APIs.

The SDK configuration module 4774 may receive configuration information for usage of the agent SDK 4704, such as permissions, application data, and agent variant information. The deployment module 4776 may allow the developer to publish and deploy the agent.

The agent SDK 4704 may enable developers to create agents by writing software code and to specify more detailed workflows. The agent SDK 4704 may include configuration information, such as metadata 4706, AOP data 4708, STT configuration data 4710, TTS configuration data 4712, and user data permissions 4714. The agent SDK 4704 may also include plugins, including a LangChain/LangGraph plugin 4716, a Dify plugin 4718, a large language model (LLM) and tools plugin 4720, and a machine learning (ML) and API plugin 4722. The plugins may allow applications that incorporate the agent SDK 4704 to access third party tools such as large language models, machine learning or artificial intelligence models, or third-party APIs. If a developer builds an agent using the agent SDK 4704 the developer can upload and manage the agent metadata in the agent development application 4702.

FIG. 47 also depicts example agents that developers may create using the agent development application 4702 or the agent SDK 4704. The example agents include a voice pipeline agent 4730, an audio listener agent 4750, a worker agent 4760, and a transcript pipeline agent 4770. Certain modules or components of an agent, such as the agent logic component 4734, may be customized by the developer. Other components or modules, such as an audio in component 4732, an emit events to room component 4736, an agent audio out component 4738, a listen to room events component 4740, and a text transcripts in component 4742, may be provided by the agent development application 4702 or the agent SDK 4704 as standard components to aid in the development of agents.

FIG. 48 depicts a block diagram of an example digital device 4800 according to some embodiments. The digital device 4800 is shown in the form of a general-purpose computing device. The digital device 4800 includes at least one processor 4802, RAM 4804, communication interface 4806, input/output device 4808, storage 4810, and a system bus 4812 that couples various system components including storage 4810 to the at least one processor 4802. A system, such as a computing system, may be or include one or more of the digital devices 4800.

System bus 4812 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

The digital device 4800 typically includes a variety of computer system readable media, such as computer system readable storage media. Such media may be any available media that is accessible by any of the systems described herein and it includes both volatile and nonvolatile media, removable and non-removable media.

In some embodiments, the at least one processor 4802 is configured to execute executable instructions (for example, programs). In some embodiments, the at least one processor 4802 comprises circuitry or any processor capable of processing the executable instructions.

In some embodiments, RAM 4804 stores programs or data. In various embodiments, working data is stored within RAM 4804. The data within RAM 4804 may be cleared or ultimately transferred to storage 4810, such as prior to reset or powering down the digital device 4800.

In some embodiments, the digital device 4800 is coupled to a network via communication interface 4806. The digital device 4800 can communicate with one or more networks such as a local area network (LAN), a general wide area network (WAN), or a public network (for example, the Internet).

In some embodiments, input/output device 4808 is any device that inputs data (for example, mouse, keyboard, stylus, sensors, etc.) or outputs data (for example, speaker, display, virtual reality headset).

In some embodiments, storage 4810 can include computer system readable media in the form of non-volatile memory, such as read only memory (ROM), programmable read only memory (PROM), solid-state drives (SSD), flash memory, or cache memory. Storage 4810 may further include other removable/non-removable, volatile/non-volatile computer system storage media. By way of example only, storage 4810 can be provided for reading from and writing to a non-removable, non-volatile magnetic media. The storage 4810 may include a non-transitory computer-readable medium, or multiple non-transitory computer-readable media, which stores programs or applications for performing functions. Although not shown, a magnetic disk drive for reading from and writing to a removable, non-volatile magnetic disk (for example, a floppy disk), and an optical disk drive for reading from or writing to a removable, non-volatile optical disk such as a CDROM, DVD-ROM or other optical media can be provided. In such instances, each can be connected to system bus 4812 by one or more data media interfaces. As will be further depicted and described below, storage 4810 may include at least one program product having a set (for example, at least one) of program modules that are configured to carry out the functions of embodiments of the technology. In some embodiments, RAM 4804 is found within storage 4810.

Programs/utilities, having a set (at least one) of program modules, such as the property layout system, may be stored in storage 4810 by way of example, and not limitation, as well as an operating system, one or more application programs, other program modules, and program data. Each of the operating system, one or more application programs, other program modules, and program data or some combination thereof, may include an implementation of a networking environment. Program modules generally carry out the functions or methodologies of embodiments of the technology as described herein.

It should be understood that although not shown, other hardware or software components could be used in conjunction with the digital device 4800. Examples include, but are not limited to microcode, device drivers, redundant processing units, and external disk drive arrays, RAID systems, tape drives, and data archival storage systems, etc.

Exemplary embodiments are described herein in detail with reference to the accompanying drawings. However, the present disclosure can be implemented in various manners, and thus should not be construed to be limited to the embodiments disclosed herein. On the contrary, those embodiments are provided for the thorough and complete understanding of the present disclosure, and completely conveying the scope of the present disclosure.

It will be appreciated that aspects of one or more embodiments may be embodied as a system, method, or computer program product. Accordingly, aspects may take the form of an entirely hardware embodiment, an entirely software embodiment (including firmware, resident software, micro-code, etc.) or an embodiment combining software and hardware aspects that may all generally be referred to herein as a circuit, module or system. Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), a solid state drive (SSD), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program or data for use by or in connection with an instruction execution system, apparatus, or device.

A transitory computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present technology may be written in any combination of one or more programming languages, including an object-oriented programming language such as Java, Smalltalk, C++, Python, or the like and conventional procedural programming languages, such as the C programming language or similar programming languages. The computer program code may execute entirely on any of the systems described herein or on any combination of the systems described herein.

Aspects of the present technology are described below with reference to flowchart illustrations or block diagrams of methods, apparatus (systems) and computer program products according to embodiments of the technology. It will be understood that each block of the flowchart illustrations or block diagrams, and combinations of blocks in the flowchart illustrations or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart or block diagram block or blocks.

While particular elements, embodiments and applications have been shown and described, it will be understood, of course, that the claims are not limited thereto since modifications may be made by those skilled in the art without departing from the spirit and scope of the present disclosure, particularly in light of the foregoing teachings. Such modifications are to be considered within the purview and scope of the claims appended hereto.

While specific examples are described above for illustrative purposes, various equivalent modifications are possible. For example, while processes or blocks are presented in a given order, alternative implementations may perform routines having steps, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed or implemented concurrently or in parallel or may be performed at different times. Further any specific numbers noted herein are only examples: alternative implementations may employ differing values or ranges.

Throughout this specification, plural instances may implement components, operations, or structures described as a single instance. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. Furthermore, any specific numbers noted herein are only examples: alternative implementations may employ differing values or ranges.

Components may be described or illustrated as contained within or connected with other components. Such descriptions or illustrations are only examples, and other configurations may achieve the same or similar functionality. Components may be described or illustrated as “coupled,” “couplable,” “operably coupled,” “communicably coupled” and the like to other components. Such description or illustration should be understood as indicating that such components may cooperate or interact with each other, and may be in direct or indirect physical, electrical, or communicative contact with each other.

Components may be described or illustrated as “configured to,” “adapted to,” “operative to,” “configurable to,” “adaptable to,” “operable to” and the like. Such description or illustration should be understood to encompass components both in an active state and in an inactive or standby state unless required otherwise by context.

The use of “or” in this disclosure is not intended to be understood as an exclusive “or.” Rather, “or” is to be understood as including “and/or.” For example, the phrase “providing products or services” is intended to be understood as having several meanings: “providing products,” “providing services,” and “providing products and services.”

Headings in this application may be provided for organization and may not necessarily be used to interpret or constrain the purview and scope of the claims appended hereto. Moreover, concepts or features of technologies described under a particular heading may be used in technologies described under other headings. Accordingly, technologies described under a particular heading are not limited to the concepts or features described under that particular heading.

It may be apparent that various modifications may be made, and other embodiments may be used without departing from the broader scope of the discussion herein. Therefore, these and other variations upon the example embodiments are intended to be covered by the disclosure herein.

1. A method comprising:
receiving, by an auditory operating system shell, an input, the input obtained from speech or another audio cue of a user;
identifying, by the auditory operating system shell, one or more commands or queries included in the input;
accessing, by the auditory operating system shell, multiple agents or applications, each agent or application of the multiple agents or applications associated with a domain of multiple domains;
identifying, by the auditory operating system shell, based on the one or more commands or queries, one or more domains and one or more agents or applications associated with the one or more domains, wherein the auditory operating system shell may identify an agent or application without the input including a name of the agent or application;
generating, by the auditory operating system shell, based on the one or more commands or queries, one or more instructions for the one or more agents or applications; and
providing, by the auditory operating system shell, the one or more instructions to the one or more agents or applications,
wherein the one or more agents or applications perform, based on the one or more instructions, one or more actions, the one or more actions responsive to the one or more commands or queries.

2. The method of claim 1 wherein the multiple agents or applications may be permitted access to functions or data associated with the user and the auditory operating system shell controls access of the multiple agents to the functions or the data.

3. The method of claim 1 wherein the speech of the user is captured by one or more devices configured to capture the speech of the user and output audio, and further comprising:
receiving, by the auditory operating system shell, one or more responses from the one or more agents;
generating, by the auditory operating system shell, based on the one or more responses, a reply to the input; and
providing, by the auditory operating system shell, the reply for output as audio by the one or more devices.

4. The method of claim 1 wherein the speech of the user is captured by one or more devices configured to capture the speech of the user and output audio, providing, by the auditory operating system shell, the one or more instructions to the one or more agents or applications includes providing, by the auditory operating system shell, first instructions to a first agent or application to perform a foreground action and second instructions to a second agent or application to perform a background action, and further comprising:
receiving, by the auditory operating system shell, a first indication from the first agent or application that the foreground action is complete; and
receiving, by the auditory operating system shell, a second indication from the second agent or application that the background action is complete,
wherein the one or more devices output first audio indicating that the foreground action is complete at a first time and second audio indicating that the background action is complete at a second time later than the first time.

5. The method of claim 1 wherein the speech of the user is captured by one or more devices configured to capture the speech of the user and output spatial audio, the one or more actions include a first action and a second action, and further comprising:
determining a first spatial audio location for first spatial audio corresponding to the first action and a second spatial audio location for second spatial audio corresponding to the second action,
wherein the one or more devices output the first spatial audio at the first spatial audio location and the second spatial audio at the second spatial audio location.

6. The method of claim 1 wherein the user is a first user, the speech of the first user is in a presence of a second user, and further comprising determining, by the auditory operating system shell, that the one or more commands or queries are directed to the auditory operating system shell and not to the second user.

7. The method of claim 1 wherein the multiple agents or applications may be permitted access to user preference data associated with the user and device data associated with a device of the user, the auditory operating system shell controls access of the multiple agents or applications to the user preference data and the device data, and the one or more agents or applications utilize the user preference data or the device data to perform the one or more actions.

8. The method of claim 1 wherein the multiple agents or applications may be permitted access to data associated with the user, the data including ephemeral data and persistent data, the auditory operating system shell controls access of the multiple agents or applications to the data, the one or more agents or applications include a first agent or application and a second agent or application, and further comprising:
receiving, by the auditory operating system shell, a first request from a first agent or application to access at least a first portion of the ephemeral data to perform a first action and a second request from a second agent or application to access at least a second portion of the persistent data to perform a second action;
accessing, by the auditory operating system shell, one or more rules defined or approved by the user regarding access to the ephemeral data and persistent data;
determining, by the auditory operating system shell, based on the one or more rules, that the first agent or application is permitted to access at least the first portion of the ephemeral data and that the second agent or application is permitted to access at least the second portion of the persistent data; and
granting, by the auditory operating system shell, access to at least the first portion of the ephemeral data to the first agent or application and access to at least the second portion of the persistent data to the second agent or application.

9. The method of claim 1 wherein the speech of the user is captured by one or more devices configured to capture the speech of the user and output audio, and further comprising:
determining, by the auditory operating system shell, a confidence score for the one or more commands or queries for identifying an agent or application;
determining, by the auditory operating system shell, that the confidence score is below a threshold for identifying an agent or application;
generating, by the auditory operating system shell, a first request for clarification of the one or more commands or queries;
providing, by the auditory operating system shell, the first request for clarification for first output as first audio by the one or more devices;
receiving, by the auditory operating system shell, a first clarification of the one or more commands or queries, wherein identification of the one or more agents or applications by the auditory operating system shell is further based on the first clarification;
determining, by the auditory operating system shell, that a portion of the one or more commands or queries is ambiguous;
generating, by the auditory operating system shell, a second request for clarification of the portion of the one or more commands or queries;
providing, by the auditory operating system shell, the second request for clarification for second output as second audio by the one or more devices; and
receiving, by the auditory operating system shell, a second clarification of the portion of the one or more commands or queries, wherein providing of the one or more instructions to the one or more agents or applications by the auditory operating system shell is further based on the second clarification.

10. The method of claim 9 wherein the speech is first speech, the first clarification is obtained from second speech of the user, and the second clarification is obtained from third speech of the user.

11. The method of claim 9 wherein the one or more devices are further configured to detect a gaze, a head orientation, or a dwell time of the user, the first clarification is obtained from first gaze, head orientation, or dwell time detection of the user, and the second clarification is obtained from second gaze, head orientation, or dwell time detection of the user.

12. The method of claim 9 wherein the speech is first speech, the one or more devices are further configured to detect a head orientation of the user, identification of the one or more agents by the auditory operating system shell is further based on a first detected head orientation of the user, and the second clarification is obtained from a second detected head orientation of the user or second speech of the user.

13. One or more non-transitory computer-readable media comprising executable instructions that when executed by one or more processors of a system cause the system to perform a method comprising:
receiving, by an auditory operating system shell, an input, the input obtained from speech of a user;
identifying, by the auditory operating system shell, one or more commands or queries included in the input;
accessing, by the auditory operating system shell, multiple agents or applications, each agent or application of the multiple agents or applications associated with a domain of multiple domains;
identifying, by the auditory operating system shell, based on the one or more commands or queries, one or more domains and one or more agents or applications associated with the one or more domains, wherein the auditory operating system shell may identify an agent or application without the input including a name of the agent;
generating, by the auditory operating system shell, based on the one or more commands or queries, one or more instructions for the one or more agents or applications; and
providing, by the auditory operating system shell, the one or more instructions to the one or more agents or applications,
wherein the one or more agents or applications perform, based on the one or more instructions, one or more actions, the one or more actions responsive to the one or more commands or queries.

14. The one or more non-transitory computer-readable media of claim 13 wherein the multiple agents or applications may be permitted access to functions or data associated with the user and the auditory operating system shell controls access of the multiple agents or applications to the functions or the data.

15. The one or more non-transitory computer-readable media of claim 13 wherein the speech of the user is captured by one or more devices configured to capture the speech of the user and output audio, and the method further comprises:
receiving, by the auditory operating system shell, one or more responses from the one or more agents or applications;
generating, by the auditory operating system shell, based on the one or more responses, a reply to the input; and
providing, by the auditory operating system shell, the reply for output as audio by the one or more devices.

16. The one or more non-transitory computer-readable media of claim 13 wherein the speech of the user is captured by one or more devices configured to capture the speech of the user and output audio, providing, by the auditory operating system shell, the one or more instructions to the one or more agents or applications includes providing, by the auditory operating system shell, first instructions to a first agent or application to perform a foreground action and second instructions to a second agent or application to perform a background action, and the method further comprises:
receiving, by the auditory operating system shell, a first indication from the first agent or application that the foreground action is complete; and
receiving, by the auditory operating system shell, a second indication from the second agent or application that the background action is complete,
wherein the one or more devices output first audio indicating that the foreground action is complete at a first time and second audio indicating that the background action is complete at a second time later than the first time.

17. The one or more non-transitory computer-readable media of claim 13 wherein the speech of the user is captured by one or more devices configured to capture the speech of the user and output spatial audio, the one or more actions include a first action and a second action, and the method further comprises:
determining a first spatial audio location for first spatial audio corresponding to the first action and a second spatial audio location for second spatial audio corresponding to the second action,
wherein the one or more devices output the first spatial audio at the first spatial audio location and the second spatial audio at the second spatial audio location.

18. The one or more non-transitory computer-readable media of claim 13 wherein the user is a first user, the speech of the first user is in a presence of a second user, and further comprising determining, by the auditory operating system shell, that the one or more commands or queries are directed to the auditory operating system shell and not to the second user.

19. The one or more non-transitory computer-readable media of claim 13 wherein the multiple agents or applications may be permitted access to user preference data associated with the user and device data associated with a device of the user, the auditory operating system shell controls access of the multiple agents or applications to the user preference data and the device data, and the one or more agents or applications utilize the user preference data or the device data to perform the one or more actions.

20. The one or more non-transitory computer-readable media of claim 13 wherein the multiple agents or applications may be permitted access to data associated with the user, the data including ephemeral data and persistent data, the auditory operating system shell controls access of the multiple agents or applications to the data, the one or more agents or applications include a first agent or application and a second agent or application, and the method further comprises:
receiving, by the auditory operating system shell, a first request from a first agent or application to access at least a first portion of the ephemeral data to perform a first action and a second request from a second agent or application to access at least a second portion of the persistent data to perform a second action;
accessing, by the auditory operating system shell, one or more rules defined or approved by the user regarding access to the ephemeral data and persistent data;
determining, by the auditory operating system shell, based on the one or more rules, that the first agent or application is permitted to access at least the first portion of the ephemeral data and that the second agent or application is permitted to access at least the second portion of the persistent data; and
granting, by the auditory operating system shell, access to at least the first portion of the ephemeral data to the first agent or application and access at least the second portion of the persistent data to the second agent.

21. The one or more non-transitory computer-readable media of claim 13 wherein the speech of the user is captured by one or more devices configured to capture the speech of the user and output audio, and the method further comprises:
determining, by the auditory operating system shell, a confidence score for the one or more commands or queries for identifying an agent;
determining, by the auditory operating system shell, that the confidence score is below a threshold for identifying an agent;
generating, by the auditory operating system shell, a first request for clarification of the one or more commands or queries;
providing, by the auditory operating system shell, the first request for clarification for first output as first audio by the one or more devices;
receiving, by the auditory operating system shell, a first clarification of the one or more commands or queries, wherein identification of the one or more agents or applications by the auditory operating system shell is further based on the first clarification;
determining, by the auditory operating system shell, that a portion of the one or more commands or queries is ambiguous;
generating, by the auditory operating system shell, a second request for clarification of the portion of the one or more commands or queries;
providing, by the auditory operating system shell, the second request for clarification for second output as second audio by the one or more devices; and
receiving, by the auditory operating system shell, a second clarification of the portion of the one or more commands or queries, wherein providing of the one or more instructions to the one or more agents or applications by the auditory operating system shell is further based on the second clarification.

22. The one or more non-transitory computer-readable media of claim 21 wherein the speech is first speech, the first clarification is obtained from second speech of the user, and the second clarification is obtained from third speech of the user.

23. The one or more non-transitory computer-readable media of claim 21 wherein the one or more devices are further configured to detect a gaze, a head orientation, or a dwell time of the user, the first clarification is obtained from first gaze, head orientation, or dwell time detection of the user, and the second clarification is obtained from second gaze, head orientation, or dwell time detection of the user.

24. The one or more non-transitory computer-readable media of claim 21 wherein the speech is first speech, the one or more devices are further configured to detect a head orientation of the user, identification of the one or more agents or applications by the auditory operating system shell is further based on a first detected head orientation of the user, and the second clarification is obtained from a second detected head orientation of the user or second speech of the user.

25. A system comprising at least one processor and at least one memory including executable instructions that when executed by the at least one processor cause the system to:
receive, by an auditory operating system shell, an input, the input obtained from speech of a user;
identify, by the auditory operating system shell, one or more commands or queries included in the input;
access, by the auditory operating system shell, multiple agents or applications, each agent or application of the multiple agents or applications associated with a domain of multiple domains;
identify, by the auditory operating system shell, based on the one or more commands or queries, one or more domains and one or more agents or applications associated with the one or more domains, wherein the auditory operating system shell may identify an agent or application without the input including a name of the agent;
generate, by the auditory operating system shell, based on the one or more commands or queries, one or more instructions for the one or more agents or applications; and
provide, by the auditory operating system shell, the one or more instructions to the one or more agents or applications,
wherein the one or more agents or applications perform, based on the one or more instructions, one or more actions, the one or more actions responsive to the one or more commands or queries.

26-69. (canceled)
